(19) United States
(12) Patent Application Publication
(10) Pub. No.: US 2025/0050421 A1
(43) Pub. Date: Feb. 13, 2025

(54) ADDITIVE MANUFACTURING, UNPACKING, AND THREE-DIMENSIONAL PRINTERS

(71) Applicant: Velo3D, Inc., Fremont, CA (US)

(72) Inventors: Benyamin Buller, Cupertino, CA (US); Dean Albert Tarrant, Gilroy, CA (US); Joseph Andrew Tralongo, El Cajon, CA (US); Robert Anthony Jacobs, Grass Valley, CA (US); Alexander Vladimirovich Varlakhanov, San Carlos, CA (US); Erel Milshtein, Cupertino, CA (US); Alex Feldman, San Jose, CA (US); Darin Birtwhistle, San Francisco, CA (US); Sergey Korepanov, Los Altos, CA (US); Thomas Brezoczky, Los Gatos, CA (US); Yacov Elgar, Sunnyvale, CA (US)

(73) Assignee: Velo3D, Inc., Fremont, CA (US)

(21) Appl. No.: 18/721,097

(22) PCT Filed: Dec. 14, 2022
(86) PCT No.: PCT/US2022/052902

§ 371 Date: Jun. 17, 2024

Related U.S. Application Data
(63) Continuation-in-part of application No. PCT/US2022/051736, filed on Dec. 2, 2022.
(60) Provisional application No. 63/429,531, filed on Dec. 1, 2022.
(60) Provisional application No. 63/289,787, filed on Dec. 15, 2021.
(60) Provisional application No. 63/289,721, filed on Dec. 15, 2021.
(60) Provisional application No. 63/429,531, filed on Dec. 1, 2022.
(60) Provisional application No. 63/290,293, filed on Dec. 16, 2021.
(60) Provisional application No. 63/289,721, filed on Dec. 15, 2021.
(60) Provisional application No. 63/432,366, filed on Dec. 13, 2022.

(51) Int. Cl. B22F 12/60; B28B 1/00; B28B 11/22; B33Y 40/00

(52) U.S. Cl. CPC B22F 12/60; B28B 1/001; B28B 11/22; B33Y 40/00; B22F 2301/15

(57) ABSTRACT

The present disclosure provides three-dimensional (3D) printing processes, apparatuses, software, devices, and systems for the production of at least one requested 3D object and for removal of a remainder material. The removal may be accomplished when the remainder material exhibits challenging conditions during removal while being safe for a user, the conditions comprising temperature, reactivity, bridging tendency, or possible loss of fluidity.

### RELATED APPLICATIONS

This patent application is related to U.S. Provisional Patent Application Ser. No. 63/289,787 filed Dec. 15, 2021; to U.S. Provisional Patent Application Ser. No. 63/289,721 filed Dec. 15, 2021; to U.S. Provisional Patent Application Ser. No. 63/429,531, filed Dec. 1, 2022; and to International Patent Application Serial No. PCT/US22/51736 filed Dec. 2, 2022; and to U.S. Provisional Patent Application Ser. No. 63/432,366, filed Dec. 13, 2022; each of which is incorporated herein by reference in its entirety.

### BACKGROUND

Three-dimensional (3D) printing (e.g., additive manufacturing) is a process for making a 3D object of any shape from a design. The design may be in the form of a data source such as an electronic data source, or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled, e.g., computer controlled, manually controlled, or both. A 3D printer can be an industrial robot.

3D printing can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layer-wise materialized.

3D models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter alia of paper, polymer, or metal) are cut to shape and joined together.

At times, it may be requested to remove a remainder material from the 3D printing, e.g., after the printing has ended. At times, the starting material used for the 3D printing and/or the remainder of the starting material that did not form the 3D object may be susceptible to ambient atmospheric conditions (e.g., oxygen or humidity). The remainder material may be at a temperature that is difficult and/or hazardous for a user to handle. The remainder may be too hot for the user to safely handle. The remainder material may cause the removal mechanism to clog, e.g., and malfunction. The remainder material may lose its fluidity and/or become bridged (e.g., clump up, aggregate, or agglomerate) during its attempted removal. It may be requested to (e.g., substantially) maintain the remainder material in its fluid state to facilitate its removal, e.g., undisturbed removal. The material removal mechanism may be requested to cool during removal of the material, e.g., using a temperature conditioning system.

In some embodiments, the present disclosure delineates methods, systems, apparatuses, and software that allow modeling of 3D objects with a reduced amount of design constraints (e.g., no design constraints). The present disclosure delineates methods, systems, apparatuses, and software that allow materialization of these 3D object models.

### SUMMARY

In some aspects, the present disclosure resolves the aforementioned hardships.

The removal may be done manually and/or automatically. The removal may reduce direct contact of an operator with a hot remainder material. For example, the removal may be done remotely, e.g., without the user contacts the remainder material during removal. The removal may be facilitated by slots through which the remainder material flows, e.g., using gravity. The slots may be reversibly open and close, e.g., automatically. The material removal may be facilitated using a material removal device such as a vacuum wand. Any of the devices facilitating the material removal may be conditioned with respect to their temperature. Any of the devices facilitating the material removal may include, or be operatively coupled to, a temperature conditioning system. The temperature conditioning system may be configured to cool the remainder material, e.g., to a handling temperature that is safe for a user.

In another aspect, an apparatus for 3D printing of at least one 3D object comprises: an unpacking station configured to facilitate removal of at least a portion of a starting material of the at least one 3D object from the at least one 3D object, which unpacking station comprises a first atmosphere; and a first build module configured to accommodate the at least one 3D object and the starting material, which first build module comprises a second atmosphere, which unpacking station and first build module are configured to reversibly engage, wherein the unpacking station and/or first build module are configured to accommodate a pressure above an ambient pressure at least during the removal. The unpacking station and/or first build module can be configured to maintain a pressure above an ambient pressure during the removal. During the removal, the unpacking station and/or first build module can be configured to facilitate pressure maintenance of the first atmosphere and/or second atmosphere respectively to above ambient pressure. Above ambient pressure can comprise at least 0.3 pound per square inch (PSI) above ambient pressure. The apparatus may further comprise a pressurized gas source. The pressurized gas source may comprise a pressurized gas-cylinder. The gas cylinder may comprise a liquid that expands into a gas. The starting material can be a pre-transformed material that is transformed to form the at least one 3D object during the 3D printing of the at least one 3D object. The starting material can be included in a remainder of a material bed that did not form the at least one 3D object. The unpacking station can be configured to facilitate removal of the remainder from the at least one 3D object. During the removal, the pressure in the unpacking station and/or first build module can be above ambient pressure. The unpacking station and/or first build module can be reversibly sealable. The unpacking station and/or first build module can comprise an opening. The opening can be reversibly sealable. The unpacking station can comprise a first sealable opening by a first lid that is reversibly removable (e.g., removable and engageable). The first build module can comprise a second sealable opening by a second lid that is reversibly removable. Upon engagement of the unpacking station with the first build module, the first lid and second lid can translate to facilitate (i) merging of the first atmosphere with the second atmosphere, (ii) entrance of the at least one 3D object from the first build module into the unpacking station (iii) merging of the first opening with the second opening, (iv) or any combination thereof. The first lid and the second lid can translate while being engaged. The first lid can engage with the second lid prior to being translated. A first translation direction of the first lid can have a horizontal and/or vertical component. A second translation direction of the second lid can have a horizontal and/or vertical component. The first direction and the second direction can be the same. The first direction and the second direction can differ. The apparatus can further comprise a first actuator configured to translate the first lid, and a second actuator configured to translate the second lid. The first actuator can be different from the second actuator. The first actuator and the second actuator can be the same actuator. The first and/or second actuator can be coupled to a first shaft and/or second shaft, respectively. The first and/or second actuator can be part of a first robot and/or second robot, respectively. The first and/or second actuator can be part of a first pick-and-place system and/or second pick-and-place system, respectively. The first and/or second actuator pick-and-place system can comprise a first and/or second shaft, respectively. The first and/or second actuator can be controlled manually and/or automatically by at least one controller. The first and/or second actuator can be configured to be actuated before, during, and/or after removal of the starting material. The first build module can comprise an actuator that facilitates vertically translate (i) a platform and/or (ii) the at least one 3D object. The unpacking station can comprise a vibrator. The first build module can comprise a platform. The platform can be configured to vertically translate using a translation mechanism comprising an encoder, vertical guidepost, vertical screw, horizontal screw, linear motor, bearing, shaft, or bellow. The platform can be configured to vertically translate using a translation mechanism comprising an optical encoder, magnetic encoder, air bearing, ball bearing, or a scissor jack. The platform can be configured to rotate, translate, tilt, and/or vibrate. The platform can be configured to rotate, translate, tilt, and/or vibrate, at least during the removal. The platform can be configured to rotate around a vertical and/or horizontal axis. The first build module can comprise a first removable base that is configured to support the at least one 3D object. The first build module can comprise a platform. The first removable base can be disposed adjacent to the platform. The first base can be configured to translate away from the platform during and/or after the removal. The unpacking station can comprise a second build module that is configured to (I) accommodate the at least one 3D object, (II) reversibly engaging with the unpacking station, (III) accommodate a third atmosphere, (IV) translate to and/or from the unpacking station, or (V) any combination thereof. The second build module can comprise a second base that is configured to accommodate the at least one 3D object after the removal. The second build module can be configured to maintain a pressure above an ambient pressure. The second build module can be configured to facilitate pressure maintenance of the third atmosphere to above ambient pressure. The maintenance of the third atmosphere to above ambient pressure can be during a translation of the second build module to and/or from the unpacking station. The second build module can comprise a third opening that is reversibly sealable by a third lid that is reversibly removable from the third opening (e.g., and to the opening). The apparatus may further comprise one or more valves. The atmosphere in the build module (e.g., first and/or second build module) and/or unpacking station may be replaced prior to entry of a pre-transformed material into the build module and/or unpacking station. The one or more valves may be used to replace (e.g., using suction and/or purging) the atmosphere in the build module (e.g., first and/or second build module) and/or unpacking station. The pressurized gas may be facilitated by a pressurized gas source. The pressurized gas source may comprise a pump or a gas-cylinder. The first atmosphere, the second atmosphere, and the third atmosphere can be (a) above ambient pressure, (b) inert, (c) different from the ambient atmosphere, and/or (d) non-reactive with the pre-transformed material and/or one or more 3D objects during the plurality of 3D printing cycles. The first atmosphere, the second atmosphere, and the third atmosphere can be non-reactive to a degree that does not cause at least one defect in the material properties and/or structural properties of the one or more 3D objects. The first atmosphere, the second atmosphere, and the third atmosphere can be non-reactive to a detectable degree. At least two of the first atmosphere, the second atmosphere, and the third atmosphere, can be detectibly the same. At least two of the first atmosphere, the second atmosphere, and the third atmosphere can differ. The unpacking station can be configured to facilitate contacting and/or manipulating the at least one 3D object from two or more spatial directions. The two or more spatial directions can comprise north, south, east, west, top, and bottom directions. Bottom can be in a direction towards a second platform adjacent to which the one or more 3D objects are disposed. The two or more directions can correspond to Cartesian directions. The Cartesian directions can comprise positive or negative Cartesian directions. The two or more direction can correspond to cardinal points. The contacting can comprise using a live or inanimate operator. The inanimate operator can comprise a shaft or an actuator. The inanimate operator can comprise a robot. The live operator can be a human. The contacting can be directly contacting. The contacting can be indirectly contacting. In some embodiments, the unpacking station comprises slots having covers (e.g., as disclosed herein), the slots being disposed at a floor of the unpacking station floor and are configured to facilitate flow of a remainder material therethrough, the covers being configured to reversibly close and open to cover and uncover the slots respectively. In some embodiments, the unpacking station comprises a material removal device (e.g., as disclosed herein) configured to attract the remainder material. The material removal device comprising a first conduit and a second conduit. The first conduit and the second conduit can be adjusted relative to each other, e.g., in terms of their relative location. The material removal device comprising a vacuum wand.

In another aspect, an apparatus for 3D printing of at least one 3D object comprises at least one controller that is configured to direct the following operations: operation (a) reversible engaging of (i) a first build module that accommodates the at least one 3D object and a starting material of the at least one 3D object, with (ii) an unpacking station that comprises a first atmosphere, which build module comprises a second atmosphere; and Operation (b) removing of at least a portion of the starting material of the at least one 3D object from the at least one 3D object, wherein the unpacking station and/or first build module are configured to accommodate a pressure above an ambient pressure at least during the removal. During removal of the at least the portion of the starting material, the at least one controller can be configured to direct maintaining a pressure above an ambient pressure in the unpacking station and/or first build module. Above ambient pressure can comprise at least 0.3 pound per square inch (PSI) above ambient pressure. The starting material can be a pre-transformed material that is transformed to form the at least one 3D object during the 3D printing of the at least one 3D object. During removal of the at least the portion of the starting material, the pressure in the processing chamber and/or first build module can be above ambient pressure. The unpacking station can comprise a first opening that is reversibly sealable by a first lid. The first build module can comprise a second opening that is reversibly sealable by a second lid (e.g., sealed and become un-sealed by the second lid). Unsealed may comprise opened. The first lid and/or second lid can be translatable. Upon and/or after engagement of the unpacking station with the first build module, the at least one controller can be collectively or separately configured to direct translation of a first lid and/or a second lid to facilitate (I) merging of the first atmosphere with the second atmosphere, (II) entrance of the at least one 3D object from the first build module into the unpacking station (III) merging of the first opening with the second opening, (IV) coupling the first lid with the second lid, (V) translating the first lid and the second lid, or (VI) any combination thereof. The first build module can engage with the unpacking station through a second load lock. The at least one controller can be collectively or separately configured to direct translation of a first lid and/or a second lid while the first build module is engaged with the unpacking station. The first lid can be coupled to the second lid during and/or after engagement of the first build module with the processing chamber. The first lid can be coupled to the second lid prior to the translation. A first translation direction of the first lid can have a horizontal and/or vertical component. A second translation direction of the second lid can have a horizontal and/or vertical component. The first direction and the second direction can be the same. The first direction and the second direction can differ. The at least one controller can be collectively or separately configured to direct an actuator to cause vertical translation of a platform and/or of the at least one 3D object. At least one controller can be collectively or separately configured to direct rotation, horizontal translation, tilting, and/or vibration of the platform. Rotation, translation, tilting, and/or vibration of the platform can be at least during removing of the at least the portion of the starting material. The rotation can be around a vertical and/or horizontal axis. The first build module can comprise a first removable base that is configured to support the at least one 3D object. The first build module can comprise a platform. The first removable base can be disposed adjacent to the platform. The build module can comprise a first base adjacent to which the at least one 3D object is disposed. At least one controller can be collectively or separately configured to direct translation of a first base away from the platform during and/or after the removal. At least one controller can be collectively or separately configured to direct (I) transfer of the at least one 3D object to a second build module, (II) reversible engagement of the second build module with the unpacking station, (III) maintenance of a third atmosphere in the second build module, (IV) translation of the second build module to and/or from the unpacking station, or (V) any combination thereof. Maintenance of the third atmosphere in the second build module can comprise maintenance of an atmosphere that (1) has a pressure above ambient pressure, (2) is inert, (3) is different from the ambient atmosphere, (4) is non-reactive with the pre-transformed material and/or one or more 3D objects during the plurality of 3D printing cycles, (5) comprises a reactive agent below a threshold, or (6) any combination thereof. Maintenance of the pressure of the third atmosphere to above ambient pressure can be during a translation of the second build module to and/or from the unpacking station. At least one controller can be collectively or separately configured to direct removal and/or engagement of a third lid from or with a third opening of the second build module, respectively. At least one controller can be collectively or separately configured to direct removal and/or engagement of a fourth lid from or with a fourth opening of the unpacking station, respectively. At least one controller can be collectively or separately configured to direct engagement of the second build module with the unpacking station. The second build module can engage with the unpacking station by (I) merging the third opening with the fourth opening, (II) coupling the third lid to the fourth lid, (III) translating the third lid and the fourth lid, (IV) merging the first atmosphere and the third atmosphere, (V) translating the at least one 3D object from the unpacking station to the second build module, or (VI) any combination thereof. The second build module can engage with the unpacking station through a first load lock. At least one controller can be collectively or separately configured to direct entrance and/or removal of the at least one 3D object to or from the unpacking station, respectively. At least one controller can be collectively or separately configured to direct entrance and/or removal of a first base to or from the unpacking station respectively. The first base can be part of the first build module. At least one controller can be collectively or separately configured to direct entrance and/or removal of a second base to or from the unpacking station respectively. The second base can be part of the second build module. The first atmosphere, the second atmosphere, and/or the third atmosphere can be (a) above ambient pressure, (b) inert, (c) different from the ambient atmosphere, and/or (d) non-reactive with the pre-transformed material and/or one or more 3D objects during the plurality of 3D printing cycles. The first atmosphere, the second atmosphere, and the third atmosphere can be non-reactive to a degree that does not cause at least one defect in the material properties and/or structural properties of the one or more 3D objects (e.g., which defect is caused during the printing). The first atmosphere, the second atmosphere, and/or the third atmosphere can be non-reactive to a detectable degree. At least two of the first atmosphere, the second atmosphere, and the third atmosphere can be detectibly the same. At least two of the first atmosphere, the second atmosphere, and the third atmosphere can differ. The unpacking station can be configured to facilitate contacting and/or manipulating the at least one 3D object from two or more spatial directions. At least one controller can be collectively or separately configured to direct contacting the at least one 3D object. Direct contacting can comprise directing usage of a shaft or an actuator. Contacting can be indirect and/or direct contacting. In some embodiments, the unpacking station comprises slots having covers (e.g., as disclosed herein), the slots being disposed at a floor of the unpacking station floor and are configured to facilitate flow of a remainder material therethrough, the covers being configured to reversibly close and open to cover and uncover the slots respectively. In some embodiments, the unpacking station comprises a material removal device (e.g., as disclosed herein) configured to attract the remainder material. The material removal device comprising a first conduit and a second conduit. The first conduit and the second conduit can be adjusted relative to each other, e.g., in terms of their relative location. The material removal device comprising a vacuum wand.

In another aspect, a method for 3D printing of at least one 3D object comprises: (a) reversibly engaging (i) a first build module that accommodates the at least one 3D object and a starting material of the at least one 3D object, with (ii) an unpacking station that comprises a first atmosphere, which build module comprises a second atmosphere; and (b) removing at least a portion of the starting material of the at least one 3D object from the at least one 3D object, wherein the unpacking station and/or first build module are configured to accommodate a pressure above an ambient pressure at least during the removal. The method can further comprise during the removing, maintaining a pressure above an ambient pressure in the unpacking station and/or first build module. Above ambient pressure can comprise at least half (0.5) a pound per square inch (PSI) above ambient pressure. The starting material can be a pre-transformed material that is transformed to form the at least one 3D object during the 3D printing of the at least one 3D object. During the removing of the at least the portion of the starting material, the pressure in the processing chamber and/or first build module can be above ambient pressure. The unpacking station can comprise a first opening that is reversibly sealable by a first lid. The first build module can comprise a second opening that is reversibly sealable by a second lid, wherein the method further comprises translating the first lid and/or second lid. Translating of the first lid and/or the second lid can be while the first build module is engaged with the unpacking station. Translating of the first lid and/or the second lid can be upon and/or after reversibly engaging the unpacking station with the first build module to facilitate (I) merging of the first atmosphere with the second atmosphere, (II) entrance of the at least one 3D object from the first build module into the unpacking station (III) merging of the first opening with the second opening, (IV) coupling the first lid with the second lid, (V) translating the first lid and the second lid, or (VI) any combination thereof. The first lid can be coupled to the second lid during and/or after engagement of the first build module with the processing chamber. The first lid can be coupled to the second lid prior to translating. The method can further comprise vertically translating a platform and/or the at least one 3D object. The method can further comprise rotating, tilting, horizontally translating and/or vibrating the platform. Rotating, tilting, horizontally translating and/or vibrating the platform can be at least during the removing of the at least the portion of the starting material. Rotating can be around a vertical and/or horizontal axis. The method can further comprise translating a first removable base, wherein the first build module comprises a platform and the first removable base disposed adjacent to the platform adjacent to which the at least one 3D object is disposed. Translating of the first removable base can be during and/or after removing the at least the portion of the starting material. Translating of the first removable base can be away from the platform, unpacking station, and/or at least one 3D object. The method can further comprise (I) transferring the at least one 3D object to a second build module, (II) reversibly engaging of the second build module with the unpacking station, (III) maintaining a third atmosphere in the second build module, and/or (IV) translating the second build module to and/or from the unpacking station. Maintaining the third atmosphere in the second build module can comprise maintaining an atmosphere that (1) has a pressure above ambient pressure, (2) is inert, (3) is different from the ambient atmosphere, and/or (4) is non-reactive with the pre-transformed material and/or one or more 3D objects during the plurality of 3D printing cycles. Maintaining the pressure of the third atmosphere to above ambient pressure can be during a translation of the second build module to and/or from the unpacking station. The method can further comprise removing and/or engaging of a third lid from or with a third opening of the second build module, respectively. The method can further comprise removing and/or engaging a fourth lid from or with a fourth opening of the unpacking station, respectively. The method can further comprise removing and/or engaging the second build module with the unpacking station. The second build module can engage with the unpacking station by (I) merging the third opening with the fourth opening, (II) coupling the third lid to the fourth lid, (III) translating the third lid and the fourth lid, (IV) merging the first atmosphere and the third atmosphere, (V) translating the at least one 3D object from the unpacking station to the second build module, or (VI) any combination thereof. The second build module can engage with the unpacking station through a first load lock. The method can further comprise entering and/or exiting the at least one 3D object to or from the unpacking station, respectively. The method can further comprise entering and/or exiting a first base to or from the unpacking station respectively. The first base can be part of the first build module. The method can further comprise entering and/or exiting a second base to or from the unpacking station respectively. The second base can be part of the second build module. The method can further comprise contacting and/or manipulating the at least one 3D object from two or more spatial directions. Contacting can comprise using of a shaft or an actuator. Contacting can be indirect and/or direct contacting. In some embodiments, the unpacking station comprises slots having covers (e.g., as disclosed herein), the slots being disposed at a floor of the unpacking station floor and are configured to facilitate flow of a remainder material therethrough, the covers being configured to reversibly close and open to cover and uncover the slots respectively. In some embodiments, the unpacking station comprises a material removal device (e.g., as disclosed herein) configured to attract the remainder material. The material removal device comprising a first conduit and a second conduit. The first conduit and the second conduit can be adjusted relative to each other, e.g., in terms of their relative location. The material removal device comprising a vacuum wand.

In another aspect, an apparatus for 3D printing of at least one 3D object comprises: an unpacking station configured to facilitate removal of at least a portion of a starting material of the at least one 3D object from the at least one 3D object, which unpacking station comprises a first opening that is reversibly closable and a second opening that is reversibly closable; a first build module configured to accommodate the at least one 3D object, which first build module comprises a third opening that is reversibly closable (e.g., can close and open); and a second build module configured to accommodate the at least one 3D object, which second build module comprises a fourth opening that is reversibly closable, which unpacking station, first build module, and second build module are configured to reversibly engage (e.g., can engage and disengage). The unpacking station and/or first build module may be configured to accommodate a pressure above an ambient pressure at least during the removal of the starting material. The second build module can be configured to engage with the unpacking station before and/or during the removal. The first build module and/or the second build module can be configured to translate. Translation of first build module and/or the second build module can comprise a vertical or horizontal translation. The unpacking station can be configured to facilitate translation of the at least one 3D object from the first build module to the second build module through the unpacking station. Translation of the at least one 3D object can comprise a vertical or horizontal translation. The unpacking station can be configured to facilitate transfer of the at least one 3D object from the first build module to the second build module thorough the unpacking station without contacting the ambient atmosphere. The unpacking station first build module and/or the second build module can be configured to maintain a pressure above an ambient pressure (e.g., during the removal). The first build module can comprise a first atmosphere, wherein the second build module can comprise a second atmosphere. The unpacking station can comprise a third atmosphere. During the removal, the first build module, the second build module and/or unpacking station can be configured to facilitate pressure maintenance of the first atmosphere, second atmosphere, and/or third atmosphere to above ambient pressure, respectively. Above ambient pressure can comprise at least half (0.5) a pound per square inch (PSI) above ambient pressure. The unpacking station can be configured to engage with the first build module and/or the second build module without being open to the ambient atmosphere. The unpacking station can be configured to engage with the first build module and/or the second build module while maintaining a pressure above ambient atmosphere in the unpacking station (i) during engagement with the first build module and/or the second build module, (ii) that is engaged with the first build module and/or the second build module, or (iii) any combination thereof. The first build module can comprise a first platform that is configured to vertically translate. The second build module can comprise a second platform that is configured to vertically translate. Vertically translate can comprise using a translation mechanism comprising an encoder, vertical guidepost, vertical screw, horizontal screw, linear motor, bearing, shaft, or bellow. Vertically translate can comprise using a translation mechanism comprising an optical encoder, magnetic encoder, wheel bearing, air bearing, or a scissor jack. The starting material can be a pre-transformed material that is transformed to form the at least one 3D object during the 3D printing of the at least one 3D object. The starting material can be included in a remainder of a material bed that did not form the at least one 3D object. The unpacking station can be configured to facilitate removal of the remainder from the at least one 3D object. Reversibly closable can be reversibly sealable. The first opening can be reversibly closable by a first lid that is reversibly removable. The second opening can be reversibly closable by a second lid that can be reversibly removable. The third opening can be reversibly closable by a third lid that is reversibly removable. The fourth opening can be reversibly closable by a fourth lid that is reversibly removable. The unpacking station can be configured to engage with the first build module. The unpacking station can be configured to engage with the first build module directly or indirectly. The unpacking station can be configured to engage with the first build module through a first load lock. The first opening can be configured to merge with the third opening. Merging of the first opening with the third opening can facilitate atmospheric exchange between the unpacking station and the first build module. Merging of the first opening with the third opening can facilitate translation of the at least one 3D object between the unpacking station and the first build module. Upon engagement of the unpacking station with the first build module, the first lid and third lid can translate to facilitate (i) merging the atmospheres of the unpacking station and the first build module, (ii) entrance of the at least one 3D object from the first build module into the unpacking station (iii) merging of the first opening with the third opening, (iv) or any combination thereof. The first lid and the third lid can translate while being engaged. The first lid can engage with the third lid prior to being translated. A first translation direction of the first lid can have a horizontal and/or vertical component. A third translation direction of the third lid can have a horizontal and/or vertical component. The first direction and the third direction can be the same. The first direction and the third direction can differ. The apparatus can further comprise a first actuator configured to translate the first lid, and a third actuator configured to translate the third lid. The first actuator can be different from the third actuator. The first actuator and the third actuator can be the same actuator. The first and/or third actuator can be coupled to a first shaft and/or third shaft, respectively. The first and/or third actuator can be part of a first robot and/or third robot, respectively. The first and/or third actuator can be part of a first pick-and-place system and/or third pick-and-place system, respectively. The first and/or third actuator pick-and-place system can comprise a first and/or third shaft, respectively. The first and/or third actuator can be controlled manually and/or automatically by at least one controller. The first and/or third actuator can be controlled before, during, and/or after removal of the starting material. The unpacking station can be configured to engage with the second build module. The unpacking station can be configured to engage with the second build module directly or indirectly. The unpacking station can be configured to engage with the second build module through a second load lock. The second load lock can be the same or different from the first load lock. The second load lock may be similar in shape, features, and/or internal volume to the first load lock. Upon engagement of the unpacking station with the second build module, the second lid and fourth lid can translate to facilitate (i) merging the atmospheres of the unpacking station and the second build module, (ii) entrance of the at least one 3D object from the unpacking station into the second build module (iii) merging of the second opening with the fourth opening, (iv) or any combination thereof. The second lid and the fourth lid can translate while being engaged. The second lid can engage with the fourth lid prior to being translated. A second translation direction of the second lid can have a horizontal and/or vertical component. A fourth translation direction of the fourth lid can have a horizontal and/or vertical component. The second direction and the fourth direction can be the same. The second direction and the fourth direction can differ. The apparatus can further comprise a second actuator configured to translate the second lid, and a fourth actuator configured to translate the fourth lid. The second actuator can be different from the fourth actuator. The second actuator and the fourth actuator can be the same actuator. The second and/or fourth actuator can be coupled to a second shaft and/or fourth shaft, respectively. The second and/or fourth actuator can be part of a second robot and/or fourth robot, respectively. The second and/or fourth actuator can be part of a second pick-and-place system and/or fourth pick-and-place system, respectively. The second and/or fourth actuator pick-and-place system can comprise a second and/or fourth shaft, respectively. The second and/or fourth actuator can be controlled manually and/or automatically by at least one controller. The second and/or fourth actuator can be controlled before, during, and/or after removal of the starting material. The first build module can comprise an actuator that facilitates vertically translation of (i) a first platform and/or (ii) the at least one 3D object. The first build module can comprise an actuator that facilitates vertically translation of (i) a second platform and/or (ii) the at least one 3D object. The unpacking station can comprise a vibrator. The first build module can comprise a first platform. The platform can be configured to rotate, translate, tilt, and/or vibrate. The first platform can be configured to rotate, translate, tilt, vibrate, or any combination thereof, at least during the removal. The first platform can rotate around a vertical and/or horizontal axis. The first build module can comprise a first removable base that is configured to support the at least one 3D object. The first build module can comprise a platform. The first removable base can be disposed adjacent to the platform. The first base can be configured to translate away from the first platform during and/or after the removal. The second build module can be configured to accommodate the first base or a second base that is configured to accommodate the at least one 3D object after the removal. The second base can be configured to translate to the second build module during and/or after the removal. The second build module can comprise a second platform that is configured to vertically translate. The second base can be configured to translate to a second platform disposed in the second build module, during and/or after the removal. The apparatus can further comprise an actuator that is configured to translate the second base from the unpacking station to the second build module. The first base can be configured to translate to the second build module during and/or after the removal. The first base can be configured to translate to the second platform during and/or after the removal. The apparatus can further comprise an actuator that is configured to translate the first base from the unpacking station to the second build module. The apparatus can further comprise an actuator that is configured to translate the first base from the first build module to the unpacking station. The first atmosphere, the second atmosphere, the third atmosphere, or any combination thereof, (a) can be above ambient pressure, (b) can be inert, (c) different from the ambient atmosphere, (d) can be non-reactive with the pre-transformed material and/or one or more 3D objects during the plurality of 3D printing cycles, (e) may comprise a reactive agent below a threshold, or (f) can be any combination thereof. The first atmosphere, the second atmosphere, the third atmosphere can be non-reactive to a degree that does not cause at least one defect in the material properties and/or structural properties of the one or more 3D objects. The first atmosphere, the second atmosphere, the third atmosphere can be non-reactive to a detectable degree. At least two of the first atmosphere, the second atmosphere, and the third atmosphere, fourth can be detectibly the same. At least two of the first atmosphere, the second atmosphere, and the third atmosphere can differ. The unpacking station can be configured to facilitate contacting and/or manipulating the at least one 3D object from two or more spatial directions. The two or more spatial directions can comprise north, south, east, west, top, and bottom directions. Bottom can be in a direction towards a second platform adjacent to which the one or more 3D objects are disposed. The two or more directions can correspond to Cartesian directions. The Cartesian directions can comprise positive or negative Cartesian directions. The two or more direction can correspond to cardinal points. Contacting the at least one 3D object from two or more spatial directions can comprise using a live or inanimate operator. The inanimate operator can comprise a shaft or an actuator. The inanimate operator can comprise a robot. The live operator can be a human. Contacting the at least one 3D object from two or more spatial directions can be directly contacting. Contacting the at least one 3D object from two or more spatial directions can be indirectly contacting. In some embodiments, the unpacking station comprises slots having covers (e.g., as disclosed herein), the slots being disposed at a floor of the unpacking station floor and are configured to facilitate flow of a remainder material therethrough, the covers being configured to reversibly close and open to cover and uncover the slots respectively. In some embodiments, the unpacking station comprises a material removal device (e.g., as disclosed herein) configured to attract the remainder material. The material removal device comprising a first conduit and a second conduit. The first conduit and the second conduit can be adjusted relative to each other, e.g., in terms of their relative location. The material removal device comprising a vacuum wand.

In another aspect, a method for 3D printing of at least one 3D object comprises: (a) reversibly engaging a first build module with an unpacking station, which first build module comprises the at least one 3D object and a starting material of the at least one 3D object; (b) removing at least a portion of a starting material of the at least one 3D object from the at least one 3D object in the unpacking station; (c) reversibly engaging a second build module with the unpacking station; and (d) evacuating the at least one 3D object from the unpacking station by enclosing it in the second build module. The method can further comprise translating the at least one 3D object from the first build module to the unpacking station after operation (a) and/or before operation (b). The method can further comprise translating the at least one 3D object from the unpacking station to the second build module after operation (b) and/or before operation (d). Operation (c) can occur before operation (d). Operation (c) can occur before or simultaneously with operation (b) and/or operation (a). The method can further comprise opening a reversibly closable first opening of the unpacking station, and opening a reversibly closable third opening of the build module after operation (a) and/or before operation (b). The method can further comprise opening a reversibly closable second opening of the unpacking station, and opening a reversibly closable fourth opening of the build module after operation (c) and/or before operation (d). The method can further comprise closing a reversibly closable second opening of the unpacking station, and closing a reversibly closable fourth opening of the build module after operation (c) and/or before operation (d), wherein the closing is after the opening. Engaging the second build module with the unpacking station can be before and/or during operation (b). The method can further comprise translating the first build module and/or the second build module to or from the unpacking station. Translating can comprise a vertical or horizontal translation. The method can further comprise translating the at least one 3D object in the unpacking station. Translation of the at least one 3D object can comprise a vertical or horizontal translation. The unpacking station can be configured to facilitate transfer of the at least one 3D object from the first build module to the second build module thorough the unpacking station without contacting the ambient atmosphere. The method can further comprise, during the removal, maintaining a pressure above an ambient pressure in the unpacking station, first build module, second build module, or any combination thereof. The first build module can comprise a first atmosphere. The second build module can comprise a second atmosphere. The unpacking station can comprise a third atmosphere. The method can further comprise, during the removal, maintaining a pressure above an ambient pressure in the first atmosphere, second atmosphere, third atmosphere, or any combination thereof. Above ambient pressure can comprise at least half (0.5) a pound per square inch (PSI) above ambient pressure. Engaging the unpacking station with the first build module and/or the second build module can be without exposing the first atmosphere, second atmosphere, and/or third atmosphere to the ambient atmosphere. Engaging the unpacking station with the first build module and/or the second build module can further comprise maintaining a pressure above ambient atmosphere in the unpacking station (i) during engagement with the first build module and/or the second build module, (ii) that is engaged with the first build module and/or the second build module, or (iii) any combination thereof. The starting material can be a pre-transformed material that is transformed to form the at least one 3D object during the 3D printing of the at least one 3D object. The starting material can be included in a remainder of a material bed that did not form the at least one 3D object. The unpacking station can be configured to facilitate removal of the remainder from the at least one 3D object. Reversibly closable can be reversibly sealable. The first opening can be reversibly closable (e.g., closed and opened) by a first lid that is reversibly removable (e.g., removed and engaged). The second opening can be reversibly closable by a second lid that is reversibly removable. The third opening can be reversibly closable by a third lid that is reversibly removable. The fourth opening can be reversibly closable by a fourth lid that is reversibly removable. Engaging the first build module with the unpacking station can be directly or indirectly. Engaging the first build module with the unpacking station can be through a first load lock. The method can further comprise merging the first opening with the third opening. Merging the first opening with the third opening can comprise facilitating atmospheric exchange between the unpacking station and the first build module. Merging the first opening with the third opening can comprise facilitating translation of the at least one 3D object between the unpacking station and the first build module. Engaging the unpacking station with the first build module can further comprise translating the first lid and third lid to facilitate (i) merging the atmospheres of the unpacking station and the first build module, (ii) maneuvering the at least one 3D object from the first build module into the unpacking station (iii) merging the first opening with the third opening, (iv) or any combination thereof. Engaging the first lid and the third lid can comprise, or can be followed by, translating the first lid and the third lid while being engaged. Engaging the first lid with the third lid can be prior to translating. Engaging the first build module with the unpacking station can comprise translating the first lid and the second lid. A first translation direction of the first lid can have a horizontal and/or vertical component. A third translation direction of the third lid can have a horizontal and/or vertical component. The method can further comprise translating the first lid with a first actuator, and translating the third lid with a third actuator. The method can further comprise controlling the first actuator and/or third actuator manually, automatically, or both manually and automatically, by at least one controller. Controlling the first actuator, the third actuator, or both the first actuator and the third actuator, can be before, during, and/or after removal of the starting material. Engaging the unpacking station with the second build module can be directly or indirectly. Engaging the unpacking station with the second build module can be indirectly through a second load lock. Upon engaging of unpacking station with the second build module, the method can further comprise translating the second lid and fourth lid to facilitate (i) merging the atmospheres of the unpacking station and the second build module, (ii) entering of the at least one 3D object from the unpacking station into the second build module (iii) merging of the second opening with the fourth opening, (iv) or any combination thereof. Translating the second lid and the fourth lid can be while engaging the second lid and the fourth lid. Translating the second lid and the fourth lid can be before engaging the second lid and the fourth lid. A second translation direction of the second lid can have a horizontal and/or vertical component. A fourth translation direction of the fourth lid can have a horizontal and/or vertical component. The second direction and the fourth direction can be the same. The second direction and the fourth direction can differ. The method can further comprise using at least one controller to control translation of the second lid and/or the fourth lid manually, automatically, or any combination thereof. The method can further comprise vertically translating (i) a first platform and/or (ii) the at least one 3D object. The method can further comprise vertically translating (i) a second platform and/or (ii) the at least one 3D object. The method can further comprise manipulating the first platform, the second platform, or the first platform and the second platform to: rotate, translate, tilt, vibrate, or any combination thereof. Manipulating the first platform, the second platform, or the first platform and the second platform, can be during operation (b). Manipulating the first platform, the second platform, or the first platform and the second platform to rotate can comprise rotating around a vertical and/or horizontal axis. The first build module can comprise a first removable base that is configured to support the at least one 3D object. The method can further comprise translating the first base away from the first platform during and/or after the removal. The second build module can be configured to accommodate the first base or a second base that is configured to accommodate the at least one 3D object after evacuating in operation (d). The method can further comprise translating the second base to the second build module during and/or after the removal. The method can further comprise vertically translating the second platform in the second build module. The method can further comprise translating the second base to the second platform during and/or after the removal. The method can further comprise translating the first base to the second build module during and/or after the removal. The method can further comprise vertically translating a second platform in the second build module. The method can further comprise translating the first base configured to translate to a second platform disposed in the second build module, during and/or after the removal. The first atmosphere, the second atmosphere, the third atmosphere, or any combination thereof, (a) can be above ambient pressure, (b) can be inert, (c) can be different from the ambient atmosphere, (d) can be non-reactive with the pre-transformed material and/or one or more 3D objects during the plurality of 3D printing cycles, (e) can comprise a reactive agent below a threshold (e.g., as disclosed herein), or (f) can be any combination thereof. The first atmosphere, the second atmosphere, the third atmosphere, or any combination thereof can be non-reactive to a degree that does not cause at least one defect in the material properties and/or structural properties of the one or more 3D objects. The first atmosphere, the second atmosphere, the third atmosphere, or any combination thereof can be non-reactive to a detectable degree. At least two of the first atmosphere, the second atmosphere, and the third atmosphere can be detectibly the same. At least two of the first atmosphere, the second atmosphere, and the third atmosphere can differ. The method can further comprise contacting, manipulating, or both contacting and manipulating the at least one 3D object in the unpacking station from two or more spatial directions. The two or more spatial directions can comprise north, south, east, west, top, and bottom directions. The bottom direction can be in a direction towards a second platform adjacent to which the at least one 3D objects are disposed. The two or more directions can correspond to Cartesian directions. The Cartesian directions can comprise positive or negative Cartesian directions. The two or more direction can correspond to cardinal points. Contacting the at least one 3D object in the unpacking station from two or more spatial directions can comprise using a live or inanimate operator. The inanimate operator can comprise a shaft or an actuator. The inanimate operator can comprise a robot. The live operator can be a human. Contacting the at least one 3D object in the unpacking station from two or more spatial directions can be directly contacting. Contacting the at least one 3D object in the unpacking station from two or more spatial directions can be indirectly contacting. In some embodiments, the unpacking station comprises slots having covers (e.g., as disclosed herein), the slots being disposed at a floor of the unpacking station floor and are configured to facilitate flow of a remainder material therethrough, the covers being configured to reversibly close and open to cover and uncover the slots respectively. In some embodiments, the unpacking station comprises a material removal device (e.g., as disclosed herein) configured to attract the remainder material. The material removal device comprising a first conduit and a second conduit. The first conduit and the second conduit can be adjusted relative to each other, e.g., in terms of their relative location. The material removal device comprising a vacuum wand.

In another aspect, a device for three-dimensional printing, the device comprising: a floor of a processing chamber in which one or more three-dimensional objects are printed in the three-dimensional printing, the floor comprises a first hole configured to accommodate a base configured to support a material bed from which the one or more three-dimensional objects are printed, the floor further comprising: holes surrounding the first hole, the four sets of holes configured to facilitate traversal therethrough of any remainder of the material bed that has not formed the one or more three-dimensions objects; flaps configured to cover the holes, which flaps are configured to cover and uncover the holes in a reversible manner, which flaps are configured to hinder, or prevent, traversal therethrough of material associated with the material bed, which flaps are configured to shut the holes during the printing, and uncover the holes after the printing; and one or more collection compartments configured to accommodate after the printing remainder of the material bed that has not formed the one or more three-dimensions objects, which remainder traverses from the processing chamber to the one or more collection compartments through the holes uncovered from the flaps. In some embodiments, the holes comprise four sets of holes. In some embodiments, each set of holes of the four sets of holes is disposed perpendicular to the other. In some embodiments, each set of holes comprises oblong shaped holes. In some embodiments, the flaps are pneumatically actuated. In some embodiments, the flaps are configured to open away from the first hole. In some embodiments, each flap of the flaps comprises one or more hinges. In some embodiments, the flaps are controlled by one or more controllers configured to control one or more energy beams configured to facilitate the printing of the one or more three-dimensional objects. In some embodiments, the processing chamber encloses an atmosphere during the printing that (i) is inert with respect of an ambient atmosphere external to the processing chamber, and/or (ii) has a pressure above ambient pressure external to the processing chamber. In some embodiments, the device encloses an atmosphere during the printing that (i) is inert with respect of an ambient atmosphere external to the processing chamber, and/or (ii) has a pressure above ambient pressure external to the processing chamber. In some embodiments, the device further comprises one or more funnels coupled to the holes and to the one or more collection compartments. In some embodiments, each of the one or more funnels has a wide opening having an aspect ratio different from 1:1. In some embodiments, the aspect ratio of the width to length of the opening is at least 1:2 or greater. In some embodiments, the one or more funnels is a plurality of funnels coupled to the set of holes. In some embodiments, a plurality of funnels have a common wide opening. In some embodiments, the holes are disposed around the first hole, which disposition of the holes is configured to capture the remainder that flows into the holes in a conical and/or pyramidal fashion, e.g., the funnels being part of, or operatively coupled to, a material conveyance system. In some embodiments, the material conveyance system is configured to (I) conveying the remainder material in a direction comprising against a gravitational vector of the ambient environment, (II) conveying the remainder material at least in part by pressurized conveyance, (III) conveying the remainder material for recycling uninterruptedly during the printing, or (IV) any combination of (I) (II) and (III). In some embodiments, conveying the remainder material for recycling uninterruptedly during the printing comprises using two parallel separators and/or two parallel reservoirs.

In another aspect, an apparatus for three-dimensional printing, the apparatus comprising at least one controller configured to control, or direct control of, any of the devices above; wherein the at least one controller is configured to (i) operatively coupled to flaps, and (ii) direct the flaps. In some embodiments, the at least one controller is configured to (I) operatively couple to and (II) direct: energy beams. In some embodiments, the at least one controller comprises, or is operatively coupled to, one or more controllers configured to control the one or more energy beams.

In another aspect, a non-transitory computer readable program instructions for three-dimensional printing, the non-transitory computer readable program instructions, when read by one or more processors, cause one or more processors to control, or direct control of, any of the devices above. In some embodiments, the one or more processors are configured to operatively couple to: one or more energy beams, and wherein the program instructions are configured to direct the energy beams. In some embodiments, the one or more processors comprise, or is operatively coupled to, the one or more controllers configured to control the one or more energy beams.

In another aspect, a method for three-dimensional printing, the method (i) employing any of the devices above, and/or (ii) executing, or directing execution of, one or more operations of any of the devices.

In another aspect, an apparatus for three-dimensional printing, the apparatus comprising at least one controller configured to: control printing one or more three-dimensional objects above a floor of a processing chamber, the floor comprising a first hole accommodating a base supporting a material bed from which the one or more three-dimensional objects are printed; control facilitating traversal of any remainder of the material bed that has not formed the one or more three-dimensions objects through holes in the floor surrounding the first hole; control flaps to selectively cover the holes, which flaps cover and uncover the holes in a reversible manner, which flaps hinder, or prevent, traversal therethrough of material associated with the material bed, which flaps shut the holes during the printing, and uncover the holes after the printing; and control the flaps to uncover the holes, allowing traversal of the printing remainder of the material bed that has not formed one or more three-dimensional object, which remainder traverses from the processing chamber to one or more collection compartments through the holes uncovered from the flaps. In some embodiments, the at least one controller comprises circuitry. In some embodiments, the at least one controller is part of, or is operatively coupled to, a hierarchical network of controllers. In some embodiments, the hierarchical network of controllers comprises three or more control hierarchical control levels. In some embodiments, the hierarchical network of controllers comprises a microcontroller. In some embodiments, the at least one controller is configured to control the three-dimensional printing.

In another aspect, a non-transitory computer readable program instructions for three-dimensional printing, the non-transitory computer readable program instructions, when read by one or more processors, cause one or more processors to execute operations comprising: controlling printing one or more three-dimensional objects above a floor of a processing chamber, the floor comprising a first hole accommodating a base supporting a material bed from which the one or more three-dimensional objects are printed; controlling facilitating traversal of any remainder of the material bed that has not formed the one or more three-dimensions objects through holes in the floor surrounding the first hole; controlling flaps to selectively cover the holes, which flaps cover and uncover the holes in a reversible manner, which flaps hinder, or prevent, traversal therethrough of material associated with the material bed, which flaps shut the holes during the printing, and uncover the holes after the printing; and controlling the flaps to uncover the holes, allowing traversal of the printing remainder of the material bed that has not formed one or more three-dimensional object, which remainder traverses from the processing chamber to one or more collection compartments through the holes uncovered from the flaps. In some embodiments, the one or more processors are part of, or are operatively coupled to, a hierarchical network of processors. In some embodiments, the hierarchical network of processors comprises three or more hierarchical levels. In some embodiments, the hierarchical network of processors comprises a microprocessor. In some embodiments, the one or more processors are configured to control the three-dimensional printing.

In another aspect, a method for three-dimensional printing, the method comprising: printing one or more three-dimensional objects above a floor of a processing chamber, the floor comprising a first hole accommodating a base supporting a material bed from which the one or more three-dimensional objects are printed; facilitating traversal of any remainder of the material bed that has not formed the one or more three-dimensions objects through holes in the floor surrounding the first hole; selectively covering the holes with flaps, which flaps cover and uncover the holes in a reversible manner, which flaps hinder, or prevent, traversal therethrough of material associated with the material bed, which flaps shut the holes during the printing, and uncover the holes after the printing; and selectively uncovering the holes from the flaps, allowing traversal of the printing remainder of the material bed that has not formed one or more three-dimensional object, which remainder traverses from the processing chamber to one or more collection compartments through the holes uncovered from the flaps.

In another aspect, a device for material removal, the device comprises: a first conduit extending along a long axis, the first conduit being hollow and configured to facilitate flow of gaseous and non-gaseous material therethrough from a first opening of the first conduit to a second opening of the first conduit opposing the first opening, the first opening and the second opening being along the long axis of the first conduit; a second conduit extending along the long axis, the second conduit being hollow and configured to facilitate flow of gas, the first conduit being nestled at least in part within the second conduit such that during operation at least a first portion of the first conduit overlaps a second portion of the second conduit; and: (A) the device being configured to reversibly toggle between orientations comprising a first orientation and a second orientation, the first orientation of the first conduit being adjustable with respect to the second orientation of the second conduit along the long axis, where adjustment of the first conduit with respect to the second conduit is configured to cause alteration of an extent of overlap between the first portion of the first conduit and the second portion of second conduit; or (B) the second conduit comprising one or more perforations configured to facilitate flow of the gas into at least a portion of the hollow (e.g., the hollow interior) of the first conduit and/or at least a portion of the hollow of the second conduit. In some embodiments, the second conduit comprising the one or more perforations configured to facilitate flow of the gas within the hollow of the first conduit and along the axis of the first conduit. In some embodiments, a vacuum wand comprises the device. In some embodiments, the one or more perforations comprise perforations arranged about an outer perimeter of the second conduit. In some embodiments, the one or more perforations are distributed evenly about the outer perimeter of the second conduit. In some embodiments, the one or more perforations are distributed at equal, or substantially equal, spacings about the outer perimeter of the second conduit. In some embodiments, the one or more perforations are elongated along the long axis. In some embodiments, the one or more perforations comprise slots, or holes. In some embodiments, the one or more perforations comprise a first dimension along the axis that is smaller than a second dimension of the second conduit along the axis. In some embodiments, the aspect ratio of the second dimension to the first dimension is at least about 1:1.5, 1:2, or 1.3. In some embodiments, during operation of the device, the one or more perforations are configured to act as vents. In some embodiments, first conduit and the second conduit are disposed concentrically. In some embodiments, first conduit and the second conduit are disposed concentrically with the long axis. In some embodiments, the device is configured to be disposed in a chamber configured to print and/or unpack one or more three dimensional objects in a printing cycle of a three-dimensional printing process. In some embodiments, the chamber is of a three-dimensional printer configured to print the one or more three dimensional objects are printed anchorlessly in the material bed. In some embodiments, the chamber comprises a processing chamber or an unpacking chamber. In some embodiments, the processing chamber is configured to act as an unpacking chamber, e.g., during an unpacking operation. In some embodiments, the processing chamber is separate from the unpacking chamber. In some embodiments, the chamber is configured to enclose an internal atmosphere during operation of the device, the internal atmosphere being different by at least one characteristic from an ambient atmosphere external to the chamber, and where the device is configured to operate in the internal atmosphere. In some embodiments, the at least one characteristic comprises a pressure, a temperature, a level or reactive agent that is reactive in the ambient atmosphere with a starting material of a three-dimensional printing process, with a byproduct of the three-dimensional printing, or with a product of the three-dimensional printing. In some embodiments, the pressure comprises a pressure above ambient pressure. In some embodiments, the chamber is configured to maintain the at least one characteristic of the internal atmosphere during operation of the device. In some embodiments, the reactive agent comprises oxygen or water (e.g., humidity). In some embodiments, the byproduct comprises debris. In some embodiments, the debris comprises soot, splatter, or spatter. In some embodiments, the first conduit is operatively coupled to an attractive force source. In some embodiments, the attractive force source comprises a vacuum force source, an electrostatic force source, or a magnetic force source. In some embodiments, the attractive force source comprises a vacuum source. In some embodiments, the device is operatively coupled to, or comprises, a channel coupled to, the second opening of the first conduit and to the attractive force source. In some embodiments, during operation, the device is configured to be disposed in a chamber, and where at least a portion of the channel is disposed in the chamber (e.g., enclosure). In some embodiments, the channel comprises a flexible material. In some embodiments, the channel comprises a non-flexible material. In some embodiments, the channel comprises a polymer or a resin. In some embodiments, the channel comprises, or is operatively coupled to, a bellow. In some embodiments, the channel comprises an elemental metal or a metal alloy. In some embodiments, the channel comprises a first section that is flexible, and a second section that it non-flexible. In some embodiments, the device is configured to operate in a chamber (e.g., enclosure) in which a three-dimensional printing occurs, the chamber comprising an atmosphere having a higher pressure relative to an ambient pressure external to the chamber. In some embodiments, the attractive force source generates an under pressure in the first conduit, the under pressure being (i) lower than the higher pressure and (ii) higher than the ambient pressure. In some embodiments, the non-gaseous material comprises an elemental metal, a metal alloy, a ceramic, or an allotrope of elemental carbon. In some embodiments, the non-gaseous material is a gas borne material. In some embodiments, the non-gaseous material comprises a starting material of a three-dimensional printing process, or a byproduct of a three-dimensional printing process. In some embodiments, the non-gaseous material comprises debris. In some embodiments, the device is configured to attract the non-gaseous material, the material being a remainder of starting material for a three-dimensional printing and/or debris generated during the three-dimensional printing. In some embodiments, the three-dimensional printing process comprises printing one or more three-dimensional objects from a material bed, and where the remainder is of the material bed, the remainder being an unused portion of the material be is not part of the one or more three-dimensional objects. In some embodiments, the device is configured for operation after a three-dimensional printing operation is terminated. In some embodiments, the three-dimensional printing is terminated at the end of a printing cycle. In some embodiments, the three-dimensional printing is terminated prior to a scheduled end of a printing cycle. In some embodiments, the device is configured for operation after completion of a three-dimensional printing cycle. In some embodiments, the device is configured to operatively couple to a material conveyance system configured to recycle the non-gaseous material for usage in three-dimensional printing. In some embodiments, the material conveyance system is configured to (I) conveying the remainder material in a direction comprising against a gravitational vector of the ambient environment, (II) conveying the remainder material at least in part by pressurized conveyance, (III) conveying the remainder material for recycling uninterruptedly during the printing, or (IV) any combination of (I) (II) and (III). In some embodiments, conveying the remainder material for recycling uninterruptedly during the printing comprises using two parallel separators and/or two parallel reservoirs. In some embodiments, the material conveyance system is configured to convey the non-gaseous material against a gravitational vector pointing to the gravitational center of an ambient environment. In some embodiments, the material conveyance system is operatively coupled to a layer dispensing mechanism configured to deposit a material bed utilized in the three-dimensional printing. In some embodiments, the device is configured to operatively couple to (I) a metrological detection system configured to detect a topographical map of an exposed surface of the material bed, (II) an alignment system for energy beams used in the three-dimensional printing, the alignment system based at least in part on printing physical markers and/or projecting optical markers, on the exposed surface of the material bed, or (III) to a combination of (I) and (II). In some embodiments, the material conveyance system is operatively coupled to a layer dispensing mechanism configured to deposit pre-transformed material to form a material bed utilized in the three-dimensional printing. In some embodiments, the layer dispensing mechanism is configured to facilitate deposition of pre-transformed material on a target surface at least in part by layerwise deposition. In some embodiments, the layer dispensing mechanism is configured to deposit pre-transformed material comprising powder material. In some embodiments, the layer dispensing mechanism is configured to deposit pre-transformed material comprising an elemental metal, a metal alloy, a ceramic, or an allotrope of carbon. In some embodiments, the material conveyance system is operatively coupled to a material removal mechanism (e.g., remover) configured to remove a second portion of the deposited pre-transformed material from the target surface to generate a planar layer of pre-transformed material as part of a material bed. In some embodiments, the material removal mechanism is operatively coupled to an attractive force source sufficient to attract the pre-transformed material from the target surface. In some embodiments, the attractive force comprises a magnetic, an electrostatic, or a vacuum source. In some embodiments, the attractive force comprises a vacuum source. In some embodiments, the material removal mechanism is configured to operatively couple to the material conveyance system that (i) recycles at least a fraction of a portion of the pre-transformed material removed by the remover and/or (ii) provides at least a portion of the pre-transformed material utilized by the dispenser. In some embodiments, the portion removed by the material removal mechanism is at least about 70%, 50% or 30% of the deposited pre-transformed material. In some embodiments, the fraction recycled is at least about 70% or 90% of the portion removed by the material removal mechanism and/or by the device. In some embodiments, the material bed generated on a surface of a build plate comprising at least one fundamental length scale having a value of at least about 300 mm or 350 mm. In some embodiments, the material bed generated on a surface of a build plate comprising at least one fundamental length scale having a value of at least about 500 mm, or 600 mm. In some embodiments, the material bed generated on a surface of a build plate comprising at least one fundamental length scale having a value of at least about 1000 mm, 1200 mm, 1500 mm, or 1750 mm. In some embodiments, the material bed generated on a surface of a build plate and supported by the build plate configured to support a weight of at least about 1000 kg. In some embodiments, the material bed generated on a surface of a build plate operatively coupled to an elevator mechanism comprising a bent arm, the elevation mechanism comprising a shaft operatively coupled to the bent arm, the shaft being vertically translatable by the bent arm, the shaft being partially disposed in the build module and partially disposed externally to the build module, the bent arm being external to the build module, the build module being configured to reversibly couple to a processing chamber, the device being configured to be disposed in the processing chamber. In some embodiments, the second conduit has a third opening and a fourth opening opposing the third opening, the third opening being closer to the first opening as compared to the fourth opening, and where the device comprises (i) a first cover disposed at the first opening of the first conduit, (ii) a second cover disposed at the third opening of the second conduit, or (iii) a combination of (i) and (ii). In some embodiments, the first cover and/or the second cover comprises an aperture, the at least one aperture comprising the apertures. In some embodiments, the first cover and/or the second cover comprises at least one aperture. In some embodiments, during operation of the device, the at least one aperture is configured to reduce (i) clumping of the non-gaseous material, (ii) coagulation of the non-gaseous material, (iii) agglomeration of the non-gaseous material, or (iv) otherwise clogging the first conduit by the non-gaseous material. In some embodiments, the at least one aperture is adjustable. In some embodiments, the at least one aperture is comprised in an iris. In some embodiments, the at least one aperture is configured to adjust (A) a number of apertures in the at least one aperture, (B) at least one dimension of the at least one aperture, (C) adjust an orientation of the at least one aperture with respect to the long axis, or (D) any combination of (A) (B) and (C). In some embodiments, the at least one aperture is configured to be rotatable, translatable, or a combination thereof. In some embodiments, the first conduit and/or second conduit comprises recessions arranged (I) on the first opening of the first conduit and/or (II) on the third opening of the second conduit. In some embodiments, the recessions are evenly spaced along (I) the first opening of the first conduit and/or (II) the third opening of the second conduit. In some embodiments, the recessions are scalloped recessions. In some embodiments, during operation of the device, the recessions are configured to reduce (i) clumping of the non-gaseous material, (ii) coagulation of the non-gaseous material, (iii) agglomeration of the non-gaseous material, or (iv) otherwise clogging the first conduit by the non-gaseous material. In some embodiments, each of the recessions comprise a curved portion and/or a straight portion. In some embodiments, the device further comprises an adjuster (e.g., set screw) configured to reversibly adjust and/or reversibly affix an overlap of the first conduit with respect to the second conduit. In some embodiments, the first opening of the first conduit defines a surface oriented at an angle with respect to the long axis. In some embodiments, the surface is normal, or substantially normal, to the long axis. In some embodiments, the surface is not normal to the long axis. In some embodiments, during operation the device is configured to be enclosed in a processing chamber having a floor comprising an opening configured to accommodate a build plate configured to support a material bed from which the one or more three-dimensional objects, the floor comprising slots arranged with respect to the opening, and flaps arranged to reversibly uncover and reversibly cover the openings to facilitate traversal of a remainder material from the three-dimensional printing through the slots when uncover, and hinder traversal of the remainder material therethrough. In some embodiments, the device is configured to operate in a chamber in which the three-dimensional printing occurs at least in part, the chamber comprising an atmosphere that differs by one or more characteristics from an ambient atmosphere external to the chamber. In some embodiments, the one or more characteristics comprises (i) a pressure higher than an ambient pressure, (ii) a gas makeup being lower in one or more reactive species, the reactive species being reactive with (I) a starting material for the three-dimensional printing and/or (II) a debris generated during the three-dimensional printing. In some embodiments, the debris comprises soot, spatter, or splatter. In some embodiments, the reactive species comprises oxygen or water (e.g., humidity). In some embodiments, the device is operatively coupled to, or comprises, a temperature conditioning system configured to condition a temperature of the first conduit and/or the non-gaseous material during its removal by the device. In some embodiments, the temperature conditioning system comprises one or more solid temperature conditioners. In some embodiments, the solid temperature conditioners comprise a heat sink. In some embodiments, the solid temperature conditioners comprise elemental metal or metal alloy. In some embodiments, the solid temperature conditioners comprise copper or silver. In some embodiments, the first conduit comprises, or is operatively coupled to, one or more channels configured for flowing a temperature conditioning fluid therethrough. In some embodiments, the fluid comprises gas, liquid, or semisolid. In some embodiments, the first conduit comprises, or is operatively coupled to, one or more channels configured for flowing a temperature conditioning fluid therethrough. In some embodiments, the fluid comprises gas, liquid, or semisolid (e.g., gel). In some embodiments, the device is configured to facilitate three-dimensional printing, where a portion of the three-dimensional printing comprises connecting particulate matter to facilitate printing of at least one three-dimensional object. In some embodiments, at least a portion of the particulate matter is disposed in a material bed during the three-dimensional printing. In some embodiments, the at least the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises an elemental metal, a metal alloy, a ceramic, or an allotrope of carbon. In some embodiments, the particulate matter comprises a super alloy. In some embodiments, the super alloy comprises Inconel, In718, Ti64, F357, Haynes282, GRCop-42, C22, CA6NM, or Hastelloy-X.

In another aspect, an apparatus for material removal, the apparatus comprising at least one controller configured to control, or direct control of, any of the above devices (e.g., including any of component of the devices). In some embodiments, the at least one controller is configured to (i) operatively coupled to the first conduit and/or to the second conduit, and (ii) direct adjustment of the first conduit and/or to the second conduit. In some embodiments, the apparatus where the at least one controller is configured to direct adjustment of a relative orientation of the first conduit and/or to the second conduit. In some embodiments, the apparatus where the at least one controller is configured to direct control of the gas flowing through the one or more perforations. In some embodiments, the apparatus where the at least one controller is configured to direct control of an attractive force source operatively coupled to the first conduit. In some embodiments, the apparatus where the at least one controller is configured to direct adjustment of at least one aperture of the first conduit and/or of the second conduit. In some embodiments, the at least one controller is configured to (I) operatively couple to and (II) direct: one or more energy beams to generate one or more three-dimensional objects in a printing cycle of a three-dimensional printing process. In some embodiments, the at least one controller comprises at least one connector configured to connect to a power source. In some embodiments, the at least one controller is configured to operatively couple to a power source at least in part by (I) having a power socket and/or (II) being configured for wireless power transfer using inductive charging. In some embodiments, the at least one controller is included in, or comprises, a hierarchical control system. In some embodiments, the apparatus where the hierarchical control system comprises at least three hierarchical control levels. In some embodiments, the at least one controller is included in a control system configured to control a three-dimensional printer that prints the one or more three-dimensional objects in a printing cycle of a three-dimensional printing process. In some embodiments, the three-dimensional printer is configured to print the one or more three dimensional objects are printed anchorlessly in the material bed. In some embodiments, the apparatus where the device is a component of a three-dimensional printing system, and where the at least one controller is configured to (i) operatively couple to an other component of the three-dimensional printing system and (ii) direct operation of the other component. In some embodiments, the at least one controller is configured to direct operation of the other component at least in part for participation of the other component in three-dimensional printing system. In some embodiments, the at least one controller is operatively coupled to at least about 900 sensors, or 1000 sensors operatively coupled to the three-dimensional printing system. In some embodiments, the at least one controller is configured to control a pressure in the three-dimensional printing system to be above ambient pressure external to the three-dimensional printing system. In some embodiments, the apparatus where the at least one controller is configured to control an internal atmosphere of the three-dimensional printing system to be depleted of a reactive agent relative to its concentration in an ambient atmosphere external to the device, the reactive agent being configured to react with a starting material of the three-dimensional printing at least during the three-dimensional printing. In some embodiments, the at least one controller is configured to direct the device to remove the non-gaseous material at least in part by being configured to control reversible toggling between orientations comprising the first orientation and the second orientation. In some embodiments, the at least one controller is configured to direct the device to remove the non-gaseous material at least in part by being configured to control a flow of the gas through the one or more perforations of the second conduit. In some embodiments, the at least one controller is configured to direct the device to remove the non-gaseous material at least in part by being configured to control a flow of the gas through at least one aperture of the second conduit and/or of the first conduit.

For example, an apparatus for material removal, the apparatus comprising at least one controller configured to: (i) operatively couple to a device comprises: a first conduit extending along a long axis, the first conduit being hollow and configured to facilitate flow of gaseous and non-gaseous material therethrough from a first opening of the first conduit to a second opening of the first conduit opposing the first opening, the first opening and the second opening being along the long axis of the first conduit; a second conduit extending along the long axis, the second conduit being hollow and configured to facilitate flow of gas, the first conduit being nestled at least in part within the second conduit such that during operation at least a first portion of the first conduit overlaps a second portion of the second conduit; where: (A) the device being configured to reversibly toggle between orientations comprising a first orientation and a second orientation, the first orientation of the first conduit being adjustable with respect to the second orientation of the second conduit along the long axis, where adjustment of the first conduit with respect to the second conduit is configured to cause alteration of an extent of overlap between the first portion of the first conduit and the second portion of second conduit; or (B) the second conduit comprising one or more perforations configured to facilitate flow of the gas into at least a portion of the hollow of the first conduit and/or at least a portion of the hollow of the second conduit; and (ii) direct the device to remove the non-gaseous material.

In another aspect, non-transitory computer readable program instructions material removal, the non-transitory computer readable program instructions, when read by one or more processors, cause one or more processors to execute one or more operations associated with any of the above devices. In some embodiments, the one or more operations comprise controlling, or directing control of, any of the above devices (e.g., including any of component of the devices). In some embodiments, the non-transitory computer readable program instructions where one or more processors are configured to operatively couple to: one or more energy beams, and where the program instructions are configured to direct the energy beams. In some embodiments, the one or more processors comprise, or are operatively coupled to, the one or more controllers configured to control the one or more energy beams. In some embodiments, the non-transitory computer readable program instructions where the program instructions are inscribed in one or more media. In some embodiments, the non-transitory computer readable program instructions where the program instructions are inscribed in one or more media. In some embodiments, the operations comprise directing the device to remove the non-gaseous material at least in part by directing reversible toggling between orientations comprising the first orientation and the second orientation. In some embodiments, the operations comprise directing the device to remove the non-gaseous material at least in part by directing controlling of a flow of the gas through the one or more perforations of the second conduit. In some embodiments, the operations comprise directing the device to remove the non-gaseous material at least in part by directing controlling of a flow of the gas through at least one aperture of the second conduit and/or of the first conduit.

For example, non-transitory computer readable program instructions for material removal, the program instructions, when read by one or more processors operatively coupled to a device; cause the one or more processors to execute, or direct execution, of one or more operations associated the device comprising directing the device to remove a non-gaseous material, the device comprises: a first conduit extending along a long axis, the first conduit being hollow and configured to facilitate flow of gaseous and of the non-gaseous material therethrough from a first opening of the first conduit to a second opening of the first conduit opposing the first opening, the first opening and the second opening being along the long axis of the first conduit; a second conduit extending along the long axis, the second conduit being hollow and configured to facilitate flow of gas, the first conduit being nestled at least in part within the second conduit such that during operation at least a first portion of the first conduit overlaps a second portion of the second conduit; where: (A) the device being configured to reversibly toggle between orientations comprising a first orientation and a second orientation, the first orientation of the first conduit being adjustable with respect to the second orientation of the second conduit along the long axis, where adjustment of the first conduit with respect to the second conduit is configured to cause alteration of an extent of overlap between the first portion of the first conduit and the second portion of second conduit; or (B) the second conduit comprising one or more perforations configured to facilitate flow of the gas into at least a portion of the hollow of the first conduit and/or at least a portion of the hollow of the second conduit.

In another aspect, a method for material removal, the method (i) employing any of the above devices and/or (ii) executing, or directing execution of, one or more operations of any of the devices (e.g., including any of component of the devices). In some embodiments, the method where directing the device to remove the non-gaseous material is at least in part by directing reversible toggling between orientations comprising the first orientation and the second orientation. In some embodiments, the method where directing the device to remove the non-gaseous material is at least in part by controlling of a flow of the gas through the one or more perforations of the second conduit. In some embodiments, the method where directing the device to remove the non-gaseous material is at least in part by controlling of a flow of the gas through at least one aperture of the second conduit and/or of the first conduit.

For example, a method for material removal, the method comprises: providing a device; and using the device to remove a non-gaseous material, the device comprising: a first conduit extending along a long axis, the first conduit being hollow and configured to facilitate flow of gaseous and of the non-gaseous material therethrough from a first opening of the first conduit to a second opening of the first conduit opposing the first opening, the first opening and the second opening being along the long axis of the first conduit; a second conduit extending along the long axis, the second conduit being hollow and configured to facilitate flow of gas, the first conduit being nestled at least in part within the second conduit such that during operation at least a first portion of the first conduit overlaps a second portion of the second conduit; where: (A) the device being configured to reversibly toggle between orientations comprising a first orientation and a second orientation, the first orientation of the first conduit being adjustable with respect to the second orientation of the second conduit along the long axis, where adjustment of the first conduit with respect to the second conduit is configured to cause alteration of an extent of overlap between the first portion of the first conduit and the second portion of second conduit; or (B) the second conduit comprising one or more perforations configured to facilitate flow of the gas into at least a portion of the hollow of the first conduit and/or at least a portion of the hollow of the second conduit.

In another aspect, a device for material removal, the device comprises: a floor of a processing chamber in which one or more three-dimensional objects are printed by three-dimensional printing, the floor comprising an opening configured to accommodate a build plate configured to support a material bed from which the one or more three-dimensional objects are printed, the floor further comprises: (A) slots arranged with respect to the opening, the slots configured to facilitate traversal of a remainder material of the material bed that has not formed the one or more three-dimensions objects through the slots away from the processing chamber; and (B) flaps (e.g., slot coverings) configured to reversibly open and close to uncover and cover the slots, respectively, where the flaps are configured to hinder (e.g., prevent) traversal of the remainder material through the slots when covered, the flaps being arranged with respect to the floor of the processing chamber such that a portion of at least one flap allows (I) an unobstructed first field of view of a detector of a metrological detection system, (II) facilitate detection of a state of the flaps by the metrological detection system, the state of the flaps being with respect to any of them being open or closed, (III) unobstructed at least one second field of view of at least one energy beam configured to print one or more three-dimensional object during the three-dimensional printing above the build plate, or (IV) any combination of (I) (II) and (III). In some embodiments, the slots comprise four sets of slots. In some embodiments, each set of slots of the four sets of slots is disposed perpendicular to another set of slots. In some embodiments, the at least one second field of view of the at least one energy beam coincides with an area of the build plate. In some embodiments, during operation of the device, the processing chamber functions as an unpacking station. In some embodiments, each set of slots comprises oblong shaped slots. In some embodiments, the device further comprises, or is operatively coupled to, one or more material reservoirs configured to accommodate a remainder material of the material bed that has not formed the one or more three-dimensions objects during the three-dimensional printing, where the remainder material traverses from the processing chamber to the one or more material reservoirs through the slots uncovered by the flaps. In some embodiments, the flaps are configured to cover the slots during the printing and uncover the slots after the printing. In some embodiments, the flaps are pneumatically actuated. In some embodiments, the flaps are configured to open away from the opening. In some embodiments, each flap of the flaps comprises one or more hinges. In some embodiments, the one or more hinges, when the flaps are in a closed position, are configured such that an exposed surface of the one or more hinges is flush with (e.g., or below) respective exposed surfaces of the closed flaps. In some embodiments, the flaps are controlled by one or more controllers configured to control the at least one energy beam. In some embodiments, the device further comprises, or is operatively coupled to, one or more actuators, each actuator of the one or more actuator configured to open and/or close at least one flap of the flaps. In some embodiments, the device further comprises, or is operatively coupled to, one or more actuators, an actuator of the one or more actuator configured to open and/or close two of the flaps. In some embodiments, the actuator is configured to facilitate (I) opening two of the flaps in a first operation, (II) closure of two of the flaps in a second operation, or (III) a combination of (I) and (II). In some embodiments, the actuator is configured to facilitate opening the two of the flaps at least in part by pushing an engagement structure against the flaps, the actuator comprising, or being configured to operatively couple to, the engagement structure. In some embodiments, the actuator is configured to facilitate closure of the two of the flaps at least in part by retracting an engagement structure away from the flaps, the actuator comprising, or being configured to operatively couple to, the engagement structure. In some embodiments, an actuator of the one or more actuators comprises, or is operatively coupled to, an engagement structure configured to engage with the at least one flap of the flaps. In some embodiments, the engagement structure comprises a beveled structure. In some embodiments, the engagement structure is configured to secure the at least one flap when the flap is closed. In some embodiments, a flap of the flaps is configured to cover a first set of the slots. In some embodiments, the engagement structure is configured to push the flap to open the flap such that the flap uncovers the first set of the slots. In some embodiments, the engagement structure is configured to push the flap to open at least in part to facilitate traversal of any of the remainder material through at least a portion of the first set of slots. In some embodiments, the engagement structure is configured to pull the flap to close, or otherwise allow the flap to close, such that the flap cover the first set of the slots. In some embodiments, the engagement structure is configured to pull the flap to close, or otherwise allow the flap to close, at least in part to hinder traversal of any of the remainder material through the first set of slots. In some embodiments, the at least one flap of the flaps comprises a corresponding engagement structure to couple to the engagement structure of at least one actuator of the one or more actuators. In some embodiments, the actuator comprises a seal configured to (e.g., substantially) prevent the remainder material from reaching at least a portion of a body of the actuator. In some embodiments, the seal comprises bellows. In some embodiments, the seal comprises a flexible or a non-flexible material. In some embodiments, the seal comprises an elemental metal, a metal alloy, a polymer, or a resin. In some embodiments, the device is operatively coupled to, or comprises, a temperature conditioning system configured to condition a temperature of the first conduit and/or the non-gaseous material during its removal by the device. In some embodiments, the first conduit comprises, or is operatively coupled to, one or more solid temperature conditioners. In some embodiments, the solid temperature conditioners comprise a heat sink. In some embodiments, the solid temperature conditioners comprise elemental metal or metal alloy. In some embodiments, the solid temperature conditioners comprise copper or silver. In some embodiments, the first conduit comprises, or is operatively coupled to, one or more channels configured for flowing a temperature conditioning fluid therethrough. In some embodiments, the fluid comprises gas, liquid, or semisolid. In some embodiments, the device comprises, or is operatively coupled to, a sensor configured to detect a state of at least one flap of the flaps with respect to the floor of the processing chamber. In some embodiments, the sensor comprises a position sensor. In some embodiments, the sensor is configured to detect whether the at least one flap in a closed position. In some embodiments, the sensor comprises a position sensor. In some embodiments, the sensor is configured to detect a position of the at least one flap relative to the position sensor. In some embodiments, the sensor comprises a proximity sensor. In some embodiments, the sensor is configured to detect proximity of the at least one flap to the proximity sensor. In some embodiments, the sensor is arranged opposite the at least one flap with respect to the floor of the processing chamber. In some embodiments, the sensor comprises a magnetic sensor. In some embodiments, the processing chamber encloses an atmosphere during the printing that (i) is inert with respect of an ambient atmosphere external to the processing chamber, and/or (ii) has a pressure above ambient pressure external to the processing chamber. In some embodiments, the device encloses an atmosphere during the printing that (i) is inert with respect of an ambient atmosphere external to the processing chamber, and/or (ii) has a pressure above ambient pressure external to the processing chamber. In some embodiments, the device further comprises one or more funnels coupled to the slots and to the one or more material reservoirs. In some embodiments, the one or more funnels are coupled to the one or more material reservoirs by respective flexible couplings. In some embodiments, the device is configured to operatively couple to a material conveyance system configured to recycle the material to be used in the three-dimensional printing, or in a subsequent three-dimensional printing. In some embodiments, the material conveyance system is operatively coupled to a layer dispensing mechanism configured to deposit pre-transformed material to form a material bed utilized in the three-dimensional printing. In some embodiments, the device where the layer dispensing mechanism is configured to facilitate deposition of pre-transformed material on a target surface at least in part by layerwise deposition. In some embodiments, the device where the layer dispensing mechanism is configured to deposit pre-transformed material comprising powder material. In some embodiments, the device where the layer dispensing mechanism (e.g., dispenser) is configured to deposit pre-transformed material comprising an elemental metal, a metal alloy, a ceramic, or an allotrope of carbon. In some embodiments, the material conveyance system is operatively coupled to a material removal mechanism configured to remove a second portion of the deposited pre-transformed material from the target surface to generate a planar layer of pre-transformed material as part of a material bed. In some embodiments, the material removal mechanism is operatively coupled to an attractive force source sufficient to attract the pre-transformed material from the target surface. In some embodiments, the attractive force comprises a magnetic, an electrostatic, or a vacuum source. In some embodiments, the attractive force comprises a vacuum source. In some embodiments, the material removal mechanism is configured to operatively couple to the material conveyance system that (i) recycles at least a fraction of a portion of the pre-transformed material removed by the remover and/or (ii) provides at least a portion of the pre-transformed material utilized by the dispenser. In some embodiments, the portion removed by the material removal mechanism is at least about 70%, 50% or 30% of the deposited pre-transformed material. In some embodiments, the fraction recycled is at least about 70% or 90% of the portion removed by the remover. In some embodiments, the device where the material bed generated on a surface of a build plate comprising at least one fundamental length scale having a value of at least about 300 mm or 350 mm. In some embodiments, the material bed generated on a surface of a build plate comprising at least one fundamental length scale having a value of at least about 500 mm, or 600 mm. In some embodiments, the material bed generated on a surface of a build plate comprising at least one fundamental length scale having a value of at least about 1000 mm, 1200 mm, 1500 mm, or 1750 mm. In some embodiments, the device where the material bed generated on a surface of a build plate and supported by the build plate comprises a weight of at least about 1000 kg. In some embodiments, the device where the material bed is generated on a surface of a build plate that is operatively coupled to an elevator mechanism comprising a bent arm, the elevation mechanism comprising a shaft operatively coupled to the bent arm, the shaft being vertically translatable by the bent arm, the shaft being partially disposed in the build module and partially disposed externally to the build module, the bent arm being external to the build module, the build module being configured to reversibly couple to a processing chamber, the device being configured to be disposed in the processing chamber. In some embodiments, the device comprises, or is operatively coupled to, conduit couplers, where the material reservoirs are coupled to the material conveyance system via respective conduit couplers. In some embodiments, the device comprises, or is operatively coupled to, valves arranged with respect to the conduit couplers to selectively allow a flow of gaseous and/or non-gaseous material from within a given material reservoir of the material reservoirs into the material conveyance system. In some embodiments, the material conveyance system is configured to (I) conveying the remainder material in a direction comprising against a gravitational vector of the ambient environment, (II) conveying the remainder material at least in part by pressurized conveyance, (III) conveying the remainder material for recycling uninterruptedly during the printing, or (IV) any combination of (I) (II) and (III). In some embodiments, conveying the remainder material for recycling uninterruptedly during the printing comprises using two parallel separators and/or two parallel reservoirs. In some embodiments, the valves are configured to sequentially allow flow of gaseous and/or non-gaseous material from each material reservoir of the material reservoirs. In some embodiments, the valves are configured to allow flow of gaseous and/or non-gaseous materials from only one material reservoir of the material reservoirs at a given time period. In some embodiments, the material reservoirs comprise, or are operatively coupled to sensors configured to detect a characteristic (e.g., volume, temperature) of the material retained within each material reservoir. In some embodiments, the valves are configured to allow the flow of gaseous and/or non-gaseous materials from a given material reservoir based at least in part on sensor data from the respective sensor for the given material reservoir. In some embodiments, each of the one or more funnels comprises an opening having an aspect ratio different from 1:1. In some embodiments, the aspect ratio of a width to a length of the opening is at least 1:2 or greater. In some embodiments, the one or more funnels is a plurality of funnels coupled to a set of slots. In some embodiments, the plurality of funnels comprise a common wide opening. In some embodiments, the slots are disposed around the opening, which disposition of the slots is configured to capture the material of the material bed that flows into the slots in a conical and/or pyramidal fashion. In some embodiments, to facilitate detection of a state of the flaps by the metrological detection system comprises allowing the metrological detection system to generate a topographical image of at least a portion of a flap of the flaps. In some embodiments, the at least the portion of the flaps comprises a tab of a flap. In some embodiments, the topological image is utilized at least in part to prevent a material dispenser from colliding with any flap (e.g., with any tab of the flap) that is not closed completely, e.g., a flap that is not flush with a floor of the chamber in which it is disposed such as a processing chamber and/or an unpacking chamber. In some embodiments, the topological image is utilized at least in part to prevent a material dispenser from colliding with any flap that exceeds a vertical threshold. The vertical threshold may be measured from the floor of the chamber, or from a ceiling of the chamber. In some embodiments, the detector of the metrological detection system is configured to detect an opened and/or closed state of the at least one flap. In some embodiments, an energy beam is configured to generate at least one alignment marker. In some embodiments, the energy beam being of the at least one energy beam. In some embodiments, the energy beam being different from the at least one energy beam. In some embodiments, as compared to the at least one energy beam, the energy beam has a different wavelength and/or a different amplitude. In some embodiments, as compared to the at least one energy beam, the energy beam has a longer wavelength and/or a lower amplitude. In some embodiments, the energy beam being a guiding beam of the at least one energy beam. In some embodiments, the first field of view of a detector of the metrological detection system comprises an intended area for the at least one alignment marker. In some embodiments, the intended area for the at least one alignment marker coincides with (I) an area of the build plate, (II) an area surrounding the circumference of the build plate having a width, or (III) any combination of (I) and (II). In some embodiments, the at least one alignment marker comprises an optical alignment marker or a physical alignment marker. In some embodiments, the intended area for the physical alignment marker coincides with an area of the build plate. In some embodiments, the intended area for the optical alignment marker comprises an area surrounding the circumference of the build plate having a width. In some embodiments, the intended area for the optical alignment marker comprises (I) an area of the build plate and (II) an area surrounding the circumference of the build plate having a width. In some embodiments, the optical alignment marker comprises a temporary light image generated by an energy beam. In some embodiments, the energy beam is utilized for the printing. In some embodiments, the physical alignment marker is generated by transforming a portion of the material bed. In some embodiments, transformation of the material bed comprises fusing. In some embodiments, transformation of the material bed facilitates removal of the physical alignment marker by a material removal mechanism. In some embodiments, the alignment marker is generated at least in part by using the material of the material bed. In some embodiments, the alignment marker yields information related to an alignment of an energy beam with respect to the material bed, the energy beam used for printing the one or more three-dimensional objects. In some embodiments, the portion of at least one flap comprises a tab. In some embodiments, the portion of at least one flap is a first portion, where the first portion comprises a curved feature having a curvature different than a curvature of a second portion of the at least one flap. In some embodiments, the device is configured to operate in the processing chamber comprising an atmosphere that differs by one or more characteristics from an ambient atmosphere external to the chamber. In some embodiments, the one or more characteristics comprises (i) a pressure higher than an ambient pressure, (ii) a gas makeup being lower in one or more reactive species, the reactive species being reactive with (I) a starting material for the three-dimensional printing and/or (II) a debris generated during the three-dimensional printing. In some embodiments, the debris comprises soot, spatter, or splatter. In some embodiments, the reactive species comprises oxygen or humidity. In some embodiments, the device is configured to facilitate three-dimensional printing, where a portion of the three-dimensional printing comprises connecting particulate matter to facilitate printing of at least one three-dimensional object. In some embodiments, at least a portion of the particulate matter is disposed in a material bed during the three-dimensional printing. In some embodiments, the at least the portion of the three-dimensional printing comprises a fusing process. In some embodiments, fusing comprises (i) sintering, (ii) melting, (iii) smelting, or (iv) any combination of (i)-(iii). In some embodiments, the particulate matter comprises an elemental metal, a metal alloy, a ceramic, or an allotrope of carbon. In some embodiments, the particulate matter comprises a super alloy. In some embodiments, the super alloy comprises Inconel, In718, Ti64, F357, Haynes282, GRCop-42, C22, CA6NM, or Hastelloy-X. In some embodiments, the device comprises, or is operatively coupled to a material removal device comprising a first conduit nestled at least in part within a second conduit, the device configured to operatively couple to an attractive force to remove a remainder of starting material that was not used for the three-dimensional printing.

In another aspect, an apparatus for material removal, the apparatus comprising at least one controller configured to operatively couple to any of the above devices; and direct execution of any operation associated with the device (e.g., including any of component of the devices). In some embodiments, the at least one controller comprises circuitry. In some embodiments, the at least one controller is part of, or is operatively coupled to, a hierarchical network of controllers. In some embodiments, the hierarchical network of controllers comprises three or more control hierarchical control levels. In some embodiments, the hierarchical network of controllers comprises a microcontroller. In some embodiments, the at least one controller is configured to control the three-dimensional printing. In some embodiments, the at least one controller comprises, or is operatively coupled to, one or more controllers configured to control one or more energy beams. In some embodiments, the at least one controller comprise at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the device is a component of a three-dimensional printing system, and where the at least one controller is configured to (i) operatively couple to an other component of the three-dimensional printing system and (ii) direct operation of the other component. In some embodiments, the apparatus where the at least one controller is configured to direct operation of the other component at least in part for participation of the other component in three-dimensional printing system. In some embodiments, the apparatus where the at least one controller is operatively coupled to at least about 900 sensors, or 1000 sensors operatively couple to the three-dimensional printing system. In some embodiments, the apparatus where the at least one controller is configured to control a pressure in the three-dimensional printing system to be above ambient pressure external to the three-dimensional printing system. In some embodiments, the apparatus where the at least one controller is configured to control an internal atmosphere of the three-dimensional printing system to be depleted of a reactive agent relative to its concentration in an ambient atmosphere external to the device, the reactive agent being configured to react with a starting material of the three-dimensional printing at least during the three-dimensional printing. In some embodiments, the apparatus where the at least one controller is configured to (I) operatively couple to an elevation mechanism, and (II) direct the elevation mechanism to elevate the build plate to become flush with a floor of the processing chamber to facilitate removal of the remainder material. In some embodiments, the apparatus where the at least one controller is configured to (I) operatively couple to the flaps, and (II) direct reversible covering and/or reversibly uncovering the flaps. In some embodiments, the apparatus where the at least one controller is configured to direct printing the one or more three-dimensional objects before removal of the remainder. In some embodiments, the apparatus where the at least one controller is configured to (to (I) operatively couple to a metrological detection system, and (II) direct use of a metrological detection system during the three-dimensional printing. In some embodiments, the apparatus where the at least one controller is configured to (I) operatively couple to one or more energy beams, and (II) direct the one or more energy beams to print the one or more three-dimensional objects.

For example, an apparatus for material removal, the apparatus comprising at least one controller configured to: (i) operatively coupled to a device; and (ii) direct use of the device to remove a remainder material from a processing chamber, the device comprises: a floor of the processing chamber in which one or more three-dimensional objects are printed by three-dimensional printing, the floor comprising an opening configured to accommodate a build plate configured to support a material bed from which the one or more three-dimensional objects are printed, the floor further comprises: (A) slots arranged with respect to the opening, the slots configured to facilitate traversal of the remainder material of the material bed that has not formed the one or more three-dimensions objects through the slots away from the processing chamber; and (B) flaps (e.g., slot coverings) configured to reversibly open and close to uncover and cover the slots, respectively, where the flaps are configured to hinder (e.g., prevent) traversal of the remainder material through the slots when covered, the flaps being arranged with respect to the floor of the processing chamber such that a portion of at least one flap allows (I) an unobstructed first field of view of a detector of a metrological detection system, (II) facilitate detection of a state of the flaps by the metrological detection system, the state of the flaps being with respect to any of them being open or closed, (III) unobstructed at least one second field of view of at least one energy beam configured to print one or more three-dimensional object during the three-dimensional printing above the build plate, or (IV) any combination of (I) (II) and (III).

In another aspect, a non-transitory computer readable program instructions for three-dimensional printing, the non-transitory computer readable program instructions, when read by one or more processors operatively coupled to any of the above devices; cause the one or more processors to execute one or more operations associated with the device (e.g., including any of component of the devices). In some embodiments, the one or more operations comprise controlling, or directing control of, any of the above devices (e.g., including any of component of the devices). In some embodiments, the non-transitory computer readable program instructions where the one or more processors are part of, or are operatively coupled to, a hierarchical network of processors. In some embodiments, the hierarchical network of processors comprises three or more hierarchical levels. In some embodiments, the hierarchical network of processors comprises a microprocessor. In some embodiments, the non-transitory computer readable program instructions where the program instructions are inscribed in one or more media. In some embodiments, the non-transitory computer readable program instructions where the one or more processors are configured to control the three-dimensional printing. In some embodiments, the non-transitory computer readable program instructions where the one or more processors are configured to operatively couple to one or more energy beams, and where the operations comprise directing the one or more energy beams to print the one or more three-dimensional objects. In some embodiments, the non-transitory computer readable program instructions where the operations comprise directing elevation of the build plate to become flush with a floor of the processing chamber to facilitate removal of the remainder material. In some embodiments, the non-transitory computer readable program instructions where the operations comprise directing reversible covering and/or reversibly uncovering the flaps. In some embodiments, the non-transitory computer readable program instructions where the operations comprise directing printing the one or more three-dimensional objects before removal of the remainder. In some embodiments, the non-transitory computer readable program instructions where the operations comprise directing use of a metrological detection system during the three-dimensional printing.

For example, a non-transitory computer readable program instructions for material removal, the non-transitory computer readable program instructions, when read by one or more processors operatively coupled to a device, cause one or more processors to execute operations comprising directing use of the device to remove a remainder material from a processing chamber, the device comprises: a floor of the processing chamber in which one or more three-dimensional objects are printed by three-dimensional printing, the floor comprising an opening configured to accommodate a build plate configured to support a material bed from which the one or more three-dimensional objects are printed, the floor further comprises: (A) slots arranged with respect to the opening, the slots configured to facilitate traversal of the remainder material of the material bed that has not formed the one or more three-dimensions objects through the slots away from the processing chamber; and (B) flaps (e.g., slot coverings) configured to reversibly open and close to uncover and cover the slots, respectively, where the flaps are configured to hinder (e.g., prevent) traversal of the remainder material through the slots when covered, the flaps being arranged with respect to the floor of the processing chamber such that a portion of at least one flap allows (I) an unobstructed first field of view of a detector of a metrological detection system, (II) facilitate detection of a state of the flaps by the metrological detection system, the state of the flaps being with respect to any of them being open or closed, (III) unobstructed at least one second field of view of at least one energy beam configured to print one or more three-dimensional object during the three-dimensional printing above the build plate, or (IV) any combination of (I) (II) and (III).

In another aspect, a method for three-dimensional printing, the method (i) providing any of the above devices and/or (ii) executing one or more operations associated with the device (e.g., including any of component of the devices). In some embodiments, the method further comprises elevating the build plate to become flush with a floor of the processing chamber to facilitate removal of the remainder material. In some embodiments, the method further comprises reversibly covering and/or reversibly uncovering the flaps. In some embodiments, the method further comprises printing the one or more three-dimensional objects before removal of the remainder. In some embodiments, the method further comprises using a metrological detection system during the three-dimensional printing.

For example, a method for material removal, the method comprises: providing a device, and using the device to remove a remainder material from a processing chamber, the device comprising: a floor of the processing chamber in which one or more three-dimensional objects are printed by three-dimensional printing, the floor comprising an opening configured to accommodate a build plate configured to support a material bed from which the one or more three-dimensional objects are printed, the floor further comprises: (A) slots arranged with respect to the opening, the slots configured to facilitate traversal of the remainder material of the material bed that has not formed the one or more three-dimensions objects through the slots away from the processing chamber; and (B) flaps (e.g., slot coverings) configured to reversibly open and close to uncover and cover the slots, respectively, where the flaps are configured to hinder (e.g., prevent) traversal of the remainder material through the slots when covered, the flaps being arranged with respect to the floor of the processing chamber such that a portion of at least one flap allows (I) an unobstructed first field of view of a detector of a metrological detection system, (II) facilitate detection of a state of the flaps by the metrological detection system, the state of the flaps being with respect to any of them being open or closed, (III) unobstructed at least one second field of view of at least one energy beam configured to print one or more three-dimensional object during the three-dimensional printing above the build plate, or (IV) any combination of (I) (II) and (III).

In another aspect, a system for effectuating the methods, operations of an apparatus, and/or operations inscribed by a non-transitory computer readable program instructions (e.g., inscribed on a media/medium), disclosed herein.

In another aspect, a system for effectuating the methods, operations of an apparatus, operation of a device, and/or operations inscribed by a non-transitory computer readable program instructions (e.g., inscribed on a media/medium), disclosed herein.

In another aspect, device(s) (e.g., apparatus) for effectuating the methods, operations of an apparatus, and/or operations inscribed by a non-transitory computer readable program instructions (e.g., inscribed on a media/medium).

In another aspect, a system for effectuating the methods, operations of the device, operations of the apparatus, and/or operations inscribed by non-transitory computer readable program instructions (e.g., inscribed on a media/medium), disclosed herein.

In other aspects, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions is inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions is inscribed on at least one medium (e.g., on a medium or on media).

Another aspect of the present disclosure provides methods, systems, apparatuses (e.g., controller(s)), and/or non-transitory computer-readable program instructions (e.g., software) that implement any operation associated with any of the devices disclosed herein. In some embodiments, the program instructions is inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled to the mechanism. In some embodiments, the controller(s) implements any of the methods and/or operations disclosed herein. In some embodiments, the at least one controller comprises, or be operatively coupled to, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a 3D printer, outside of the 3D printer, in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled to the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two of operations of the apparatus are directed by the same controller. In some embodiments, at least two of operations of the apparatus are directed by different controllers.

In some embodiments, at least operations (e.g., instructions) are carried out by the same processor and/or by the same sub-computer software product. In some embodiments, at least two of operations (e.g., instructions) are carried out by different processors and/or sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled to the mechanism. In some embodiments, the mechanism comprises an apparatus or an apparatus component.

In another aspect, a non-transitory computer-readable medium/media comprising machine-executable code that, upon execution by one or more computer processors, implements any of the methods and/or operations disclosed herein.

In another aspect, a non-transitory computer-readable medium/media comprising machine-executable code that, upon execution by one or more computer processors, effectuates directions of the controller(s) (e.g., as disclosed herein).

In another aspect, a computer system comprising one or more computer processors and a non-transitory computer-readable medium coupled thereto. In some embodiments, the non-transitory computer-readable medium comprises machine-executable code that, upon execution by the one or more computer processors, implements any of the methods disclosed herein and/or effectuates directions of the controller(s) disclosed herein.

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively couple to the device, and (ii) direct executing one or more operations associated with at least one configuration of the device(s) disclosed herein.

In another aspect, non-transitory computer readable program instructions for three-dimensional printing, the non-transitory computer readable program instructions, when read by one or more processors operatively couped to the device, cause the one or more processors to direct executing one or more operations associated with at least one configuration of the device(s) disclosed herein.

The various embodiments in any of the above aspects are combinable (e.g., within an aspect), as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention(s) are set forth with particularity in the appended claims. A better understanding of the features and advantages of the present invention(s) will be obtained by reference to the following detailed description that sets forth illustrative embodiments, in which the principles of the invention(s) are utilized, and the accompanying drawings or figures (also “Fig.” and “Figs.” herein), of which:

FIG. 1 schematically illustrates a vertical cross section of a three-dimensional (3D) printing system and its components;

FIG. 2 schematically illustrates a vertical cross section of a 3D printing system and its components;

FIG. 3 schematically illustrates a side view of components in a 3D printing system;

FIG. 4 schematically illustrates a vertical cross section of components in a 3D printing system;

FIG. 5 schematically illustrates a computer control system that is programmed or otherwise configured to facilitate the formation of one or more 3D objects;

FIG. 6 illustrates a path;

FIG. 7 schematically illustrates a vertical cross section of a 3D object unpacking system;

FIGS. 8A-8D schematically illustrate various views of 3D object unpacking systems;

FIG. 9 schematically illustrates a vertical cross section of a 3D object unpacking system;

FIG. 10 schematically illustrates various components of a 3D printing system and portions thereof;

FIG. 11 schematically illustrates various components of a 3D printing system and portions thereof;

FIG. 12 schematically illustrates a perspective view of a 3D printing system and its components;

FIG. 13 schematically illustrates various components of a 3D printing system and portions thereof;

FIG. 14 schematically illustrates various hole arrangements in a processing chamber floor;

FIG. 15 schematically illustrates various components of a 3D printing system and portions thereof; and

FIG. 16 schematically illustrates, and shows photographs various components of a 3D printing system and portions thereof.

FIG. 17 shows a block diagram of a 3D printing system and its components;

FIG. 18 shows a block diagram of a 3D printing system and its components

FIG. 19 is a flow diagram of an example process of the 3D printing system;

FIG. 20 is a flow diagram of another example process of the 3D printing system;

FIG. 21 schematically illustrates various components of a 3D printing system and portions thereof;

FIG. 22 shows schematic views of 3D printing system components;

FIG. 23 shows schematic views of 3D printing system components;

FIG. 24 shows schematic views of 3D printing system components;

FIG. 25 shows schematic views of 3D printing system components;

FIG. 26 shows schematic views of 3D printing system components;

FIG. 27 shows a schematic view of a 3D printing system and its components;

FIG. 28 shows a schematic view of a 3D printing system and its components;

FIG. 29 schematically depicts calibration marks, e.g., above material beds;

FIG. 30 shows schematic views of a portion of a 3D printing system and its components;

FIG. 31 shows schematic views of 3D printing system components;

FIG. 32 shows schematic views of 3D printing system components; and

FIG. 33 schematically illustrates components of a 3D printing system

FIG. 34 shows schematic views of 3D printing system components.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a”, “an” and “the” are not intended to refer to only a singular entity, but include the general class of which a specific example may be used for illustration. The terminology herein is used to describe specific embodiments of the invention(s), but their usage does not delimit the invention(s).

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) their endpoint(s) is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in X and/or Y (including in the specification and claims) is meant to include (i) X, (ii) Y, and (iii) X and Y. The conjunction of “and/or” in the phrase “including X, Y, and/or Z” is meant to include any combination and plurality thereof. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

“Real time” as understood herein may be during at least part of the printing of a 3D object. Real time may be during a print operation. Real time may be during a print cycle. Real time may comprise: during formation of (i) a 3D object, (ii) a layer of hardened material as part of the 3D object, (iii) a hatch line, or (iv) a melt pool.

A central tendency as understood herein comprises mean, median, or mode. The mean may comprise a geometric mean.

The phrase “is/are structured” or “is/are configured,” when modifying an article, refers to a structure of the article that is able to bring about the referred result.

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid, phase.

The 3D printing process may comprise printing one or more layers of hardened material in a building cycle (e.g., printing cycle). A building cycle, as understood herein, comprises printing all (e.g., hardened, or solid) material layers of a print job, which may comprise printing one or more 3D objects above a platform and/or a base (e.g., in a single material bed).

Pre-transformed material, as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may have been transformed by a 3D printer process prior to the upcoming 3D printing process. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is still considered a pre-transformed material relative to the second 3D printing process. The remainder can be filtered and otherwise recycled for use as a pre-transformed material in the second 3D printing process.

Fundamental length scale (abbreviated herein as “FLS”) can be referred herein as to any suitable scale (e.g., dimension) of an object. For example, a FLS of an object may comprise a length, a width, a height, a diameter, a spherical equivalent diameter, or a diameter of a bounding sphere. In some cases, FLS may refer to an area, a volume, a shape, or a density.

Performing a reversible first operation is understood herein to mean performing the first operation and being capable of performing the opposite of that first operation (e.g., which is a second operation). For example, when a controller directs reversibly opening a shutter, that shutter can also close, and the controller can optionally direct a closure of that shutter.

The present disclosure provides three-dimensional (3D) printing apparatuses, systems, software, and methods for forming a 3D object. For example, a 3D object may be formed by sequential addition of material or joining of pre-transformed material to form a structure in a controlled manner (e.g., under manual or automated control). Pre-transformed material, as understood herein, is a material before it has been transformed during the 3D printing process. The transformation can be effectuated by utilizing an energy beam and/or flux. The pre-transformed material may be a material that was, or was not, transformed prior to its use in a 3D printing process. The pre-transformed material may be a starting material for the 3D printing process.

In some embodiments, a 3D printing process, the deposited pre-transformed material is fused, (e.g., sintered or melted), bound or otherwise connected to form at least a portion of the requested 3D object. Fusing, binding or otherwise connecting the material is collectively referred to herein as “transforming” the material. Fusing the material may refer to melting, smelting, or sintering a pre-transformed material.

Melting may comprise liquefying the material (i.e., transforming to a liquefied state). A liquefied state refers to a state in which at least a portion of a transformed material is in a liquid state. Melting may comprise liquidizing the material (i.e., transforming to a liquidus state). A liquidus state refers to a state in which an entire transformed material is in a liquid state. The apparatuses, methods, software, and/or systems provided herein are not limited to the generation of a single 3D object, but may be utilized to generate one or more 3D objects simultaneously (e.g., in parallel) or separately (e.g., sequentially). The multiplicity of 3D object may be formed in one or more material beds (e.g., powder bed). In some embodiments, a plurality of 3D objects is formed in one material bed.

In some embodiments, 3D printing methodologies comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition.

In some embodiments, the 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

In some embodiments, the deposited pre-transformed material within the enclosure is a liquid material, semi-solid material (e.g., gel), or a solid material (e.g., powder). The deposited pre-transformed material within the enclosure can be in the form of a powder, wires, sheets, or droplets. The material (e.g., pre-transformed, transformed, and/or hardened) may comprise elemental metal, metal alloy, ceramics, or an allotrope of elemental carbon. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplastic material. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding.

Transforming can comprise chemical bonding. Chemical bonding can comprise covalent bonding. The pre-transformed material may be pulverous. The printed 3D object can be made of a single material (e.g., single material type) or multiple materials (e.g., multiple material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some cases, a layer within the 3D object comprises a single type of material. In some examples, a layer of the 3D object may comprise a single elemental metal type, or a single alloy type. In some examples, a layer within the 3D object may comprise several types of material (e.g., an elemental metal and an alloy, an alloy and a ceramic, an alloy, and an elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than member of a type of material.

In some examples the material bed, platform, or both material bed and platform comprise a material type which constituents (e.g., atoms) readily lose their outer shell electrons, resulting in a free-flowing cloud of electrons within their otherwise solid arrangement. In some examples, the powder, the base, or both the powder and the base comprise a material characterized in having high electrical conductivity, low electrical resistivity, high thermal conductivity, or high density. The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times.” The high electrical conductivity can be between any of the afore-mentioned electrical conductivity values (e.g., from about 1*10⁵ S/m to about 1*108 S/m). The thermal conductivity, electrical resistivity, electrical conductivity, electrical resistivity, and/or density can be measured at ambient temperature (e.g., at R.T., or 20° C.). The low electrical resistivity may be at most about 1*10⁻⁵-ohm times meter (Q*m), 5*10⁻⁶ Ω*m, 1*10⁻⁶ Ω*m, 5*10⁻⁷ Ω*m, 1*10⁻⁷ Ω*m, 5*10⁻⁸ or 1*10⁻⁸ Ω*m. The low electrical resistivity can be between any of the afore-mentioned values (e.g., from about 1×10⁻⁵ Ω*m to about 1×10⁻⁸ Ω*m). The high thermal conductivity may be at least about 10 Watts per meter times Kelvin (W/mK), 15 W/mK, 20 W/mK, 35 W/mK, 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be between any of the afore-mentioned thermal conductivity values (e.g., from about 20 W/mK to about 1000 W/mK). The high density may be at least about 1.5 grams per cubic centimeter (g/cm³), 1.7 g/cm³, 2 g/cm³, 2.5 g/cm³, 2.7 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore mentioned values (e.g., from about 1 g/cm³ to about 25 g/cm³).

The elemental metal can comprise an alkali metal, an alkaline earth metal, a transition metal, a rare-earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare-earth metal can be a lanthanide or an actinide. The antinode metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth. The material may comprise a precious metal. The precious metal may comprise gold, silver, palladium, ruthenium, rhodium, osmium, iridium, or platinum. The material may comprise at least about 40%, 50%, 60%, 70%, 80%, 90%, 95%, 97%, 98%, 99%, 99.5% or more precious metal. The powder material may comprise at most about 40%, 50%, 60%, 70%, 80%, 90%, 95%, 97%, 98%, 99%, 99.5% or less precious metal. The material may comprise precious metal with any value in between the afore-mentioned values. The material may comprise at least a minimal percentage of precious metal according to the laws in the particular jurisdiction.

The metal alloy can comprise iron based alloy, nickel based alloy, cobalt based alloy, chrome based alloy, cobalt chrome based alloy, titanium based alloy, magnesium based alloy, or copper based alloy. The alloy may comprise an oxidation or corrosion resistant alloy. The alloy may comprise a super alloy (e.g., Inconel). The super alloy may comprise Inconel 600, 617, 625, 690, 718 or X-750. The alloy may comprise an alloy used for aerospace applications, automotive application, surgical application, or implant applications. The metal may include a metal used for aerospace applications, automotive application, surgical application, or implant applications. The super alloy may comprise IN 738 LC, IN 939, Rene 80, IN 6203 (e.g., IN 6203 DS), PWA 1483 (e.g., PWA 1483 SX), or Alloy 247.

The metal alloys can comprise Refractory Alloys. The refractory metals and alloys may be used for heat coils, heat exchangers, furnace components, or welding electrodes. The Refractory Alloys may comprise a high melting points, low coefficient of expansion, mechanically strong, low vapor pressure at elevated temperatures, high thermal conductivity, or high electrical conductivity.

In some embodiments, the material (e.g., alloy or elemental) comprises a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, tablet), air conditioning, generators, furniture, musical equipment, art, jewelry, cooking equipment, or sport gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

In some examples, the metal alloy comprises a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron-based alloy can comprise Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron-based alloy may include cast iron or pig iron. The steel may include Bulat steel, Chromoly, Crucible steel, Damascus steel, Hadfield steel, High speed steel, HSLA steel, Maraging steel, Maraging steel (M300), Reynolds 531, Silicon steel, Spring steel, Stainless steel, Tool steel, Weathering steel, or Wootz steel. The high-speed steel may include Mushet steel. The stainless steel may include AL-6XN, Alloy 20, celestrium, marine grade stainless, Martensitic stainless steel, surgical stainless steel, or Zeron 100. The tool steel may include Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade such as 440F, 410, 312, 430, 440A, 440B, 440C, 304, 305, 304L, 304L, 301, 304LN, 301LN, 2304, 316, 316L, 316LN, 317L, 2205, 409, 904L, 321, 254SMO, 316Ti, 321H, 17-4, 15-5, 420 or 304H. The steel may comprise stainless steel of at least one crystalline structure selected from the group consisting of austenitic, superaustenitic, ferritic, martensitic, duplex and precipitation-hardening martensitic. Duplex stainless steel may be lean duplex, standard duplex, super duplex, or hyper duplex. The stainless steel may comprise surgical grade stainless steel (e.g., austenitic 316, martensitic 420 or martensitic 440). The austenitic 316 stainless steel may include 316L or 316LN. The steel may include 17-4 Precipitation Hardening steel (also known as type 630 is a chromium-copper precipitation hardening stainless steel, or 17-4PH steel). The stainless steel may comprise 360L stainless steel.

In some examples, the titanium-based alloys include alpha alloys, near alpha alloys, alpha and beta alloys, or beta alloys. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 22, 23, 24, 25, 26, 26H, 27, 28, 29, 30, 31, 32, 33, 34, 35, 36, 37, 38 or higher. In some instances, the titanium base alloy includes TiAl₆V₄ or TiAl₆Nb₇.

In some examples, the Nickel based alloy includes Alnico, Alumel, Chromel, Cupronickel, Ferronickel, German silver, Hastelloy, Inconel, Monel metal, Nichrome, Nickel-carbon, Nicrosil, Nisil, Nitinol, Hastelloy X, Cobalt-Chromium or Magnetically “soft” alloys. The magnetically “soft” alloys may comprise Mu-metal, Permalloy, Supermalloy, or Brass. The Brass may include nickel hydride, stainless or coin silver. The cobalt alloy may include Megallium, Stellite (e. g. Talonite), Ultimet, or Vitallium. The chromium alloy may include chromium hydroxide, or Nichrome.

In some examples, the aluminum-based alloy includes AA-8000, Al—Li (aluminum-lithium), Alnico, Duralumin, Hiduminium, Kryron Magnalium, Nambe, Scandium-aluminum, or, Y alloy. The magnesium alloy may be Elektron, Magnox or T—Mg—Al—Zn (Bergman phase) alloy. At times, the material excludes at least one aluminum-based alloy (e.g., AlSi₁₀Mg).

In some examples, the copper based alloy comprises Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo or Tumbaga. The Brass may include Calamine brass, Chinese silver, Dutch metal, Gilding metal, Muntz metal, Pinchbeck, Prince's metal, or Tombac. The Bronze may include Aluminum bronze, Arsenical bronze, Bell metal, Florentine bronze, Guanin, Gunmetal, Glucydur, Phosphor bronze, Ormolu, or Speculum metal. The elemental carbon may comprise graphite, Graphene, diamond, amorphous carbon, carbon fiber, carbon nanotube, or fullerene. The copper alloy may be a high-temperature copper alloy (e.g., GRCop-84).

In some embodiments, the pre-transformed (e.g., powder) material (also referred to herein as a “pulverous material”) comprises a solid comprising fine particles. The powder may be a granular material. The powder can be composed of individual particles. At least some of the particles can be spherical, oval, prismatic, cubic, or irregularly shaped. At least some of the particles can have a fundamental length scale (e.g., diameter, spherical equivalent diameter, length, width, or diameter of a bounding sphere). The fundamental length scale (abbreviated herein as “FLS”) of at least some of the particles can be from about 1 nanometers (nm) to about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, or 5 nm. At least some of the particles can have a FLS of at least about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, 5 nanometers (nm) or more. At least some of the particles can have a FLS of at most about 1000 micrometers (microns), 500 microns, 400 microns, 300 microns, 200 microns, 100 microns, 50 microns, 40 microns, 30 microns, 20 microns, 10 microns, 1 micron, 500 nm, 400 nm, 300 nm, 200 nm, 100 nm, 50 nm, 40 nm, 30 nm, 20 nm, 10 nm, 5 nm or less. In some cases, at least some of the powder particles may have a FLS in between any of the afore-mentioned FLSs.

In some embodiments, the pre-transformed material is composed of a homogenously shaped particle mixture such that all of the particles have substantially the same shape and FLS magnitude within at most about 1%, 5%, 8%, 10%, 15%, 20%, 25%, 30%, 35%, 40%, 50%, 60%, 70%, or less distribution of FLS. In some cases, the powder can be a heterogeneous mixture such that the particles have variable shape and/or FLS magnitude. In some examples, at least about 30%, 40%, 50%, 60%, or 70% (by weight) of the particles within the powder material have a largest FLS that is smaller than the median largest FLS of the powder material. In some examples, at least about 30%, 40%, 50%, 60%, or 70% (by weight) of the particles within the powder material have a largest FLS that is smaller than the mean largest FLS of the powder material.

In some examples, the size of the largest FLS of the transformed material (e.g., height) is greater than the average largest FLS of the powder material by at least about 1.1 times, 1.2 times, 1.4 times, 1.6 times, 1.8 times, 2 times, 4 times, 6 times, 8 times, or 10 times. In some examples, the size of the largest FLS of the transformed material is greater than the median largest FLS of the powder material by at most about 1.1 times, 1.2 times, 1.4 times, 1.6 times, 1.8 times, 2 times, 4 times, 6 times, 8 times, or 10 times. The powder material can have a median largest FLS that is at least about 1 μm, 5 μm, 10 μm, 20 μm, 30 μm, 40 μm, 50 μm, 100 μm, or 200 μm. The powder material can have a median largest FLS that is at most about 1 μm, 5 μm, 10 μm, 20 μm, 30 μm, 40 μm, 50 μm, 100 μm, or 200 μm. In some cases, the powder particles may have a FLS in between any of the FLS listed above (e.g., from about 1 μm to about 200 μm, from about 1 μm to about 50 μm, or from about 5 μm to about 40 μm).

In another aspect provided herein is a method for generating a 3D object comprising: a) depositing a layer of pre-transformed material in an enclosure (e.g., to form a material bed such as a powder bed); b) providing energy (e.g., using an energy beam) to at least a portion of the layer of pre-transformed material according to a path for transforming the at least a portion of the layer of pre-transformed material to form a transformed material as at least a portion of the 3D object; and c) optionally repeating operations a) to b) to generate the 3D object. The method may further comprise after operation b) and before operation c): allowing the transformed material to harden into a hardened material that forms at least a portion of the 3D object. The enclosure may comprise at least one chamber. The enclosure (e.g., the chamber) may comprise a building platform (e.g., a substrate and/or base). The 3D object may be printed adjacent to (e.g., above) the building platform.

In another aspect provided herein is a system for generating a 3D object comprising: an enclosure for accommodating at least one layer of pre-transformed material (e.g., powder); an energy (e.g., energy beam) capable of transforming the pre-transformed material to form a transformed material; and a controller that directs the energy to at least a portion of the layer of pre-transformed material according to a path (e.g., as described herein). The transformed material may be capable of hardening to form at least a portion of a 3D object. The system may comprise an energy source, an optical system, a temperature control system, a material delivery mechanism (e.g., a recoater, or a layer dispensing mechanism), a pressure control system, an atmosphere control system, an atmosphere, a pump, a nozzle, a valve, a sensor, a central processing unit, a display, a chamber, or a computational scheme. The chamber may comprise a building platform. Examples of 3D printing systems, their components, associated methods of use, software, devices, systems, software, and apparatuses, can be found in International Patent Application Serial No. PCT/US15/36802 filed on Jun. 19, 2015, titled “APPARATUSES, SYSTEMS AND METHODS FOR THREE-DIMENSIONAL PRINTING” or in U.S. patent application Ser. No. 17/881,797 filed Aug. 5, 2022, titled “SKILLFUL THREE-DIMENSIONAL PRINTING,” each of which is incorporated herein by reference in its entirety. At least one FLS (e.g., width, depth, and/or height) of the material bed can be at least about 50 millimeters (mm), 60 mm, 70 mm, 80 mm, 90 mm, 100 mm, 200 mm, 250 mm, 280 mm, 300 mm, 350 mm, 400 mm, 500 mm, 800 mm, 900 mm, 1 meter (m), 1.5 m, 2 m or 5 m. At least one FLS of the material bed can be at most about 60 mm, 70 mm, 80 mm, 90 mm, 100 mm, 200 mm, 250 mm, 280 mm, 300 mm, 350 mm, 400 mm, 500 mm, 800 mm, 900 mm, 1 m, 1.5 m, 2 m or 5 m. At least one FLS of the material bed can be between any of the afore-mentioned values, e.g., from about 50 mm to about 5 m, from about 250 mm to about 500 mm, from about 280 mm to about 1 m, or from about 500 mm to about 5 m. At least one FLS of the build module can be at least about 50 millimeters (mm), 60 mm, 70 mm, 80 mm, 90 mm, 100 mm, 200 mm, 250 mm, 280 mm, 300 mm, 350 mm, 400 mm, 500 mm, 800 mm, 900 mm, 1 m, 1.5 m, 2 m or 5 m. At least one FLS of the build module can be at most about 60 mm, 70 mm, 80 mm, 90 mm, 100 mm, 200 mm, 250 mm, 280 mm, 300 mm, 350 mm, 400 mm, 500 mm, 800 mm, 900 mm, 1 m, 1.5 m, 2 m or 5 m. At least one FLS of the build module can be between any of the afore-mentioned values, e.g., from about 50 mm to about 5 m, from about 250 mm to about 500 mm, from about 280 mm to about 1 m, or from about 500 mm to about 5 m. At least one FLS of the processing chamber can be at least about 50 millimeters (mm), 60 mm, 70 mm, 80 mm, 90 mm, 100 mm, 200 mm, 250 mm, 280 mm, 300 mm, 350 mm, 400 mm, 500 mm, 800 mm, 900 mm, 1 m, 1.5 m, 2 m or 5 m. At least one FLS of the processing chamber can be at most about 60 mm, 70 mm, 80 mm, 90 mm, 100 mm, 200 mm, 250 mm, 280 mm, 300 mm, 350 mm, 400 mm, 500 mm, 800 mm, 900 mm, 1 m, 1.5 m, 2 m or 5 m. At least one FLS of the processing chamber can be between any of the afore-mentioned values, e.g., from about 50 mm to about 5 m, from about 250 mm to about 500 mm, from about 280 mm to about 1 m, or from about 500 mm to about 5 m.

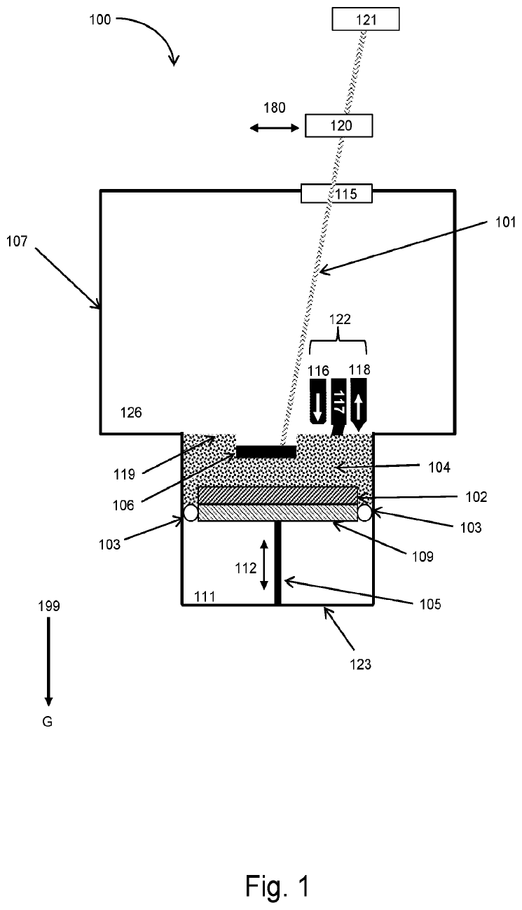

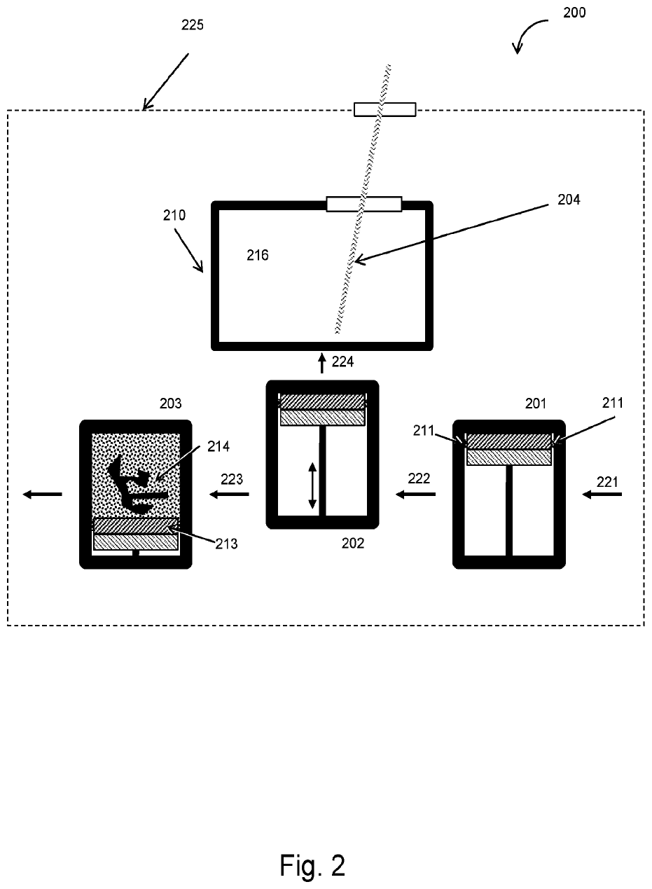

In some embodiments, the 3D printing system (e.g., FIG. 1, 100) comprises a chamber (e.g., FIG. 1, 107, comprising an atmosphere 126; FIG. 2, 216). The chamber may be referred herein as the “processing chamber.” The processing chamber may comprise an energy beam (e.g., FIG. 1, 101; FIG. 2, 204) generated by an energy source (e.g., FIG. 1, 121). The energy beam may be directed towards an exposed surface (e.g., 119) of a material bed (e.g., FIG. 1, 104). The 3D printing system may comprise one or more modules (e.g., FIGS. 2, 201, 202, and 203). The one or more modules may be referred herein as the “build modules.” At times, at least one build module (e.g., FIG. 1, 123) may be situated in the enclosure comprising the processing chamber (e.g., FIG. 1, comprising an atmosphere 126). At times, at least one build module may engage with the processing chamber (e.g., FIG. 1). At times, at least one build module may not engage with the processing chamber (e.g., FIG. 2). At times, a plurality of build modules (e.g., FIGS. 2, 201, 202, and 203) may be situated in an enclosure (e.g., FIG. 2, 200) comprising the processing chamber (e.g., FIG. 2, 210). The build module may reversibly engage with (e.g., couple to) the processing chamber. The engagement of the build module with the processing chamber may be controlled (e.g., by a controller, such as for example by a microcontroller). The control may be automatic and/or manual. The engagement of the build module with the processing chamber may be reversible. In some embodiments, the engagement of the build module with the processing chamber may be permanent. The FLS (e.g., width, depth, and/or height) of the processing chamber can be at least about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m, or 5 m. The FLS of the processing chamber can be at most about 50 millimeters (mm), 60 mm, 70 mm, 80 mm, 90 mm, 100 mm, 200 mm, 250 mm, 400 mm, 500 mm, 800 mm, 900 mm, 1 meter (m), 2 m, or 5 m. The FLS of the processing chamber can be between any of the afore-mentioned values (e.g., 50 mm to about 5 m, from about 250 mm to about 500 mm, or from about 500 mm to about 5 m).

In some embodiments, at least one of the build modules is operatively coupled to at least one controller. The controller may be its own controller. The controller may comprise a control circuit. The controller may comprise programmable control code. The controller may be different than the controller controlling the 3D printing process and/or the processing chamber. The controller controlling the 3D printing process and/or the processing chamber may comprise a different control circuit than the control circuit of the build module controller. The controller controlling the 3D printing process and/or the processing chamber may comprise a different programmable control code than the programmable control code of the build module controller. The build module controller may communicate the engagement of the build module to the processing chamber. Communicating may comprise emitting signals to the processing chamber controller. The communication may cause initialization of the 3D printing. The communication may cause one or more load lock shutters to alter their position, e.g., to open. The build module controller may monitor sensors (e.g., position, motion, optical, thermal, spatial, gas, gas composition or location) within the build module. The build module controller may control (e.g., adjust) the active elements (e.g., actuator, atmosphere, elevator mechanism, valves, opening/closing ports, seals) within the build module based on the sensed measurements. The translation facilitator may comprise an actuator. The actuator may comprise a motor. The translation facilitator may comprise an elevation mechanism. The translation mechanism may comprise a gear (e.g., a plurality of gears). The gear may be circular or linear. The translation facilitator may comprise a rack and pinion mechanism, or a screw. The translation facilitator (e.g., build module delivery system) may comprise a controller (e.g., its own controller). The controller of the translation facilitator may be different than the controller controlling the 3D printing process and/or the processing chamber. The controller of the translation facilitator may be different than the controller of the build module. The controller of the translation facilitator may comprise a control circuit (e.g., its own control circuit). The controller of the translation facilitator may comprise a programmable control code (e.g., its own programmable code). The build module controller and/or the translation facilitator controller may be a microcontroller. At times, the controller of the 3D printing process and/or the processing chamber may not interact with the controller of the build module and/or translation facilitator. At times, the controller of the build module and/or translation facilitator may not interact with the controller of the 3D printing process and/or the processing chamber. For example, the controller of the build module may not interact with the controller of the processing chamber. For example, the controller of the translation facilitator may not interact with the controller of the processing chamber. The controller of the 3D printing process and/or the processing chamber may be able to interpret one or more signals emitted from (e.g., by) the build module and/or translation facilitator. The controller of the build module and/or translation facilitator may be able to interpret one or more signals emitted from (e.g., by) the processing chamber. The one or more signals may be electromagnetic, electronic, magnetic, pressure, or sound signals. The electromagnetic signals may comprise visible light, infrared, ultraviolet, or radio frequency signals. The electromagnetic signals may comprise a radio frequency identification signal (RFID). The RFID may be specific for a build module, user, entity, 3D object model, processor, material type, printing instruction, 3D print job, or any combination thereof.

In some embodiments, the build module controller controls an engagement of the build module with the processing chamber and/or load-lock. In some embodiments, the build module controller controls a dis-engagement (e.g., release and/or separation) of the build module with the processing chamber and/or load-lock. In some embodiments, the processing chamber controller may control the engagement of the build module with the processing chamber and/or load-lock. The processing chamber controller may control a dis-engagement (e.g., release, and/or separation) of the build module with the processing chamber and/or load-lock. In some embodiments, the load-lock controller may control the engagement of the build module with the processing chamber and/or load-lock. The load-lock controller may control a dis-engagement (e.g., release, and/or separation) of the build module with the processing chamber and/or load-lock. In some embodiments, the 3D printer comprises one controller that is a build module controller, a processing chamber controller, or a load-lock controller. In some embodiments, the 3D printer comprises at least two controllers selected from the group consisting of: a build module controller, a processing chamber controller, and a load-lock controller.

In some embodiments, when a plurality of controllers are configured to direct a plurality of operations; at least two operations of the plurality of operations can be directed by the same controller of the plurality of controllers. In some embodiments, when a plurality of controllers are configured to direct a plurality of operations; at least two operations of the plurality of operations can be directed by different controllers of the plurality of controllers.

In some embodiments, the build module controller controls the translation of the build module, sealing status of the build module, atmosphere of the build module, engagement of the build module with the processing chamber, exit of the build module from the enclosure, entry of the build module into the enclosure, or any combination thereof. Controlling the sealing status of the build module may comprise opening or closing of the build module shutter. The build chamber controller may be able to interpret signals from the 3D printing controller and/or processing chamber controller. The processing chamber controller may be the 3D printing controller. For example, the build module controller may be able to interpret and/or respond to a signal regarding the atmospheric conditions in the load lock. For example, the build module controller may be able to interpret and/or respond to a signal regarding the completion of a 3D printing process (e.g., when the printing of a 3D object is complete). The build module may be connected to an actuator. The actuator may be translating or stationary. In some embodiments, the actuator may be coupled to a portion of the build module. For examples, the actuator may be coupled to a bottom surface of the build module. In some examples, the actuator may be coupled to a side surface of the build module (e.g., front, and/or back of the build module). The controller of the build module may direct the translation facilitator (e.g., actuator) to translate the build module from one position to another (e.g., arrows 221-224 in FIG. 2), when translation is possible. The translation facilitator (e.g., actuator) may translate the build module in a vertical direction, horizontal direction or at an angle (e.g., planar and/or compound). In some examples, the build module may be heated during translation. The translation facilitator may be a build module delivery system. The translation facilitator may be autonomous. The translation facilitator may operate independently of the 3D printer (e.g., mechanisms directed by the 3D printing controller). The translation facilitator (e.g., build module delivery system) may comprise a controller and/or a motor. The translation facilitator may comprise a machine or a human. The translation is possible, for example, when the destination position of the build module is empty. The controller of the 3D printing and/or the processing chamber may be able to sense signals emitted from the controller of the build module. For example, the controller of the 3D printing and/or the processing chamber may be able to sense a signal from the build module that is emitted when the build module is docked into engagement position with the processing chamber. The signal from the build module may comprise reaching a certain position in space, reaching a certain atmospheric characteristic threshold, opening, or shutting the build plate closing, or engaging or disengaging (e.g., docking or undocking) from the processing chamber. The build module may comprise one or more sensors. For example, the build module may comprise a proximity, movement, light, sounds, or touch sensor.

In some embodiments, the build module is included as part of the 3D printing system. In some embodiments, the build module is separate from the 3D printing system. The build module may be independent (e.g., operate independently) from the 3D printing system. For example, the build module may comprise its own controller, motor, elevator, build plate, valve, channel, or shutter. In some embodiments, one or more conditions differ between the build module and the processing chamber, and/or among the different build modules. The difference may comprise different pre-transformed materials, atmospheres, platforms, temperatures, pressures, humidity levels, oxygen levels, gas (e.g., inert), traveling speed, traveling method, acceleration speed, or post processing treatment. For example, the relative velocity of the various build modules with respect to the processing chamber may be different, similar, or substantially similar. The build plate may undergo different, similar, or substantially similar post processing treatment (e.g., further processing of the 3D object and/or material bed after the generation of the 3D object in the material bed is complete).

In some embodiments, at least one build module translates relative to the processing chamber. The translation may be parallel or substantially parallel to the bottom surface of the build chamber. The bottom surface of the build chamber is the one closest to the gravitational center. The translation may be at an angle (e.g., planar or compound) relative to the bottom surface of the build chamber. The translation may use any device that facilitates translation (e.g., an actuator). For example, the translation facilitator may comprise a robotic arm, conveyor (e.g., conveyor belt), rotating screw, or a moving surface (e.g., platform). The translation facilitator may comprise a chain, rail, motor, or an actuator. The translation facilitator may comprise a component that can move another. The movement may be controlled (e.g., using a controller). The movement may comprise using a control signal and source of energy (e.g., electricity). The translation facilitator may use electricity, pneumatic pressure, hydraulic pressure, or human power.

In some embodiments, the 3D printing system comprises multiple build modules. The 3D printing system may comprise at least 1, 2, 3, 4, 5, 6, 7, 8, 9, or 10 build modules. FIG. 2 shows an example of three build modules (e.g., 201, 202, and 203) and one processing chamber 210.

In some embodiments, at least one build module (e.g., 201, 202, and 203) engages (e.g., 224) with the processing chamber to expand the interior volume of the processing chamber. At times, the build module may be connected to, or may comprise an autonomous guided vehicle (AGV). The AGV may have at least one of the following: a movement mechanism (e.g., wheels), positional (e.g., optical) sensor, and controller. The controller (e.g., build module controller) may enable self-docking of the build module (e.g., to a docking station) and/or self-driving of the AGV. The self-docking of the build module (e.g., to the processing chamber) and/or self-driving may be to and from the processing chamber. The build module may engage with (e.g., couple to) the processing chamber. The engagement may be reversible. The engagement of the build module with the processing chamber may be controlled (e.g., by a controller). The controller may be separate from a controller that controls the processing chamber (or any of its components). In some embodiments, the controller of the processing chamber may be the same controller that controls the build module. The control may be automatic, remote, local, and/or manual. The engagement of the build module with the processing chamber may be reversible. In some embodiments, the engagement of the build module with the processing chamber may be permanent. The controller (e.g., of the build module) may control the engagement of the build module with a load lock mechanism (e.g., that is coupled to the processing chamber). Control may comprise regulate, monitor, restrict, limit, govern, restrain, supervise, direct, guide, manipulate, or modulate.

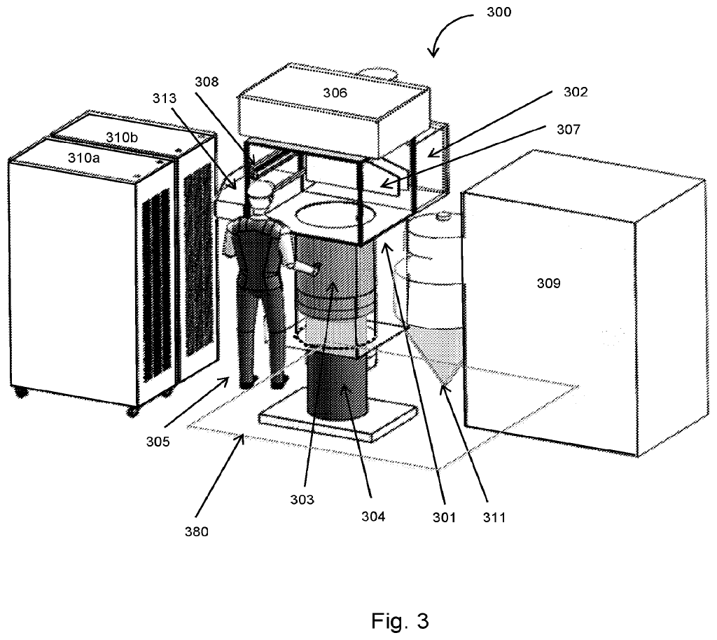

FIG. 3 shows an example of a 3D printing system 300 disposed in relation to gravitational vector 390 directed towards gravitational center G of the environment, e.g., Earth. The 3D printing system comprises processing chamber 301 coupled to an ancillary chamber (e.g., garage) 302 configured to accommodate a layer dispensing mechanism (e.g., recoater), e.g., in its resting (e.g., idle) position. The processing chamber is coupled to a build module 303 that extends 304 under a plane 380 (e.g., floor) at which user 305 stands on, e.g., can extend under-grounds. The processing chamber may comprise a door (not shown) facing user 305. 3D printing system 300 comprises enclosure 306 that can comprise an energy beam alignment system (e.g., an optical system) and/or an energy beam directing system (e.g., scanner)—not shown. A layer dispensing mechanism (not shown) may be coupled to a framing 307 as part of a movement system that facilitate movement of the layer dispensing mechanism along the material bed and ancillary chamber (e.g., garage), such as in a reversible back-and-forth movement. The movement system comprises a translation inducer system, e.g., comprising a belt or a chain 308 3D printing system 300 comprises a filter unit 309, heat exchangers 310a and 310b, pre-transformed material reservoir 311, and gas flow mechanism (e.g., comprising gas inlets and gas inlet portions) disposed in enclosure 313. The filtering system may filter gas and/or pre-transformed (e.g., powder) material. The filtering system may be configured to filter debris, e.g., comprising byproduct(s) of the 3D printing

In some embodiments, during at least a portion of the 3D printing process, the atmospheres of at least two of the processing chambers, build module, and enclosure may merge. The merging may be through a load lock environment. At times, during at least a portion of the 3D printing process, the atmospheres of the chamber and enclosure may remain separate. During at least a portion of the 3D printing process, the atmospheres of the build module and processing chamber may be separate. The build module may be mobile or stationary. The build module may comprise an elevator. The elevator may be connected to a platform (e.g., building platform). The elevator may be reversibly connected to at least a portion of the platform (e.g., to the base). The elevator may be irreversibly connected to at least a portion of the platform (e.g., to the substrate). The platform may be separated from one or more walls (e.g., side walls) of the build module by a seal (e.g., FIG. 2, 211; FIG. 1, 103). The seal may be impermeable or substantially impermeable to gas. The seal may be permeable to gas. The seal may be flexible. The seal may be elastic. The seal may be bendable. The seal may be compressible. The seal may comprise rubber (e.g., latex), Teflon, plastic, or silicon. The seal may comprise a mesh, membrane, sieve, paper (e.g., filter paper), cloth (e.g., felt), or brush. The mesh, membrane, paper and/or cloth may comprise randomly and/or non-randomly arranged fibers. The paper may comprise a HEPA filter. The seal may be permeable to at least one gas, and impermeable to the pre-transformed (e.g., and to the transformed) material. The seal may not allow a pre-transformed (e.g., and to the transformed) material to pass through.

In some embodiments, the build module engages with the processing chamber. The engagement may comprise engaging the supported component with the supporting component. The supported component (e.g., first fixture) may be operatively coupled to the build module. The supported component may be able to carry the weight of the build module, 3D object, material bed, or any combination thereof. The supporting component (e.g., second fixture) may be operatively coupled to the processing chamber. The supporting component may be operatively coupled to the processing chamber through the load lock. For example, the supporting component may be directly coupled to the processing chamber. For example, the supporting component may be directly coupled to the load lock that is coupled to the processing chamber. The supported component may be able to support a weight of the build module, 3D object, material bed, or any combination thereof. The supporting component may be able to support a weight of at least about 10 kilograms (Kg), 50 Kg, 100 Kg, 500 Kg, 1000 Kg, 1500 Kg, 2000 Kg, 2500 Kg, 3000 Kg, or 5000 Kg. The supporting component may be able to support the weight of at most about 500 Kg, 1000 Kg, 1500 Kg, 2000 Kg, 2500 Kg, 3000 Kg, or 5000 Kg. The supporting component may be able to support a weight of any weight value between the afore mentioned weight values (e.g., from about 10 Kg to about 5000 Kg, from about 10 Kg to about 500 Kg, from about 100 Kg to about 2000 Kg, or from about 1000 Kg to about 5000 Kg). The supported component may be able to carry a weight having any of the weight values that the supporting component is able to support.

In some embodiments, the build module, processing chamber, and/or enclosure comprises one or more seals. The seal may be a sliding seal or a top seal. For example, the build module and/or processing chamber may comprise a sliding seal that meets with the exterior of the build module upon engagement of the build module with the processing chamber. For example, the processing chamber may comprise a top seal that faces the build module and is pushed upon engagement of the processing chamber with the build module. For example, the build module may comprise a top seal that faces the processing chamber and is pushed upon engagement of the processing chamber with the build module. The seal may be a face seal, or compression seal. The seal may comprise an O-ring.

In some embodiments, the build module, processing chamber, and/or enclosure are sealed, sealable, or open. The atmosphere of the build module, processing chamber, and/or enclosure may be regulated. The build module may be sealed, sealable, or open. The processing chamber may be sealed, sealable, or open. The enclosure may be sealed, sealable, or open. The build module, processing chamber, and/or enclosure may comprise a valve and/or a gas opening port. The valve and/or a gas opening port may be below, or above the building platform. The valve and/or a gas opening port may be disposed at the horizontal plane of the build plate. The valve and/or a gas opening port may be disposed at the adjacent to the build plate. The valve and/or a gas opening port may be disposed between the processing chamber and the build module. The valve may allow at least one gas to travel through. The gas may enter or exit through the valve. For example, the gas may enter or exit the build module, processing chamber, and/or enclosure through the valve. In some embodiments, the atmosphere of the build module, processing chamber, and/or enclosure may be individually controlled. In some embodiments, the atmosphere of at least two of the build modules, processing chamber, and enclosure may be separately controlled. In some embodiments, the atmosphere of at least two of the build modules, processing chamber, and enclosure may be controlled in concert (e.g., simultaneously). In some embodiments, the atmosphere of at least one of the build modules, processing chamber, or enclosure may be controlled by controlling the atmosphere of at least one of the build module, processing chamber, or enclosure in any combination or permutation. In some examples, the atmosphere in the build module is not controllable by controlling the atmosphere in the processing chamber.

In some embodiments, the material bed is of a cylindrical or cuboid shape. The material bed may translate. The translation may be vertical (e.g., FIG. 1, 112). The translation may be rotational. The rotation (e.g., 127) may be about a vertical axis (e.g., 105). The translation of the material bed may be facilitated by a translation of the substrate (e.g., 109). The translation may be controlled (e.g., manually and/or automatically, e.g., using a controller). The translation may be during at least a portion of the 3D printing. For example, the translation may be before using the energy beam (e.g., 101) to transform the pre-transformed material. For example, the translation may be before using the layer dispensing mechanism (e.g., 116, 117, and 118). The rotation may be at any angle. For example, any value of the angle alpha described herein. The translation may be prior to deposition of a layer of pre-transformed material.

In some embodiments, the build module, processing chamber, unpacking enclosure, and/or other enclosure comprises a gas equilibration channel, e.g., as part of a gas conveyance system. The gas (e.g., pressure and/or content) may equilibrate between at least two of the build module, processing chamber, unpacking enclosure and other enclosure through the gas equilibration channel. At least two of the build modules, processing chamber, unpacking enclosure and other enclosure may be fluidly connected through the gas equilibration channel. In some embodiments, the gas equilibration may be connected to the processing enclosure (e.g., chamber). In some embodiments, the gas equilibration may be connected to the unpacking enclosure. The gas equilibration channel may couple to a wall of a build module (e.g., as it docks). In some embodiments, the gas equilibration may be operatively coupled (e.g., connected) to the build module. The gas equilibration channel may couple to a wall of the processing chamber or unpacking chamber (e.g., as the build module docks). The gas equilibration channel may comprise a valve and/or a gas opening port. The valve and/or a gas opening port may be disposed in the build module below, or above the building platform. The valve and/or a gas opening port may be disposed in the build module at the horizontal plane of the build plate. The valve and/or a gas opening port may be disposed in the build module adjacent to the build plate. The valve and/or a gas opening port may be disposed between the processing chamber and the build module. For example, the gas equilibration channel may be operatively coupled to (e.g., connected to) a load-lock. The valve and/or a gas opening port may be disposed between the unpacking chamber and the build module. For example, the gas equilibration channel may be operatively coupled to (e.g., connected to) a load-lock. The load lock can comprise a partition (e.g., a wall) having an internal volume. The gas equilibration channel may couple to the build module, e.g., as the build module docks. For example, the gas equilibration channel may be connected to build module. The gas equilibration channel may couple to the load-lock. For example, as the build module couples with the processing chamber such as when the build module docks to the processing chamber. For example, as the build module couples with the unpacking chamber such as when the build module docks to the unpacking chamber.

In some embodiments, the unpacking station comprises a load lock. For example, the unpacking chamber and the build module may be coupled through a load lock. In some embodiments, the 3D printing system comprises a load lock. For example, the processing chamber and the build module may be coupled through a load lock. The load lock may comprise a chamber acting as an intermediary between two other chambers whose interior atmospheres are to be merged, e.g., in a controlled manner. The load lock may be used to facilitate controlled atmospheric exchange between the two other chambers. Controlled may be with respect to the atmospheric exchange, e.g., with respect to at least one characteristic of the exchanged atmosphere. For example, the load lock may be utilized to merge atmospheres of the build module with the atmosphere of the processing chamber without exposing the atmosphere of the processing chamber and/or of the build module to the ambient atmosphere. For example, the load lock may be utilized to merge atmospheres of the build module with the atmosphere of the processing chamber without exposing the atmosphere of the processing chamber to the ambient atmosphere. For example, the load lock may be utilized to merge atmospheres of the build module with the atmosphere of the unpacking chamber without exposing the atmosphere of the unpacking chamber and/or of the build module to the ambient atmosphere. For example, the load lock may be utilized to merge atmospheres of the build module with the atmosphere of the unpacking chamber without exposing the atmosphere of the unpacking chamber to the ambient atmosphere. Prior to engagement with the load lock, the build module may be disposed in the ambient atmosphere in a closed or open configuration. In some embodiments, the build module is closed (e.g., sealed such as gas tight sealed) prior to its engagement with the load lock. The build module may enclosure an atmosphere different from the ambient atmosphere. The load lock may facilitate reducing (e.g., substantially eliminating) contamination from reactive species in the ambient atmosphere prior to engagement with the atmosphere of the processing chamber. The load lock may be configured for purging its interior space with an atmosphere different than the ambient atmosphere (e.g., external atmosphere). The load lock may be configured to retain an atmosphere different by at least one characteristic (e.g., pressure, temperature, and/or gas content) from the ambient atmosphere. For example, the load lock may be configured to maintain pressure above ambient atmospheric pressure, e.g., as disclosed herein. Examples of load lock, and build module, gas equilibration channel, and seals, unpacking stations, 3D printing systems, their components, associated methods of use, software, devices, systems, and apparatuses, can be found in International Patent Application Serial No. PCT/US17/39422 filed Jun. 27, 2017; in U.S. patent application Ser. No. 15/634,228 filed Jun. 27, 2017; or in International Patent Application Serial No. PCT/US22/52588 filed Dec. 12, 2022; each of which is incorporated herein by reference in its entirety.

In some embodiments, the gas equilibration channel controls (e.g., maintain) the atmospheric pressure and/or gas content within at least two of the build modules, processing chamber, and load-lock area. Control may include closing the opening port and/or valve. For example, control may include opening the opening port and/or valve to perform exchange of atmospheres between the build module and/or the processing chamber. Control may include controlling the flow of gas. The flow of gas may be from the build module to the processing chamber or vice-versa. The flow of gas may be from the build module to the load-lock area or vice-versa. Maintaining the gas pressure and/or content may include closing the opening port and/or valve. Maintaining may include inserting gas into the build module, processing chamber, and/or load-lock area. Maintaining may include inserting gas into the processing chamber. Maintaining may include evacuating gas from the build module, load-lock area, and/or processing chamber. In some embodiments, the atmosphere of the build module, processing chamber, and/or enclosure may be individually controlled. In some embodiments, the atmosphere of at least two of the build modules, processing chamber, load-lock area, and enclosure may be separately controlled. In some embodiments, the atmosphere of at least two of the build modules, processing chamber, load-lock area, and enclosure may be controlled in concert (e.g., simultaneously). In some embodiments, the atmosphere of at least one of the build modules, processing chamber, load-lock area, or enclosure may be controlled by controlling the atmosphere of at least one of the different build module, processing chamber, load-lock area, or enclosure in any combination or permutation. In some examples, the atmosphere in the build module is not controllable by controlling the atmosphere in the processing chamber and/or load-lock area.

In some embodiments, the 3D printing system comprises a load lock. The load lock may be disposed between the unpacking chamber and the build module. The load lock may be formed by engaging the build module with the unpacking chamber (e.g., using the load-lock mechanism). The load lock may be sealable. For example, the load lock may be sealed by engaging the build module with the unpacking chamber (e.g., directly, or indirectly). An exchange of atmosphere may take place in the load lock by evacuating gas from the load lock and/or by inserting gas, e.g., by purging gas. In some embodiments, the load lock may comprise one or more gas opening ports. At times, the load lock may comprise one or more gas transport channels. At times, the load lock may comprise one or more valves. A gas transport channel may comprise a valve. The gas transport channel may comprise the gas equilibration channel. The opening and/or closing of a first valve of the 3D printing system may or may not be coordinated with the opening and/or closing of a second valve of the 3D printing system. The valve may be controlled automatically (e.g., by a controller) and/or manually. The load lock may comprise a gas entry opening port and a gas exit opening port. In some embodiments, a pressure below ambient pressure (e.g., of 1 atmosphere) is formed in the load lock. In some embodiments, a pressure exceeding ambient pressure (e.g., of 1 atmosphere) is formed in the load lock such as any positive pressure disclosed herein. At times, during the exchange of load lock atmosphere, a pressure below and/or above ambient pressure if formed in the load lock. At times, a pressure equal or substantially equal to ambient pressure is maintained (e.g., automatically, and/or manually) in the load lock. The load lock, building module, unpacking chamber, and/or enclosure may comprise a valve. The valve may comprise a pressure relief, pressure release, pressure safety, safety relief, pilot-operated relief, low pressure safety, vacuum pressure safety, low and vacuum pressure safety, pressure vacuum release, snap acting, or modulating valve. The valve may comply with the legal industry standards presiding the jurisdiction. The volume of the load lock may be smaller than the volume within the build module and/or unpacking chamber. The total volume within the load lock may be at most about 0.1%, 0.5%, 1%, 5%, 10%, 20%, 50%, or 80% of the total volume encompassed by the build module and/or unpacking chamber. The total volume within the load lock may be between any of the afore-mentioned percentage values, e.g., from about 0.1% to about 80%, from about 0.1% to about 5%, from about 5% to about 20%, from about 20% to about 50%, or from about 50% to about 80%. The percentage may be volume per volume percentage. While the disclosure herein pertains to the unpacking chamber of the unpacking station, the processing chamber of the 3D printer can assume a similar configuration and/or operation to those of the unpacking station.

In some embodiments, the atmosphere of the build module and/or the unpacking chamber is fluidly connected to the atmosphere of the load lock. At times, conditioning the atmosphere of the load lock will condition the atmosphere of the build module and/or the unpacking chamber that is fluidly connected to the load lock. The fluid connection may comprise gas flow. The fluid connection may be through a gas permeable seal and/or through a channel (e.g., a pipe). The channel may be a sealable channel (e.g., using a valve).

In some embodiments, the shutter of the build module engages with the shutter of the unpacking chamber. The engagement may be spatially controlled. For example, when the shutter of the build module is within a certain gap distance from the unpacking chamber shutter, the build module shutter engages with the unpacking chamber shutter. The gap distance may trigger an engagement mechanism. The gap trigger may be sufficient to allow sensing of at least one of the shutters. The engagement mechanism may comprise magnetic, electrostatic, electric, hydraulic, pneumatic, or physical force. The physical force may comprise manual force. Subsequent to the engagement, the single unit may transfer (e.g., relocate, or move) away from the energy beam. For example, the engagement may trigger the transferring (e.g., relocating) of the build module shutter and the unpacking chamber shutter as a single unit.

In some embodiments, removal of the shutter (e.g., of the build module and/or unpacking chamber) depends on reaching a certain (e.g., predetermined) level of at atmospheric characteristic comprising a gas content (e.g., relative gas content), gas pressure, oxygen level, humidity, argon level, or nitrogen level. For example, the certain level may be an equilibrium between an atmospheric characteristic in the build chamber and that atmospheric characteristic in the unpacking chamber. The shutter may be a gas tight shutter. The shutter may be a hermetically sealed shutter.

In some embodiments, the 3D printing process initiates after merging of the build module with the processing chamber. At the beginning of the 3D printing process, the build plate may be at an elevated position. At the end of the 3D printing process, the build plate may be at a vertically reduced position, e.g., FIG. 2, 213. The building module may translate between three positions during a 3D printing run. The build module may enter the enclosure from a position away from the engagement position with the processing chamber, e.g., FIG. 2, 201. The build module may then advance toward (e.g., 222 and 224) the processing chamber (e.g., FIG. 2, 202), and engage with the processing chamber. The layer dispensing mechanism and energy beam will translate and form the 3D object within the material bed (e.g., as described herein), while the platform gradually lowers its vertical position. Once the 3D object printing is complete (e.g., FIG. 2, 214), the build module may disengage from the processing chamber and translate (e.g., 223) away from the processing chamber engagement position, e.g., FIG. 2, 203. Disengagement of the build module from the processing chamber may include closing the processing chamber with its shutter, closing the build module with its shutter, or both closing the processing chamber shutter and closing the build module shutter. Disengagement of the build module from the processing chamber may include maintaining the processing chamber atmosphere to be separate from the enclosure atmosphere, maintaining the build module atmosphere to be separate from the enclosure atmosphere, or maintaining both the processing chamber atmosphere and the build atmosphere separate from the enclosure atmosphere. Disengagement of the build module from the processing chamber may include maintaining the processing chamber atmosphere to be separate from the ambient atmosphere, maintaining the build module atmosphere to be separate from the ambient atmosphere, or maintaining both the processing chamber atmosphere and the build atmosphere separate from the ambient atmosphere. The building platform that is disposed within the build module before engagement with the processing chamber, may be at its topmost position, bottom most position, or anywhere between its top most position and bottom most position within the build module.

In some embodiments, the usage of sealable build modules, processing chamber, and/or unpacking chamber allows a small degree of operator intervention, low degree of operator exposure to the pre-transformed material, and/or low-down time of the 3D printer. The 3D printing system may operate most of the time without an intermission. The 3D printing system may be utilized for 3D printing most of the time. Most of the time may be at least about 50%, 70%, 80%, 90%, 95%, 96%, 97%, 98%, or 99% of the time. Most of the time may be between any of the afore-mentioned values (e.g., from about 50% to about 99%, from about 80% to about 99%, from about 90% to about 99%, or from about 95% to about 99%) of the time. The entire time includes the time during which the 3D printing system prints a 3D object, and time during which it does not print a 3D object. Most of the time may include operation during seven days a week and/or 24 hours during a day.

In some embodiments, the 3D printing system requires operation of maximum a single standard daily work shift. The 3D printing system may require operation by a human operator working at most of about 8 hours (h), 7 h, 6 h, 5 h, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day).

In some embodiments, the 3D printing system requires operation of maximum a single standard work week shift. The 3D printing system may require operation by a human operator working at most of about 50 h, 40 h, 30 h, 20 h, 10 h, 5 h, or 1 h a week. The 3D printing system may require operation by a human operator working between any of the afore-mentioned time frames (e.g., from about 40 h to about 1 h, from about 40 h to about 20 h, from about 30 h to about 10 h, from about 20 h to about 1 h, or from about 10 h to about 1 h a week). A single operator may support during his daily and/or weekly shift at least 1, 2, 3, 4, 5, 6, 7, 8, 9, or 10 3D printers (e.g., 3D printing systems).

In some embodiments, the enclosure and/or processing chamber of the 3D printing system is opened to the ambient environment sparingly. In some embodiments, the enclosure and/or processing chamber of the 3D printing system may be opened by an operator (e.g., human) sparingly. Sparing opening may be at most once in at most every 1, 2, 3, 4, or 5 weeks. The weeks may comprise weeks of standard operation of the 3D printer.

In some embodiments, the 3D printer has a capacity of 1, 2, 3, 4, or 5 full prints in terms of pre-transformed material (e.g., powder) reservoir capacity. The 3D printer may have the capacity to print a plurality of 3D objects in parallel. For example, the 3D printer may be able to print at least 2, 3, 4, 5, 6, 7, 8, 9, or 10 3D objects in parallel.

In some embodiments, the printed 3D object is retrieved soon after terminating the last transformation operation of at least a portion of the material bed. Soon after terminating may be at most about 1 day, 12 hours, 6 hours, 3 hours, 2 hours, 1 hour, 30 minutes, 15 minutes, 5 minutes, 240 seconds (sec), 220 sec, 200 sec, 180 sec, 160 sec, 140 sec, 120 sec, 100 sec, 80 sec, 60 sec, 40 sec, 20 sec, 10 sec, 9 sec, 8 sec, 7 sec, 6 sec, 5 sec, 4 sec, 3 sec, 2 sec, or 1 sec. Soon after terminating may be between any of the afore-mentioned time values (e.g., from about 1 s to about 1 day, from about 1 s to about 1 hour, from about 30 minutes to about 1 day, or from about 20 s to about 240 s).

In some embodiments, the 3D printer has a capacity of 1, 2, 3, 4, or 5 full prints before requiring human intervention. Human intervention may be required for refilling the pre-transformed (e.g., powder) material, unloading the build modules, unpacking the 3D object, or any combination thereof. The 3D printer operator may condition the 3D printer at any time during operation of the 3D printing system (e.g., during the 3D printing process). Conditioning of the 3D printer may comprise refilling the pre-transformed material that is used by the 3D printer, replacing gas source, or replacing filters. The conditioning may be with or without interrupting the 3D printing system. For example, refilling and unloading from the 3D printer can be done at any time during the 3D printing process without interrupting the 3D printing process. Conditioning may comprise refreshing the 3D printer and/or the pre-transformed (e.g., recycled) material. Conditioning may comprise avoiding reactions (e.g., oxidation) of the material (e.g., powder) with agents (e.g., water and/or oxygen). For example, a material (e.g., liquid, or particulate material) may have chromium that oxidizes and forms chromium oxide. The oxidized material may have a high vapor pressure (e.g., low evaporation temperature). To avoid reactions, the material may be conditioned. Conditioning may comprise removal of reactive species (e.g., comprising oxygen and/or water). Types of conditioning may include heating the material (e.g., before recycling or use), irradiating the material (e.g., ablation), flushing the material with an inert gas (e.g., argon). The flushing may be done in an inert atmosphere (e.g., within the processing chamber). The flushing may be done in an atmosphere that is (e.g., substantially) non-reactive with the material (e.g., liquid, or particulate material).

In some embodiments, the 3D printer comprises at least one filter. The filter may be a ventilation filter. The ventilation filter may capture fine powder from the 3D printing system. The filter may comprise a paper filter such as a high-efficiency particulate arrestance (HEPA) filter (a.k.a., high-efficiency particulate arresting or high-efficiency particulate air filter). The ventilation filter may capture spatter. The spatter may result from the 3D printing process. The ventilator may direct the spatter in a requested direction (e.g., by using positive or negative gas pressure). For example, the ventilator may use vacuum. For example, the ventilator may use gas blow.

At times, there is a time lapse (e.g., time delay) between the end of printing in a first material bed, and the beginning of printing in a second material bed. The time lapse between the end of printing in a first material bed, and the beginning of printing in a second material bed may be at most about 60 minutes (min), 40 min, 30 min, 20 min, 15 min, 10 min, or 5 min. The time lapse between the end of printing in a first material bed, and the beginning of printing in a second material bed may be between any of the afore-mentioned times (e.g., from about 60 min to abo 5 min, from about 60 min to about 30 min, from about 30 min to about 5 min, from about 20 min to about 5 min, from about 20 min to about 10 min, or from about 15 min to about 5 min). The speed during which the 3D printing process proceeds is disclosed in PCT/US15/36802 that is incorporated herein in its entirety.

In some embodiments, the 3D object is removed from the material bed after the completion of the 3D printing process. For example, the 3D object may be removed from the material bed when the transformed material that formed the 3D object hardens. For example, the 3D object may be removed from the material bed when the transformed material that formed the 3D object is no longer susceptible to deformation under standard handling operation (e.g., human and/or machine handling).

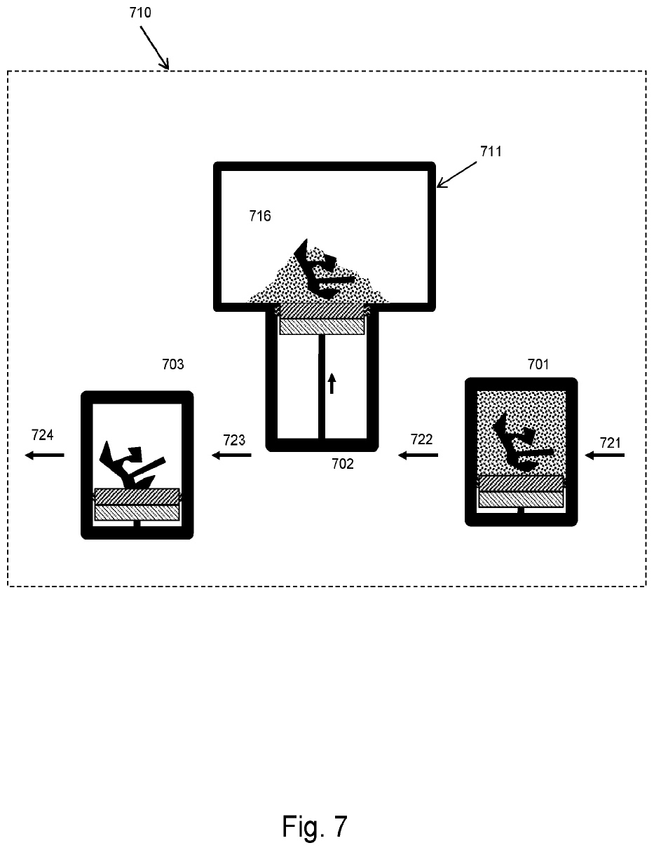

In some embodiments, the 3D object is removed from the build module inside or outside of the 3D printer (e.g., 3D printer enclosure, e.g., FIG. 2, 225). For example, the 3D object that is disposed within the material bed may be removed outside of the enclosure (e.g., by being enclosed in the build module, e.g., FIG. 2, 203). The 3D object may be removed from the build module to an unpacking station (also referred to herein as “unpacking system”). The unpacking station may be within the 3D printer enclosure, or outside of the 3D printer enclosure. The enclosure of the unpacking station may be different (e.g., separate) from the 3D printer enclosure. FIG. 7 shows an example of an unpacking station comprising an enclosure 710, an unpacking chamber 711, and build modules (e.g., 701, 702, and 703) disposed at various positions within the unpacking station enclosure. In some embodiments, the unpacking station enclosure 710 is absent. The build modules may transition between the various positions (e.g., near numbers 701, 702, and 703) according to arrows 721, 722, 723, and 724 respectively. The separate enclosure (e.g., 710), unpacking station (e.g., 711), and/or build module (e.g., 701, 702, and/or 703) may comprise an ambient or a controlled atmosphere. The atmosphere in the separate (e.g., unpacking station) enclosure may be identical, substantially identical, or different from the atmosphere in the build module, processing chamber, and/or enclosure housing the processing chamber (e.g., 3D printer enclosure). The unpacking chamber may comprise a controlled atmosphere. The atmosphere 716 of the unpacking chamber (e.g., 711) may be controlled separately or together with the atmosphere of the unpacking station enclosure (e.g., 710). The unpacking chamber may comprise a shutter (e.g., similar to the shutter of the processing chamber). The build modules may dock to the unpacking chamber in a manner similar to the way the build modules dock to the processing chamber (e.g., through a load lock, conditioning the load lock atmosphere to 3D printing atmosphere, and removing the respective shutters). The docking may be from any direction (e.g., any of the six spatial directions). The direction may comprise a Cartesian direction. The direction may comprise a cardinal direction. The direction may be horizontal or vertical. The direction may be lateral. The material bed comprising the 3D object may be separated from an operator (e.g., human). The unpacking operation may take place without contact of the operator with the pre-transformed material (e.g., remainder). The unpacking operation may take place without contact of the pre-transformed material (e.g., remainder) with the ambient atmosphere. The unpacking station may be sealed prior to engagement, or after an engagement with the build module (e.g., using an unpacking station shutter), for example, to deter atmospheric exchange between the external environment and the interior of the unpacking station. The build module may be sealed prior to engagement of the build module with the unpacking station, for example, to deter atmospheric exchange between the external environment and the interior of the unpacking station. The build module may be sealed prior to disengagement of the build module from the unpacking station (e.g., using a load lock shutter), for example, to deter atmospheric exchange between the external environment and the interior of the unpacking station. To deter atmospheric exchange between the external environment and the interior of the unpacking station may comprise to deter infiltration of one or more reactive agents from the ambient atmosphere. The reactive agent may comprise humidity and/or oxidizing agent (e.g., oxygen). The separate enclosure (e.g., 710), unpacking station (e.g., 711), and/or build module (e.g., 701, 702, and/or 703) may comprise an atmosphere having a pressure greater than the ambient pressure. Greater pressure may be a pressure of at least about 0.2 pounds per square inch (PSI), 0.25 PSI, 0.3 PSI, 0.35PSI, 0.4 PSI, 0.45 PSI, 0.5 PSI, 0.8 PSI, 1.0 PSI, 1.5 PSI, or 2.0 PSI above ambient pressure (e.g., of 14.7 PSI). The ambient pressure may be constant or fluctuating. Greater pressure may be between any of the afore-mentioned values (e.g., from about 0.2 PSI to about 2.0 PSI, from about 0.3 PSA to about 1.5 PSI, or from about 0.4 PSI to about 1.0 PSI above ambient pressure). The 3D object in the build module may be kept at an atmosphere that is different from the external (e.g., ambient) atmosphere from prior to entry to the unpacking station (e.g., 701), through it unpacking (e.g., 702), to its exit from the unpacking station (e.g., 703).

In some embodiments, the atmosphere is exchanged in an enclosure. For example, the atmosphere is exchanged before the pre-transformed material is introduced into that enclosure (e.g., to reduce possibility of a reaction of the pre-transformed material with a reactive agent, and/or to allow recycling of the pre-transformed material). For example, the atmosphere is exchanged in an enclosure before the 3D printing is conducted in that enclosure (e.g., to reduce possibility of a reaction of the pre-transformed material or of a by-product, with a reactive agent). The by-product may comprise evaporated transformed material, or gas borne pre-transformed material. The by-product may comprise soot. The reactive agent may comprise oxygen or humidity. The atmospheric exchange may comprise sucking the atmosphere or purging the atmosphere. The suction or purging may utilize a pump (e.g., pressure or vacuum pump). The atmospheric exchange (e.g., purging) may comprise utilizing a pressurized gas source. The pressurized gas source may comprise a pressurized gas container (e.g., a gas-cylinder). The pressurized gas source may comprise a build module that encloses pressurized atmosphere that has a pressure greater than the pressure in the processing chamber. The pressurized build module may engage with a chamber. The chamber may comprise the processing chamber or the unpacking station. The engagement of the build module with the chamber may comprise merging their atmospheres to have a combined atmosphere pressure that is above ambient pressure. The pressurized gas source may comprise a build module that encloses pressurized atmosphere that has a pressure greater than the pressure in the chamber (e.g., unpacking station or processing chamber). The combined atmosphere may have a pressure greater than the ambient pressure by at least about 0.2 pounds per square inch (PSI), 0.25 PSI, 0.3 PSI, 0.35PSI, 0.4 PSI, 0.45 PSI, 0.5 PSI, 0.8 PSI, 1.0 PSI, 1.5 PSI, or 2.0 PSI above ambient pressure (e.g., of 14.7 PSI). The combined atmosphere may have a pressure greater than the ambient pressure by any value between any of the afore-mentioned values (e.g., from about 0.2 PSI to about 2.0 PSI, from about 0.3 PSA to about 1.5 PSI, or from about 0.4 PSI to about 1.0 PSI above ambient pressure). The build module, processing chamber, and/or unpacking station may comprise an evacuator of the reactive agent (e.g., oxygen). The evacuator can be passive or active. The passive evacuator may comprise a scavenger for the reactive agent (e.g., a desiccating agent). The passive evacuator may comprise a material that (e.g., spontaneously) absorbs and/or reacts with the reactive agent (e.g., to scavenge it from the atmosphere). At least one controller may be coupled to the build module, processing chamber, and/or unpacking station and may control the amount of the reactive agent (e.g., to be below a certain threshold value).

In some embodiments, the build module is designed to maintain the 3D object within an atmosphere suitable for transport. The build module can comprise a boundary (e.g., comprising one or more walls) that define an internal volume that is configured to store the 3D object in an internal atmosphere. During storage, the build module may be resting (e.g., kept in one location), or be in transit (e.g., from one location to another). The build module may be stored in ambient temperature (e.g., room temperature). The build module can comprise an opening within the boundary (e.g., within at least one of the walls) and that is designed to couple with the processing chamber and having a shape and size suitable for passing the 3D object therethrough. The build module can comprise the build module shutter that is configured to close the opening and form a seal between the internal atmosphere maintained within the build module and an ambient atmosphere outside of the build module. The seal and/or material of the build module may deter atmospheric exchange between the internal volume of the build module and the ambient atmosphere. The internal atmosphere may comprise a pressure different (e.g., lower or higher) than the one in the ambient pressure. For example, the internal atmosphere may comprise a pressure above ambient pressure. The internal volume of the build module may comprise a gas that is non-reactive with the pre-transformed material (e.g., before, after, and/or during the printing). The build module may comprise a gas that is non-reactive with a remainder of starting material that did not form the 3D object. The build module internal atmosphere can be (a) above ambient pressure, (b) inert, (c) different from the ambient atmosphere, (d) non-reactive with the pre-transformed material, remainder, and/or one or more 3D objects during the plurality of 3D printing cycles, (e) comprise a reactive agent below a threshold value, or (f) any combination thereof. The 3D object, remainder (e.g., including the pre-transformed material), and/or a new pre-transformed material may be stored in the build module for a period. For example, contents within the internal volume of the build module can be stored in any of atmospheres (a), (b), (c), (d), (e), or (f) supra for a period between processing operations, such as after forming the 3D object and before removing the 3D object from the build module (e.g., when the build module is coupled to the unpacking station). In some cases, the period may be at least about 0.5 day, 1 day, 2 days, 3 days, 4 days, 5 days, 6 days, 7 days, or 10 days. The period may be any period between the afore-mentioned periods (e.g., from about 0.5 day to about 10 days, from about 0.5 day to about 4 days, or from about 2 days to about 7 days). The period may be limited by the reduction rate of the pressure in the build module, and/or the leakage rate of a relative agent (e.g., comprising oxygen or humidity) in the ambient environment into the build module. The number of reactive species (e.g., reactive agent) may be controlled. The control may be to maintain a level below a threshold value. The threshold value may correspond to a detectable degree of a reaction product of the reactive agent with the pre-transformed material (or remainder) that is detectable. The threshold value may correspond to a detectable degree of a reaction product of the reactive agent with the pre-transformed material (or remainder) that causes at least one detectable defect in the material properties and/or structural properties of the pre-transformed material (or remainder). The reaction product may be generated on the surface of the pre-transformed material (e.g., on the surface of the particles of the particulate material). The reaction may occur following an engagement of the build module with the processing chamber. The reaction may occur during the release of the internal atmosphere of the build chamber into the processing chamber (e.g., followed by the 3D printing). The reaction may occur during the 3D printing. The reaction may cause defects in the material properties (e.g., cracking) and/or structural properties (e.g., warping) of the 3D object (e.g., as described herein). The threshold may correspond to the threshold of the depleted or reduced level of gas disclosed herein. The level of the depleted or reduced level gas may correspond to the level of reactive agent. The depleted or reduced level gas may comprise oxygen or water. The threshold value may correspond to the reactive agent in the internal volume of the build module. The reactive agent may comprise water (e.g., humidity) or oxygen. The threshold value of oxygen may be at most about 5 ppm, 10 ppm, 50 ppm, 100 ppm, 150 ppm, 300 ppm, or 500 ppm. The threshold value of oxygen may be between any of the afore-mentioned values (e.g., from about 5 ppm to about 500 ppm, from about 5 ppm to about 300 ppm, or from about 5 ppm to about 100 ppm). The build module may be configured to accommodate at least about 5 liters, 15 liters, 25 liters, or 30 liters of starting material. The platform may be configured to support at least about 5 liters, 15 liters, 25 liters, or 30 liters of starting material. The build module (in its closed configuration) may be configured to permit accumulation (in the internal volume of the build module) of water weight per liter of starting material for a prolonged period. The build module in its closed state can comprise a closed (e.g., sealed) shutter (e.g., lid). For example, the build module (in its closed configuration) may be configured to permit accumulation (in the internal volume of the build module) of water weight of at most about 10 micrograms (μgr), 50 μgr, 100 μgr, 500 μgr, or 1000 μgr, per liter of starting material (e.g., powder), for a period of at least about 1 days, 2 days, 3 days, 5 days or 7 days. The build module in a closed state may be configured to permit accumulation of water weight between any of the aforementioned values (e.g., from about 10 μgr to about 1000 μgr, from about 10 μgr to about 500 μgr, or from about 100 μgr to about 1000 μgr), per liter of starting material, for a period of at least about 1 days, 2 days, 3 days, 5 days or 7 days. The build module (in its closed configuration) may be configured to limit an ingress (e.g., leakage or flow) of water into the internal volume of the build module. For example, the water may penetrate to the internal volume of the build module from an external water source (e.g., that contacts the build module (e.g., sealing area, seal material, build module shutter material and/or build module boundary material). For example, the water may penetrate to the internal volume of the build module from the ambient environment. The ingress of water into the internal volume of the build module may be at a rate of at most about 10 micrograms per day (μgr/d), 50 μgr/d, 100 μgr/d, 500 μgr/d, or 1000 μgr/d. The ingress of water into the internal volume of the build module may be at a rate between any of the afore-mentioned rates (e.g., from about 10 μgr/d, to about 1000 μgr/d, from about 10 μgr/d, to about 500 μgr/d, or from about 10 μgr/d to about 100 μgr/d). Maintaining a reduced level of reactive agent (e.g., such as by keeping a positive pressure of inert gas in the build module for a prolonged amount of time) can allow the contents of the build module to be kept in any of the atmospheres (a), (b), (c), (d), (e), or (f) supra, for example, with minimal (e.g., without) exposure to an external environment (e.g., ambient air). In some case, the build module is transported using a transit system, which may comprise movement by car, train, boat, or aircraft. The build module can be robotically and/or manually transported. The transportation may comprise transit between cities, states, countries, continents, or global hemispheres. The build module may comprise and/or may be operatively coupled to at least one sensor for detecting certain qualities of the internal atmosphere within the internal volume (e.g., pressure, temperature, types of reactive agent, and/or amounts of reactive agent). The build module may comprise at least one controller that controls (e.g., regulates, maintains, and/or modulates) (i) a level of the reactive agent in the build module, (ii) a pressure level in the build module, (iii) a temperature in the build module, or (iv) any combination thereof. The build module may be configured to allow cooling or heating of the internal volume. A controller may control a temperature alteration of the build module (e.g., internal volume thereof), e.g., to reach a threshold value, e.g., at a certain rate. The rate may be predetermined. The rate may comprise a temperature alteration function (e.g., linear or non-linear). For example, the build module (e.g., its internal volume) may be cooled to a handling temperature. For example, the build module may be heated to a temperature at which water parts (e.g., separates) from the starting material. For example, the build module may be heated to a pyrolytic temperature. The sensor and controller may be separate units or part of a single detector-controller unit. The build module may comprise at least one opening port that is configured to allow gas to pass to and/or from the internal volume. The opening port can be operatively coupled to a valve, a secondary pressurized gas source (e.g., gas cylinder or valve), or any combination thereof. The build module can comprise mechanisms and/or (e.g., structural) features that facilitate engagement with the processing chamber (e.g., through a load lock). The build module can comprise mechanisms and/or (e.g., structural) features that facilitate 3D printing (e.g., a vertically translatable platform). For example, the build module can comprise a lifting mechanism (e.g., an actuator configured to vertically translate the platform) that is configured to move the 3D object within the internal volume. The lifting mechanism can be configured to move the 3D object in accordance with a vertical axis, as described herein.

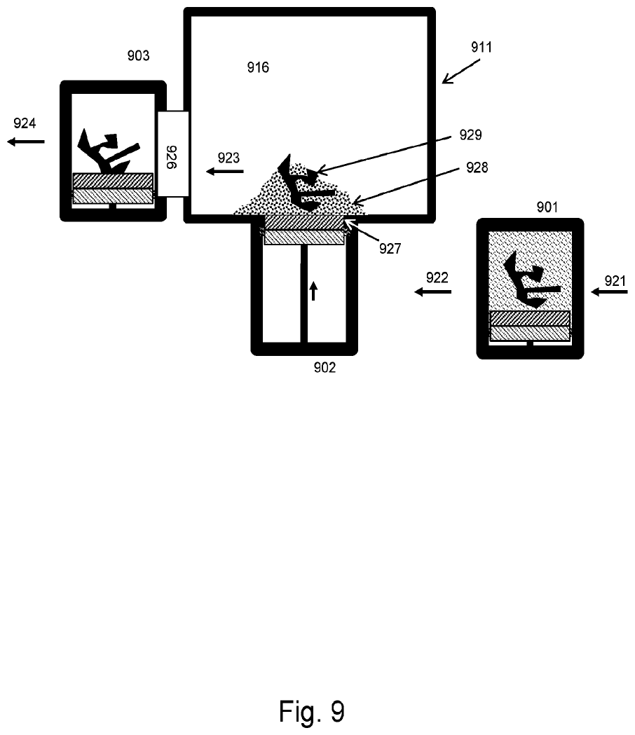

In some embodiments, the unpacking station can engage with a plurality of build modules (e.g., simultaneously). The plurality of build modules may comprise at least 2, 3, 4, 5, or 6 build modules. The unpacking station may comprise a plurality of reversibly closable openings (e.g., each of which comprises a reversibly removable shutter or lid). A plurality of reversibly closable build modules (e.g., each of which comprises a reversibly removable shutter or lid) may engage with, disengage with the unpacking station simultaneously or sequentially. A plurality of reversibly closable build may dock to the unpacking station at a given time. FIG. 9 shows an example of an unpacking station 911 onto which two build modules 902 and 903 dock. The docking can be directly or indirectly (e.g., through a load lock). At least one of the plurality of build modules (e.g., 902) can dock directly to the unpacking station. At least one of the plurality of build modules (e.g., 903) can dock indirectly to the unpacking station (e.g., through a load lock 926). The unpacking station may comprise a plurality of opening to facilitate simultaneous engagement of a plurality of build modules onto the unpacking station. The plurality of openings may comprise at least 2, 3, 4, 5, or 6 openings. When the build module docks onto the unpacking station, the build module opening may be sealed by a load lock shutter (lid), and the corresponding unpacking station opening may be sealed by an unpacking station shutter. The gaseous volume that is entrapped between the build module shutter and the processing chamber shutter upon their mutual engagement, may be purged, evacuated, and/or exchanged. The gaseous volume may be part of a load lock mechanism. After engagement of the build module with the unpacking station (e.g., and exchange of the entrapped gas between their shutters), the build module shutter and the respective unpacking station shutter may be removed to allow merging of the build module atmosphere with the unpacking station atmosphere (e.g., 916), travel of the 3D object between the unpacking station and the unpacking station, and/or travel of the base (e.g., 927) between the unpacking station and the build module. The base may comprise a build plate. The removal (e.g., by translation) of the build module shutter and the unpacking station shutter may be in the same direction or in different directions. The translation may be to any direction (e.g., any of the six spatial directions). The direction may comprise a Cartesian direction. The direction may comprise a cardinal direction. The direction may be horizontal or vertical. The direction may be lateral. In some examples, the shutters may be removed (e.g., from a position where they shut the opening) separately. FIG. 9 shows an example of unpacking a remainder 928 of a material bed that was not transformed to form the 3D object, from a 3D object 929. FIG. 9 shows an example in which a sealed first build module (e.g., 901) comprising a formed 3D object in a material bed approaches 921 from a 3D printer (e.g., comprising a processing chamber) to an unpacking station 911; the first build module docks 902 onto the unpacking station and an actuator translates the 3D object onto the unpacking station where the remainder is separated from the 3D object; the 3D object is then translated into a second build module 903 that docks onto the unpacking station; which second build module subsequently separates from the unpacking station into a destination 924. Before separation of the second build module from the unpacking station, the second build module opening may be shut (e.g., by a shutter), and/or the respective unpacking station opening may be shut (e.g., by a shutter). Such closure of these two openings prior to their disengagement may ensure that upon disengagement of the second build module from the unpacking station, the remainder (e.g., comprising the pre-transformed material) and/or 3D object remain separate from the ambient atmosphere. Upon and/or after engagement of the build module and the unpacking station: (a) the build module shutter may be translated from the build module opening which the shutter reversibly closes, and/or (b) the unpacking station shutter may be translated from the unpacking station opening which the shutter reversibly closes. The translation of the two shutters may be simultaneous or sequential. The translation of the two shutters may be automatic or manual. The translation of the two shutters may be to the same or do different directions. The two shutters may engage with each other before and/or during the translation. The engagement may be using a mechanism comprising actuator, lever, shaft, clipper, or a suction cup. The engagement may include using a power generator that generates electrostatic, magnetic, hydraulic, or pneumatic force. The engagement may include using manual force and/or a robotic arm.

In some embodiments, the 3D object exchanges a base during the unpacking process in the unpacking station. In some embodiments, the 3D object may exchange a plurality of bases during unpacking (e.g., removal of the remainder). In some embodiments, plurality of bases may be present or coupled to an unpacking station (e.g., simultaneously). The plurality of bases may comprise at least 2, 3, 4, 5, or 6 bases. For example, the 3D object may be disposed adjacent to a first base (e.g., 927) that is in turn disposed in a first build module (e.g., 902). The 3D object and the first base may be separated from each other in the unpacking station, (e.g., before, during, and/or after the removal of the remainder). The 3D object may be disposed on a second base after its separation from the first base (e.g., in the unpacking station or in the second build module). The second build module may comprise the second base with the 3D object upon separation from the unpacking station (e.g., 924). At least one of the two bases (e.g., the first base) may be manipulated (e.g., removed, or displaced) using an actuator. For example, at least one of the two bases may be manipulated using a robotic arm and/or manually. For example, at least one of the two bases may be manipulated using a pick-and-place mechanism (e.g., comprising a shaft and/or an actuator). At least two of the plurality of bases (e.g., the first and the second base) may be manipulated by the same mechanism. At least two of the plurality of bases may be manipulated by their own separate respective mechanism.

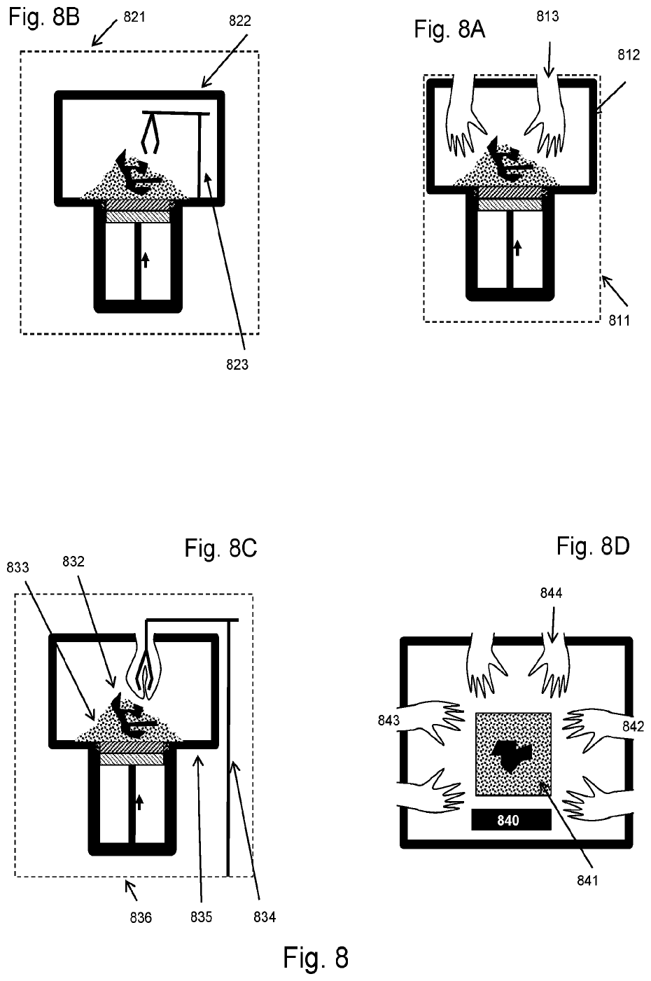

In some embodiments, when a build module is docked in the unpacking chamber, and the build module shutter and the unpacking chamber shutter are opened (e.g., removed), the vertical translation mechanism (e.g., elevator) may elevate the 3D object with its respective material bed into the unpacking chamber. The unpacking chamber atmosphere may be controlled. The 3D object (e.g., FIG. 8C, 832) may be removed from the remainder of the material bed that did not transform to form the 3D object (e.g., FIG. 8C, 833). The removal may be in a controlled (e.g., inert) atmosphere. The removal may be using a human or a machine. The removal may be fully automatic, partially automatic, or manual. The unpacking FIGS. 8A-8C show examples of 3D object removal using manual intervention (e.g., FIG. 8A), or mechanical intervention (e.g., FIG. 8B or 8C). The manual intervention may use a glove box. The machine (e.g., FIG. 8B, 823) may be situated in the unpacking chamber (e.g., FIG. 8B, 822). The machine (e.g., FIG. 8C, 834) may be situated in the unpacking enclosure (e.g., FIG. 8C, 836). The machine (e.g., FIG. 8C, 834) may be situated outside of the unpacking chamber (e.g., FIG. 8C, 835). The machine may be situated outside of the unpacking enclosure. At least one side of the unpacking chamber (e.g., 812) may merge with at least one respective side of the unpacking station enclosure (e.g., 811). At times, at least one side of the unpacking chamber (e.g., 822) may not merge with at least one respective side of the unpacking station enclosure (e.g., 821). The mechanical intervention may comprise a motor, a tweezer, a hook, a swivel axis, a joint, a crane, or a spring. The mechanical intervention device may comprise a robot. The mechanical intervention device may be controlled by a controller (e.g., locally, or remotely). The remote control may use a remote input device. The remote control may use a remote console device (e.g., a joystick). The controller may use a gaming console device. The controller may use a home video game console, handheld game console, micro-console, a dedicated console, or any combination thereof. The local controller may be directly connected to the unpacking station (e.g., using one or more wires), or through a local network (e.g., as disclosed herein). The local controller may be stationary or mobile. The remote controller may connect to the unpacking station through a network that is not local. The remote controller may be stationary or mobile. The unpacking station (e.g., unpacking chamber) may comprise its own controller. The controller may control (e.g., direct, monitor, and/or regulate) one or more apparatuses in the unpacking process, unpacking temperature, unpacking atmosphere. The apparatuses in the unpacking process may comprise a shutter, mechanical intervention device, pre-transformed material removal device (e.g., powder removal device).

In some embodiments, the build module may comprise a first atmosphere, the processing chamber may comprise a second atmosphere, and the unpacking station may comprise a third atmosphere. At least two of the first, second, and third atmosphere may be detectibly the same. At least two of the first, second, and third atmosphere may differ. Differ may be in material (e.g., gaseous) composition and/or pressure. For example, the pressure in the build module may be higher than in the processing chamber (e.g., before their mutual engagement). For example, the pressure in the build module may be higher than in the unpacking station (e.g., before their mutual engagement). For example, the pressure in the build module may be lower than in the unpacking station (e.g., before their mutual engagement). For example, the pressure in the build module may be lower than in the processing chamber (e.g., before their mutual engagement). At least two of the first, second, and third atmosphere (e.g., all three atmospheres) may have a pressure above ambient pressure. The pressure above ambient pressure may deter reactive agents from the ambient atmosphere to penetrate into an enclosure having a positive atmospheric pressure (e.g., whether it is a build module, unpacking station, and/or processing chamber).

In some embodiments, the usage of reversibly closable (e.g., sealable) build modules may facilitate separation of the 3D object and/or any remainder of pre-transformed material that was not used to form the 3D object, from contacting at least one reactive agent in the ambient atmosphere. In some embodiments, the usage of reversibly closable (e.g., sealable) build modules may facilitate separation of a pre-transformed material from contacting at least one reactive agent in the ambient atmosphere.

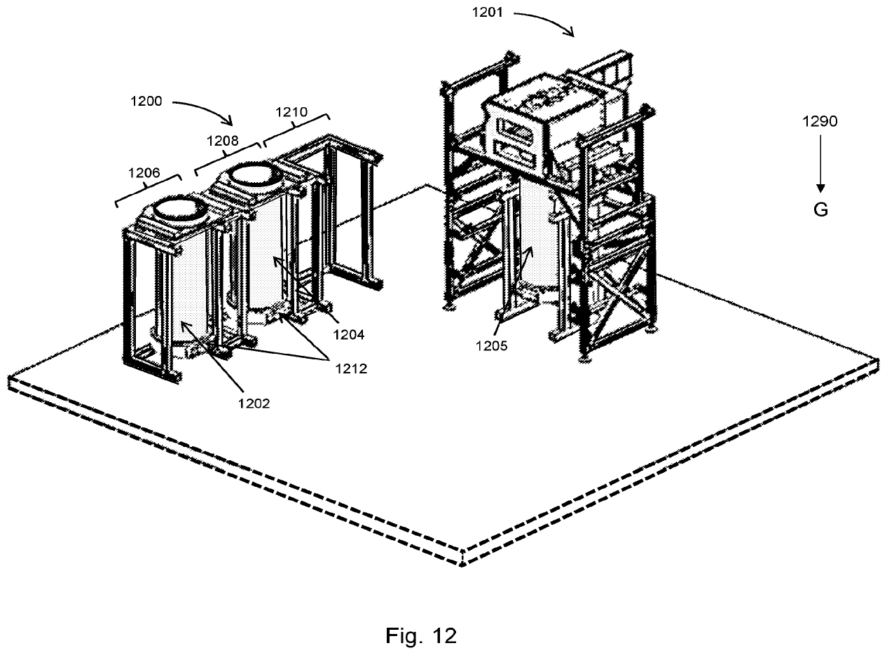

FIG. 12 shows an example of a 3D printing system and components depicted relative to the gravitational vector 1290 pointing to the gravitational environmental center G. As depicted in FIG. 12, a collective waiting station 1200 is depicted in which several build modules and several frames are disposed. Each of the frames configured to support a build module, e.g., using a kinematic mounting that it may have. A 3D printing system 1201 may engage with build modules during respective number of 3D printing cycles, e.g., one build module per building cycle. Collective waiting station 1200 can be utilized (i) to prepare (e.g., purge), (ii) store (e.g., under inert atmosphere), and (iii) transfer the build modules 1202, 1204, to their subsequent density. The storage may be at an atmosphere different from the ambient atmosphere external to the 3D printer and to the build modules. The build module may be empty or full. Empty may be with respect to a material bed, and/or with respect to any 3D objects. The empty build module may be destined to engage with a processing chamber of a 3D printing system such as 1201. The build module may contain a printed 3D object when it is destined to an unpacking station, e.g., after the printing cycle ends. Build modules 1202, 1204 may be retained in collective waiting station 1200 while another build module 1205 is engaged with the 3D printing system 1201. Collective waiting station 1200 can include individualized waiting stations 1206, 1208, 1210. The 3D object(s) disposed in a build module may be unpacked from the build module (I) at the processing chamber, (II) at a dedicated unpacking station separate from the processing chamber, or (III) at the waiting station. Individualized waiting stations such as 1206, 1208, and 1210 can be configured for (A) build module cooling, (B) build module unpacking (e.g., of parts and pre-transformed/transformed material), (C) pre-purge (e.g., prior to and/or after a 3D printing process), or (D) any combination thereof. At least two individualized waiting stations of the collective waiting station can have (e.g., substantially) same configuration. At least two individualized waiting stations of the collective waiting station can have different configurations. Collective waiting station 1200 can include connections (not shown) that can be reversibly engaged/disengaged with interconnects 1212 of a respective build module such as 1202, and 1204. Connections can include gas sources (e.g., helium, argon, nitrogen, or the like), electrical, and/or hydraulic pressure source. Connections can include control system, e.g., to control operation of a build platform assembly, and/or to maintain the atmosphere in the build module. Unpacking stations 1206, 1208, 1210 include a frame for reversibly engaging and disengaging with a build modules such as 1202, 1204. Individualized waiting stations 1206, 1208, 1210 can include a locking mechanism (not shown) to secure the build module and/or frame with respect to the individualized waiting station. Individualized waiting stations such as 1206, 1208, and 1210 can be configured to be supportive of a kinematic mounting platform of the build module. The unused starting material removed from the 3D object(s) during unpacking may be recycled. The unpacking station may be operatively coupled to a recycling system. The recycling system can be the same, similar, or different from the recycling system of the 3D printer. The recycling system can be any recycling system disclosed herein. In some embodiments, the build platform assembly comprises a substrate, a base, a shaft, a post (e.g., posts), an encoder, a compartment associated with the encoder, a temperature adjustment system, a distance measuring scale (e.g., ruler), a sensor, a bent arm, or an actuator. The temperature adjustment system may comprise a temperature adjustment channel, a temperature adjustment chamber, or a temperature adjuster such as controller(s). Examples of 3D printing systems, unpacking stations, their components, associated methods of use, software, devices, systems, and apparatuses, can be found in International Patent Application Serial No. PCT/US22/52588 filed Dec. 12, 2022, which is incorporated herein by reference in its entirety.

In some embodiments, the pre-transformed material is removed from the 3D object (e.g., within the unpacking chamber) by suction (e.g., vacuum), gas blow, mechanical removal, magnetic removal, or electrostatic removal. Examples of pre-transformed material removal, 3D printing systems, their components, associated methods of use, software, devices, systems, and apparatuses, can be found in International Patent Application Serial No. PCT/US15/36802, or in U.S. patent application Ser. No. 17/881,797, each of which is incorporated herein by reference in its entirety. The pre-transformed material may comprise shaking the pre-transformed material (e.g., powder) from the 3D object. The shaking may comprise vibrating. Vibrating may comprise using a motor. Vibrating may comprise using a vibrator or a sonicator. The vibration may comprise ultrasound waves, sound waves, or mechanical force. For example, the 3D object may be disposed on a scaffold that vibrates. The ultrasonic waves may travel through the atmosphere of the unpacking chamber. The ultrasonic waves may travel through the material bed disposed in the unpacking chamber. The scaffold may be tilted at an angle that allows the pre-transformed material to separate from the 3D object. The scaffold may be rotated in a way that allows the pre-transformed material to separate from the 3D object (e.g., a centrifugal rotation). The scaffold may comprise a rough surface that can hold the 3D object (e.g., using friction). The scaffold may comprise hinges that prevent slippage of the 3D object (e.g., during the vibrating operation). The scaffold may comprise one or more holes. The scaffold may comprise a mesh. The one or more holes or mesh may allow the pre-transformed material to pass through, and prevent the 3D object from passing through (e.g., such that the 3D object is held on an opposite side of the mesh from the removed pre-transformed material). FIG. 8, 840 shows an example of a top view of a scaffold.

In some embodiments, the removal of the pre-transformed material comprises using a modular material removal mechanism. The material removal mechanism may be similar to the one used for leveling the exposed surface of the material bed. The material removal mechanism may be interchangeable between the 3D printing enclosure and the unpacking enclosure. For example, the material removal mechanism may be interchangeable between the processing chamber and the unpacking chamber. For example, the material removal mechanism may be used for at least one of leveling an exposed surface of a material bed, cleaning the processing chamber (e.g., from excess pre-transformed material), and removing the pre-transformed material from the 3D object. The material removal mechanism may remove the pre-transformed material and sieve it.

In some embodiments, the removed pre-transformed material (e.g., the remainder) is conditioned to be used in the 3D printing process. The remainder may be recycled and used in the 3D printing process. The unpacking station may further comprise a unit that allows conditioning of the pre-transformed material that was removed from the 3D object. Conditioning may comprise sieving of the pre-transformed material that was removed from the 3D object. Conditioning may be to allow recycling of the pre-transformed material and usage in a 3D printing cycle. Conditioning may be chemical conditioning (e.g., removal of oxide layer). Conditioning may be physical conditioning (e.g., such as sieving, e.g., removal of transformed material).

In some embodiments, the 3D printing system comprises a recycling mechanism. The recycling mechanism may be housed in a modular chamber and form the recycling module. The recycling module may comprise a pump, or a (e.g., physical, and/or chemical) conditioning mechanism. Physical conditioning may comprise a sieve. The recycling module may be operatively coupled to at least one of (i) the processing chamber (e.g., to the layer dispensing mechanism such as to the material dispensing mechanism) and (ii) the unpacking station. For example, the same recycling module may be coupled to (i) the processing and (ii) the unpacking station. For example, a first recycling module may be coupled to the processing chamber and a second (e.g., different) recycling module may be coupled to the unpacking station. Coupled may be physically connected. The recycling module may be reversibly coupled. The recycling module can be extracted and/or exchanged from the (i) the processing and/or (ii) the unpacking station before, during, or after the 3D printing.

In some examples, while the build module (housing the 3D object) travels outside of the 3D printer enclosure (e.g., between the 3D printer enclosure and the unpacking station enclosure), the build module is sealed. Sealing may be sufficient to maintain the atmosphere within the build module. Sealing may be sufficient to prevent influence of the atmosphere outside of the build module to the atmosphere within the build module. Sealing may be sufficient to prevent exposure of the pre-transformed material (e.g., powder) to reactive atmosphere. Sealing may be sufficient to prevent leakage of the pre-transformed material from the build module. Sufficient may be in the time scale in which the build module transfers from one enclosure to another (e.g., through an ambient atmosphere). Sufficient may be to maintain 3D object surface requirements. Sufficient may be to maintain safety requirements prevailing in the jurisdiction.

In some embodiments, the unpacking station comprises an unpacking chamber. The unpacking chamber may be accessed from one or more directions (e.g., sides) by a person or machine located outside of the unpacking chamber. In some embodiments, in addition to the docking area (e.g., FIG. 8D, 841), the unpacking chamber may be accessed from at least one, two, three, four, five, or six directions by a person or machine located outside of the unpacking chamber. FIG. 8A shows an unpacking chamber that can be accessed from the top (e.g., 813). FIG. 8D shows a top view of an unpacking chamber that can be accessed by a person standing outside from three directions (e.g., 844, 842, and 843). In some embodiments, the 3D object may be removed from an opening (e.g., a door) of the unpacking chamber. The removal of the 3D object may be directly from the unpacking chamber (e.g., not through usage of the build module).

In some embodiments, the material bed disposed within the unpacking chamber is translated (e.g., moved). The movement can be effectuated by using a moving 3D plane. The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf. The term “3D plane” is understood herein to be a generic (e.g., curved) 3D surface. For example, the 3D plane may be a curved 3D surface. Examples of material bed movement by a 3D plane, 3D printing systems, their components, associated methods of use, software, devices, systems, and apparatuses, can be found in U.S. Ser. No. 17/881,797 that is incorporated herein by reference in its entirety. The 3D plane may form a shovel, or squeegee. The 3D plane may be from a rigid or flexible material. The 3D plane may move the material bed from the docking station to a different position in the unpacking chamber. For example, the different position may be on the scaffold.

In some embodiments, the removal of the 3D object from the material bed is manual or automatic. The removal of the 3D object from the material bed may be at least partially automatic. Removal of the 3D object from the build module may comprise removal of the 3D object from the material bed. Removal of the 3D object from the build module may comprise removal of the remainders of the material bed that did not transform to form the 3D object, from the generated 3D object. The removal of substantially all the remainder of the material bed is disclosed in PCT/US15/36802 that is incorporated herein in its entirety.

In some cases, unused pre-transformed material (e.g., remainder) surrounds the 3D object in the material bed. The unused pre-transformed material can be substantially removed from the 3D object. Substantial removal may refer to pre-transformed material covering at most about 20%, 15%, 10%, 8%, 6%, 4%, 2%, 1%, 0.5%, or 0.1% of the surface of the 3D object after removal. Substantial removal may refer to removal of all the pre-transformed material that was disposed in the material bed and remained as pre-transformed material at the end of the 3D printing process (e.g., the remainder), except for at most about 10%, 3%, 1%, 0.3%, or 0.1% of the weight of the remainder. Substantial removal may refer to removal of all the remainder except for at most about 50%, 10%, 3%, 1%, 0.3%, or 0.1% of the weight of the printed 3D object. The unused pre-transformed material (e.g., powder) can be removed to permit retrieval of the 3D object without digging through the pre-transformed material. For example, the unused pre-transformed material can be suctioned out of the material bed by one or more vacuum ports built adjacent to the powder bed. After the unused pre-transformed material is evacuated, the 3D object can be removed, and the unused pre-transformed material can be re-circulated to a reservoir for use in future 3D prints.

In some embodiments, the 3D object is generated on a mesh substrate. A solid platform (e.g., base or substrate) can be disposed underneath the mesh such that the powder stays confined in the pre-transformed material bed and the mesh holes are blocked. The blocking of the mesh holes may not allow a substantial amount of pre-transformed material to flow through. The mesh can be moved (e.g., vertically or at an angle) relative to the solid platform by pulling on one or more posts connected to either the mesh or the solid platform (e.g., at the one or more edges of the mesh or of the base) such that the mesh becomes unblocked. The one or more posts can be removable from the one or more edges by a threaded connection. The mesh substrate can be lifted out of the material bed with the 3D object to retrieve the 3D object such that the mesh becomes unblocked. Alternatively, the solid platform can be tilted, horizontally moved such that the mesh becomes unblocked. When the mesh is unblocked, at least part of the powder flows from the mesh while the 3D object remains on the mesh.

In some embodiments, the 3D object is built on a construct comprising a first and a second mesh, such that at a first position the holes of the first mesh are completely obstructed by the solid parts of the second mesh such that no powder material can flow through the two meshes at the first position, as both mesh holes become blocked. The first mesh, the second mesh, or both can be controllably moved (e.g., horizontally or in an angle) to a second position. In the second position, the holes of the first mesh and the holes of the second mesh are at least partially aligned such that the pre-transformed material disposed in the material bed can flow through to a position below the two meshes, leaving the exposed 3D object.

In some cases, a cooling gas is directed to the hardened material (e.g., 3D object) for cooling the hardened material during its retrieval. The mesh can be sized such that the unused pre-transformed material will sift through the mesh as the 3D object is exposed from the material bed. In some cases, the mesh can be attached to a pulley or other mechanical device such that the mesh can be moved (e.g., lifted) out of the material bed with the 3D part.

In some cases, the 3D object (e.g., 3D part) is retrieved within at most about 12 hours (h), 6 h, 5 h, 4 h, 3 h, 2 h, 1 h, 30 minutes (min), 20 min, 10 min, 5 min, 1 min, 40 seconds (sec), 20 sec, 10 sec, 9 sec, 8 sec, 7 sec, 6 sec, 5 sec, 4 sec, 3 sec, 2 sec, or 1 sec after transforming of at least a portion of the last powder layer. The 3D object can be retrieved during a time period between any of the afore-mentioned time periods (e.g., from about 12 h to about 1 sec, from about 12 h to about 30 min, from about 1 h to about 1 sec, or from about 30 min to about 40 sec).

In some embodiments, the 3D object is retrieved at a pre-determined (e.g., handling) temperature. In some embodiments, the 3D object is retrieved at a handling (e.g., predetermined) temperature. The 3D object can be retrieved when the 3D object (composed of hardened (e.g., solidified) material) is at a handling temperature that is suitable to permit the removal of the 3D object from the material bed without substantial deformation. The handling temperature can be a temperature that is suitable for packaging of the 3D object. The handling temperature can be at most about 120° C., 100° C., 80° C., 60° C., 40° C., 30° C., 25° C., 20° C., 10° C., or 5° C. The handling temperature can be of any value between the afore-mentioned temperature values (e.g., from about 120° C. to about 20° C., from about 40° C. to about 5° C., or from about 40° C. to about 10° C.). The deformation may include geometric distortion. The deformation may include internal deformation. Internal may be within the 3D object or a portion thereof. The deformation may include a change in the material properties. The deformation may be disruptive (e.g., for the intended purpose of the 3D object). The deformation may comprise a geometric deformation. The deformation may comprise inconsistent material properties. The deformation may occur before, during, and/or after hardening of the transformed material. The deformation may comprise bending, warping, arching, curving, twisting, balling, cracking, bending, or dislocating. Deviation may comprise deviation from a structural dimension or from requested material characteristic.

In some embodiments, the generated 3D object requires very little or no further processing after its retrieval. Further processing may be post printing processing. Further processing may comprise trimming, as disclosed herein. Further processing may comprise polishing (e.g., sanding). In some cases, the generated 3D object can be retrieved and finalized without removal of transformed material and/or auxiliary support features.

In some embodiments, the generated 3D object is deviated from its intended dimensions. The 3D object (e.g., solidified material) that is generated can have an average deviation value from the intended dimensions (e.g., of a requested 3D object) of at most about 0.5 microns (μm), 1 μm, 3 μm, 10 μm, 30 μm, 100 μm, 300 μm or less. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula Dv+L/K_{dv}, wherein Dv is a deviation value, L is the length of the 3D object in a specific direction, and K_{dv} is a constant. Dv can have a value of at most about 300 μm, 200 μm, 100 μm, 50 μm, 40 μm, 30 μm, 20 μm, 10 μm, 5 μm, 1 μm, or 0.5 μm. Dv can have a value of at least about 0.5 μm, 1 μm, 3 μm, 5 μm, 10 μm, 20 μm, 30 μm, 50 μm, 70 μm, 100 μm, 300 μm or less. Dv can have any value between the afore-mentioned values. For example, Dv can have a value that is from about 0.5 μm to about 300 μm, from about 10 μm to about 50 μm, from about 15 μm to about 85 μm, from about 5 μm to about 45 μm, or from about 15 μm to about 35 μm. K_{dv} can have a value of at most about 3000, 2500, 2000, 1500, 1000, or 500. K_{dv} can have a value of at least about 500, 1000, 1500, 2000, 2500, or 3000. K_{dv} can have any value between the afore-mentioned values. For example, K_{dv} can have a value that is from about 3000 to about 500, from about 1000 to about 2500, from about 500 to about 2000, from about 1000 to about 3000, or from about 1000 to about 2500.

In some embodiments, the generated 3D object (i.e., the printed 3D object) does not require further processing following its generation by a method described herein. The printed 3D object may require reduced amount of processing after its generation by a method described herein. For example, the printed 3D object may not require removal of auxiliary support (e.g., since the printed 3D object was generated as a 3D object devoid of auxiliary support). The printed 3D object may not require smoothing, flattening, polishing, or leveling. The printed 3D object may not require further machining. In some examples, the printed 3D object may require one or more treatment operations following its generation (e.g., post generation treatment, or post printing treatment). The further treatment step(s) may comprise surface scraping, machining, polishing, grinding, blasting (e.g., sand blasting, bead blasting, shot blasting, or dry ice blasting), annealing, or chemical treatment. The further treatment may comprise physical or chemical treatment. The further treatment step(s) may comprise electrochemical treatment, ablating, polishing (e.g., electro polishing), pickling, grinding, honing, or lapping. In some examples, the printed 3D object may require a single operation (e.g., of sand blasting) following its formation. The printed 3D object may require an operation of sand blasting following its formation. Polishing may comprise electro polishing (e.g., electrochemical polishing or electrolytic polishing). The further treatment may comprise the use of abrasive(s). The blasting may comprise sand blasting or soda blasting. The chemical treatment may comprise use of an agent. The agent may comprise an acid, a base, or an organic compound. The further treatment step(s) may comprise adding at least one added layer (e.g., cover layer). The added layer may comprise lamination. The added layer may be of an organic or inorganic material. The added layer may comprise elemental metal, metal alloy, ceramic, or elemental carbon. The added layer may comprise at least one material that composes the printed 3D object. When the printed 3D object undergoes further treatment, the bottom most surface layer of the treated object may be different than the original bottom most surface layer that was formed by the 3D printing (e.g., the bottom skin layer).

In some embodiments, the methods described herein are performed in the enclosure (e.g., container, processing chamber, and/or build module). One or more 3D objects can be formed in the enclosure (e.g., simultaneously, and/or sequentially). The enclosure may have a predetermined and/or controlled pressure. The enclosure may have a predetermined and/or controlled atmosphere. The control may be manual or via a control system. The atmosphere may comprise at least one gas. In some embodiments, during the 3D printing, the material bed is at a constant pressure (e.g., without substantial pressure variations).

In some embodiments, the enclosure comprises ambient pressure (e.g., 1 atmosphere), negative pressure (i.e., vacuum) or positive pressure. Different portions of the enclosure may have different atmospheres. The different atmospheres may comprise different gas compositions. The different atmospheres may comprise different atmosphere temperatures. The different atmospheres may comprise ambient pressure (e.g., 1 atmosphere), negative pressure (i.e., vacuum) or positive pressure. The different portions of the enclosure may comprise the processing chamber, build module, or enclosure volume excluding the processing chamber and/or build module. The vacuum may comprise pressure below 1 bar, or below 1 atmosphere. The positively pressurized environment may comprise pressure above 1 bar or above 1 atmosphere. In some examples, the pressure in the chamber is at least about 10 Torr, 100 Torr, 150 Torr, 200 Torr, 300 Torr, or 400 Torr, above atmospheric pressure (e.g., above 760 Torr). In some examples, the pressure in the chamber is at least about 10 Torr, 100 Torr, 150 Torr, 200 Torr, 300 Torr, 400 Torr, 500 Torr, or 600 Torr, above atmospheric pressure (e.g., above 760 Torr). The pressure in the chamber can be at a range between any of the afore-mentioned pressure values above atmospheric pressure, e.g., from about 10 Torr to about 600 Torr, from about 100 Torr to about 200 Torr, the values representing a pressure difference above atmospheric pressure (e.g., above 760 Torr). The pressure in the chamber is at least about 20 Kilo Pascal (KPa), 18 KPa, 16 KPa, 14 KPa, 12 KPa, 10 KPa, or 5 KPa above atmospheric pressure, e.g., above 101 KPa. The pressure in the chamber can be at a range between any of the afore-mentioned pressure values above atmospheric pressure, e.g., from about 5 KPa to about 20 KPa, the values representing a pressure difference above atmospheric pressure, e.g., above 101 KPa. The pressure can be measured by a pressure gauge. The pressure can be measured at ambient temperature (e.g., R.T.). In some cases, the chamber pressure can be standard atmospheric pressure. The pressure may be measured at an ambient temperature (e.g., room temperature, 20° C., or 25° C.). In some embodiments, the interior of the 3D printing system (e.g., the processing chamber, build module, ancillary chamber, gas conveyance system, material conveyance system and/or material recycling system) have a pressure above ambient pressure outside of the 3D printing system.

In some embodiments, the enclosure includes an atmosphere. The enclosure may comprise a (e.g., substantially) inert atmosphere. The atmosphere in the enclosure may be (e.g., substantially) depleted by one or more gases present in the ambient atmosphere. The atmosphere in the enclosure may include a reduced level of one or more gases relative to the ambient atmosphere. For example, the atmosphere may be substantially depleted, or have reduced levels of water (i.e., humidity), oxygen, nitrogen, carbon dioxide, hydrogen sulfide, or any combination thereof. The level of the depleted or reduced level gas may be at most about 1 ppm, 10 ppm, 50 ppm, 100 ppm, 500 ppm, 1000 ppm, 5000 ppm, 10000 ppm, 25000 ppm, 50000 ppm, or 70000 ppm volume by volume (v/v). The level of the gas (e.g., depleted or reduced level gas, oxygen, or water) may between any of the afore-mentioned levels of gas (e.g., from about 1 ppm to about 500 ppm, from about 10 ppm to about 100 ppm, from about 500 ppm to about 5000 ppm). The reduced level of gas may be compared to the level of gas in the ambient environment. The gas may be a reactive agent. The atmosphere may comprise air. The atmosphere may be inert. The atmosphere may be non-reactive. The atmosphere may be non-reactive with the material (e.g., the pre-transformed material deposited in the layer of material (e.g., powder), or the material comprising the 3D object). The atmosphere may prevent oxidation of the generated 3D object. The atmosphere may prevent oxidation of the pre-transformed material within the layer of pre-transformed material before its transformation, during its transformation, after its transformation, before its hardening, after its hardening, or any combination thereof. The atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened material, or the material within the 3D object. Ambient refers to a condition to which people are generally accustomed. For example, ambient pressure may be 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a spaceship, a ship, a boat, or any other vehicle. Room temperature may represent the small range of temperatures at which the atmosphere feels neither hot nor cold, approximately 24° C. it may denote 20° C., 25° C., or any value from about 20° C. to about 25° C.

In some embodiments, the pre-transformed material is deposited in an enclosure (e.g., a container). FIG. 1 shows an example of an enclosure comprising a processing chamber 107 coupled to a build module 123. The enclosure can contain the pre-transformed material to form a material bed (e.g., may contain the pre-transformed material without spillage; FIG. 1, 104). The material bed 104 is disposed above a build plate 102 (e.g., also referred to herein a “base” or “build plate”). The build plate 102 is disposed on substate 109 (e.g., piston). The material bed may have a horizontal cross-sectional shape, which cross sectional shape may be a geometrical shape (e.g., any geometric shape described herein, for example, triangle, rectangle (e.g., square), ellipse (e.g., circle), or any other polygon). The material may be placed in, or inserted to the enclosure. The material may be deposited in, pushed to, sucked into, or lifted to the processing chamber. The material may be layered (e.g., spread) in the processing chamber. The enclosure may comprise a substrate (e.g., FIG. 1, 109). The substrate may be situated adjacent to the bottom of the processing chamber (e.g., FIG. 1, 111). Bottom may be relative to the gravitational field, or relative to the position of the footprint of the energy beam (e.g., FIG. 1, 101) on the layer of pre-transformed material as part of a material bed. The footprint of the energy beam may follow a Gaussian bell shape. In some embodiments, the footprint of the energy beam does not follow a Gaussian bell shape. The processing chamber may comprise a build plate (e.g., base) (e.g., FIG. 1, 102). The build plate may reside adjacent to the substrate. The pre-transformed material may be layered adjacent to a side of the processing chamber (e.g., on the bottom of the processing chamber). The 3D printing system 100 comprises an optical assembly 120 (e.g., a guidance system) for energy beam 101 (e.g., a galvanometer scanner). Optical assembly 120 (e.g., a field replaceable unit (FRU)) can be translatable along axis 180, e.g., translatable along an axis perpendicular to gravitational vector 199. Energy source (e.g., laser source) 121 generates energy beam 101 that traverses through the optical assembly 120 (e.g., comprising a scanner) and through an optical window 115 into processing chamber 107 enclosing interior space that can include an atmosphere 126. The transforming energy beam 101 may travel along a path to transform at least a portion of the material bed 104 into a transformed material. The transformed material may harden into at least a portion of the 3D object. In the example shown in FIG. 1, part 106 represents a layer of transformed material within the material bed 104. Processing chamber 107 can include an optional temperature adjustment device (e.g., cooling plate), not shown. The pre-transformed material may be layered adjacent to the substrate and/or adjacent to the build plate. Adjacent to may be above. Adjacent to may be directly above, or directly on. The substrate may have one or more seals (e.g., 103) that enclose the material in a selected area within the processing chamber and/or build module (e.g., FIG. 1, 111). The one or more seals may be flexible or non-flexible. The one or more seals may comprise a polymer or a resin, e.g., as disclosed herein. The one or more seals may comprise a round edge or a flat edge. The one or more seals may be bendable or non-bendable. The seals may be stiff. The seal may comprise a bellow. The seal may comprise felt. The seal may be permeable to gas. The seal may be impermeable to the pre-transformed material. The container may comprise the base. The base may be situated within the container. The container may comprise the platform, which may be situated within the container. The enclosure, container, processing chamber, and/or build module may comprise an optical window. An example of an optical window can be seen in FIG. 1, 115. The optical window may allow the energy beam (e.g., 101) to pass through without (e.g., substantial) energetic loss. A ventilator may prevent spatter from accumulating on the surface optical window that is disposed within the enclosure (e.g., within the processing chamber) during the 3D printing. An opening of the ventilator may be situated within the enclosure (e.g., comprising atmosphere 126).

In some embodiments, the pre-transformed material is deposited in the enclosure by a material dispensing mechanism (e.g., FIGS. 1, 116, 117 and 118) to form a layer of pre-transformed material within the enclosure. The deposited material may be leveled by a leveling operation. The leveling operation may comprise using a material (e.g., powder) removal mechanism that does not contact the exposed surface of the material bed (e.g., FIG. 1, 118). The leveling operation may comprise using a leveling mechanism that contacts the exposed surface of the material bed (e.g., FIG. 1, 117). The material (e.g., powder) dispensing mechanism may comprise one or more dispensers (e.g., FIG. 1, 116). The material dispensing system may comprise at least one material (e.g., bulk) reservoir. The material may be deposited by a layer dispensing mechanism (e.g., recoater). The layer dispensing mechanism may level the dispensed material without contacting the material bed (e.g., the top surface of the powder bed). The layer dispensing mechanism may comprise a material (e.g., powder) dispenser, a material leveling mechanism, or a material removal mechanism. Examples of layer dispensing mechanism, 3D printing systems, their components, associated methods of use, software, devices, systems, and apparatuses, can be found in PCT/US15/36802, or in U.S. Ser. No. 17/881,797, each of which is incorporated herein by reference in its entirety. In some embodiments, the layer dispensing mechanism includes components comprising a material dispensing mechanism, material leveling mechanism, material removal mechanism, or any combination or permutation thereof. At times, the layer dispensing mechanism is parked in the ancillary chamber when idle, e.g., parked in a garage. The layer dispensing mechanism may comprise a material removal mechanism that may include pre-transformed material (e.g., starting material such as powder) and/or other debris (e.g., soot, spatter, splatter, or other debris). The debris may be dispersed on the floor of the ancillary chamber when the layer dispensing mechanism may be parked in the ancillary chamber. The (e.g., floor of the) ancillary chamber may be coupled to a recycling system. For example, the floor of the ancillary chamber may be coupled to the powder recycling system via a vacuum. The ancillary chamber may be coupled to a reconditioning system. The recycling and/or reconditioning system may comprise a sieve. The recycling system may comprise a reservoir that holds the recycled material. The recycled material may be reconditioned (e.g., having reduced level of reactive species such as oxygen, or water). The recycled material may be sieved through the sieving system. In some examples, material may not be reconditioned. The material may be pushed, attracted, and/or gravitationally removed from the ancillary chamber. For example, the material may be sucked by a vacuum, e.g., from the floor of the ancillary chamber. The ancillary chamber may be built to assist removal of the material by way of gravity. For example, the floor of the ancillary chamber may be tilted. For example, the ancillary chamber may be operatively coupled to a conveyance system that flows or bounces the material in a direction away from the ancillary chamber. The floor of the ancillary chamber may be sloped at an angle. The debris and material removed by the layer dispensing mechanism accumulated in the ancillary chamber may be transported away from the ancillary chamber (e.g., into the recycling system). Transportation may be via an opening port in the ancillary chamber. Transportation may be via a pipe, hole, channel, or a conveyor system. In some embodiments, the floor, a ceiling, or any other wall of the ancillary chamber includes one or more features to facilitate movement of the accumulated material through an opening port to the recycling system. The accumulated material may comprise the material removed by the layer dispensing mechanism, excess material and/or debris. At least a portion of the accumulated material may be removed from the layer dispensing mechanism, e.g., using the material remover.

In some embodiments, the 3D printing system comprises a platform. The platform may be disposed in the enclosure (e.g., in the build module and/or processing chamber). The platform may comprise a substrate (e.g., piston) or a base (e.g., build plate). The substrate and/or the base may be reversibly removable or be non-removable. The build plate may be (e.g., substantially) horizontal, (e.g., substantially) planar, or non-planar. The build plate may have a surface that points towards the deposited pre-transformed material (e.g., powder material), which at times may point towards the top of the enclosure (e.g., away from the center of gravity). The build plate may have a surface that points away from the deposited pre-transformed material (e.g., towards the center of gravity), which at times may point towards the bottom of the container. The build plate may have a surface that is (e.g., substantially) flat and/or planar. The build plate may have a surface that is not flat and/or not planar. The build plate may have a surface that comprises protrusions or indentations. The build plate may have a surface that comprises embossing. The build plate may have a surface that comprises supporting features (e.g., auxiliary support). The build plate may have a surface that comprises a mold. The build plate may have a surface that comprises a wave formation. The surface may point towards the layer of pre-transformed material within the material bed. The wave may have an amplitude (e.g., vertical amplitude or at an angle). The build plate (e.g., base) may comprise a mesh through which the pre-transformed material (e.g., the remainder) may flow through. The platform may comprise a motor. The platform (e.g., substrate and/or base) may be fastened to the container. The platform (or any of its components) may be transportable. The transportation of the platform may be controlled and/or regulated by a controller (e.g., control system). The platform may be transportable horizontally, vertically, or at an angle (e.g., planar or compound).

In some embodiments, the platform comprises an engagement mechanism. The engagement mechanism may facilitate engagement and/or dis-engagement of a base (e.g., FIG. 1, 102) to a substrate (e.g., FIG. 1, 109). The substrate may comprise a (e.g., horizontal) cross section having a geometrical shape. The geometrical shape can be any geometrical shape described herein, e.g., a polygon, triangle, ellipse (e.g., circle), or rectangle. The substrate may comprise a 3D shape. The 3D shape may form a protrusion or intrusion from the average plane of an exposed surface of the substrate. The 3D shape may comprise a cuboid (e.g., cube), or a tetrahedron. The 3D shape may comprise a polyhedron (e.g., primary parallelohedron), at least a portion of an ellipse (e.g., circle), a cone, or a cylinder. The polyhedron may be a prism (e.g., hexagonal prism), or octahedron (e.g., truncated octahedron). The substrate may comprise a Platonic solid. The substrate may comprise octahedra, truncated octahedron, or a cube. The substrate may comprise convex polyhedra (e.g., with regular faces). The substrate may comprise a triangular prism, hexagonal prism, cube, truncated octahedron, or gyrobifastigium. The substrate may comprise a pentagonal pyramid.

In some embodiments, the platform (e.g., base) is translatable (e.g., to engage (and/or dis-engage) with the substrate and/or stopper). The build plate may be reversibly and/or controllably connected to the substrate. The build plate may comprise a geometrical shape (e.g., any geometric shape described herein, for example, triangle, rectangle, ellipse, or polygon). Any component of the platform may comprise the engagement mechanism. The engagement mechanism may be manual and/or automatic. The engagement mechanism may be controlled. At least a portion of the engagement (and/or dis-engagement) of the build plate with the substrate may be at an angle (e.g., planar or compound) relative to the bottom surface of the platform. The engagement mechanism may use a device that facilitates the engagement (e.g., an actuator). For example, the engagement mechanism may comprise a robotic arm, a crane, conveyor (e.g., conveyor belt), rotating screw, or a moving surface (e.g., moving build plate). The engagement and/or disengagement may be manual. The engagement mechanism may comprise a portion of an aligner (e.g., comprising a rail, a bar, a lever, a sensor, a mark, an actuator, or a track) operatively coupled to the substrate (or a part of the substrate) that engages with the build plate. The engagement mechanism may comprise a portion of an aligner operatively coupled to the build plate (or a part of the build plate) that engages with the substrate. The aligner may be disposed on the build plate and/or on the substrate. In some embodiments, a first portion of the aligner may be coupled to (or be part of) the build plate, and a complementary portion of the aligner may be coupled to (or be part of) the substrate. The engagement mechanism may comprise a mechanism that can move a platform component (e.g., move the build plate). The movement may be controlled (e.g., manually, and/or automatically, e.g., using a controller). The movement may include using (i) a control signal and/or (ii) a source of energy (e.g., manual power, electricity, hydraulic pressure, gas pressure, electrostatic force, or magnetic force). The gas pressure may be positive and/or negative as compared to the ambient pressure. Optionally, the movement may comprise using a sensor, or an aligner. The engagement mechanism may use electricity, pneumatic pressure, hydraulic pressure, magnetic power, electrostatic power, human power, or any combination thereof. In some embodiments, the (e.g., entire) top surface of the build plate may be available for use during the 3D printing (e.g., to build the 3D object). The top surface of the build plate may be (e.g., entirely) free of a feature (e.g., clamping mechanism, or a bolt) that facilitates engagement of the to the substrate.

In some cases, auxiliary support(s) adhere to the upper surface of the build plate. In some examples, the auxiliary supports of the printed 3D object may touch the build plate (e.g., the bottom of the enclosure, the substrate, or the base). Sometimes, the auxiliary support may adhere to the build plate. In some embodiments, the auxiliary supports are an integral part of the build plate. At times, auxiliary support(s) of the printed 3D object, do not touch the build plate. In any of the methods described herein, the printed 3D object may be supported only by the pre-transformed material within the material bed (e.g., powder bed, FIG. 1, 104). Any auxiliary support(s) of the printed 3D object, if present, may be suspended adjacent to the build plate. Occasionally, the build plate may have a pre-hardened (e.g., pre-solidified) amount of material. Such pre-solidified material may provide support to the printed 3D object. At times, the build plate may provide adherence to the material. At times, the build plate does not provide adherence to the material. The build plate may comprise elemental metal, metal alloy, elemental carbon, or ceramic. The build plate may comprise a composite material (e.g., as disclosed herein). The build plate may comprise glass, stone, zeolite, or a polymeric material. The polymeric material may include a hydrocarbon or fluorocarbon. The build plate (e.g., base) may include Teflon. The build plate may include compartments for printing small objects. Small may be relative to the size of the enclosure. The compartments may form a smaller compartment within the enclosure, which may accommodate a layer of pre-transformed material.

The processing chamber may comprise elemental metal, metal alloy, elemental carbon, or ceramic. The processing chamber may comprise a composite material (e.g., as disclosed herein). The processing chamber may comprise glass, stone, zeolite, or a polymeric material. The polymeric material may include silicone, a hydrocarbon, or a fluorocarbon. The processing chamber may comprise an opaque portion or a transparent portion (e.g., a window).

The unpacking chamber may comprise elemental metal, metal alloy, elemental carbon, or ceramic. The unpacking chamber may comprise a composite material (e.g., as disclosed herein). The unpacking chamber may comprise glass, stone, zeolite, or a polymeric material. The polymeric material may include silicone, a hydrocarbon, or a fluorocarbon. The unpacking chamber may comprise an opaque portion or a transparent portion (e.g., a window).

The build module may comprise elemental metal, metal alloy, elemental carbon, or ceramic. The build module may comprise a composite material (e.g., as disclosed herein). The build module may comprise glass, stone, zeolite, or a polymeric material. The polymeric material may comprise silicone, a hydrocarbon, or a fluorocarbon. The build module may comprise an opaque portion or a transparent portion (e.g., a window).

In some embodiments, the energy beam projects energy to the material bed. The apparatuses, systems, and/or methods described herein can comprise at least one energy beam. In some cases, the apparatuses, systems, and/or methods described can comprise two, three, four, five, or more energy beams. The energy beam may include radiation comprising electromagnetic, electron, positron, proton, plasma, or ionic radiation. The electromagnetic beam may comprise microwave, infrared, ultraviolet, or visible radiation. The ion beam may include a cation or an anion. The electromagnetic beam may comprise a laser beam. The energy beam may derive from a laser source. The energy source may be a laser source. The laser may comprise a fiber laser, a solid-state laser, or a diode laser. The energy source may be stationary. The energy source may not translate during the 3D printing.

In some embodiments, the laser source comprises a Nd:YAG, Neodymium (e.g., neodymium-glass), or an Ytterbium laser. The laser beam may comprise a corona laser beam, e.g., a laser beam having a footprint similar to a doughnut shape. The laser may comprise a carbon dioxide laser (CO₂ laser). The laser may be a fiber laser. The laser may be a solid-state laser. The laser can be a diode laser. The energy source may comprise a diode array. The energy source may comprise a diode array laser. Examples 3D printing systems, their components (e.g., energy beams such as lasers), associated methods of use, software, devices, systems, and apparatuses, can be found in U.S. Ser. No. 17/881,797, which is incorporated herein by reference in its entirety.

In some embodiments, the 3D printer includes a plurality of energy beam, e.g., laser beams. The 3D printer may comprise at least 2, 4, 6, 8, 10, 12, 16, 20, 24, 32, 36, 64 or more energy beams. Each of the energy beam may be coupled with its own optical window. At times, at least two energy beams may shine through the same optical window. At times, at least two energy beams may shine through different optical windows.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a doughnut (e.g., corona) beam profile. For example, the energy beam may print a first portion of the 3D object using a gaussian beam profile, and then print a second portion of the 3D object using a doughnut shaped beam profile.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may have a cross section with a FLS (e.g., diameter) of at least about 50 micrometers (μm), 100 μm, 150 μm, 200 μm, or 250 μm. The energy beam may have a cross section with a FLS of at most about 60 micrometers (μm), 100 μm, 150 μm, 200 μm, or 250 μm. The energy beam may have a cross section with a FLS of any value between the afore-mentioned values (e.g., from about 50 μm to about 250 μm, from about 50 μm to about 150 μm, or from about 150 μm to about 250 μm). The power per unit area of the energy beam may be at least about 100 Watt per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², or 10000 W/mm². The power per unit area of the tiling energy flux may be at most about 110 W/mm², 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², or 10000 W/mm². The power per unit area of the energy beam may be any value between the afore-mentioned values (e.g., from about 100 W/mm² to about 3000 W/mm², from about 100 W/mm² to about 5000 W/mm², from about 100 W/mm² to about 10000 W/mm², from about 100 W/mm² to about 500 W/mm², from about 1000 W/mm² to about 3000 W/mm², from about 1000 W/mm² to about 3000 W/mm², or from about 500 W/mm² to about 1000 W/mm²). The scanning speed of the energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the energy beam may be at most about 50 mm/sec, 100 mm/sec, 500 mm/sec, 1000 mm/sec, 2000 mm/sec, 3000 mm/sec, 4000 mm/sec, or 5000 mm/sec. The scanning speed of the energy beam may any value between the afore-mentioned values (e.g., from about 50 mm/sec to about 5000 mm/sec, from about 50 mm/sec to about 3000 mm/sec, or from about 2000 mm/sec to about 5000 mm/sec). The energy beam may be continuous or non-continuous (e.g., pulsing). The energy beam may be modulated before and/or during the formation of a transformed material as part of the 3D object. The energy beam may be modulated before and/or during the 3D printing process.

In some embodiments, the energy beam is generated by an energy source having a power. The energy source (e.g., laser) may have a power of at least about 10 Watt (W), 30 W, 50 W, 80 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy beam may have a power of at most about 10 W, 30 W, 50 W, 80 W, 100 W, 120 W, 150 W, 200 W, 250 W, 300 W, 350 W, 400 W, 500 W, 750 W, 800 W, 900 W, 1000 W, 1500 W, 2000 W, 3000 W, or 4000 W. The energy source may have a power between any of the afore-mentioned energy source power values (e.g., from about 10 W to about 100 W, from about 100 W to about 1000 W, or from about 1000 W to about 4000 W). The energy beam may derive from an electron gun. The energy beam may include a pulsed energy beam, a continuous wave energy beam, or a quasi-continuous wave energy beam. The pulse energy beam may have a repetition frequency of at least about 1 Kilo Hertz (KHz), 2 KHz, 3 KHz, 4 KHz, 5 KHz, 6 KHz, 7 KHz, 8 KHz, 9 KHz, 10 KHz, 20 KHz, 30 KHz, 40 KHz, 50 KHz, 60 KHz, 70 KHz, 80 KHz, 90 KHz, 100 KHz, 150 KHz, 200 KHz, 250 KHz, 300 KHz, 350 KHz, 400 KHz, 450 KHz, 500 KHz, 550 KHz, 600 KHz, 700 KHz, 800 KHz, 900 KHz, 1 Mega Hertz (MHZ), 2 MHZ, 3 MHz, 4 MHZ, or 5 MHz. The pulse energy beam may have a repetition frequency of at most about 1 Kilo Hertz (KHz), 2 KHz, 3 KHz, 4 KHz, 5 KHz, 6 KHz, 7 KHz, 8 KHz, 9 KHz, 10 KHz, 20 KHz, 30 KHz, 40 KHz, 50 KHz, 60 KHz, 70 KHz, 80 KHz, 90 KHz, 100 KHz, 150 KHz, 200 KHz, 250 KHz, 300 KHz, 350 KHz, 400 KHz, 450 KHz, 500 KHz, 550 KHz, 600 KHz, 700 KHz, 800 KHz, 900 KHz, 1 Mega Hertz (MHz), 2 MHZ, 3 MHZ, 4 MHZ, or 5 MHz. The pulse energy beam may have a repetition frequency between any of the afore-mentioned repetition frequencies (e.g., from about 1 KHz to about 5 MHz, from about 1 KHz to about 1 MHz, or from about 1 MHz to about 5 MHz).

In some embodiments, the methods, apparatuses and/or systems disclosed herein comprise Q-switching, mode coupling or mode locking to effectuate the pulsing energy beam. The apparatus or systems disclosed herein may comprise an on/off switch, a modulator, or a chopper to effectuate the pulsing energy beam. The on/off switch can be manually or automatically controlled. The switch may be controlled by the control system. The switch may alter the “pumping power” of the energy beam. The energy beam may be at times focused, non-focused, or defocused. In some instances, the defocus is substantially zero (e.g., the beam is non-focused).

In some embodiments, the energy source(s) projects energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle). The energy source(s) can be modulated. The energy beam(s) emitted by the energy source(s) can be modulated. The modulator can include an amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an acousto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

In some examples, the energy beam(s), energy source(s), and/or the platform of the energy beam translates. The energy beam(s), energy source(s), and/or the platform of the energy beam array can be translated via a galvanometer scanner, a polygon, a mechanical stage (e.g., X-Y stage), a piezoelectric device, gimbal, or any combination of thereof. The galvanometer may comprise a mirror. The galvanometer scanner may comprise a two-axis galvanometer scanner. The scanner may comprise a modulator (e.g., as described herein). The scanner may comprise a polygonal mirror. The scanner can be the same scanner for two or more energy sources and/or beams. At least two (e.g., each) energy source and/or beam may have a separate scanner. The energy sources can be translated independently of each other. In some cases, at least two energy sources and/or beams can be translated at different rates, and/or along different paths. For example, the movement of a first energy source may be faster as compared to the movement of a second energy source. The systems and/or apparatuses disclosed herein may comprise one or more shutters (e.g., safety shutters), on/off switches, or apertures.

In some examples, the energy beam comprises an energy beam footprint on the target surface. The energy beam (e.g., laser) may have a FLS (e.g., a diameter) of its footprint on the on the exposed surface of the material bed of at least about 1 micrometer (μm), 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a FLS on the layer of it footprint on the exposed surface of the material bed of at most about 1 μm, 5 μm, 10 μm, 20 μm, 30 μm, 40 μm, 50 μm, 60 μm, 70 μm, 80 μm, 90 μm, 100 μm, 200 μm, 300 μm, 400 μm, or 500 μm. The energy beam may have a FLS on the exposed surface of the material bed between any of the afore-mentioned energy beam FLS values (e.g., from about 5 μm to about 500 μm, from about 5 μm to about 50 μm, or from about 50 μm to about 500 μm). The beam may be a focused beam. The beam may be a dispersed beam. The beam may be an aligned beam. The apparatus and/or systems described herein may further comprise a focusing coil, a deflection coil, or an energy beam power supply. The defocused energy beam may have a FLS of at least about 1 mm, 5 mm, 10 mm, 20 mm, 30 mm, 40 mm, 50 mm, or 100 mm. The defocused energy beam may have a FLS of at most about 1 mm, 5 mm, 10 mm, 20 mm, 30 mm, 40 mm, 50 mm, or 100 mm. The energy beam may have a defocused cross-sectional FLS on the layer of pre-transformed material between any of the afore-mentioned energy beam FLS values (e.g., from about 5 mm to about 100 mm, from about 5 mm to about 50 mm, or from about 50 mm to about 100 mm).

The power supply to any of the components described herein can be supplied by a grid, generator, local, or any combination thereof. The power supply can be from renewable or non-renewable sources. The renewable sources may comprise solar, wind, hydroelectric, or biofuel. The powder supply can comprise rechargeable batteries.

In some embodiments, the energy beam comprises an exposure time (e.g., the amount of time that the energy beam may be exposed to a portion of the target surface). The exposure time of the energy beam may be at least 1 microsecond (μs), 5 μs, 10 μs, 20 μs, 30 μs, 40 μs, 50 μs, 60 μs, 70 μs, 80 μs, 90 μs, 100 μs, 200 μs, 300 μs, 400 μs, 500 μs, 800 μs, or 1000 μs. The exposure time of the energy beam may be most about 1 μs, 5 μs, 10 μs, 20 μs, 30 μs, 40 μs, 50 μs, 60 μs, 70 μs, 80 μs, 90 μs, 100 μs, 200 μs, 300 μs, 400 μs, 500 μs, 800 μs, or 1000 μs. The exposure time of the energy beam may be any value between the afore-mentioned exposure time values (e.g., from about 1 μs to about 1000 μs, from about 1 μs to about 200 μs, from about 1 μs to about 500 μs, from about 200 μs to about 500 μs, or from about 500 μs to about 1000 μs).

In some embodiments, the 3D printing system comprises a controller. The controller may control one or more characteristics of the energy beam (e.g., variable characteristics). The control of the energy beam may allow a low degree of material evaporation during the 3D printing process. For example, controlling on or more energy beam characteristics may (e.g., substantially) reduce the amount of spatter generated during the 3D printing process. The low degree of material evaporation may be measured in grams of evaporated material and compared to a Kilogram of hardened material formed as part of the 3D object. The low degree of material evaporation may be evaporation of at most about 0.25 grams (gr.), 0.5 gr, 1 gr, 2 gr, 5 gr, 10 gr, 15 gr, 20 gr, 30 gr, or 50 gr per every Kilogram of hardened material formed as part of the 3D object. The low degree of material evaporation per every Kilogram of hardened material formed as part of the 3D object may be any value between the afore-mentioned values (e.g., from about 0.25 gr to about 50 gr, from about 0.25 gr to about 30 gr, from about 0.25 gr to about 10 gr, from about 0.25 gr to about 5 gr, or from about 0.25 gr to about 2 gr).

The methods, systems and/or the apparatus described herein comprise at least one energy source. In some cases, the system can comprise two, three, four, five, or more energy sources. An energy source can be a source configured to deliver energy to an area (e.g., a confined area). An energy source can deliver energy to the confined area through radiative heat transfer.

The energy source can supply any of the energies described herein (e.g., energy beams). The energy source may deliver energy to a point or to an area. The energy source may include an electron gun source. The energy source may include a laser source. The energy source may comprise an array of lasers. In an example, a laser can provide light energy at a peak wavelength of at least about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example, a laser can provide light energy at a peak wavelength of at most about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example, a laser can provide light energy at a peak wavelength between the afore-mentioned peak wavelengths (e.g., from 100 nm to 2000 nm, from 100 nm to 1100 nm, or from 1000 nm to 2000 nm). The energy beam can be incident on the top surface of the material bed. The energy beam can be incident on, or be directed to, a specified area of the material bed over a specified time period. The energy beam can be substantially perpendicular to the top (e.g., exposed) surface of the material bed. The material bed can absorb the energy from the energy beam (e.g., incident energy beam) and, as a result, a localized region of the material in the material bed can increase in temperature. The increase in temperature may transform the material within the material bed. The increase in temperature may heat and transform the material within the material bed. In some embodiments, the increase in temperature may heat and not transform the material within the material bed. The increase in temperature may heat the material within the material bed.

In some embodiments, the energy beam and/or source are moveable such that it can translate relative to the material bed. The energy beam and/or source can be moved by a scanner. The movement of the energy beam and/or source can comprise utilization of a scanner.

In some embodiments, the 3D printing system includes at least two energy beams. At one point in time, and/or (e.g., substantially) during the entire build of the 3D object: At least two of the energy beams and/or sources can be translated independently of each other or in concert with each other. At least two of the multiplicity of energy beams can be translated independently of each other or in concert with each other. In some cases, at least two of the energy beams can be translated at different rates such that the movement of the one is faster compared to the movement of at least one other energy beam. In some cases, at least two of the energy sources can be translated at different rates such that the movement of the one energy source is faster compared to the movement of at least another energy source. In some cases, at least two of the energy sources (e.g., all of the energy sources) can be translated at different paths. In some cases, at least two of the energy sources can be translated at substantially identical paths. In some cases, at least two of the energy sources can follow one another in time and/or space. In some cases, at least two of the energy sources translate substantially parallel to each other in time and/or space. The power per unit area of at least two of the energy beam may be (e.g., substantially) identical. The power per unit area of at least one of the energy beams may be varied (e.g., during the formation of the 3D object). The power per unit area of at least one of the energy beams may be different. The power per unit area of at least one of the energy beams may be different. The power per unit area of one energy beam may be greater than the power per unit area of a second energy beam. The energy beams may have the same or different wavelengths. A first energy beam may have a wavelength that is smaller or larger than the wavelength of a second energy beam. The energy beams can derive from the same energy source. At least one of the energy beams can derive from different energy sources. The energy beams can derive from different energy sources. At least two of the energy beams may have the same power (e.g., at one point in time, and/or (e.g., substantially) during the entire build of the 3D object). At least one of the beams may have a different power (e.g., at one point in time, and/or substantially during the entire build of the 3D object). The beams may have different powers (e.g., at one point in time, and/or (e.g., substantially) during the entire build of the 3D object). At least two of the energy beams may travel at (e.g., substantially) the same velocity. At least one of the energy beams may travel at different velocities. The velocity of travel (e.g., speed) of at least two energy beams may be (e.g., substantially) constant. The velocity of travel of at least two energy beams may be varied (e.g., during the formation of the 3D object or a portion thereof). The travel may refer to a travel relative to (e.g., on) the exposed surface of the material bed (e.g., powder material). The travel may refer to a travel close to the exposed surface of the material bed. The travel may be within the material bed. The at least one energy beam and/or source may travel relative to the material bed.

In some embodiments, the energy (e.g., energy beam) travels in a path. The path may comprise a hatch. The path of the energy beam may comprise repeating a path. For example, the first energy may repeat its own path. The second energy may repeat its own path, or the path of the first energy. The repetition may comprise a repetition of 1, 2, 3, 4, 5, 6, 7, 8, 9, 10 times or more. The energy may follow a path comprising parallel lines. The lines may be hatch lines. The distance between each of the parallel lines or hatch lines, may be at least about 1 μm, 5 μm, 10 μm, 20 μm, 30 μm, 40 μm, 50 μm, 60 μm, 70 μm, 80 μm, 90 μm, or more. The distance between each of the parallel lines or hatch lines, may be at most about 1 μm, 5 μm, 10 μm, 20 μm, 30 μm, 40 μm, 50 μm, 60 μm, 70 μm, 80 μm, 90 μm, or less. The distance between each of the parallel lines or hatch lines may be any value between any of the afore-mentioned distance values (e.g., from about 1 μm to about 90 μm, from about 1 μm to about 50 μm, or from about 40 μm to about 90 μm). The distance between the parallel or parallel lines or hatch lines may be substantially the same in every layer (e.g., plane) of transformed material. The distance between the parallel lines or hatch lines in one layer (e.g., plane) of transformed material may be different than the distance between the parallel lines or hatch lines respectively in another layer (e.g., plane) of transformed material within the 3D object. The distance between the parallel lines or hatch lines portions within a layer (e.g., plane) of transformed material may be substantially constant. The distance between the parallel lines or hatch lines within a layer (e.g., plane) of transformed material may be varied. The distance between a first pair of parallel lines or hatch lines within a layer (e.g., plane) of transformed material may be different than the distance between a second pair of parallel lines or hatch lines within a layer (e.g., plane) of transformed material respectively. The first energy beam may follow a path comprising two hatch lines or paths that cross in at least one point. The hatch lines or paths may be straight or curved. The hatch lines or paths may be winding.

In some embodiments, the formation of the 3D object includes transforming (e.g., fusing, binding, or connecting) the pre-transformed material (e.g., powder material) using an energy beam. The energy beam may be projected on to a particular area of the material bed, thus causing the pre-transformed material to transform. The energy beam may cause at least a portion of the pre-transformed material to transform from its present state of matter to a different state of matter. For example, the pre-transformed material may transform at least in part (e.g., completely) from a solid to a liquid state. The energy beam may cause at least a portion of the pre-transformed material to chemically transform. For example, the energy beam may cause chemical bonds to form or break. The chemical transformation may be an isomeric transformation. The transformation may comprise a magnetic transformation or an electronic transformation. The transformation may comprise coagulation of the material, cohesion of the material, or accumulation of the material.

In some examples, the methods described herein further comprise repeating the operations of material deposition and material transformation operations to produce a 3D object (or a portion thereof) by at least one 3D printing (e.g., additive manufacturing) method. For example, the methods described herein may further comprise repeating the operations of depositing a layer of pre-transformed material and transforming at least a portion of the pre-transformed material to connect to the previously formed 3D object portion, thus forming at least a portion of a 3D object. The transforming operation may comprise utilizing an energy beam to transform the material. In some instances, the energy beam is utilized to transform at least a portion of the material bed (e.g., utilizing any of the methods described herein).

In some examples, the transforming energy is provided by an energy source. The transforming energy may comprise an energy beam. The energy source can produce an energy beam. The energy beam may include a radiation comprising electromagnetic, electron, positron, proton, plasma, or ionic radiation. The electromagnetic beam may comprise microwave, infrared, ultraviolet, or visible radiation. The ion beam may include a charged particle beam. The ion beam may include a cation, or an anion. The electromagnetic beam may comprise a laser beam. The laser may comprise a fiber, or a solid-state laser beam. The energy source may include a laser. The energy source may include an electron gun. The energy depletion may comprise heat depletion. The energy depletion may comprise cooling. The energy may comprise an energy flux (e.g., energy beam. E.g., radiated energy). The energy may comprise an energy beam. The energy may be the transforming energy. The energy may be a warming energy that is not able to transform the deposited pre-transformed material (e.g., in the material bed). The warming energy may be able to raise the temperature of the deposited pre-transformed material. The energy beam may comprise energy provided at a (e.g., substantially) constant or varied energy beam characteristic. The energy beam may comprise energy provided at (e.g., substantially) constant or varied energy beam characteristic, depending on the position of the generated hardened material within the 3D object. The varied energy beam characteristic may comprise energy flux, rate, intensity, wavelength, amplitude, power, cross-section, or time exerted for the energy process (e.g., transforming or heating). The energy beam cross-section may be the average (or mean) FLS of the cross section of the energy beam on the layer of material (e.g., powder). The FLS may be a diameter, a spherical equivalent diameter, a length, a height, a width, or diameter of a bounding circle. The FLS may be the larger of a length, a height, and a width of a 3D form. The FLS may be the larger of a length and a width of a substantially two-dimensional (2D) form (e.g., wire, or 3D surface).

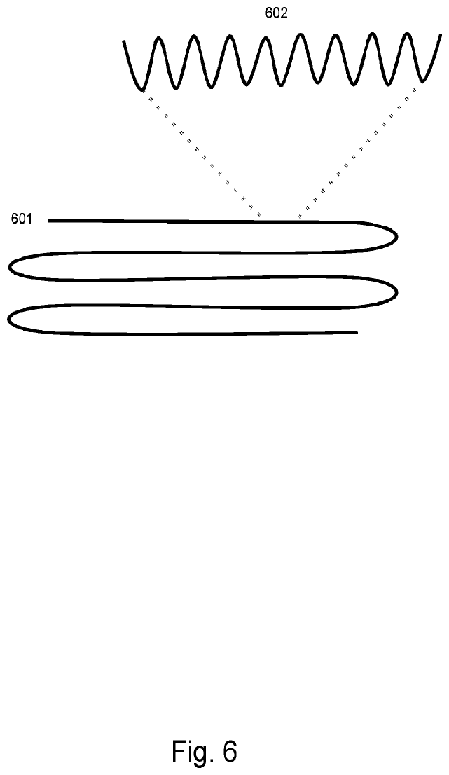

In some examples, the energy beam follows a path. The path of the energy beam may be a vector. The path of the energy beam may comprise a raster, a vector, or any combination thereof. The path of the energy beam may comprise an oscillating pattern. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave. FIG. 6 shows an example of a path 601 of an energy beam comprising a zigzag sub-pattern (e.g., 602 shown as an expansion (e.g., blow-up) of a portion of the path 601). The sub-path of the energy beam may comprise a wave (e.g., sine or cosine wave) pattern. The sub-path may be a small path that forms the large path. The sub-path may be a component (e.g., a portion) of the large path. The path that the energy beam follows may be a predetermined path. A model may predetermine the path by utilizing a controller or an individual (e.g., human). The controller may comprise a processor. The processor may comprise a computer, computer program, drawing or drawing data, statue or statue data, or any combination thereof.

In some embodiments, the path comprises successive lines. The successive lines may touch each other. The successive lines may overlap each other in at least one point. The successive lines may substantially overlap each other. The successive lines may be spaced by a first distance (e.g., hatch spacing). Examples hatch spacing, 3D printing systems, their components, associated methods of use, software, devices, systems, and apparatuses, can be found in International Patent Application Serial No. PCT/US16/34857 filed on May 27, 2016, titled “THREE-DIMENSIONAL PRINTING AND THREE-DIMENSIONAL OBJECTS FORMED USING THE SAME” that is entirely incorporated herein by reference. In some examples, the methods, apparatuses, software, and/or systems described herein comprise a 3D printing process (e.g., added manufacturing) including at least one modification. The modification may include changes to the (e.g., a conventional) 3D printing process, 3D model of the requested 3D object, 3D printing instructions, or any combination thereof. The changes may comprise subtraction or addition. The printing instructions may include instruction given to the radiated energy (e.g., energy beam). The instructions can be given to a controller that controls (e.g., regulates) the energy beam and/or energy source. The modification can be in the energy power, frequency, duty cycle, and/or any other modulation parameter. The modification may comprise varying an energy beam characteristic. The modification can include 3D printing process modification. The modification can include a correction (e.g., a geometrical correction) to a model of a requested 3D object. The geometric correction may comprise duplicating a path in a model of the 3D object with a vertical, lateral, or angular (e.g., planer or compound angle) change in position. Examples modifications, 3D printing systems, their components (e.g., energy beams such as lasers), associated methods of use, software, devices, systems, and apparatuses, can be found in International Patent Application Serial No. PCT/US16/34857 filed on May 27, 2016, titled “THREE-DIMENSIONAL PRINTING AND THREE-DIMENSIONAL OBJECTS FORMED USING THE SAME,” or in U.S. patent application Ser. No. 17/849,866 filed on Jun. 27, 2022, titled “ACCURATE THREE-DIMENSIONAL PRINTING,” each of which is incorporated by reference herein in its entirety. The geometric correction may comprise expanding a path in a model of the 3D object in a vertical, lateral, or angular (e.g., planar or compound angle) position. Angular relocation may comprise rotation. The geometric correction may comprise altering (e.g., expanding or shrinking) a path in a model of the 3D object in a vertical, lateral, or angular (e.g., planer or compound angle) position. The modification can include a variation in a characteristic of the energy (e.g., energy beam) using in the 3D printing process, a variation in the path that the energy travels on (or within) a layer of material (in a material bed) to be transformed and form the 3D object. The layer of material can be a layer of powder material. The modification may depend on a selected position within the generated 3D object, such as an edge, a kink, a suspended structure, a bridge, a lower surface, or any combination thereof. The modification may depend on a hindrance for (e.g., resistance to) energy depletion within the 3D object as it is being generated, or a hindrance for (e.g., resistance to) energy depletion in the surrounding pre-transformed material (e.g., powder material). The modification may depend on a degree of packing of the pre-transformed material within a material bed (e.g., a powder material within a powder bed). For example, the modification may depend on the density of the powder material within a powder bed. The powder material may be unused, recycled, new, or aged.

In some embodiments, the methods, apparatuses, software, and/or systems comprise corrective deformation of a 3D model of the requested 3D structure, that substantially result in the requested 3D structure. The corrective deformation may consider features comprising stress within the forming structure, deformation of transformed material as it hardens to form at least a portion of the 3D object, the manner of temperature depletion during the printing process, the manner of deformation of the transformed material as a function of the density of the pre-transformed material within the material bed (e.g., powder material within a powder bed). The modification may comprise alteration of a path of a cross section (or portion thereof) in the 3D model that is used in the 3D printing instructions. The alteration of the path may comprise alteration of the path filling at least a portion of the cross section (e.g., hatches). The alteration of the hatches may comprise alteration of the direction of hatches, the density of the hatch lines, the length of the hatch lines, and/or the shape of the hatch lines. The modification may comprise alteration of the thickness of the transformed material. The modification may comprise varying at least a portion of a cross-section of the 3D model (e.g., that is used in the 3D printing instructions) by an angle, and/or inflicting to at least a portion of a cross section, a radius of curvature. The angle can be planer or compound angle. The radius of curvature may arise from a bending of at least a portion of the cross section of a 3D model. The one or more layers may have a radius of curvature equal to the radius of curvature of the layer surface. The radius of curvature can be the inverse of the curvature. In the case of a 3D curve (also herein a “space curve”), the radius of curvature may be the length of the curvature vector. The curvature vector can comprise of a curvature (e.g., the inverse of the radius of curvature) having a particular direction. For example, the particular direction can be the direction towards the build plate (e.g., designated herein as negative curvature), or away from the build plate (e.g., designated herein as positive curvature). For example, the particular direction can be the direction towards the direction of the gravitational field (e.g., designated herein as negative curvature), or opposite to the direction of the gravitational field (e.g., designated herein as positive curvature). A curve (also herein a “curved line”) can be an object similar to a line that is not required to be straight. A straight line can be a special case of curved line wherein the curvature is (e.g., substantially) zero. A line of substantially zero curvature has a (e.g., substantially) infinite radius of curvature. A curve can be in two dimensions (e.g., vertical cross section of a plane), or in three-dimension (e.g., curvature of a plane). The curve may represent a cross section of a curved plane. A straight line may represent a cross section of a flat (e.g., planar) plane.

In some examples, the path of the transforming energy deviates. The path of the transforming energy may deviate at least in part from a cross section of a requested 3D object. In some instances, the generated 3D object (e.g., substantially) corresponds to the requested 3D object. In some instances, the transforming energy beam follows a path that differs from a cross section of a model of the requested 3D object (e.g., a deviated path), to form a transformed material. When that transformed material hardens, the hardened transformed material may (e.g., substantially) correspond to the respective cross section of a model of the requested 3D object. In some instances, when that transformed material hardens, the hardened material may not correspond to the respective cross section of a model of the requested 3D object. In some instances, when that transformed material hardens, the hardened transformed material may not correspond to the respective cross section of a model of the requested 3D object, however the accumulated transformed material (e.g., accumulated as it forms a plurality of layers of hardened material) may (e.g., substantially) correspond to the requested 3D object. In some instances, when that transformed material hardens, the accumulated hardened material that forms the generated 3D object substantially corresponds to the requested 3D object. The deviation from the path may comprise a deviation between different cross-sections of the requested 3D object. The deviation may comprise a deviation within a cross-section of the requested 3D object. The path can comprise a path section that is larger than a corresponding path section in the cross section of the requested 3D object. Larger may be larger within the plane of the cross section (e.g., horizontally larger) and/or outside the plane of the cross section (e.g., vertically larger). The path may comprise a path section that is smaller than a respective path section in the cross section of a model of the requested 3D object. Smaller may be within the plane of the cross section (e.g., horizontally smaller) and/or outside the plane of the cross section (e.g., vertically smaller).

In some embodiments, the transformed material deforms upon hardening (e.g., cooling). The deformation of the hardened material may be anticipated. Sometimes, the hardened material may be generated such that the transformed material may deviate from its intended structure, which subsequently forming hardened material therefrom assumes the intended structure. The intended structure may be devoid of deformation, or may have a (e.g., substantially) reduced amount of deformation in relation to its intended use. Such corrective deviation from the intended structure of the tile is termed herein as “geometric correction.”

In some examples, a newly formed layer of material (e.g., comprising transformed material) reduces in volume during its hardening (e.g., by cooling). Such reduction in volume (e.g., shrinkage) may cause a deformation in the requested 3D object. The deformation may include cracks, and/or tears in the newly formed layer and/or in other (e.g., adjacent) layers. The deformation may include geometric deformation of the 3D object or at least a portion thereof. The newly formed layer can be a portion of a 3D object. The one or more layers that form the 3D printed object (e.g., sequentially) may be (e.g., substantially) parallel to the building platform. An angle may be formed between a layer of hardened material of the 3D printed object and the platform. The angle may be measured relative to the average layering plane of the layer of hardened material. The platform may comprise the base, or the substrate.

In an aspect provided herein is a 3D object comprising a layer of hardened material generated by at least one 3D printing method described herein, wherein the layer of material (e.g., hardened) is different from a corresponding cross section of a model of the 3D object. For example, the generated layers differ from the proposed slices. The layer of material within a 3D object can be indicated by the microstructure of the material. Examples material microstructures, 3D printing systems, their components (e.g., energy beams such as lasers), associated methods of use, software, devices, systems, and apparatuses, can be found in PCT/US15/36802 that is incorporated herein by reference in its entirety. The 3D model may comprise a generated, ordered, provided, or replicated 3D model. The model may be generated, ordered, provided, or replicated by a customer, individual, manufacturer, engineer, artist, human, computer, or software. The software can be neural network software. The 3D model can be generated by a 3D modeling program (e.g., SolidWorks®, Google SketchUp®, SolidEdge®, Engineer®, Auto-CAD®, or I-Deas®). In some cases, the 3D model can be generated from a provided sketch, image, or 3D object.

In some examples, the layer of transformed material differs from a respective slice in a model of the 3D object. The layer of transformed material may differ from a respective cross section (e.g., slice) of a model of the 3D object. The difference may be in the area of the transformed material layer as compared to a respective cross section of a model of the 3D object. For example, the area of the transformed material layer may be smaller than the respective cross section of a model of the 3D object. The area of the transformed material layer may be larger than the respective cross section of a model (e.g., model slice) of the 3D object. The area of the transformed material layer may be a portion of the respective cross section of a model of the 3D object. The area of the respective cross section of a model of the 3D object may be divided between at least two different layers of transformed material. The area of the transformed material layer may be larger than the respective cross section of a model of the 3D object and may shrink to form a hardened material that is substantially identical to the respective cross section of a model of the 3D object. The area of the transformed material layer may be different than the respective cross section of a model of the 3D object and may deform to form a hardened material that is substantially identical to the respective cross section of a model of the 3D object. The layer of hardened material may differ from a respective cross section (e.g., slice) of a model of the 3D object. The layer of hardened material may be (e.g., substantially) the same as a respective cross section (e.g., slice) of a model of the 3D object. The area of the transformed material layer may be different than the respective cross section of a model of the 3D object and may deform to form a hardened material within the generated 3D object, wherein the generated 3D object may be substantially identical to the respective cross section of a model of the 3D object. The area of the transformed material layer may be different than the respective cross section of a model of the 3D object and may form a hardened material within the generated 3D object, wherein the generated 3D object may be (e.g., substantially) identical to the respective cross section of a model of the 3D object. The layer of hardened material may differ from a respective cross section of a model of the 3D object. The difference may be in the area of the hardened material layer as compared to a respective cross section of a model of the 3D object. For example, the area of the hardened material layer may be smaller than the respective cross section of a model of the 3D object. The area of the hardened material layer may be larger than the respective cross section of a model of the 3D object. The area of the hardened material layer may be a portion of the respective cross section of a model of the 3D object. The area of the respective cross section of a model of the 3D object may be divided between at least two different layers of hardened material. The area of the hardened material layer may be different than the respective cross section of a model of the 3D object, and the generated 3D object may be substantially identical to the respective cross section of a model of the 3D object.

In some embodiments, the material microstructure of the 3D object reveals the manner in which the 3D object was generated. The material microstructure in a hardened material layer within the 3D object may reveal the manner in which the 3D object was generated. The microstructure of the material in a hardened material layer within the 3D object may reveal the manner in which the layer within the 3D object was generated. The microstructure may comprise the grain-structure, or the melt-pool structure. For example, the path in which the energy traveled and transformed the pre-transformed material to form the hardened material within the printed 3D object may be indicated by the microstructure of the material within the 3D object.

In some examples, a portion of the generated 3D object is printed with auxiliary support. The term “auxiliary support,” as used herein, generally refers to at least one feature that is a part of a printed 3D object, but not part of the requested, intended, designed, ordered, and/or final 3D object. Auxiliary support may provide structural support during and/or subsequent to the formation of the 3D object. The auxiliary support may be anchored to the enclosure. For example, an auxiliary support may be anchored to the build plate, to the side walls of the material bed, to a wall of the enclosure, to an object (e.g., stationary, or semi-stationary) within the enclosure, or any combination thereof. The auxiliary support may be the platform (e.g., the base, the substrate) or the bottom of the enclosure. The auxiliary support may enable the removal or energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, platform, or another stabilization feature. In some instances, the auxiliary support may be mounted, clamped, or situated on the platform. The auxiliary support can be anchored to the building platform, to the sides (e.g., walls) of the building platform, to the enclosure, to an object (stationary or semi-stationary) within the enclosure, or any combination thereof.

In some examples, the generated 3D object is printed without auxiliary support. In some examples, overhanging feature of the generated 3D object can be printed without (e.g., without any) auxiliary support. The generated object can be devoid of auxiliary supports. The generated object may be suspended (e.g., float anchorlessly) in the material bed (e.g., powder bed). The term “anchorlessly,” as used herein, generally refers to without or in the absence of an anchor. In some examples, an object is suspended in a powder bed anchorlessly without attachment to a support. For example, the object floats in the powder bed. The generated 3D object may be suspended in the layer of pre-transformed material (e.g., powder material). The pre-transformed material (e.g., powder material) can offer support to the printed 3D object (or the object during its generation). Sometimes, the generated 3D object may comprise one or more auxiliary supports. The auxiliary support may be suspended in the pre-transformed material (e.g., powder material). The auxiliary support may provide weights or stabilizers. The auxiliary support can be suspended in the material bed within the layer of pre-transformed material in which the 3D object (or a portion thereof) has been formed. The auxiliary support (e.g., one or more auxiliary supports) can be suspended in the pre-transformed material within a layer of pre-transformed material other than the one in which the 3D object (or a portion thereof) has been formed (e.g., a previously deposited layer of (e.g., powder) material). The auxiliary support may touch the platform. The auxiliary support may be suspended in the material bed (e.g., powder material) and not touch the platform. The auxiliary support may be anchored to the platform. The distance between any two auxiliary supports can be at least about 1 millimeter, 1.3 millimeters (mm), 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 11 mm, 15 mm, 20 mm, 30 mm, 40 mm, 41 mm, or 45 mm. The distance between any two auxiliary supports can be at most 1 millimeter, 1.3 mm, 1.5 mm, 1.8 mm, 1.9 mm, 2.0 mm, 2.2 mm, 2.4 mm, 2.5 mm, 2.6 mm, 2.7 mm, 3 mm, 4 mm, 5 mm, 10 mm, 11 mm, 15 mm, 20 mm, 30 mm, 40 mm, 41 mm, or 45 mm. The distance between any two auxiliary supports can be any value in between the afore-mentioned distances (e.g., from about 1 mm to about 45 mm, from about 1 mm to about 11 mm, from about 2.2 mm to about 15 mm, or from about 10 mm to about 45 mm). At times, a sphere intersecting an exposed surface of the 3D object may be devoid of auxiliary support.

In some examples, the diminished number of auxiliary supports or lack of auxiliary support, facilitates a 3D printing process that requires a smaller amount of material, produces a smaller amount of material waste, and/or requires smaller energy as compared to commercially available 3D printing processes. The reduced number of auxiliary supports can be smaller by at least about 1.1, 1.3, 1.5, 2, 3, 4, 5, 6, 7, 8, 9, or 10 as compared to conventional 3D printing. The smaller amount may be smaller by any value between the aforesaid values (e.g., from about 1.1 to about 10, or from about 1.5 to about 5) as compared to conventional 3D printing.

In some embodiments, the generated 3D object has a surface roughness profile. The generated 3D object can have various surface roughness profiles, which may be suitable for various applications. The surface roughness may be the deviations in the direction of the normal vector of a real surface from its ideal form. The surface roughness may be measured as the arithmetic average of the roughness profile (hereinafter “Ra”). The formed object can have a Ra value of at most about 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The 3D object can have a Ra value between any of the afore-mentioned Ra values (e.g., from about 50 μm to about 1 μm, from about 100 μm to about 4 μm, from about 30 μm to about 3 μm, from about 60 nm to about 1 μm, or from about 80 nm to about 0.5 μm). The Ra values may be measured by a contact or by a non-contact method. The Ra values may be measured by a roughness tester and/or by a microscopy method (e.g., any microscopy method described herein). The measurements may be conducted at ambient temperatures (e.g., R.T.). The roughness (e.g., as Ra values) may be measured by a contact or by a non-contact method. The roughness measurement may comprise one or more sensors (e.g., optical sensors). The roughness measurement may comprise a metrological measurement device (e.g., using metrological sensor(s)). The roughness may be measured using an electromagnetic beam (e.g., visible or IR).

In some embodiments, the generated 3D object (e.g., the hardened cover) is substantially smooth. The generated 3D object may have a deviation from an ideal planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The generated 3D object may have a deviation from an ideal planar surface of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The generated 3D object may have a deviation from an ideal planar surface between any of the afore-mentioned deviation values. The generated 3D object may comprise a pore. The generated 3D object may comprise pores. The pores may be of an average FLS (diameter or diameter equivalent in case the pores are not spherical) of at most about 1.5 nanometers (nm), 2 nm, 3 nm, 4 nm, 5 nm, 10 nm, 15 nm, 20 nm, 25 nm, 30 nm 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, or 500 μm. The pores may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, or 500 μm. The pores may be of an average FLS between any of the afore-mentioned FLS values (e.g., from about 1 nm to about 500 μm, or from about 20 μm, to about 300 μm). The 3D object (or at least a layer thereof) may have a porosity of at most about 0.05 percent (%), 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity of at least about 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have porosity between any of the afore-mentioned porosity percentages (e.g., from about 0.05% to about 80%, from about 0.05% to about 40%, from about 10% to about 40%, or from about 40% to about 90%). In some instances, a pore may traverse the generated 3D object. For example, the pore may start at a face of the 3D object and end at the opposing face of the 3D object. The pore may comprise a passageway extending from one face of the 3D object and ending on the opposing face of that 3D object. In some instances, the pore may not traverse the generated 3D object. The pore may form a cavity in the generated 3D object. The pore may form a cavity on a face of the generated 3D object. For example, pore may start on a face of the plane and not extend to the opposing face of that 3D object.

In some embodiments, the formed plane comprises a protrusion. The protrusion can be a grain, a bulge, a bump, a ridge, or an elevation. The generated 3D object may comprise protrusions. The protrusions may be of an average FLS of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The protrusions may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The protrusions may be of an average FLS between any of the afore-mentioned FLS values. The protrusions may constitute at most about 0.05%, 0.1%, 0.2%, 0.3%, 0.4%, 0.5%, 0.6%, 0.7%, 0.8%, 0.9%, 1%, 2%, 3%, 4%, 5%, 10%, 20%, 30%, 40%, or 50% of the area of the generated 3D object. The protrusions may constitute at least about 0.05%, 0.1%, 0.2%, 0.3%, 0.4%, 0.5%, 0.6%, 0.7%, 0.8%, 0.9%, 1%, 2%, 3%, 4%, 5%, 10%, 20%, 30%, 40%, or 50% of the area of the 3D object. The protrusions may constitute a percentage of an area of the 3D object that is between the afore-mentioned percentages of 3D object area. The protrusion may reside on any surface of the 3D object. For example, the protrusions may reside on an external surface of a 3D object. The protrusions may reside on an internal surface (e.g., a cavity) of a 3D object. At times, the average size of the protrusions and/or of the holes may determine the resolution of the printed (e.g., generated) 3D object. The resolution of the printed 3D object may be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or more. The resolution of the printed 3D object may be at most about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or less. The resolution of the printed 3D object may be any value between the above-mentioned resolution values. At times, the 3D object may have a material density of at least about 99.9%, 99.8%, 99.7%, 99.6%, 99.5%, 99.4%, 99.3%, 99.2% 99.1%, 99%, 98%, 96%, 95%, 94%, 93%, 92%, 91%, 90%, 8%, or 70%. At times, the 3D object may have a material density of at most about 99.5%, 99%, 98%, 96%, 95%, 94%, 93%, 92%, 91%, 90%, 8%, or 70%. At times, the 3D object may have a material density between the afore-mentioned material densities. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dip. The resolution of the 3D object may be any value between the afore-mentioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80, 70 μm, 60 μm, 50 μm, 40 μm, 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

In some embodiments, when the energy source is in operation, the material bed reaches a certain (e.g., average) temperature. The average temperature of the material bed can be an ambient temperature or “room temperature.” The average temperature of the material bed can have an average temperature during the operation of the energy (e.g., beam). The average temperature of the material bed can be an average temperature during the formation of the transformed material, the formation of the hardened material, or the generation of the 3D object. The average temperature can be below or just below the transforming temperature of the material. Just below can refer to a temperature that is at most about 1° C., 2° C., 3° C., 4° C., 5° C., 6° C., 7° C., 8° C., 9° C., 10° C., 15° C., or 20° C. below the transforming temperature. The average temperature of the material bed (e.g., pre-transformed material) can be at most about 10° C. (degrees Celsius), 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be at least about 10° C., 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be any temperature between the afore-mentioned material average temperatures. The average temperature of the material bed (e.g., pre-transformed material) may refer to the average temperature during the 3D printing. The pre-transformed material can be the material within the material bed that has not been transformed and generated at least a portion of the 3D object (e.g., the remainder). The material bed can be heated or cooled before, during, or after forming the 3D object (e.g., hardened material). Bulk heaters can heat the material bed. The bulk heaters can be situated adjacent to (e.g., above, below, or to the side of) the material bed, or within a material dispensing system. For example, the material can be heated using radiators (e.g., quartz radiators, or infrared emitters). The material bed temperature can be substantially maintained at a predetermined value. The temperature of the material bed can be monitored. The material temperature can be controlled manually and/or by a control system.

In some examples, the pre-transformed material within the material bed is heated by a first energy source such that the heating will transform the pre-transformed material. The remainder of the material that did not transform to generate at least a portion of the 3D object (e.g., the remainder) can be heated by a second energy source. The remainder can be at an average temperature that is less than the liquefying temperature of the material (e.g., during the 3D printing). The maximum temperature of the transformed portion of the material bed and the average temperature of the remainder of the material bed can be different. The solidus temperature of the material can be a temperature wherein the material is in a solid state at a given pressure (e.g., ambient pressure). Ambient may refer to the surrounding. After the portion of the material bed is heated to the temperature that is at least a liquefying temperature of the material by the first energy source, that portion of the material may be cooled to allow the transformed (e.g., liquefied) material portion to harden (e.g., solidify). In some cases, the liquefying temperature can be at least about 100° C., 200° C., 300° C., 400° C., or 500° C., and the solidus temperature can be at most about 500° C., 400° C., 300° C., 200° C., or 100° C. For example, the liquefying temperature is at least about 300° C. and the solidus temperature is less than about 300° C. In another example, the liquefying temperature is at least about 400° C. and the solidus temperature is less than about 400° C. The liquefying temperature may be different from the solidus temperature. In some instances, the temperature of the pre-transformed material is maintained above the solidus temperature of the material and below its liquefying temperature. In some examples, the material from which the pre-transformed material is composed has a super cooling temperature (or super cooling temperature regime). In some examples, as the first energy source heats up the pre-transformed material to cause at least a portion of it to melt, the molten material will remain molten as the material bed is held at or above the material super cooling temperature of the material, but below its melting point. When two or more materials make up the material layer at a specific ratio, the materials may form a eutectic material on transformation of the material. The liquefying temperature of the formed eutectic material may be the temperature at the eutectic point, close to the eutectic point, or far from the eutectic point. Close to the eutectic point may designate a temperature that is different from the eutectic temperature (i.e., temperature at the eutectic point) by at most about 0.1° C., 0.5° C., 1° C., 2° C., 4° C., 5° C., 6° C., 8° C., 10° C., or 15° C. A temperature that is farther from the eutectic point than the temperature close to the eutectic point is designated herein as a temperature far from the eutectic Point. The process of liquefying and solidifying a portion of the material can be repeated until the entire object has been formed. At the completion of the generated 3D object, it can be removed from the remainder of material in the container. The remaining material can be separated from the portion at the generated 3D object. The generated 3D object can be hardened and removed from the container (e.g., from the substrate or from the base).

In some examples, the methods described herein further comprise stabilizing the temperature within the enclosure. For example, stabilizing the temperature of the atmosphere or the pre-transformed material (e.g., within the material bed). Stabilization of the temperature may be to a predetermined temperature value. The methods described herein may further comprise altering the temperature within at least one portion of the container. Alteration of the temperature may be to a predetermined temperature. Alteration of the temperature may comprise heating and/or cooling the material bed. Elevating the temperature (e.g., of the material bed) may be to a temperature below the temperature at which the pre-transformed material fuses (e.g., melts or sinters), connects, or bonds.

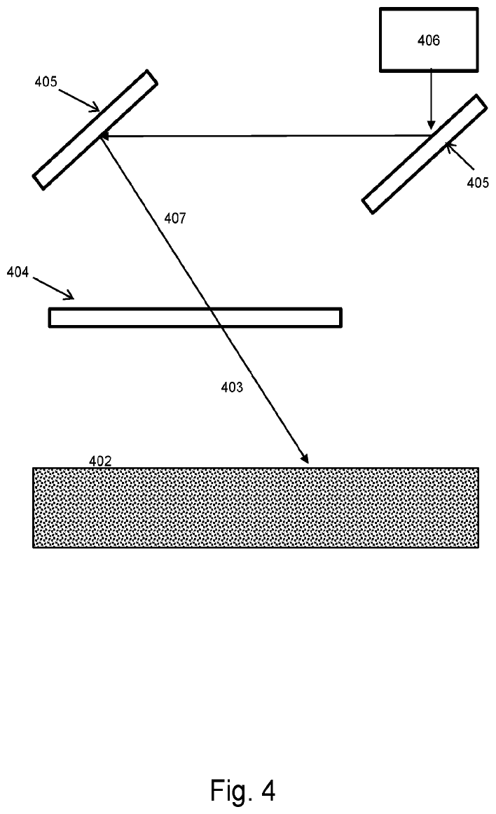

In some embodiments, the apparatus and/or systems described herein comprise an optical system. The optical system may comprise one or more (e.g., plurality) of optical assemblies. The optical components may be controlled manually and/or via a control system (e.g., a controller). The optical system (e.g., one or more optical assemblies) 120 may be configured to direct at least one energy beam from the at least one energy source to a position on the material bed within the enclosure (e.g., a predetermined position). A scanner can be included in the optical system. Each optical assembly of the one or more optical assemblies may comprise a respective scanner. The printing system may comprise a processor (e.g., a central processing unit). The processor can be programmed to control a trajectory of the at least one energy beam and/or energy source with the aid of the optical system. The systems and/or the apparatus described herein can further comprise a control system in communication with the at least one energy source and/or energy beam. The control system can regulate a supply of energy from the at least one energy source to the material in the container. The control system may control the various components of the optical system (e.g., FIG. 1, 120). The various components of the optical system (e.g., FIG. 4) may include optical components comprising a mirror (e.g., 405), a lens (e.g., concave or convex), a fiber, a beam guide, a rotating polygon, or a prism. The lens may be a focusing or a dispersing lens. The lens may be a diverging or converging lens. The mirror can be a deflection mirror. The optical components may be tiltable and/or rotatable. The optical components may be tilted and/or rotated. The mirror may be a deflection mirror. The optical components may comprise an aperture. The aperture may be mechanical. The optical system may comprise a variable focusing device. The variable focusing device may be connected to the control system. The variable focusing device may be controlled by the control system and/or manually. The variable focusing device may comprise a modulator. The modulator may comprise an acousto-optical modulator, mechanical modulator, or an electro optical modulator. The focusing device may comprise an aperture (e.g., a diaphragm aperture). The optical system may comprise an optical window (e.g., 404). FIG. 4 shows an example of an optical system and an energy source 406 that produces an energy beam 407 that travels through the components of the optical system (e.g., 405 and 404) to a target surface 402.

In some embodiments, the enclosure (e.g., processing chamber and/or build module) described herein comprises at least one sensor. The sensor may be connected and/or controlled by the control system (e.g., computer control system, or controller). The control system may be able to receive signals from the at least one sensor. The control system may act upon at least one signal received from the at least one sensor. The control may utilize (e.g., rely on) feedback and/or feed forward mechanisms that has been pre-programmed. The feedback and/or feed forward mechanisms may rely on input from at least one sensor that is connected to the control unit.

In some embodiments, the sensor detects the amount of material (e.g., pre-transformed material) in the enclosure. The controller may monitor the amount of material in the enclosure (e.g., within the material bed). The systems and/or the apparatus described herein can include a pressure sensor. The pressure sensor may measure the pressure of the chamber (e.g., pressure of the chamber atmosphere). The pressure sensor can be coupled to a control system. The pressure can be electronically and/or manually controlled. The controller may control (e.g., regulate, maintain, or alter) the pressure (e.g., with the aid of one or more pumps such as vacuum pumps or pressure pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, angle, and/or volume). The metrology sensor may comprise a magnetic, acceleration, orientation, or optical sensor. The optical sensor may comprise a camera (e.g., IR camera, or CCD camera (e.g., single line CCD camera)). The sensor may transmit and/or receive sound (e.g., echo), magnetic, electronic, or electromagnetic signal. The electromagnetic signal may comprise a visible, infrared, ultraviolet, ultrasound, radio wave, or microwave signal. The metrology sensor may measure the tile. The metrology sensor may measure the gap. The metrology sensor may measure at least a portion of the layer of material (e.g., pre-transformed, transformed, and/or hardened). The layer of material may be a pre-transformed material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer, Pyrometer, IR camera, or CCD camera (e.g., single line CCD camera). The temperature sensor may measure the temperature without contacting the material bed (e.g., non-contact measurements). The pyrometer may comprise a point pyrometer, or a multi-point pyrometer. The Infrared (IR) thermometer may comprise an IR camera. The pressure sensor may comprise Barograph, Barometer, Boost gauge, Bourdon gauge, hot filament ionization gauge, Ionization gauge, McLeod gauge, Oscillating U-tube, Permanent Downhole Gauge, Piezometer, Pirani gauge, Pressure sensor, Pressure gauge, tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode as light sensor, Light-addressable potentiometric sensor, Nichols radiometer, Fiber optic sensors, optical position sensor, photo detector, photodiode, photomultiplier tubes, phototransistor, photoelectric sensor, photoionization detector, photomultiplier, photo resistor, photo switch, phototube, scintillometer, Shack-Hartmann, single-photon avalanche diode, superconducting nanowire single-photon detector, transition edge sensor, visible light photon counter, or wave front sensor. The weight of the enclosure (e.g., container), or any components within the enclosure can be monitored by at least one weight sensor in or adjacent to the material. For example, a weight sensor can be situated at the bottom of the enclosure. The weight sensor can be situated between the bottom of the enclosure and the substrate. The weight sensor can be situated between the substrate and the base. The weight sensor can be situated between the bottom of the container and the base. The weight sensor can be situated between the bottom of the container and the top of the material bed. The weight sensor can comprise a pressure sensor. The weight sensor may comprise a spring scale, a hydraulic scale, a pneumatic scale, or a balance. At least a portion of the pressure sensor can be exposed on a bottom of the container. In some cases, the at least one weight sensor can comprise a button load cell. Alternatively, or additionally a sensor can be configured to monitor the weight of the material by monitoring a weight of a structure that contains the material (e.g., a material bed). One or more position sensors (e.g., height sensors) can measure the height of the material bed relative to the substrate. The position sensors can be optical sensors. The position sensors can determine a distance between one or more energy sources and a surface of the material bed. The surface of the material bed can be the upper surface of the material bed. For example, FIG. 1, 119 shows an example of an upper surface of the material bed 104.

In some embodiments, the methods, systems, and/or the apparatus described herein comprise at least one valve. The valve may be shut or opened according to an input from the at least one sensor, or manually. The degree of valve opening or shutting may be regulated by the control system, for example, according to at least one input from at least one sensor. The systems and/or the apparatus described herein can include one or more valves, such as throttle valves.

In some embodiments, the methods, systems, and/or the apparatus described herein comprise an actuator. In some embodiments, the methods, systems, and/or the apparatus described herein comprise a motor. The motor may be controlled by the control system and/or manually. The apparatuses and/or systems described herein may include a system providing the material (e.g., powder material) to the material bed. The system for providing the material may be controlled by the control system, or manually. The motor may connect to a system providing the material (e.g., powder material) to the material bed. The system and/or apparatus of the present disclosure may comprise a material reservoir. The material may travel from the reservoir to the system and/or apparatus of the present disclosure may comprise a material reservoir. The material may travel from the reservoir to the system for providing the material to the material bed. The motor may alter (e.g., the position of) the substrate and/or to the base. The motor may alter (e.g., the position of) the elevator. The motor may alter an opening of the enclosure (e.g., its opening or closure). The motor may be a step motor or a servomotor. The motor may comprise a stepper motor. The methods, systems and/or the apparatus described herein may comprise a piston. The piston may be a trunk, crosshead, slipper, or deflector piston.

In some embodiments, the systems and/or the apparatus described herein comprise at least one nozzle. The nozzle may be regulated according to at least one input from at least one sensor. The nozzle may be controlled automatically or manually. The controller may control the nozzle. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle.

In some embodiments, the systems and/or the apparatus described herein comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valve-less pump, steam pump, gravity pump, eductor-jet pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump. In some examples, the systems and/or the apparatus described herein include one or more vacuum pumps selected from mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector.

In some embodiments, the systems, apparatuses, and/or parts thereof comprise a communication technology. The systems, apparatuses, and/or parts thereof may comprise Bluetooth technology. The systems, apparatuses, and/or parts thereof may comprise a communication port. The communication port may be a serial port or a parallel port. The communication port may be a Universal Serial Bus port (i.e., USB). The systems, apparatuses, and/or parts thereof may comprise USB ports. The USB can be micro or mini-USB. The USB port may relate to device classes comprising 00 h, 01 h, 02 h, 03 h, 05 h, 06 h, 07 h, 08 h, 09 h, 0 Ah, 0 Bh, 0 Dh, 0 Eh, 0 Fh, 10 h, 11 h, DCh, E0 h, EFh, FEh, or FFh. The systems, apparatuses, and/or parts thereof (e.g., at least one controller) may comprise a plug and/or a socket (e.g., electrical, AC power, DC power). The systems, apparatuses, and/or parts thereof may comprise an adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In some embodiments, the controller monitors and/or directs (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may comprise multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise a control scheme including feedback control. The controller may comprise feed-forward control. The control may comprise on-off control, proportional control, proportional-integral (PI) control, or proportional-integral-derivative (PID) control. The control may comprise open loop control, or closed loop control. The controller may comprise closed loop control. The controller may comprise open loop control. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. Examples controllers, 3D printing systems, their components (e.g., energy beams such as lasers), associated methods of use, software, devices, systems, and apparatuses, can be found in International Patent Application Serial No. PCT/US16/59781 filed on Oct. 31, 2016; or in U.S. patent application Ser. No. 15/339,712 filed on Oct. 31, 2016; each of which is incorporated herein by reference in its entirety.

In some embodiments, the methods, systems, and/or the apparatus described herein further comprise a control system. The control system may comprise at least three hierarchical control levels. The control system may comprise a microcontroller. Control may comprise regulate, maintain, adjust, monitor, restrict, limit, govern, restrain, supervise, direct, guide, manipulate, or modulate. The control system may be configured to direct one or more operations of the methods, systems, and/or the apparatus described herein. For example, the control system can be in communication with one or more energy sources and/or energy (e.g., energy beams). The energy sources may be of the same type or of different types. For example, the energy sources can be both lasers, or a laser and an electron beam. For example, the control system may be in communication with the first energy and/or with the second energy. The control system may regulate the one or more energies (e.g., energy beams). The control system may regulate the energy supplied by the one or more energy sources. For example, the control system may regulate the energy supplied by a first energy beam and by a second energy beam, to the pre-transformed material within the material bed. The control system may regulate the position of the one or more energy beams. For example, the control system may regulate the position of the first energy beam and/or the position of the second energy beam.

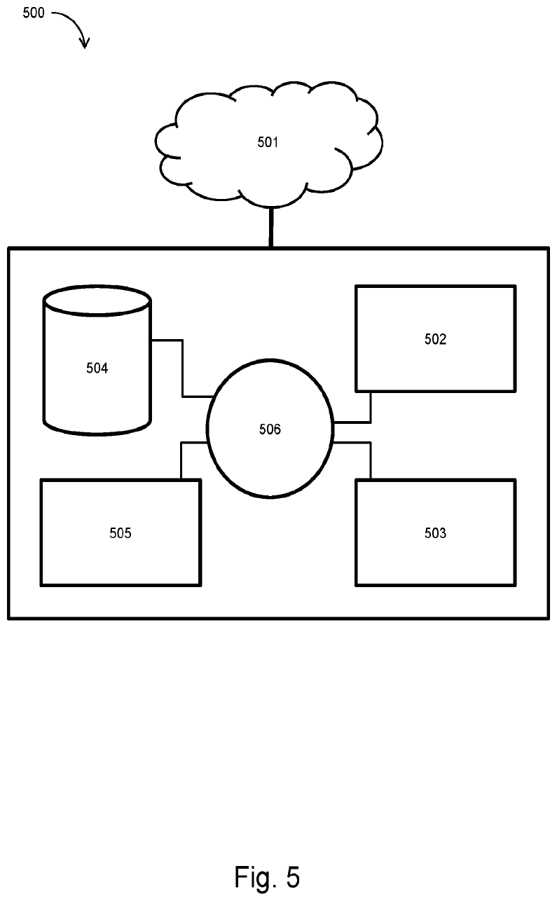

In some embodiments, the 3D printing system comprises a processor. The processor may be a processing unit. The controller may comprise a processing unit. The processing unit may be central. The processing unit may comprise a central processing unit (herein “CPU”). The controllers or control mechanisms (e.g., comprising a computer system) may be programmed to implement methods of the disclosure. The processor (e.g., 3D printer processor) may be programmed to implement methods of the disclosure. The controller may control at least one component of the systems and/or apparatuses disclosed herein. FIG. 5 is a schematic example of a computer system 500 that is programmed or otherwise configured to facilitate the formation of a 3D object according to the methods provided herein. The computer system 500 can control (e.g., direct, monitor, and/or regulate) various features of printing methods, apparatuses and systems of the present disclosure, such as, for example, control force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system 500 can be part of, or be in communication with, a 3D printing system or apparatus. The computer may be coupled to one or more mechanisms disclosed herein, and/or any parts thereof. For example, the computer may be coupled to one or more sensors, valves, switches, motors, pumps, scanners, optical components, or any combination thereof.

In some embodiments, the computer system 500 includes a processing unit 506 (also “processor,” “computer” and “computer processor” used herein). The computer system may include memory or memory location 502 (e.g., random-access memory, read-only memory, flash memory), electronic storage unit 504 (e.g., hard disk), communication interface 503 (e.g., network adapter) for communicating with one or more other systems, and peripheral devices 505, such as cache, other memory, data storage and/or electronic display adapters. The memory 502, storage unit 504, interface 503, and peripheral devices 505 are in communication with the processing unit 506 through a communication bus (solid lines), such as a motherboard. The storage unit can be a data storage unit (or data repository) for storing data. The computer system can be operatively coupled to a computer network (“network”) 501 with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

In some embodiments, the processing unit executes a sequence of machine-readable instructions, which can be embodied in a program or software. The instructions may be stored in a memory location, such as the memory 502. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the computer system 500 can be included in the circuit.

In some embodiments, the storage unit 504 stores files, such as drivers, libraries and saved programs. The storage unit can store user data (e.g., user preferences and user programs). In some cases, the computer system can include one or more additional data storage units that are external to the computer system, such as located on a remote server that is in communication with the computer system through an intranet or the Internet.

In some embodiments, the computer system communicates with one or more remote computer systems through a network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. A user (e.g., client) can access the computer system via the network.

In some examples, the methods as described herein are implemented by way of machine (e.g., computer processor) executable code stored on an electronic storage location of the computer system, such as, for example, on the memory 502 or electronic storage unit 504. The machine executable or machine-readable code can be provided in the form of software. During use, the processing unit 506 can execute the code. In some cases, the code can be retrieved from the storage unit and stored on the memory for ready access by the processor. In some situations, the electronic storage unit can be precluded, and machine-executable instructions are stored on memory.

In some embodiments, the code is pre-compiled and configured for use with a machine that has a processor adapted to execute the code or can be compiled during runtime. The code can be supplied in a programming language that can be selected to enable the code to execute in a pre-compiled or as-compiled fashion.

In some embodiments, the processing unit includes one or more cores. The computer system may comprise a single core processor, multi core processor, or a plurality of processors for parallel processing. The processing unit may comprise one or more central processing unit (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may c cache coherency circuitry. The multiple cores may be disposed in close proximity. The physical unit may comprise an integrated circuit chip. The integrated circuit chip may comprise one or more transistors. The integrated circuit chip may comprise at least about 0.2 billion transistors (BT), 0.5 BT, 1 BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. The multiplicity of cores may include at least about 2, 10, 40, 100, 400, 1000, 2000, 3000, 4000, 5000, 6000, 7000, 8000, 9000, 10000, 11000, 12000, 13000, 14000 or 15000 cores. The multiplicity of cores may include at most about 1000, 2000, 3000, 4000, 5000, 6000, 7000, 8000, 9000, 10000, 11000, 12000, 13000, 14000, 15000, 20000, 30000, or 40000 cores. The multiplicity of cores may include cores of any number between the afore-mentioned numbers (e.g., from about 2 to about 40000, from about 2 to about 400, from about 400 to about 4000, from about 2000 to about 4000, from about 4000 to about 10000, from about 4000 to about 15000, or from about 15000 to about 40000 cores). In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating-point operations per second (FLOPS). The number of FLOPS may be at least about 0.1 Tera FLOPS (T-FLOPS), 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 0.2 T-FLOPS, 0.25 T-FLOPS, 0.5 T-FLOPS, 0.75 T-FLOPS, 1 T-FLOPS, 2 T-FLOPS, 3 T-FLOPS, 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1 P-FLOPS, 2 P-FLOPS, 3 P-FLOPS, 4 P-FLOPS, 5 P-FLOPS, 10 P-FLOPS, 50 P-FLOPS, 100 P-FLOPS, 1 EXA-FLOP, 2 EXA-FLOPS, or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS, from about 50 T-FLOPS to about 1 EXA-FLOP, or from about 0.1 T-FLOP to about 10 EXA-FLOPS). In some processors (e.g., FPGA), the operations per second may be measured as (e.g., Giga) multiply-accumulate operations per second (e.g., MACs or GMACs). The MACs value can be equal to any of the T-FLOPS values mentioned herein measured as Tera-MACs (T-MACs) instead of T-FLOPS respectively. The FLOPS can be measured according to a benchmark. The benchmark may be a HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI refers to Message Passing Interface.

In some embodiments, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by NVidia, ATI Technologies, S3 Graphics, Advanced Micro Devices (AMD), or Matrox. The processing unit may be able to process a computational scheme comprising a matrix or a vector. The core may comprise a complex instruction set computing core (CISC), or reduced instruction set computing (RISC).

In some embodiments, the computer system includes an electronic chip that is reprogrammable, e.g., field programmable gate array (FPGA). For example, the FPGA may comprise Tabula, Altera, or Xilinx FPGA. The electronic chips may comprise one or more programmable logic blocks, e.g., an array thereof. The logic blocks may compute combinational functions, logic gates, or any combination thereof. The computer system may include custom hardware. The custom hardware may comprise a computational scheme.

In some embodiments, the computer system includes configurable computing, partially reconfigurable computing, reconfigurable computing, or any combination thereof. The computer system may include a FPGA. The computer system may include an integrated circuit that performs the computational scheme. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration. The FPGA may comprise configurable FPGA logic, and/or fixed-function hardware comprising multipliers, memories, microprocessor cores, first in-first out (FIFO) and/or error correcting code (ECC) logic, digital signal processing (DSP) blocks, peripheral Component interconnect express (PCI Express) controllers, Ethernet media access control (MAC) blocks, or high-speed serial transceivers. DSP blocks can be DSP slices.

In some embodiments, the computing system includes an integrated circuit that performs the computational scheme (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the computational scheme output in at most about 0.1 microsecond (μs), 1 μs, 10 μs, 100 μs, or 1 millisecond (ms). The physical unit may produce the computational scheme output in any time between the above-mentioned times (e.g., from about 0.1 μs, to about 1 ms, from about 0.1 μs, to about 100 μs, or from about 0.1 μs to about 10 μs).

In some instances, the controller uses calculations, real time measurements, or any combination thereof to regulate the energy beam(s). The sensor (e.g., temperature and/or positional sensor) may provide a signal (e.g., input for the controller and/or processor) at a rate of at least about 0.1 KHz, 1 KHz, 10 KHz, 100 KHz, 1000 KHz, or 10000 KHz). The sensor may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processing unit may be at least about 1 gigabyte per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may be at most about 1 gigabyte per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processing unit may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real-time measurements may be conducted during the 3D printing process. The real-time measurements may be in situ measurements in the 3D printing system and/or apparatus, the real-time measurements may be during the formation of the 3D object. In some instances, the processing unit may use the signal obtained from the at least one sensor to provide a processing unit output, which output is provided by the processing system at a speed of at most about 100 min, 50 min, 25 min, 15 min, 10 min, 5 min, 1 min, 0.5 min (i.e., 30 sec), 15 sec, 10 sec, 5 sec, 1 sec, 0.5 sec, 0.25 sec, 0.2 sec, 0.1 sec, 80 milliseconds (msec), 50 msec, 10 msec, 5 msec, 1 msec, 80 microseconds (μsec), 50 μsec, 20 μsec, 10 μsec, 5 μsec, or 1 μsec. In some instances, the processing unit may use the signal obtained from the at least one sensor to provide a processing unit output, which output is provided at a speed of any value between the afore-mentioned values (e.g., from about 100 min to about 1 μsec, from about 100 min to about 10 min, from about 10 min to about 1 min, from about 5 min to about 0.5 min, from about 30 sec to about 0.1 sec, from about 0.1 sec to about 1 msec, from about 80 msec to about 10 μsec, from about 50 μsec to about 1 μsec, from about 20 μsec to about 1 μsec, or from about 10 μsec to about 1 μsec).

In some embodiments, the processing unit computes an output. The processing unit output may comprise an evaluation of the temperature at a location, position at a location (e.g., vertical, and/or horizontal), or a map of locations. The location may be on the target surface. The map may comprise a topological or temperature map. The temperature sensor may comprise a temperature imaging device (e.g., IR imaging device).

In some embodiments, the processing unit uses the signal obtained from the at least one sensor in a computational scheme that is used in controlling the energy beam. The computational scheme may comprise the path of the energy beam. In some instances, the computational scheme may be used to alter the path of the energy beam on the target surface. The path may deviate from a cross section of a model corresponding to the requested 3D object. The processing unit may use the output in a computational scheme that is used in determining the manner in which a model of the requested 3D object may be sliced. The processing unit may use the signal obtained from the at least one sensor in a computational scheme that is used to configure one or more parameters and/or apparatuses relating to the 3D printing process. The parameters may comprise a characteristic of the energy beam. The parameters may comprise movement of the platform and/or material bed. The parameters may comprise relative movement of the energy beam and the material bed. In some instances, the energy beam, the platform (e.g., material bed disposed on the platform), or both may translate. The controller may use historical data for the control. The processing unit may use historical data in its one or more computational schemes. The parameters may comprise the height of the layer of powder material disposed in the enclosure and/or the gap by which the cooling element (e.g., heat sink) is separated from the target surface. The target surface may be the exposed layer of the material bed.

In some examples, aspects of the systems, apparatuses, and/or methods provided herein, such as the computer system, are embodied in programming (e.g., using a software). Various aspects of the technology may be thought of as “product,” “object,” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

In some embodiments, the memory comprises a random-access memory (RAM), dynamic random-access memory (DRAM), static random-access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complemented to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

In some examples, the portions of the software include communication. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution. Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

In some embodiments, the computer system includes or is in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may utilize (e.g., rely on) a feedback mechanism (e.g., from the one or more sensors). The control may utilize (e.g., rely on) historical data. The feedback mechanism (e.g., feedback control scheme) may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output the amount of oxygen, water, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited as optionally output by the output unit.

In some embodiments, the system and/or apparatus described herein (e.g., controller) and/or any of their components comprises an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen.

In some embodiments, the computer system includes, or is in communication with, an electronic display unit that comprises a user interface (UI) for providing, for example, a model design or graphical representation of an object to be printed. Examples of UI's include a graphical user interface (GUI) and web-based user interface. The historical and/or operative data may be displayed on a display unit. The computer system may store historical data concerning various aspects of the operation of the cleaning system. The historical data may be retrieved at predetermined times and/or at a whim. The historical data may be accessed by an operator and/or by a user. The display unit (e.g., monitor) may display various parameters of the printing system (as described herein) in real time or in a delayed time. The display unit may display the requested printed 3D object (e.g., according to a model), the printed 3D object, real time display of the 3D object as it is being printed, or any combination thereof. The display unit may display the cleaning progress of the object, or various aspects thereof. The display unit may display at least one of the total time, time remaining, and time expanded on the cleaned object during the cleaning process. The display unit may display the status of sensors, their reading, and/or time for their calibration or maintenance. The display unit may display the type or types of material used and various characteristics of the material or materials such as temperature and flowability of the pre-transformed material. The particulate material that did not transform to form the 3D object (e.g., the remainder) disposed in the material bed may be flowable (e.g., during the 3D printing process). The display unit may display the amount of a certain gas in the chamber. The gas may comprise oxygen, hydrogen, water vapor, or any of the gasses mentioned herein. The display unit may display the pressure in the chamber. The computer may generate a report comprising various parameters of the methods, objects, apparatuses, or systems described herein. The report may be generated at predetermined time(s), on a request (e.g., from an operator) or at a whim.

In some examples, the methods, apparatuses, and/or systems of the present disclosure are implemented by way of one or more computational schemes. A computational scheme can be implemented by way of software upon execution by one or more computer processors. For example, the processor can be programmed to calculate the path of the energy beam and/or the power per unit area emitted by the energy source (e.g., that should be provided to the material bed in order to achieve the requested result). Examples controllers, computational schemes related to control, 3D printing systems, their components, associated methods of use, software, devices, systems, and apparatuses, can be found in U.S. patent application Ser. No. 17/849,866 filed on Jun. 27, 2022, titled “ACCURATE THREE-DIMENSIONAL PRINTING, which is incorporated herein by reference in its entirety.

In some embodiments, the 3D printer comprises at least one processor (referred herein as the “3D printer processor”). The 3D printer may comprise a plurality of processors. At least two of the plurality of the 3D printer processors may interact with each other. At times, at least two of the plurality of the 3D printer processors may not interact with each other. Discontinuous line 809 illustrates a firewall.

In some embodiments, a 3D printer processor interacts with at least one processor that acts as a 3D printer interface (also referred to herein as “machine interface processor”). The processor (e.g., machine interface processor) may be stationary or mobile. The processor may be a remote computer system. The machine interface one or more processors may be connected to at least one 3D printer processor. The connection may be through a wire (e.g., cable) or be wireless (e.g., via Bluetooth technology). The machine interface may be hardwired to the 3D printer. The machine interface may directly connect to the 3D printer (e.g., to the 3D printer processor). The machine interface may indirectly connect to the 3D printer (e.g., through a server, or through wireless communication). The cable may comprise coaxial cable, shielded twisted cable pair, unshielded twisted cable pair, structured cable (e.g., used in structured cabling), or fiber-optic cable.

In some embodiments, the machine interface processor directs 3D print job production, 3D printer management, 3D printer monitoring, or any combination thereof. The machine interface processor may not be able to influence (e.g., direct, or be involved in) pre-print or 3D printing process development. The machine management may comprise controlling the 3D printer controller (e.g., directly, or indirectly). The printer controller may direct start of a 3D printing process, stopping a 3D printing process, maintenance of the 3D printer, clearing alarms (e.g., concerning safety features of the 3D printer).

In some embodiments, the machine interface processor allows monitoring of the 3D printing process (e.g., accessible remotely or locally). The machine interface processor may allow viewing a log of the 3D printing and status of the 3D printer at a certain time (e.g., 3D printer snapshot). The machine interface processor may allow to monitor one or more 3D printing parameters. The one or more printing parameters monitored by the machine interface processor can comprise 3D printer status (e.g., 3D printer is idle, preparing to 3D print, 3D printing, maintenance, fault, or offline), active 3D printing (e.g., including a build module number), status and/or position of build module(s), status of build module and processing chamber engagement, type and status of pre-transformed material used in the 3D printing (e.g., amount of pre-transformed material remaining in the reservoir), status of a filter, atmosphere status (e.g., pressure, gas level(s)), ventilator status, layer dispensing mechanism status (e.g., position, speed, rate of deposition, level of exposed layer of the material bed), status of the optical system (e.g., optical window, mirror), status of scanner, alarm (boot log, status change, safety events, motion control commands (e.g., of the energy beam, or of the layer dispensing mechanism), or printed 3D object status (e.g., what layer number is being printed),

In some embodiments, the machine interface processor allows monitoring the 3D print job management. The 3D print job management may comprise status of each build module (e.g., atmosphere condition, position in the enclosure, position in a queue to go in the enclosure, position in a queue to engage with the processing chamber, position in queue for further processing, power levels of the energy beam, type of pre-transformed material loaded, 3D printing operation diagnostics, status of a filter. The machine interface processor (e.g., output device thereof) may allow viewing and/or editing any of the job management and/or one or more printing parameters. The machine interface processor may show the permission level given to the user (e.g., view, or edit). The machine interface processor may allow viewing and/or assigning a certain 3D object to a particular build module, prioritize 3D objects to be printed, pause 3D objects during 3D printing, delete 3D objects to be printed, select a certain 3D printer for a particular 3D printing job, insert and/or edit considerations for restarting a 3D printing job that was removed from 3D printer. The machine interface processor may allow initiating, pausing, and/or stopping a 3D printing job. The machine interface processor may output message notification (e.g., alarm), log (e.g., other than Excursion log or other default log), or any combination thereof.

In some embodiments, the 3D printer interacts with at least one server (e.g., print server). The 3D print server may be separate or interrelated in the 3D printer.

In some embodiments, one or more users interact with the one or more 3D printing processors through one or more user processors (e.g., respectively). The interaction may be in parallel and/or sequentially. The users may be clients. The users may belong to entities that request a 3D object to be printed, or entities who prepare the 3D object printing instructions. The one or more users may interact with the 3D printer (e.g., through the one or more processors of the 3D printer) directly and/or indirectly. Indirect interaction may be through the server. One or more users may be able to monitor one or more aspects of the 3D printing process. One or more users can monitor aspects of the 3D printing process through at least one connection (e.g., network connection). For example, one or more users can monitor aspects of the printing process through direct or indirect connection. Direct connection may be using a local area network (LAN), and/or a wide area network (WAN). The network may interconnect computers within a limited area (e.g., a building, campus, neighborhood). The limited area network may comprise Ethernet or Wi-Fi. The network may have its network equipment and interconnects locally managed. The network may cover a larger geographic distance than the limited area. The network may use telecommunication circuits and/or internet links. The network may comprise Internet Area Network (IAN), and/or the public switched telephone network (PSTN). The communication may comprise web communication. The aspect of the 3D printing process may comprise a 3D printing parameter, machine status, or sensor status. The 3D printing parameter may comprise hatch strategy, energy beam power, energy beam speed, energy beam focus, thickness of a layer (e.g., of hardened material or of pre-transformed material).

In some embodiments, a user develops at least one 3D printing instruction and directs it to the 3D printer (e.g., through communication with the 3D printer processor) to print in a requested manner according to the developed at least one 3D printing instruction. A user may or may not be able to control (e.g., locally, or remotely) the 3D printer controller. For example, a client may not be able to control the 3D printing controller (e.g., maintenance of the 3D printer).

In some embodiments, the user (e.g., other than a client) processor uses real-time and/or historical 3D printing data. The 3D printing data may comprise metrology data, or temperature data. The user processor may comprise quality control. The quality control may use a statistical method (e.g., statistical process control (SPC)). The user processor may log excursion log, report when a signal deviates from the nominal level, or any combination thereof. The user processor may generate a configurable response. The configurable response may comprise a print/pause/stop command (e.g., automatically) to the 3D printer (e.g., to the 3D printing processor). The configurable response may be based on a user defined parameter, threshold, or any combination thereof. The configurable response may result in a user defined action. The user processor may control the 3D printing process and ensure that it operates at its full potential. For example, at its full potential, the 3D printing process may make a maximum number of 3D object with a minimum of waste and/or 3D printer down time. The SPC may comprise a control chart, design of experiments, and/or focus on continuous improvement.

In some embodiments, the user (e.g., non-client) processor comprises a pre-print non-transitory computer-readable medium (e.g., software). The pre-print non-transitory computer-readable medium may comprise a workflow. The work flow may comprise (1) importing a model geometry of a requested 3D object, (2) repairing the requested 3D object geometry, (3) inputting 3D printing parameters (also referred to herein as “process parameters”) to the requested 3D object geometry, (4) selecting or inputting a preferred orientation of the 3D object in the material bed according to which orientation the requested 3D object will be printed, (5) creating or adding auxiliary support geometry to the requested 3D object model, (6) optimizing the geometry and/or number of auxiliary supports (e.g., using at least one simulation), (7) optimizing the orientation of the 3D object (e.g., using at least one simulation), (8) creating a layout of individual parts in a material bed. So, that several could be printed together. The process parameters may comprise pre-transformed material type, hatching scheme, energy beam characteristic (e.g., varied energy beam characteristic disclosed herein), deformation tolerance, surface roughness tolerance, target porosity of the hardened material, resolution. The workflow may further comprise an object pre-correction operation (e.g., OPC). The OPC may depend on the process parameters. The OPC may comprise using at least one simulation. For example, the OPC may be added to the workflow after (2) repairing the requested 3D object geometry. For example, the OPC may be added to the workflow before (8) creating a layout of individual parts in a material bed. The order of workflow operations (3) to (8) may be interchangeable. Any of the operations (3) to (8) may be omitted from the workflow. The workflow may comprise repeating any of the operations (3) to (8) until an optimized workflow is formed. Optimized may be in terms of 3D print time, quality of the 3D object (e.g., minimal deformation, resolution, density), amount of pre-transformed material used, energy used, gas used, electricity used, heat excreted, or any combination thereof. The repair the 3D object model geometry may be such that the geometry of the requested 3D object is watertight. Watertight geometry refers to a geometry that includes continuous a surface(s). The orientation of the 3D object may comprise a deviation from its natural position.

In some embodiments, the work flow facilitates printing a portion of the 3D object. The fundamental length scale (e.g., the diameter, spherical equivalent diameter, diameter of a bounding circle, or largest of height, width and length; abbreviated herein as “FLS”) of the printed 3D object or a portion thereof can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object or a portion thereof can be at most about 150 μm, 170 μm, 200 μm, 230 μm, 250 μm, 270 μm, 300 μm, 400 μm, 500 μm, 600 μm, 700 μm, 800 μm, 1 mm, 1.5 mm, 2 mm, 3 mm, 5 mm, 1 cm, 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m, 500 m, or 1000 m. The FLS of the printed 3D object or a portion thereof can any value between the afore-mentioned values (e.g., from about 50 μm to about 1000 m, from about 500 μm to about 100 m, from about 50 μm to about 50 cm, or from about 50 cm to about 1000 m). In some cases, the FLS of the printed 3D object or a portion thereof may be in between any of the afore-mentioned FLS values. The portion of the 3D object may be a heated portion or disposed portion (e.g., tile).

In some embodiments, the layer of pre-transformed material (e.g., powder) is of a predetermined height (thickness). The layer of pre-transformed material can comprise the material prior to its transformation in the 3D printing process. The layer of pre-transformed material may have an upper surface that is substantially flat, leveled, or smooth. In some instances, the layer of pre-transformed material may have an upper surface that is not flat, leveled, or smooth. The layer of pre-transformed material may have an upper surface that is corrugated or uneven. The layer of pre-transformed material may have an average or mean (e.g., pre-determined) height. The height of the layer of pre-transformed material (e.g., powder) may be at least about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, or 1000 mm. The height of the layer of pre-transformed material may be at most about 5 micrometers (μm), 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, 100 mm, 200 mm, 300 mm, 400 mm, 500 mm, 600 mm, 700 mm, 800 mm, 900 mm, or 1000 mm. The height of the layer of pre-transformed material may be any number between the afore-mentioned heights (e.g., from about 5 μm to about 1000 mm, from about 5 μm to about 1 mm, from about 25 μm to about 1 mm, or from about 1 mm to about 1000 mm). The “height” of the layer of material (e.g., powder) may at times be referred to as the “thickness” of the layer of material. In some instances, the layer of hardened material may be a sheet of metal. The layer of hardened material may be fabricated using a 3D manufacturing methodology. Occasionally, the first layer of hardened material may be thicker than a subsequent layer of hardened material. The first layer of hardened material may be at least about 1.1 times, 1.2 times, 1.4 times, 1.6 times, 1.8 times, 2 times, 4 times, 6 times, 8 times, 10 times, 20 times, 30 times, 50 times, 100 times, 500 times, 1000 times, or thicker (higher) than the average (or mean) thickness of a subsequent layer of hardened material, the average thickens of an average subsequent layer of hardened material, or the average thickness of any of the subsequent layers of hardened material.

In some instances, one or more intervening layers separate adjacent components from one another. For example, the one or more intervening layers can have a thickness of at most about 10 micrometers (“microns”), 1 micron, 500 nanometers (“nm”), 100 nm, 50 nm, 10 nm, or 1 nm. For example, the one or more intervening layers can have a thickness of at least about 10 micrometers (“microns”), 1 micron, 500 nanometers (“nm”), 100 nm, 50 nm, 10 nm, or 1 nm. In an example, a first layer is adjacent to a second layer when the first layer is in direct contact with the second layer. In another example, a first layer is adjacent to a second layer when the first layer is separated from the second layer by a third layer. In some instances, adjacent to may be ‘above’ or ‘below.’ Below can be in the direction of the gravitational force or towards the platform. Above can be in the direction opposite to the gravitational force or away from the platform.

In some embodiments, 3D printing system comprises a material conveyance system, e.g., a powder conveyance system. The material conveyance system may facilitate recycling pre-transformed material for reuse in a 3D printing process. The material conveyance system may be coupled to a processing chamber having a layer dispensing mechanism, e.g., a recoater. Pre-transformed material (e.g., powder) from a reservoir (e.g., hopper) can be introduced into the layer dispensing mechanism disposed in the processing chamber or in an ancillary chamber (e.g., a garage) coupled to a processing chamber. The layer dispensing mechanism comprises a material dispenser and a material remover. After the material dispenser dispenses a layer of pre-transformed material, excess material may be attracted away from the material bed using the material remover, to form a (e.g., substantially) a layer having a planar exposed surface as part of the material bed. In this process, excess pre-transformed material may be attracted away from the material bed and conveyed to a separator (e.g., first cyclone), and optionally to an overflow separator (e.g., second cyclone). The pre-transformed material may undergo separation (e.g., cyclonic separation) in separator(s), and may be introduced into sieve(s), and into lower reservoir(s). The flow to the lower reservoir(s) may utilize a gravitational flow. The separated (e.g., and sieved) pre-transformed material can be then delivered back into the layer dispensing mechanism. The separator may be coupled to sieve(s) instead of to, or in addition to, the reservoir. The material conveyance system may comprise one or more pumps, and a temperature conditioning system. The pump(s) may be any of the ones disclosed herein, e.g., displacement pump and/or compressor pump. The pump(s) may be temperature conditioning system may be any of the ones disclosed herein, e.g., comprising a heater or radiator such as a radiant plane. The material conveyance system may comprise a venturi nozzle, e.g., to facilitate suction of the pre-transformed material from one compartment to the other coupled at least in part by the venturi nozzle such as from the reservoir into a separator. The material conveyance system can comprise a condensed gas source, e.g., a blower or a condensed gas cylinder. The conveyance system may comprise at least one heat exchanger. The conveyance system may include one or more filters. The conveyance system may operate at an atmosphere different by one or more characteristic from an ambient atmosphere external to the conveyance system, e.g., in a positive pressure above ambient pressure external to the conveyance system (e.g., above about one atmosphere). The gas conveyance system may be configured to circulate gas also in the processing chamber. The gas conveyance system may sweep debris (e.g., soot, spatter, and/or splatter) away from the process area in which the 3D object is being printed. At times, a pressure differential is required to convey pre-transformed material from one compartment of the 3D printer to another. The pressure differential may be established via pressurizing or vacuuming one or more compartments. The pressure differential may be at a pressure different than the ambient pressure. For example, the pressure differential may be at a pressure above ambient pressure. For example, pre-transformed material from the layer dispensing system to the recycling system may be conveyed using (a) induced pressure differential among components, (b) pressure isolation of the components, and/or (c) induced pressure equilibration of components.

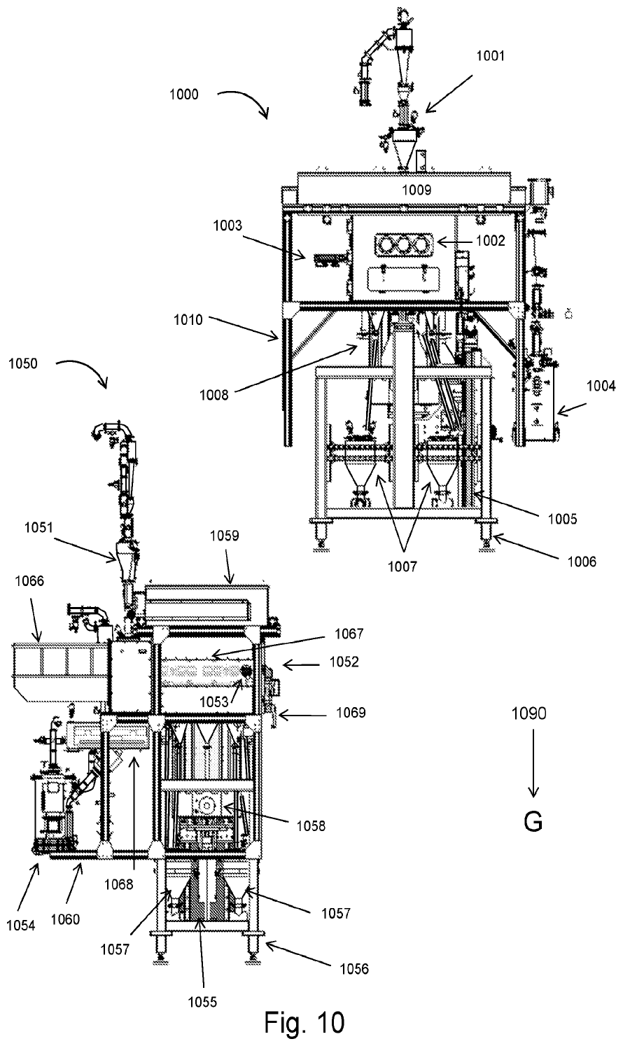

FIG. 10 shows in example 1000 a front side example of a portion of a 3D printing system comprising a material reservoir 1001 configured to feed pre-transformed material to a layer dispensing mechanism, an enclosure 1009 enclosing, e.g., scanners and/or directors (e.g., optical system) of at least one energy beam (e.g., laser beam) configured to transform the pre-transformed material into a transformed material to print one or more 3D object in a printing cycle. Example 1000 of FIG. 10 shows a processing chamber 1002 having a door and three circular windows. The windows may be any window disclosed herein. The window may be a single or a double pane window. The window may be an insulated glass unit (IGU), the window may be configured to withstand positive pressure within the processing chamber, e.g., during printing. The positive pressure is above ambient pressure external to the build module, e.g., of about one atmosphere. Example 1000 show a material reservoir 1004 configured to accumulate recycled remainder from the layer dispensing process to form a material bed and/or a remainder of the material bed that did not form one or more 3D objects during a printing cycle, post 1005 as part of an elevator mechanism of build module 1008; two material reservoirs 1007 for accumulating a remainder of the material bed that did not form the 3D object, and actuator 1003 configured to translate the layer dispensing mechanism to dispense a layer of pre-transformed material as part of a material bed. Supports 1006 are planarly stationed in a first horizontal plane, which supports 1006 and associated framing support one section of the 3D printing system portion 1000, and framing 1010 is disposed on a second horizontal plane higher than the first horizontal plane. FIG. 10 shows in 1050 a side view example of a portion of the 3D printing system shown in example 1000, which side view comprises a material reservoir 1051 configured to feed pre-transformed material to a layer dispensing mechanism, an enclosure 1059 enclosing, e.g., scanners and/or directors (e.g., optical system) of at least one energy beam (e.g., laser beam) configured to transform the pre-transformed material into a transformed material to print one or more 3D object in a printing cycle. Example 1050 of FIG. 10 shows a processing chamber 1052 having a door comprising handle 1069. Example 1000 show a material reservoir 1054 configured to accumulate recycled remainder from the layer dispensing process to form a material bed and/or a remainder of the material bed that did not form one or more 3D objects during a printing cycle, a portion of the material conveyance system 1068 configured to convey the material to reservoir 1054. The material conveyed to reservoir 1054 may be separated (e.g., sieved) before reaching reservoir 1054. The example shown in 1050 shows post 1055 as part of an elevator mechanism of build module 1058; two material reservoirs 1057 for accumulating a remainder of the material bed that did not form the 3D object, and actuator 1053 configured to translate the layer dispensing mechanism to dispense a layer of pre-transformed material as part of a material bed, e.g., along railing 1067 in processing chamber and into garage 1066 in a reversible (e.g., back and forth) movement. Supports 1056 are planarly stationed in a first horizontal plane, which supports 1006 and associated framing support one section of the 3D printing system portion 1050, and framing 1060 is disposed on a second horizontal plane higher than the first horizontal plane. In FIG. 10, the 3D printing system components are aligned with respect to gravitational vector 1090 pointing towards gravitational center G.

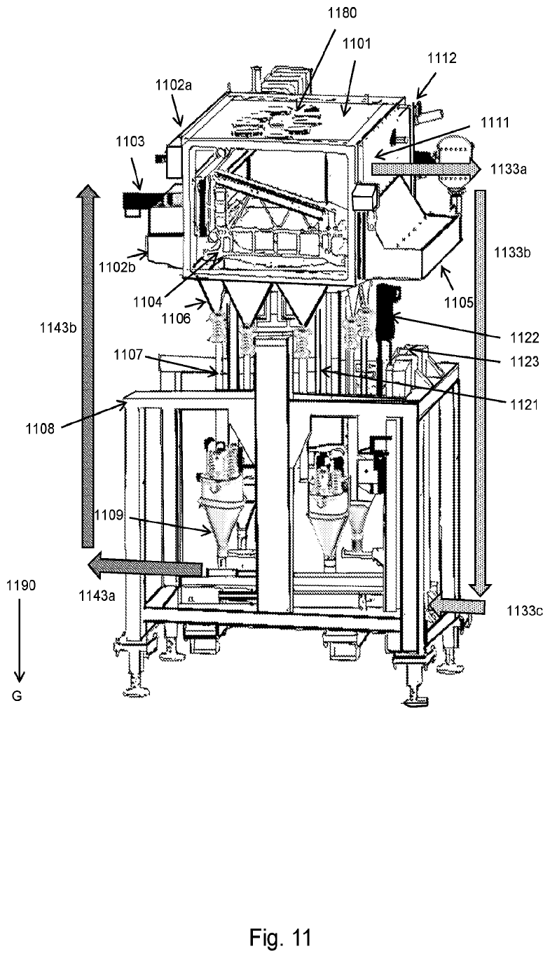

FIG. 11 shows a perspective view example of a portion of a 3D printing system including a processing chamber having a roof 1101 in which optical windows are disposed to facilitate penetration of an energy beam into the processing chamber interior space, side wall 1111 having a gas exit port covering 1105 coupled thereto. The processing chamber has two gas entrance port coverings 1102a and 1102b coupled to an opposing wall to side wall 1111. The opposing wall is coupled to an actuator 1103 configured to facilitate translation of a layer dispensing mechanism mounted on a framing 1104 above a base disposed adjacent to a floor of the processing chamber, which framing is configured to translate back and forth in the processing chamber along railings. The processing chamber floor has slots through which remainder material can flow downwards towards gravitational center G along gravitational vector 1190. The slots are coupled to funnels such as 1106 that are connected by channels (e.g., pipes) such as 1107 to material reservoir such as 1109. The processing chamber is coupled to a build module 1121 that comprises a substrate to which the base is attached, which substrate is configured to vertically translate with the aid of actuator 1122 coupled to an elevator motion stage (e.g., supporting plate) 1123 via a bent arm. The elevator motion stage and coupled components are supported by framing 1108 that is missing a beam (e.g., 4180) removed (e.g., for installation and/or maintenance). Atmosphere (e.g., content and/or pressure) may be equilibrated between the material reservoirs and the processing chamber via schematic channel (e.g., pipe) portions 1133a-c. Remainder material in the material reservoirs may be conveyed via schematic channels (e.g., pipes) 1143a-b to a material recycling system, e.g., for future use in printing. The components of the 3D printing system are disposed relative to gravitational vector 1190 pointing to gravitational center G.

In some embodiments, the 3D printing system comprises an unpacking station that is integral with the 3D printing system, e.g., to facilitate unpacking of the printed 3D object(s) in the processing chamber. The processing chamber may comprise a slotted floor to facilitate the unpacking process, e.g., to allow any remainder of the material bed that did not form the 3D object(s), to flow there through. The processing chamber may comprise a respective slot (e.g., hole) covering configured to reversibly cover and uncover at least one of the slots of the slotted floor to selectively facilitate the unpacking process. The processing chamber may comprise a plurality of slot coverings, e.g., two or more, three or more, or four or more slot coverings, each configured to cover one or more (e.g., a plurality of) slots in the slotted floor of the processing chamber. The slot coverings may be manually and/or automatically actuated, e.g., reversibly opened and closed. The slot coverings may have an extended dimension, e.g., length, aligned with an array (e.g., linear array) of slots in the slotted floor of the processing chamber. The slot covering may comprise a straight portion, e.g., a portion covering at least one slot of the slotted floor. The slot covering may comprise a curved portion, e.g., a curvature in place of a corner of the slot covering. Slot coverings may include curved features where an inner perimeter and an outer perimeter defined by the slot coverings define squares having rounded edges with respective degrees of curvature. At least two of the degrees of curvature of each of the inner perimeter and the outer perimeter may be different. At least two of the degrees of curvature of each of the inner perimeter and the outer perimeter may be (e.g., substantially) the same. A degree of curvature of the inner perimeter may be larger than a degree of curvature of an outer perimeter. The slot covering may comprise a tab, e.g., a flap, arranged with respect to the processing chamber and aligned with a sensor and/or with an actuator. The tab may be aligned with the sensor such that the tab compresses, covers, blocks, or otherwise engages the sensor, e.g., while the slot covering is in a closed position. The tab may be aligned with the actuator such that the tab can engage with the actuator when in the closed and/or in the open position of the tab. The tab may comprise an extended curved portion of the slot covering. The tab may comprise a rectangular portion extending perpendicularly from a length of the slot covering. In some embodiments, the tab may extend towards the platform retained in the processing chamber, e.g., toward a center point of the platform. A portion of the tab may be visible in a field of view of at least one sensor (e.g., detector) of a metrological detection system. A portion of the tab may be visible in a field of view of at least one energy beam (e.g., of an optical assembly). In some embodiments, the tab is excluded from a field of view of at least one sensor (e.g., detector) of a metrological detection system. In some embodiments, the tab is excluded from a field of view of at least one energy beam utilized in the 3D printing to print the 3D object(s) in a printing cycle. The energy beams may be part of an array of energy beams. The 3D objects may be printed anchorlessly in the material bed.

In some embodiments, the slot coverings (e.g., flaps) comprise a pivoting mechanism (e.g., hinges, links, pins, or springs) configured to facilitate the reversible covering and uncovering of the at least one of the slots of the slotted floor. The reversible covering and uncovering of the at least one of the slots of the slotted floor may be controlled, e.g., manually or by at least one controller such as disclosed herein. A pivoting mechanism (e.g., the hinges) may be configured to affix a slot covering to the floor of the processing chamber. The pivoting mechanism may be arranged with respect to the slot coverings such that, when the slot coverings are in a “closed” position, the pivoting of the pivoting mechanism exerts minimal (e.g., zero) protrusion (I) above an exposed surface of the slot covering into the processing chamber, and/or (II) above an exposed surface of a floor of a processing chamber. The slot coverings may comprise fixtures (e.g., latches, pins, locks, tabs) configured to affix the slot covering to the floor of the processing chamber, e.g., when the slot coverings are in a “closed” position. The pivoting mechanism may comprise the fixtures.

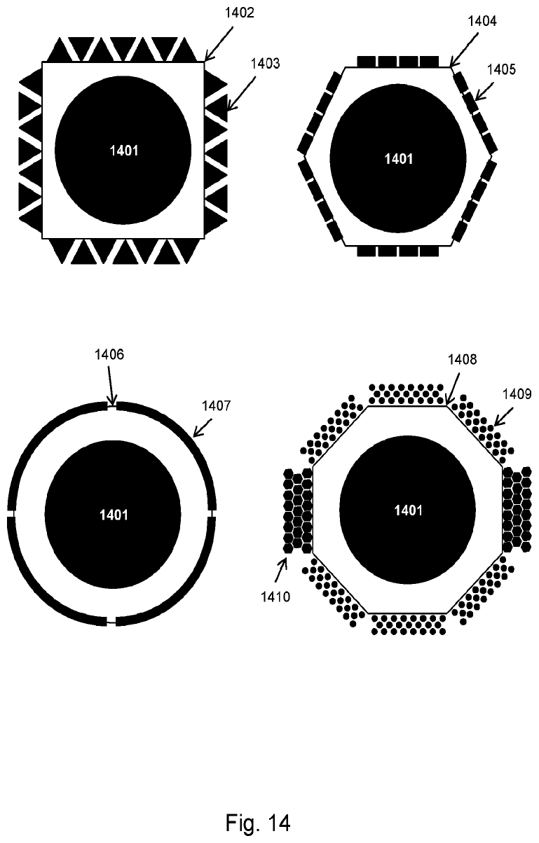

In some embodiments, the slot coverings comprise, or be operatively coupled to, at least one actuator, e.g., any actuator recited herein. The actuator may be configured to (A) reversibly open and close at least one slot covering, (B) secure (e.g., affix) at least one slot covering in a first position (e.g., open position) with respect to the slotted floor of the processing chamber, and (C) secure at least one slot covering in a second position (e.g., closed position) with respect to the slotted floor of the processing chamber. The actuator may comprise a seal configured to hinder (e.g., prevent or substantially prevent) the pre-transformed material from flowing around or below the actuator, e.g., with respect to a gravitational center of the 3D printing system. The seal may comprise any seal disclosed herein. The seal may comprise a polymer or a resin, e.g., as disclosed herein. For example, the seal may comprise rubber. For example, the seal may comprise a bellow. The actuator may comprise one or more bellows. The below may be reversibly extendable and retractable, e.g., to protect a portion of the actuator during actuation. The actuator may be operatively coupled to at least one slot covering, e.g., at least two slot coverings. For example, the actuator may be coupled to two slot coverings such that when the actuator is actuated, the two slot coverings coupled to the actuator are reversibly opened or reversibly closed. At times, the unpacking station may comprise at least two actuators. At times, the unpacking station may comprise at least four actuators. The four actuators may be located at respective corners (e.g., at the ends) of slot coverings (e.g., four slot coverings). At times, two actuators are sufficient to operate the four slot coverings, but more actuators are installed, e.g., for backup. For example, while two actuators are sufficient to operate the four slot coverings, four actuators are installed, e.g., for backup. For example, an actuator may be disposed between two slot coverings such that the actuator's associated positioning with respect to the coverings control the open/closed positions of the slot coverings. For example, an actuator may be disposed between every two slot coverings. In some embodiments, every other actuator may be sufficient to operate the open/closed positioning of its two immediately adjacent slots covering. In some embodiments, every other actuator is operative to facilitate opening/closing the slot covering(s), while the rest of the actuators function as reserves. The slots may be arranged in sets, and an actuator may be disposed between two immediately adjacent sets. Each set of slots may be covered by a covering configured to reversibly open and close the slot set. For example, four actuators may be disposed each at a corner of a rectangle such as the one in FIG. 14, 1402 designating a floor of the unpacking chamber and/or processing chamber, e.g., the processing chamber acting as the unpacking chamber during the unpacking. The slots may be disposed as four sets around each side of the rectangle, such as the slot set including slot 1403. Two opposing corners along the square's diagonal may be functional actuators, while the two remaining corners may be idle and/or redundant actuators. The idle and/or redundant actuator may function as reserve in case a respective functional actuator malfunctions, e.g., becomes clogged or otherwise fails. The floor of the processing chamber (functioning as the unpacking chamber) may comprise at least one reserve actuator. The actuator may contact at least one slot covering, e.g., may contact two immediately adjacent slot coverings. The actuator may contact and not couple to the at least one slot covering. The actuator may contact and coupled to the at least one slot covering. In some embodiments, the actuator comprises an engagement structure configured to engage with a corresponding engagement structure on at least one slot covering. The engagement structure may comprise a hook, latch, pin, or clip. The engagement structure may comprise a beveled (e.g., tapered, oblique, curved) feature configured to engage with a corresponding feature on at least one slot covering. The beveled structure may engage with the corresponding feature of the slot covering, e.g., to adjust a position (e.g., open and/or closed) of the slot covering with respect to the floor of the processing chamber. For example, the beveled structure may facilitate pushing the slot covering into an open position as the actuator extends to a first position to push the beveled structure (e.g., portion). For example, the beveled structure may facilitate pulling the slot covering, retracting the slot covering, or allowing the slot covering to fall (e.g., using gravity), into a closed position as the actuator retracts to a second position. The second position retracts away from an exposed surface of a build plate, e.g., relative to the first position. The second position retracts towards the gravitational center of the ambient environment, e.g., relative to the first position. The beveled structure may engage to secure the slot covering in the closed position (e.g., lock the slot covering into the closed position).

In some embodiments, the unpacking station comprises, or is operatively coupled to, at least one sensor. The actuator may comprise, or be operatively coupled to, at least one sensor, e.g., any sensor recited herein. The sensor may be configured to measure a position of the actuator, e.g., to measure a state of the actuator. For example, whether the actuator is in an extended or retracted state. The sensor may be configured to measure a position of a portion of the actuator with respect to (i) at least one slot covering and/or (ii) an exposed surface (e.g., upper surface) of the slotted floor of the processing chamber. Sensor data from the sensor may be utilized to determine an “open” or “closed” state (I) of the actuator and/or (II) at least one slot covering coupled to the actuator. The slot covering may comprise, or be operatively coupled to, a sensor. The sensor may be a magnetic sensor. The sensor may be arranged with respect to the slot covering, e.g., such that the sensor data can be utilized to distinguish between an open and closed position of the slot covering. The sensor may be a proximity sensor. The sensor may be arranged with respect to the slot covering, e.g., such that sensor data can be utilized to distinguish between an open and closed position of the slot covering. The sensor and/or actuator may be disposed below a thickness of the processing chamber floor. For example, the sensor may be located on an opposing surface of the floor in a direction (I) away from optical windows of the processing chamber and/or (II) towards an environmental gravitational center. For example, the sensor may be located on an opposing surface of the floor in a direction such that when the slot covering is in a closed position, the sensor will detect the slot covering, e.g., detect the metal composing the slot covering. The floor of the processing chamber may comprise, or be operatively coupled to, at least one sensor. A sensor may be arranged with respect to a slot covering at the floor of the processing chamber, e.g., such that sensor data from the sensor may be utilized to determine an “open” or “closed” state of the slot covering. For example, the sensor may be countersunk into and/or below the floor of the processing chamber. For example, the sensor may be arranged below the slot covering. For example, the sensor may be arranged such that when the slot covering is a closed position, the sensor will detect the slot covering, e.g., detect the metal composing the slot covering.

In some embodiments, the unpacking process includes the following operations: (i) opening slot covering at the end of a printing cycle, (ii) raising (e.g., slowly) the build plate to allow the remainder to spill into the slots in the processing chamber floor, (iii) once all the remainder has spilled into the slots, the covering of the slots are lowered to shut the slots. The material remainder can optionally return to be recycled and used in subsequent printing cycle(s). In some embodiments, the covering of the slots remain open, or are absent. The remainder may accumulate at one or more material reservoirs situated below the slots. The remainder material may fall into the slots and/or material reservoir(s) (e.g., hoppers) as it is attracted by gravity. The unpacking station may include a slotted floor, covering (e.g., flaps), actuator (e.g., pneumatic actuator or any other actuator disclosed herein), guide, a material reservoir, and/or a valve. The guide may comprise a channel or a funnel. The funnel may comprise a planar side or a curved side. The funnel may have an elongated opening or round opening. The funnel may have an opening that engulfs a FLS of one or more floor slots, e.g., a length of one or more slots, and/or a width of one or more slots. The slots may be arranged in a geometric shape concentric with the base (e.g., build plate). The geometric shape of the build plate and the slot arrangement can be the same or different. For example, the slots can be arranged along a rectangle whereas the build plate may be circular. The reservoir(s) have the same environment, or a different environment as compared to that of the processing chamber.

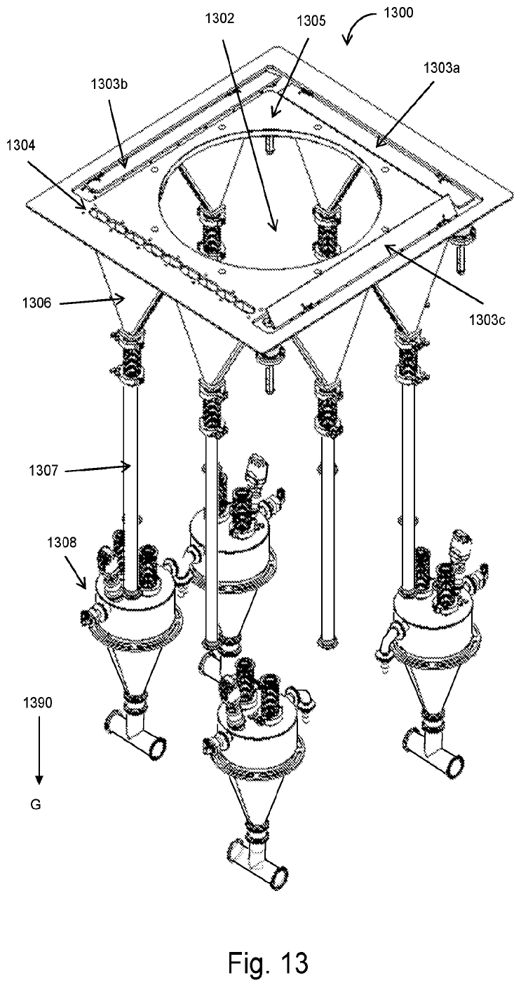

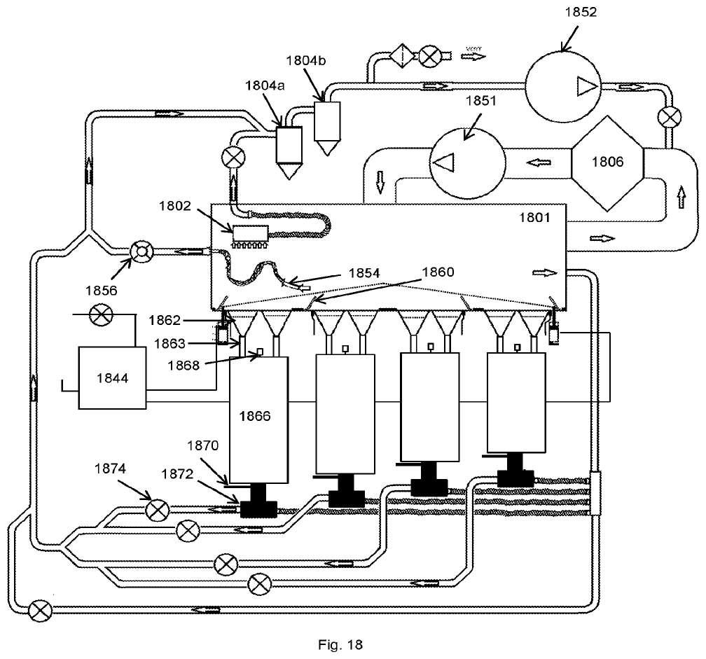

FIG. 13 shows a perspective view example of a portion of a 3D printing system including processing chamber floor 1305 having an opening 1302 configured to fit a base (e.g., build plate), opening 1304 (e.g., holes such as slits) configured to facilitate flow of material remainder therethrough, flap 1303a and 1303b configured to shut the openings and prevent flow of material through, which flaps can be configured to shut and open. Flap 1303c shows an example of an open flap. Flap 1303a and flap 1303b show examples of shut flaps, and openings 1304 show an example of openings arranged in a single file that are devoid of a flap. The openings are arranged along a circumference (e.g., sides) of rectangle concentric with the (e.g., circular hole) opening 1302. The openings are coupled (e.g., connected) to funnels such as 1306, with two funnels coupled to every side of the rectangle along which the openings are arranged. Each funnel (e.g., 1306) is connected to a channel (e.g., 1307) configured to facilitate flow of material remainder to collection reservoirs. In the example shown in FIG. 13, the collection reservoirs are not aligned with the reservoirs to connect to the channels, e.g., for presentation purposes. However, in a working 3D printing system, the channels would be connected to the reservoirs respectively, e.g., as is shown in the example of FIG. 18. The funnels may or may not be connected to form one top opening. For example, the funnels along a file of openings maybe connected to form one top opening. For example, some of the funnels may be connected to form one top opening, and some of the funnels may not be connected to form one top opening. For example, funnels of different side of the geometric shape along which circumference the openings are arranged, may be disconnected.

In some embodiments, openings (e.g., holes such as slits) are disposed in the floor of the processing chamber to facilitate in-situ removal of a remainder of the material bed that did not form 3D object(s). The openings can be a plurality of openings of any shape. The openings can have a geometric shape such as a rectangle, triangle, oval, or oblong shape. The openings can have an aspect ratio greater than, or equal to about 1:1. For example the openings can have an aspect ratio of at least about 1.5:1, 2:1, 2.5:1, 3:1, or 4:1 of length:width (length to width) of the shape. The FLS (e.g., length or width) of the hole may be at least about 10 millimeters (mm), 15 mm, 20 mm, 25 mm, 30 mm, 50 mm, 60 mm, 70 mm, 80 mm, 90 mm, or 100 mm. The FLS (e.g., length or width) of the hole may be at most about 15 mm, 20 mm, 25 mm, 30 mm, 50 mm, 60 mm, 70 mm, 80 mm, 90 mm, 100 mm, or 150 mm. The FSL of the hole may be between any of the aforementioned values (e.g., from about 10 mm to about 50 mm, from about 50 mm to about 100 mm, or from about 10 mm to about 150 mm). The openings can be elongated. The openings can be disposed around an opening configured to fit a base above which the 3D object(s) are printed during the 3D printing process. Around the opening can be along a circumference of a two-dimensional shape disposed on the floor of the processing chamber. The shape can be a geometric shape. The shape can have a surface having a FLS greater than that of the base. The shape can be a convex or a concave shape. The shape can be a polygon. Openings can be arranged on one or more parallel lines along the perimeter of the shape. For example, the openings can form a mesh along the perimeter of the shape. The number of openings along a side of a polygonal shape can comprise 1, 2, 3, 4, 5, 6, 7, 8, 9, 10, 15, 20, or more openings. At least two of the openings may be different (e.g., different shape or FLS). At least two of the openings may be the same (e.g., different shape or FLS). The flap may open (e.g., with the aid of the actuator) to an angle (e.g., 5655) of at most about 20°, 35°, 50°, 55°, 70°, or 80°. The flap may open (e.g., with the aid of the actuator) to an angle of at most about 30°, 35°, 50°, 55°, 70°, 80° or 90°. The flap may open to any angle between the aforementioned angles with respect to the processing chamber floor (e.g., from about 20° to about, 90°, from about 20° to about, 70°, or from about 50° to about, 90°).

FIG. 14 shows an example of platform (e.g., build plate) 1401 around which various openings are arranged around a peripheral of a geometric shape. Triangular openings such as 1403 are arranged in double rows along square circumference 1402; rectangular openings such as 1405 are arranged along hexagon circumference 1404 in single files; arched openings such as 1407 are arranged along circular circumference 1406; and various openings are arranged along octagonal circumference 1408, which includes two types of openings: circular openings such as 1409 and hexagonal openings such as 1410. The openings are arranged in respective arrays (e.g., closed packed arrays). The opening can be elongated. The opening can comprise a straight portion or a bent portion. Longer openings may be more structurally weak, e.g., more susceptible to mechanical deformation, the less robust the opening is. For example, opening 1407 may be weaker structurally as compared to opening array having opening 1409.

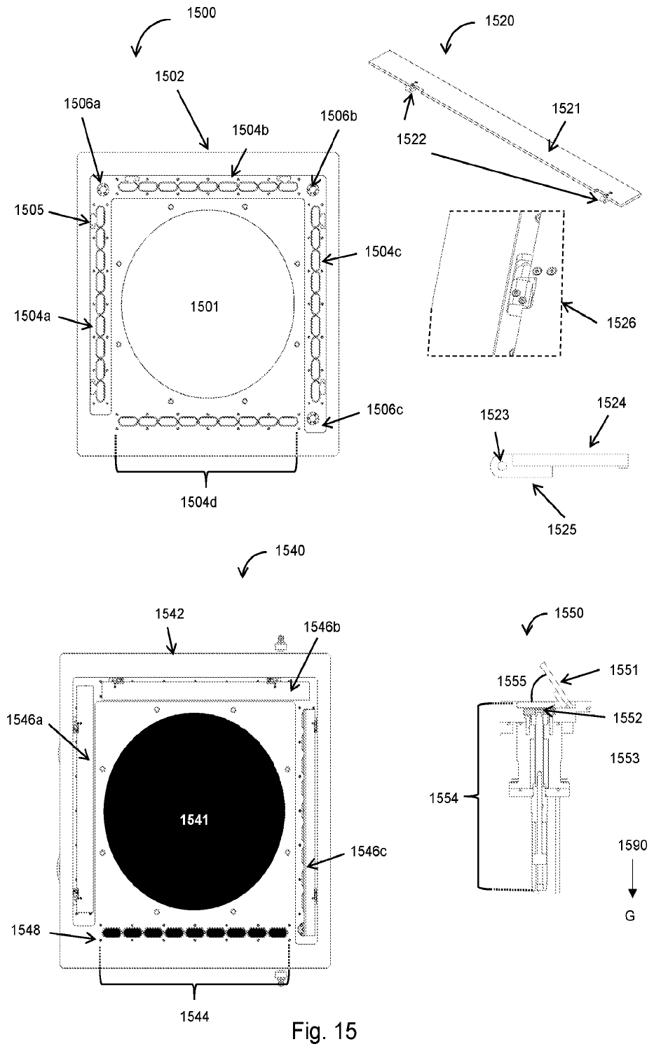

FIG. 15 shows a top view example 1500 of processing chamber floor 1502 having four groups of openings 1504a, 1504b, 1504c, and 1504d arranged along a circumference of a square. Each of the openings group includes nine oblong openings arranged along their long axis in a single file. Each of opening groups 1504a, 1504b, and 1504c is configured to be covered with a slot covering (e.g., flap). The flap is configured to attach to processing chamber floor 1502 by fasteners (e.g., hinges) configured to couple to two designated locations per opening group in floor 1502, which location includes location 1505 (e.g., hinge leaf recess and mounting). Floor 1502 is configured to mount an actuator (e.g., electrical, magnetic, or pneumatic). For example, actuator positioned at 1506a will be configured to facilitate opening and closing of flap covering hole group 1504a. For example, actuator positioned at 1506b will be configured to facilitate opening and closing of a flap covering the opening group 1504b. For example, actuator positioned at 1506c will be configured to facilitate opening and closing of the flap covering the opening group 1504c. Which positions include actuator cutouts and mountings. Hole group 1504d is configured to remain open and is devoid of a designated flap and actuator. The flap may comprise one or more extensions configured to couple with a hinge. FIG. 15 shows in example 1520 a perspective view of flap 1521. The flap is one leaf of two or more hinges. For example, flap 1521 comprises two extensions 1522 that are spaced apart by a gap, each of the 1522 leaf extensions is configured to connect to a respective hinge leaf configured to be fastened to processing chamber floor 1502 at the designated locations such as location 1505. Hinge leaf 5425 and flap 1524 having extensions such as 1522 are coupled by a 1523 having a long axis that constitutes the swivel axis of the hinge, which coupling is depicted in perspective view example 1526. FIG. 15 shows a top view example 1540 of a processing chamber floor 1541 having four groups of nine oblong holes such as group of holes 1544, with holes of each of the groups are arranged in a single file along their long axis with gaps between every two immediately adjacent holes. Two groups of holes are covered by fully closed flaps 1546a and 1546b. One group of holes is partially covered with partially closed flap 1546c flap. Group of holes 1544d is not covered by a flap. Each group of holes is configured to be coupled to material reservoirs through funnels (not shown) being fastened to the Processing chamber floor by fasteners such as 1548. Processing chamber floor 1542 has a central opening 1541 configured to accommodate a base above which 3D object(s) will be printed. FIG. 15 shows in example 1550 a vertical cross section in an actuator assembly 1554 operatively coupled to a flap 1551 disposed in a section of the processing chamber floor. The actuator (e.g., pneumatic actuator) comprises a cap 1552 configured to protect the actuator from the environment in the processing chamber during times different than unpacking times, for example, from the environment during printing (e.g., from debris arising in the chamber during the printing). Actuator assembly 1550 is depicted with respect to gravitational vector 1590 pointing towards gravitational center G.

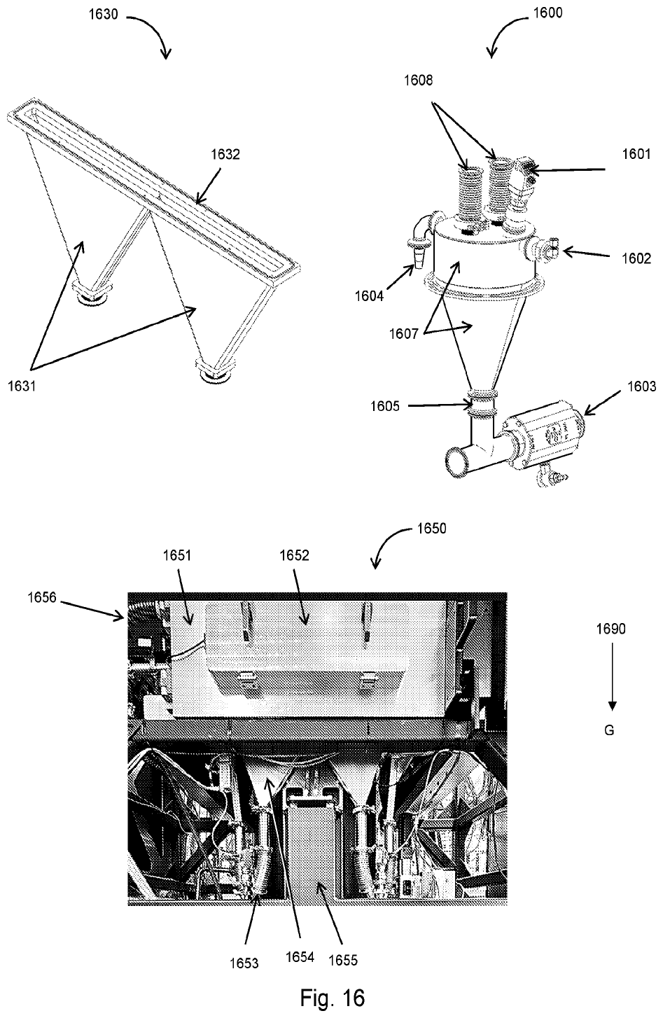

In some embodiments, the powder conveyance system comprises at least one material reservoir assembly. FIG. 16 shows a perspective view example of a material reservoir assembly 1600 that can be utilized for collection of material bed remainder. The material reservoir comprises a body 1607, a (e.g., pressure) relief outlet (e.g., and valve) 1604, one or more sensors 1601 such as material level sensor, pressure sensor, oxygen sensor, humidity sensor, and/or temperature sensors. Material reservoir (e.g., hopper) includes a purge inlet 1602 (e.g., and valve) that may be utilized to purge the accumulated material therein with a gas (e.g., inert gas or reactive gas such as one containing humidity or oxygen, e.g., for passivation). The material reservoir is coupled to a material feed tube 1605 coupled to valve 1603, which feed tube is extends to a recycling system to recycle the material for subsequent print(s). The material reservoir (e.g., hopper) comprises two opening 1608. One of openings 1608 can be for material intake (e.g., from a channel and/or funnel), and one for material outtake from the reservoir; or both openings 5608 can be for material intake. FIG. 16 shows in perspective view example 1630 two funnels 1631 whose openings are merged to one opening 1632, which opening 1632 comprises a mounting to the bottom of the processing chamber floor. The mounting may comprise a tapped flange. The mounting may comprise half dovetail structure. Opening 1632 is configured to accommodate holes in a single file such as hole group 1504d. Items in FIG. 16 are depicted with respect to gravitational vector 1690 pointing towards gravitational center G. FIG. 16 shows an example of a portion of a processing chamber door 1651 having a secondary door 1652 acting as a glovebox, the glovebox components not shown as the secondary door 1652 is closed. The processing chamber can act as an unpacking chamber, e.g., at the end of printing one or more 3D objects. The processing chamber is couped to triangular funnels such as funnel 1654 configured to receive remainder material (e.g., remainder powder) for a 3D printing process, and funnel it away (and downward) from the processing chamber and to material conveyance channel such as 1653 comprising a flexible bellow. The 3D printing system components are held by a framing that includes framing portion 1655. Gas enters the processing chamber through gas conveyance channel 1656 as part of the gas conveyance system.

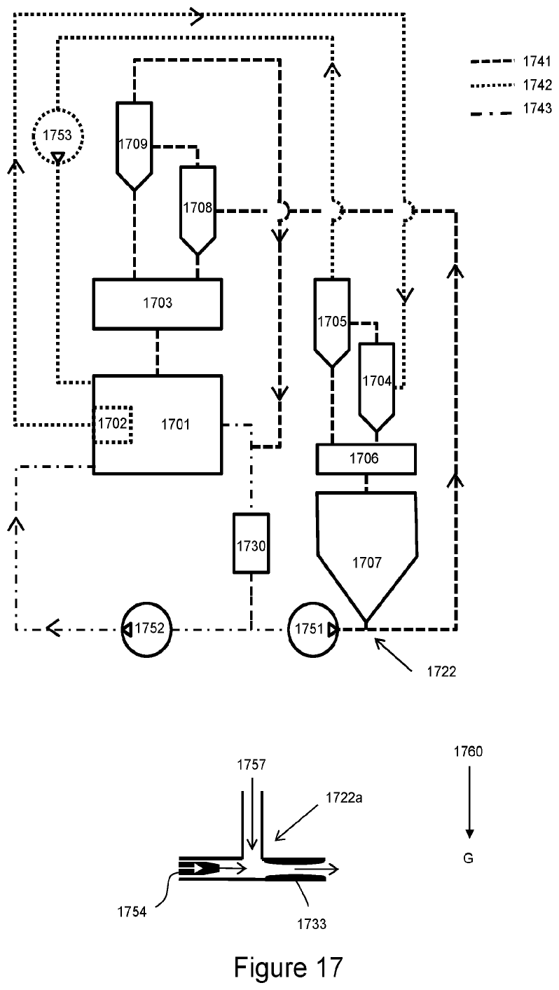

At times, the 3D printer comprises a material (e.g., powder) conveyance system. FIG. 17 schematically depicts a pre-transformed material (e.g., starting material such as powder) conveyor system coupled to a processing chamber 1701, having a layer dispensing mechanism (e.g., recoater) 1702. Pre-transformed material (e.g., powder) from a reservoir (e.g., hopper) 1703 can be introduced into the layer dispensing mechanism 1702. The layer dispensing mechanism is disposed in processing chamber 1701. Once the layer dispensing mechanism dispensers a layer of pre-transformed material to layerwise form a material bed utilized for the three-dimensional printing. In this process, excess pre-transformed material is attracted away from the material bed using layer dispensing mechanism 1702 and introduced into separator (e.g., cyclone) 1704, and optionally to overflow separator (e.g., cyclone) 1704. The pre-transformed material undergoes separation (e.g., cyclonic separation) in separators 1705 and optionally 1705, and is introduced into sieve 1706, followed by gravitational flow into a lower reservoir (e.g., hopper) 1707. The separated and sieved pre-transformed material is then delivered into separator (e.g., cyclone) 1708 and optional separator (e.g., cyclone) 1709, and into reservoir 1703 that delivers the pre-transformed material back into layer dispensing mechanism 1702. FIG. 17 shows examples of pumps (e.g., displacement pump and/or compressor) 1751, 1752, 1753, and a temperature regulator (e.g., heater or radiator such as a radiant plane). Arrows in FIG. 17 depict direction of flow. In the channels facilitating the flow of the pre-transformed material, a venturi nozzle is introduced near junction 1722 to facilitate suction of the pre-transformed material from reservoir 1707 into separator 1708. A magnified view of junction 1722 is shown in 1722a in an enlarged cross sectional view, depicting venturi nozzle portion 1733 that is introduced in a channel opposing a gas inlet 1754 and normal to an inlet 1757 from which the pre-transformed material descends gravitationally towards gravitational center G along vector 1760. The conveyance system can include a condensed gas source (e.g., a blower or a cylinder of condensed gas) not shown. When the pre-transformed material descends towards junction 1722 from reservoir (e.g., hopper) 1707. The pre-transformed material is conveyed from junction 1722 to separator 1708. The conveyance system may include a heat exchanger. The conveyance system may include one or more filters. The conveyance system may operate at a positive pressure above ambient pressure external to the conveyance system (e.g., above about one atmosphere). In some embodiments, separator 1709 is coupled to sieve 1706 instead of to reservoir 1703.

FIG. 17 shows an example of at least a portion of a gas circulation system including channel marked with dotted line 1743, pumps 1752 and 1751, and filter 1730. FIG. 17 shows an example of a first portion of a material conveyance system including channels marked with dotted line 1742 that convey material to and from the layer dispensing mechanism 1702 (e.g., recoater). FIG. 17 shows an example of a second portion of a material conveyance system including channels marked with dotted line 1741 that convey material in other portions of the material conveyance system, other than to and from the layer dispensing mechanism 1702. The gas conveyance system may be configured to circulate (e.g. and recirculate) gas also in the processing chamber (e.g., 1701). The gas conveyance system may sweep debris (e.g., soot) away from the process area in which the 3D object is being printed. The debris may collect on a filter (e.g., 1730), after which a cleaner gas is sent back (e.g., using a pump) through the channels of the gas circulation system (e.g., marked with dotted line 1743) to the processing chamber. In some embodiments, the 3D printer comprises one or more temperature adjusters (e.g., heat exchangers). For example, temperature adjusters operatively coupled to the gas circulation channel between pumps 1752 and 1751. For example, temperature adjusters operatively coupled to the material conveyance channel between pump 1751 and reservoir 1707. In some embodiments, the conveyance system of the pre-transformed material (e.g., powder) is in positive pressure above ambient pressure outside of the conveyance system and/or outside of the 3D printer. For example, the pressure in the 3D printer may be at least about 3 kilo Pascal (kPa), 5 kPa, 8 kPa, 10 kPa, 12 kPa, 14 kPa, 16 kPa, 18 kPa, or 20 kPa. That pressure may be controlled (e.g., maintained) in the processing chamber, gas conveying system, recycling system, ancillary chamber, and/or build module. At times, a pressure differential is required to convey pre-transformed material from one compartment of the 3D printer to another. The pressure differential may be established via pressurizing or vacuuming one or more compartments. For example, pre-transformed material from the layer dispensing system to the recycling system (e.g., including the separator(s), sieve(s), and/or reservoirs) may be conveyed using (a) induced pressure differential among components, (b) pressure isolation of the components, and (c) induced pressure equilibration of components.

In some embodiments, the enclosure includes an atmosphere. The enclosure may comprise a processing chamber, an ancillary chamber, a build module, or any other enclosure disclosed herein, e.g., in relation to the three-dimensional printing system. The enclosure may comprise a (e.g., substantially) inert atmosphere. The atmosphere in the enclosure may be (e.g., substantially) depleted by one or more gases present in the ambient atmosphere. The atmosphere in the enclosure may include a reduced level of one or more gases relative to the ambient atmosphere. For example, the atmosphere may be substantially depleted, or have reduced levels of water (i.e., humidity), oxygen, nitrogen, carbon dioxide, hydrogen sulfide, or any combination thereof. The level of the depleted or reduced level gas may be at most about 0.1 parts per million (ppm), 1 ppm, 3 ppm, 10 ppm, 50 ppm, 100 ppm, 500 ppm, 1000 ppm, 3000 ppm, or 5000 ppm volume by volume (v/v). The level of the depleted or reduced level gas may be at least about 1 ppm, 10 ppm, 50 ppm, 100 ppm, 500 ppm, 1000 ppm, or 5000 ppm (v/v). The level of the oxygen gas may be at most about 1 ppm, 10 ppm, 50 ppm, 100 ppm, 500 ppm, 1000 ppm, or 2000 ppm (v/v). The level of the water vapor may be at most about 1 ppm, 10 ppm, 50 ppm, 100 ppm, 500 ppm, 700 ppm, 800 ppm, 900 ppm, or 1000 ppm, (v/v). The level of the gas (e.g., depleted or reduced level gas, oxygen, or water) may be between any of the afore-mentioned levels of gas. The atmosphere may comprise air. The atmosphere may be inert. The atmosphere in the enclosure (e.g., processing chamber) may have reduced reactivity (e.g., be non-reactive) as compared to the ambient atmosphere external to the processing chamber and/or external to the printing system. The atmosphere may have reduced reactivity with the material (e.g., the pre-transformed material deposited in the layer of material (e.g., powder) or with the material comprising the 3D object), which reduced reactivity is compared to the reactivity of the ambient atmosphere. The atmosphere may hinder (e.g., prevent) oxidation of the generated 3D object, e.g., as compared to the oxidation by an ambient atmosphere external to the 3D printer and/or processing chamber. The atmosphere may hinder (e.g., prevent) oxidation of the pre-transformed material within the layer of pre-transformed material before its transformation, during its transformation, after its transformation, before its hardening, after its hardening, or any combination thereof. The atmosphere may comprise an inert gas. For example, the atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened material, or the material within the 3D object. Ambient refers to a condition to which people are generally accustomed. For example, ambient pressure may be about one (1) atmosphere. The concentration of oxygen and/or humidity in the enclosure (e.g., chamber) can be minimized, e.g., below a predetermined threshold value. For example, the gas composition of the chamber can contain a level of oxygen that is at most about 4000 parts per million (ppm), 3000 ppm, 2000 ppm, 1500 ppm, 1000 ppm, 500 ppm, 400 ppm, 100 ppm, 50 ppm, 10 ppm, or 5 ppm. The gas composition of the chamber can contain an oxygen level between any of the afore-mentioned values (e.g., from about 4000 ppm to about 5 ppm, from about 2000 ppm to about 500 ppm, from about 1500 ppm to about 500 ppm, or from 500 ppm to about 50 ppm). For example, the gas composition of the chamber can contain a level of humidity that correspond to a dew point of at most about −10° C., −15° C., −20° C., −25° C., −30° C., −35° C., −40° C., −50° C., −60° C., or −70° C. The gas composition of the chamber can contain a level of humidity that correspond to a dew point of between any of the aforementioned values, e.g., from about −70° C. to about −10° C., −60° C. to about −10° C. or from about −30° C. to about −20° C. The gas composition may be measures by one or more sensors, e.g., an oxygen and/or humidity sensor. In some cases, the chamber can be opened at or after printing the 3D object. When the processing chamber is opened, ambient air containing oxygen and/or humidity can enter the chamber. Exposure of one or more components inside of the chamber to air can be reduced by, for example, flowing an inert gas while the chamber is open (e.g., to prevent entry of ambient air), or by flowing a heavy gas (e.g., argon) that rests on the surface of the powder bed. Room temperature may represent the small range of temperatures at which the atmosphere feels neither hot nor cold, approximately 24° C. it may denote 20° C., 25° C., or any value from about 20° C. to about 25° C.

In some embodiments, the material (e.g., powder) conveyance system comprises, or is operatively coupled to an unpacking station. Material from the material bed (e.g., remainder) may flow into slots of the slotted floor of the processing chamber and be collected by one or more material reservoirs (e.g., hoppers), e.g., using gravity. The material reservoirs may be coupled to the slots of the slotted floor by funnel(s). Each funnel may be coupled to at least one (e.g., a plurality) of slots from the slotted floor. The funnel(s) of the unpacking station may be coupled to a material reservoir via a flexible channel (e.g., a flexible hose connection). The funnel(s) may each be connected to a respective material reservoir. Two or more funnels may be connected to a same material reservoir, e.g., via flexible hose connections. The material reservoir(s) may comprise a sensor, e.g., any sensor disclosed herein. A material reservoir may comprise a temperature sensor, e.g., to measure a temperature of the material within the material reservoir. A material reservoir may comprise a (e.g., fill) sensor configured to measure an amount (e.g., volume, weight, density) of material within the material reservoir. The material reservoir may comprise, or be operatively coupled to, a conduit connector configured to facilitate flow of material from within the material reservoir and into the material (e.g., powder) conveyance system. The conduit connector may comprise a t-shaped pipe fitting configured to facilitate material flow through the conduit connector. The conduit connector may be configured to prevent bridging (e.g., clogging) of material through the conduit connector and into the material conveyance system. The conduit connector may comprise a Venturi t-shaped fitting. The conduit connector may comprise, or be operatively coupled to, a valve having a reversibly selectable “OPEN” and “CLOSED” state, where the valve may be manually and/or automatically actuated to allow or prevent material flow from the material reservoir into the material conveyance system, respectively. At times, the unpacking station may comprise two or more material reservoirs coupled to respective valves and configured to selectively open or close the respective valves to allow flow from at least one material reservoir for a given time period into the material conveyance system. At times, the unpacking station is configured to selectively open or close the respective valves to only allow flow from one material reservoir for a given time period into the material conveyance system. Determination of whether to allow flow from a given material reservoir can be based at least in part on an amount of material retained within the material reservoir. For example, a flow from the given material reservoir can be selected based on the material reservoir having a threshold amount of material retained within the material reservoir. Determining whether to allow flow from a given material reservoir can be based at least in part on a temperature of the material retained within the material reservoir. At times, flow from the given material reservoir can be selected based on the material reservoir having a threshold temperature (e.g., maximum temperature) of the material retained within the material reservoir. For example, a valve for a given material reservoir may change states (e.g., open or close) based in part on a temperature of the material within the material reservoir determined by a temperature sensor. At times, flow of material from respective material reservoirs into the powder conveyance system can be sequentially selected by selective actuation of respective valves of the material reservoirs. For example, flow of at least a portion of the material from within the material reservoir can be allowed into the material conveyance system from each material reservoir in turn. Material exiting the respective valves coupled to the material reservoirs may be introduced into a separator (e.g., cyclone), and optionally to an overflow separator (e.g., cyclone). The (e.g., pre-transformed) material may undergo a separation process (e.g., cyclonic separation) in one or more separators. The material may be introduced into a sieve, e.g., to remove any debris. The material may flow (e.g., by gravitational flow) into a lower reservoir (e.g., hopper). The delivery to a reservoir may be through one or more separators, e.g., one or more cyclones. The separated and/or sieved pre-transformed material may be delivered to a reservoir that delivers the material back into layer dispensing mechanism.

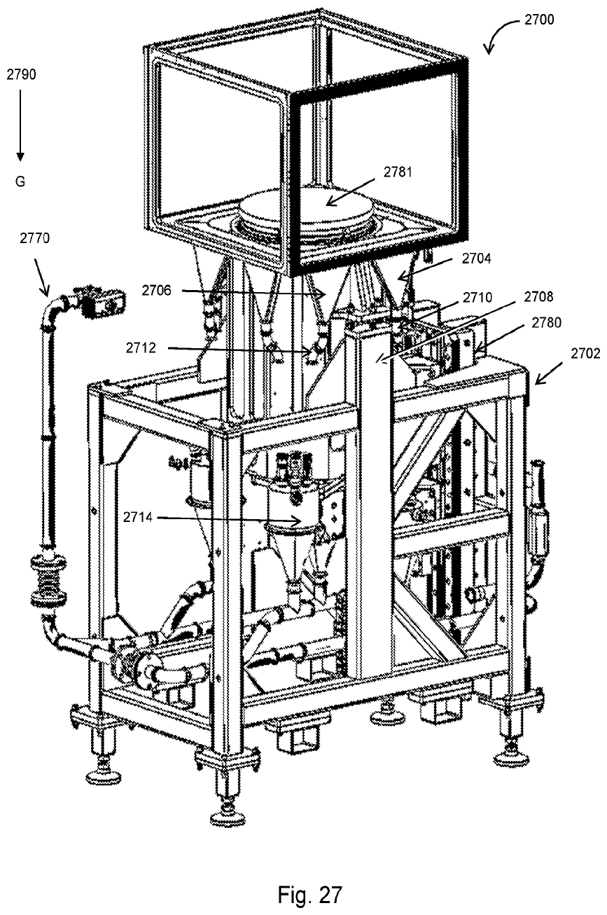

In some embodiments, the material (e.g., powder) conveyance system comprises, or is operatively coupled to, a material removal device such as suction device, e.g., a vacuum wand. The material removal device (e.g., removal wand) may be configured to facilitate an unpacking process, e.g., removal of material from within the processing chamber at least in part by attraction of the material to be removed, e.g., a remainder of a material bed that did not form the 3D object(s) in the printing cycle. The material removal device may comprise, or be operatively coupled to, e.g., at least one of a pump, blower, and/or fan. The material removal device may be operatively coupled to an attractive force source. The attractive force may comprise a vacuum, an electrostatic, or a magnetic force. The material removal device may comprise at least one component of the material removal mechanism described herein. The material removal device (e.g., removal wand) may be coupled fluidically to the attractive force source to facilitate a flow of (i) a fluid, (ii) a gas, (iii) a plasma, or (iv) any combination thereof. The material removal device may be configured to attract pre-transformed material and/or debris. The debris may comprise a byproduct of the 3D printing. The debris may comprise soot, spatter, or splatter. A fluid may comprise solid material (e.g., powder material), a liquid, or a gas. The fluid may comprise non liquid material that is or becomes gas borne. The gas may comprise a composition (e.g., substantially) similar to that of the atmosphere within the processing chamber and/or the unpacking chamber. The material removal device may be configured to establish a pressure gradient within at least one channel of the material removal device, e.g., a gas conveyor channel and/or material conveyer channel. The channels may be configured as any channel described herein. A pressure gradient may facilitate movement of a gas and/or material in the channel of the material removal device. The pressure gradient may be at a pressure above ambient pressure external to the enclosure in which the material removal device is disposed during operation, e.g., a processing chamber and/or an unpacking chamber. The unpacking chamber may be integrated in the processing chamber, e.g., in FIG. 27 the processing chamber acts as the unpacking chamber during unpacking. The unpacking chamber may be separate from the processing chamber, e.g., unpacking station in FIG. 9. The remainder material (e.g., pre-transformed material not used during the 3D printing) may be removed from the material bed supported by the platform and encompassing the printed one or more 3D objects. The remainder material may be removed from a surface of the unpacking chamber, e.g., a bottom portion of the processing chamber. The material removal device may comprise, or be operatively coupled to, a material conveyance system such as the material (e.g., powder) conveyance system of the 3D printer. The material removal device may be coupled to the powder conveyance system via a valve configured to selectively and reversibly “OPEN” and “CLOSE” to allow or prevent flow of material through the material removal device into the material conveyance system, respectively. The material conveyance system may be part of, or may be operatively coupled to, a material recycling system such as the one disclosed herein. In some embodiments, an unpacking process may comprise various operations.

At times, the unpacking process may comprise the following operations: (i) opening slot covering at the end of a printing cycle, (ii) raising (e.g., slowly) the build plate to allow the remainder to spill into the slots in the processing chamber floor, and (iii) once all the remainder has spilled into the slots, the covering of the slots are lowered to shut the slots. The remainder material can optionally return to be recycled and used in subsequent printing cycle(s). In some embodiments, the covering of the slot(s) remains open or is absent. The remainder material (also herein the “remainder”) may accumulate at one or more material reservoirs situated below the slots. The remainder material may fall into the slots and/or material reservoir(s) (e.g., hoppers) as it is attracted by gravity. The remainder material may fall into the slots and/or material reservoir(s) (e.g., hoppers) as it directed by a gas pressure (e.g., of at least one stream). The unpacking station may comprise a slotted floor, covering (e.g., flaps), actuator, guide, a material reservoir, or a valve. The actuators may comprise a pneumatic actuator or any other actuator disclosed herein. The guide may comprise a channel or a funnel. The funnel side may comprise a planar portion or a curved portion. The funnel may comprise a planar side or a curved side. The funnel may have an opening that engulfs at least one FLS of one or more floor slots, e.g., a length of one or more slots, and/or a width of one or more slots. The slots may be arranged in a geometric shape. The geometric shape may be concentric with the base (e.g., build plate). The geometric shape of the build plate and the slot arrangement can be the same or different. For example, the slots can be arranged along a rectangle whereas the build plate may be circular, e.g., FIG. 15, 1500. The reservoir(s) have the same environment, or a different environment, as compared to that of the chamber to which they are coupled to, e.g., the processing chamber and/or the unpacking chamber.

In some embodiments, the temperature of the pre-transformed material is controlled (e.g., conditioned) before, after, and/or during at least a portion of the 3D printing. The temperature may be controlled at least in part by altering the temperature of the pre-transformed material or maintaining the temperature of the remainder material (e.g., in the pre-transformed material). The remainder material conveyed through the channel may be at a temperature below, above, or at ambient temperature. For example, the material in an external material source, separator, and/or pressure container, may be cooled, heated, and/or maintained at a temperature. Controlling the temperature may be manual and/or automatic. The automatic control may comprise use of at least one controller, e.g., any controller disclosed herein. The bulk feed, separator, pressure container, and/or at least one component of the layer dispensing mechanism may be operatively coupled to a temperature conditioning system. The temperature conditioning system may control (e.g., alter and/or maintain) the temperature. The temperature conditioning system may comprise a heat transfer device, e.g., a cooling member. The temperature conditioning system may comprise at least one channel. The temperature conditioning system may comprise a heater, a cooler, or a heaving ventilation and air conditioning system (HVAC). The temperature conditioning system may comprise a thermostat. The temperature conditioning system may comprise a temperature conditioning material, e.g., a heat exchanger such as a cooling member. The temperature conditioning material may comprise an active temperature exchanger, or a passive temperature exchanger. The temperature conditioning material may comprise an energy conductive material. The temperature conditioning material may comprise an active energy transfer, or a passive energy transfer. The temperature conditioning material may comprise a cooling liquid (e.g., aqueous or oil), cooling gas or cooling solid. The temperature conditioning material may be further connected to a cooler, heater, HVAC, and/or to a thermostat. The fluid (e.g., gas or liquid) comprising the temperature conditioning material may be stationary or circulating. The temperature conditioning material can circulate through a plumbing system. The plumbing system may comprise one or more channels (e.g., pipe, or coil). The temperature conditioning material can be configured to exchange (e.g., absorb/release) heat through any one or combination of heat transfer mechanisms, e.g., conduction, natural convection, forced convection, and radiation. The one or more channels may accommodate the temperature conditioning material. The channel may be configured to facilitate flow a fluid temperature conditioning material comprising a gas, a liquid, or a semisolid (e.g., gel). The temperature conditioning material may comprise air, argon, water, or oil. The temperature conditioning system may comprise a temperature conditioning material. The temperature conditioning material may flow in the channel(s). The temperature conditioning material may stationary. The temperature conditioning material may be configured for high heat conductivity. In some embodiments, the channels comprise a solid temperature conditioning material. For example, the channels may be rods. The temperature conditioning material may comprise a solid temperature exchange material comprising a heat sink. The temperature conditioning material may comprise an elemental metal or a metal alloy. The temperature conditioning material may comprise copper, silver, or aluminum.

In some embodiments, the 3D printer comprises a material (e.g., powder) conveyance system. FIG. 18 shows an example of a pre-transformed material (e.g., powder) conveyor system coupled to a processing chamber 1801, having a layer dispensing mechanism (e.g., recoater) 1802. Pre-transformed material (e.g., powder) from a reservoir (e.g., hopper) 1803 can be introduced into the layer dispensing mechanism 1802. The layer dispensing mechanism is disposed in processing chamber 1801. Once the layer dispensing mechanism dispensers a layer of pre-transformed material to layerwise form a material bed utilized for the three-dimensional printing. In this process, excess pre-transformed material is attracted away from the material bed using layer dispensing mechanism 1802 and introduced into separator (e.g., cyclone) 1804a, and optionally to overflow separator (e.g., cyclone) 1804b, the cyclones included in a material recycling system. The pre-transformed material can undergo separation (e.g., cyclonic separation) in separators (not shown), and is introduced into sieve 1806, followed by gravitational flow into a lower reservoir (e.g., hopper), not shown. The separated and sieved pre-transformed material can be delivered into separator(s) (e.g., cyclone, not shown). The separated and sieved pre-transformed material can be (e.g., then) into reservoir (not shown) that delivers the pre-transformed material back into layer dispensing mechanism 1802. FIG. 18 shows examples of pumps 1851, 1852, e.g., displacement pump and/or compressor. The conveyance system can include a condensed gas source 1844, e.g., a blower or a cylinder of condensed gas. A optional material removal device (e.g., vacuum wand) 1854 is disposed in processing chamber 1801 that acts as an unpacking chamber, e.g., after the 3D printing process has ended. A flow pathway can be established from the material removal device 1854 into the material conveyance system via a valve 1856. Remainder material is attracted away from the material bed using material removal device 1854, and is introduced into separator 1804a and optionally 1804b. Optionally, an unpacking system can be operatively coupled to the material conveyance system. Slot coverings (e.g., flaps) 1860 can be opened to allow material within the processing chamber 1801 to flow through slots in the floor of the processing chamber 1801 and collected by funnels, e.g., funnel 1862. The funnels are coupled to material reservoirs via (e.g., flexible) channels, e.g., material reservoir 1866 via a channel (e.g., flexible hose) 1863. Material reservoirs include a fill sensor, e.g., sensor 1868. Fill sensors can be utilized to determine an amount of material within the material reservoir. Material reservoirs comprise a temperature sensor, e.g., temperature sensor 1870. Temperature sensor can be located, as depicted in FIG. 18, about a bottom portion of the material reservoir (e.g., with respect to a gravitational center of the Earth). The material reservoir may comprise, or be operatively coupled to, a temperature conditioning system, e.g., as disclosed herein. The material reservoirs are coupled to respects conduit connectors, e.g., conduit connector 1872. As depicted in FIG. 18, the conduit connectors can include a t-shaped connection. Each material reservoir is coupled to the material conveyance system via a respective valve, e.g., valve 1874. The valves, e.g., valve 1874, can be reversibly opened and closed to allow flow from the respective material reservoir (e.g., material reservoir 1866) to the separator(s) of the material conveyance system. The valve can be operatively coupled to a powder level sensor, e.g., disposed in the funnel such as 1862 and/or in the reservoir such as 1866. The valve can open when (i) the funnel receives material and/or (ii) the reservoir can accept the material. FIG. 18 is depicted relative to gravitational vector 1890 pointing towards the gravitational center of the ambient environment.

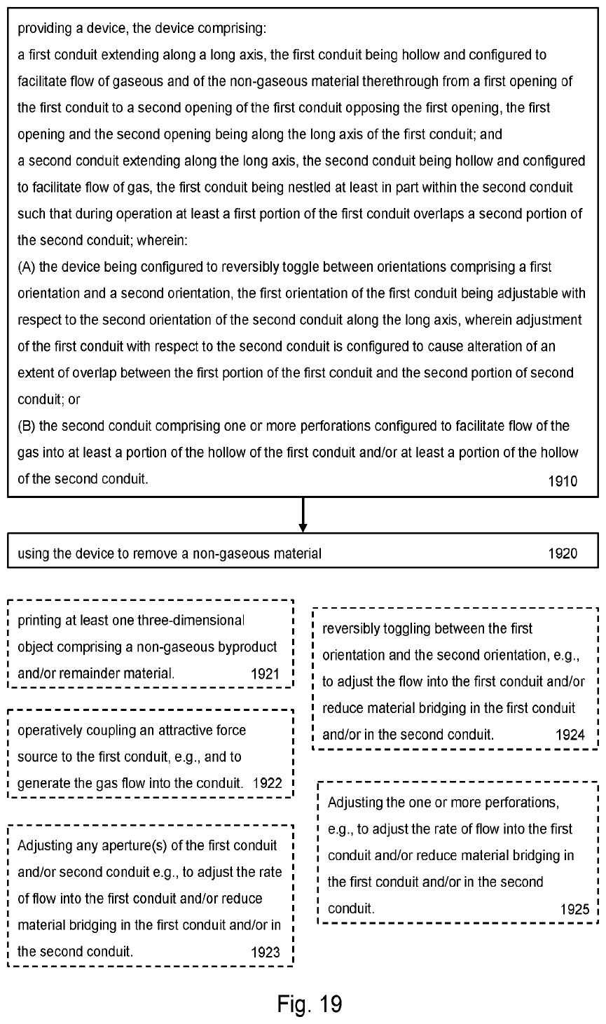

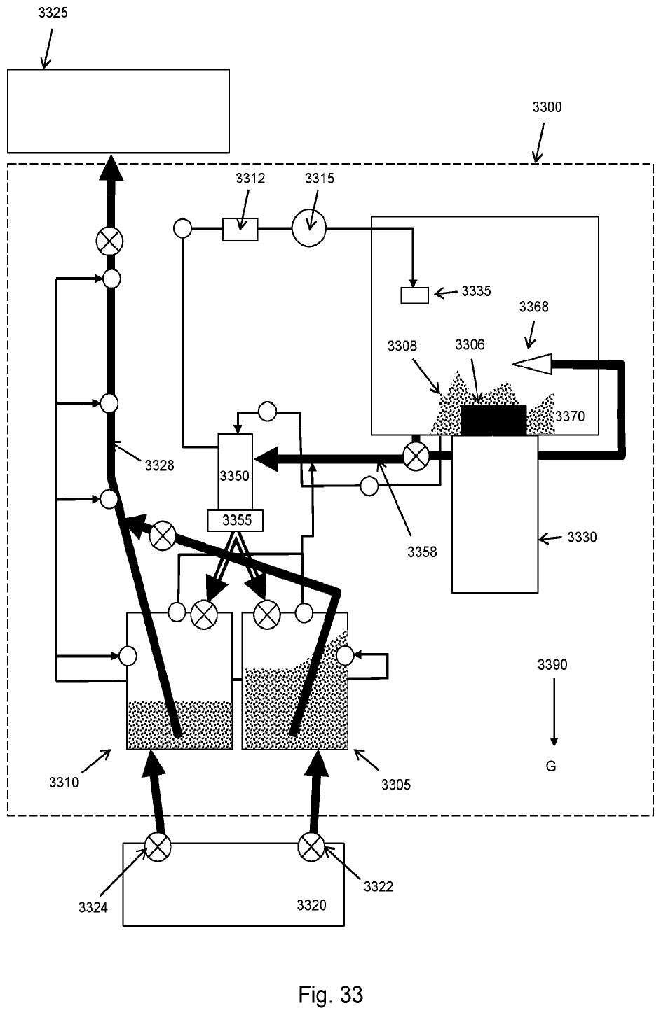

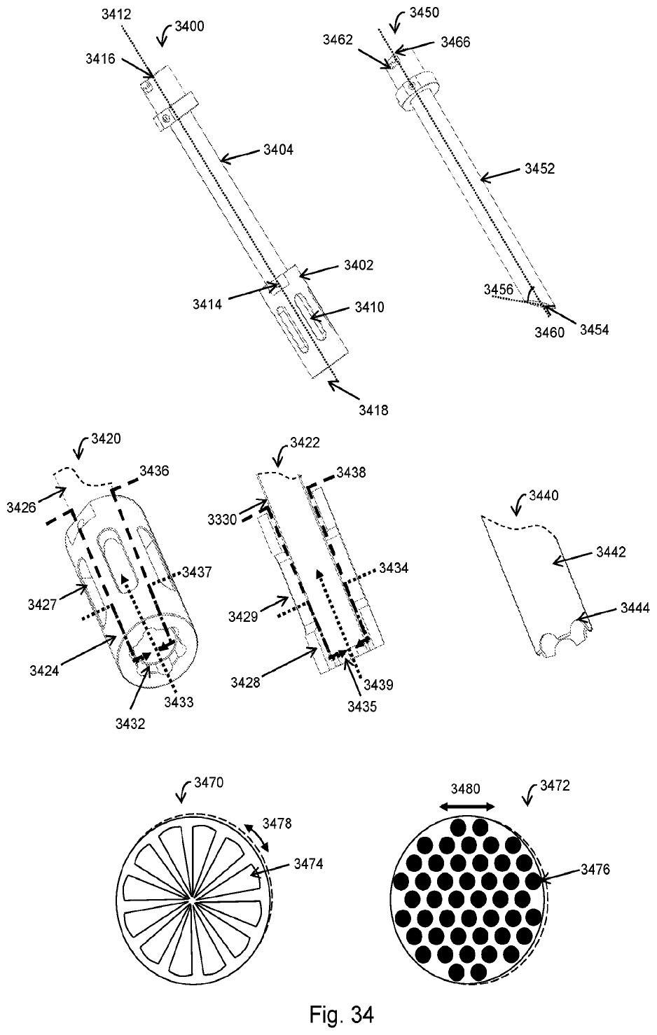

FIG. 19 shows an example of the methods disclosed herein, e.g., using a material removal device such as the ones depicted in FIGS. 33 and 34. In block 1910, providing a device, the device comprising: a first conduit extending along a long axis, the first conduit being hollow and configured to facilitate flow of gaseous and of the non-gaseous material therethrough from a first opening of the first conduit to a second opening of the first conduit opposing the first opening, the first opening and the second opening being along the long axis of the first conduit; and a second conduit extending along the long axis, the second conduit being hollow and configured to facilitate flow of gas, the first conduit being nestled at least in part within the second conduit such that during operation at least a first portion of the first conduit overlaps a second portion of the second conduit; wherein: (A) the device being configured to reversibly toggle between orientations comprising a first orientation and a second orientation, the first orientation of the first conduit being adjustable with respect to the second orientation of the second conduit along the long axis, wherein adjustment of the first conduit with respect to the second conduit is configured to cause alteration of an extent of overlap between the first portion of the first conduit and the second portion of second conduit; or (B) the second conduit comprising one or more perforations configured to facilitate flow of the gas into at least a portion of the hollow of the first conduit and/or at least a portion of the hollow of the second conduit; and in operation 1920, using the device to remove a non-gaseous material. Operations 1921 are various optional operations carried out in association with removal of the non-gaseous material. In operation 1921, print at least one three-dimensional object comprising a non-gaseous byproduct and/or remainder material. In operation 1922, operatively coupling an attractive force source to the first conduit, e.g., and to generate the gas flow into the conduit. In operation 1923, adjusting any aperture(s) of the first conduit and/or second conduit e.g., to adjust the rate of flow into the first conduit and/or reduce material bridging in the first conduit and/or in the second conduit. In operation 1924, reversibly toggling between the first orientation and the second orientation, e.g., to adjust the flow into the first conduit and/or reduce material bridging in the first conduit and/or in the second conduit. In operation 1925, adjusting the one or more perforations, e.g., to adjust the rate of flow into the first conduit and/or reduce material bridging in the first conduit and/or in the second conduit.

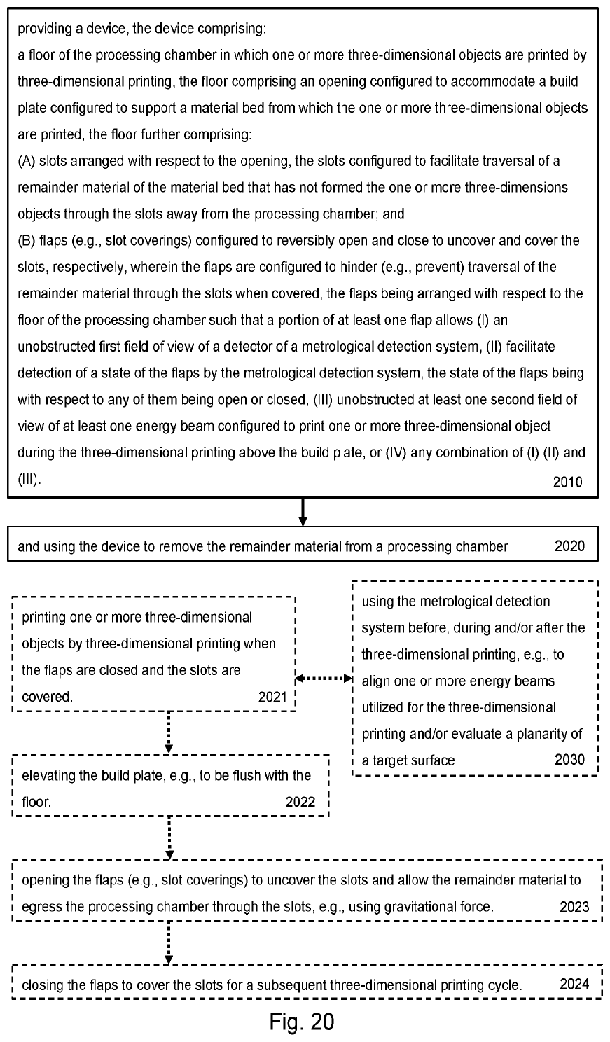

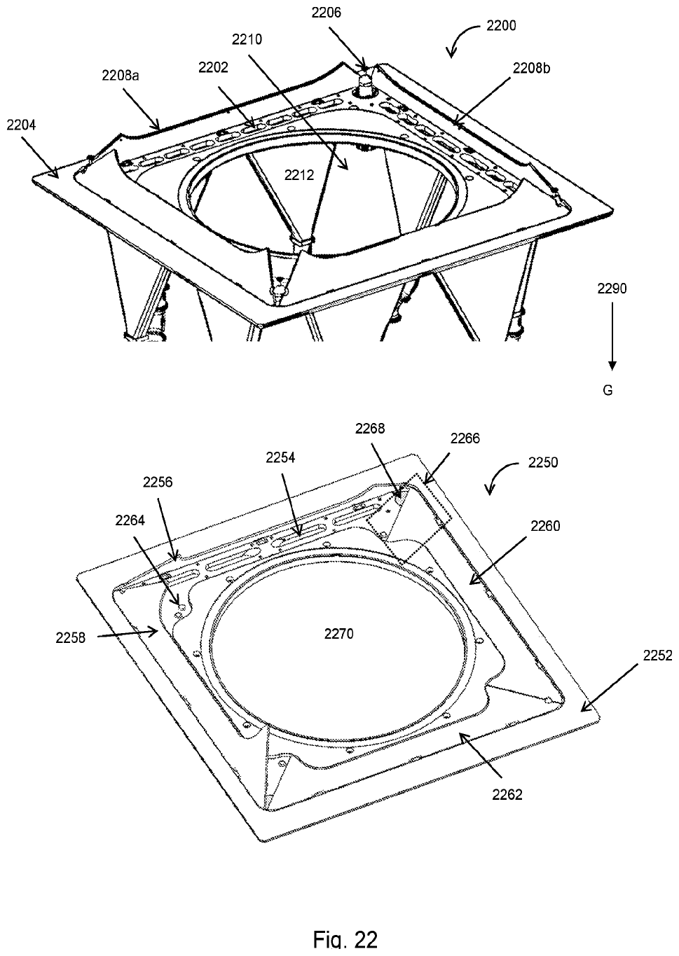

FIG. 20 shows an example of methods disclosed herein, e.g., to remove a remainder material such as the ones depicted in FIGS. 13 and 22. In block 2010, providing a device, the device comprising: a floor of the processing chamber in which one or more three-dimensional objects are printed by three-dimensional printing, the floor comprising an opening configured to accommodate a build plate configured to support a material bed from which the one or more three-dimensional objects are printed, the floor further comprising: (A) slots arranged with respect to the opening, the slots configured to facilitate traversal of a remainder material of the material bed that has not formed the one or more three-dimensions objects through the slots away from the processing chamber; and (B) flaps (e.g., slot coverings) configured to reversibly open and close to uncover and cover the slots, respectively, wherein the flaps are configured to hinder (e.g., prevent) traversal of the remainder material through the slots when covered, the flaps being arranged with respect to the floor of the processing chamber such that a portion of at least one flap allows (I) an unobstructed first field of view of a detector of a metrological detection system, (II) facilitate detection of a state of the flaps by the metrological detection system, the state of the flaps being with respect to any of them being open or closed, (III) unobstructed at least one second field of view of at least one energy beam configured to print one or more three-dimensional object during the three-dimensional printing above the build plate, or (IV) any combination of (I) (II) and (III); in block 2020, using the device to remove the remainder material from a processing chamber. Blocks 2021-2030 depict various optional operations associated with removal of the remainder material from a processing chamber functioning as an unpacking chamber. In block 2021, printing one or more three-dimensional objects by three-dimensional printing when the flaps are closed and the slots are covered; in block 2022, elevating the build plate, e.g., to be flush with the floor; in block 2023, opening the flaps (e.g., slot coverings) to uncover the slots and allow the remainder material to egress the processing chamber through the slots, e.g., using gravitational force; and in block 2024, closing the flaps to cover the slots for a subsequent three-dimensional printing cycle. Each of operation 2021-2024 may be an optional operation. The processing chamber may be substituted, or may function as, the unpacking chamber. Operation 2030 includes using the metrological detection system before, during and/or after the three-dimensional printing, e.g., to align one or more energy beams utilized for the three-dimensional printing and/or evaluate a planarity of a target surface. Operation 2030 may be executed before, after, or during the 3D printing. Operation 2030 may be an optional operation. The optional operations are depicted in FIG. 20 by being confined in a box having a broken lined circumference.

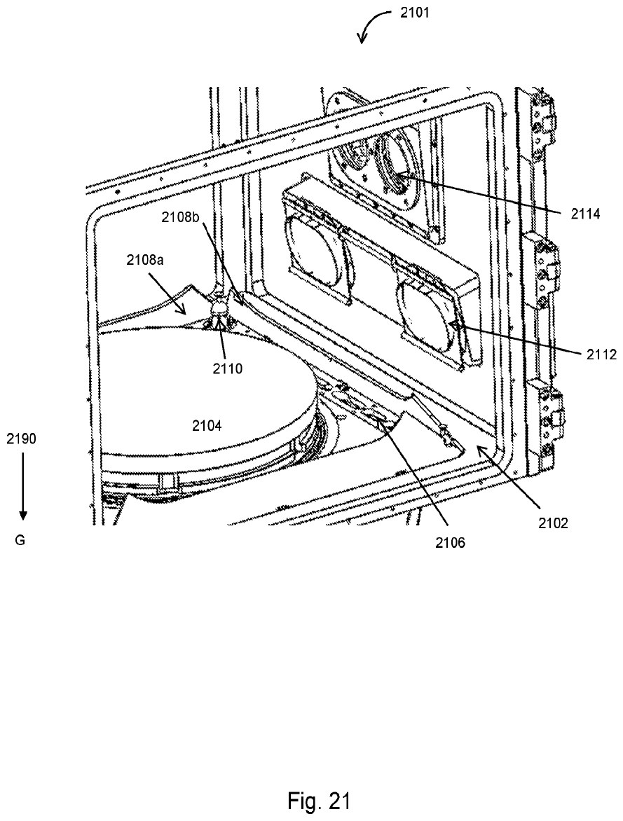

In some embodiments, a processing chamber comprises, or is operatively coupled to, an unpacking station. FIG. 21 shows a perspective view example of a portion of a 3D printing system including processing chamber 2101 with respect to environmental gravitational vector 2190. The processing chamber 2101 comprises a processing chamber floor 2102 having an opening configured to accommodate a build plate 2104. Processing chamber floor 2102 comprises an unpacking station including slots, e.g., slot 2106, configured to facilitate flow of material remainder via the slots 2106 to a material (e.g., powder) conveyance system (not shown). The slot may be a vent. The slot may be a hole. Slot coverings (e.g., flaps), e.g., slot coverings 2108a and 2108b, are configured to reversibly expose and block the slots and prevent flow of material through the slots. Slot coverings can be reversibly opened and closed by one or more actuators, e.g., actuator 2110, coupled to the respective slot coverings. As depicted in FIG. 21, slot coverings 2108a and 2108b are shown in respective open positions. The slots are arranged along a circumference (e.g., sides) of rectangle concentric with the build plate 2104. The processing chamber 2101 comprises a glove box 2112 including gloves (not shown) through which a user may insert their arms (e.g., hands and forearms) into the processing chamber 2101, e.g., without compromising an inner atmosphere of the processing chamber 2101. The processing chamber 2101 comprises viewing windows, e.g., viewing window 2114 through which a user may observe the interior of the processing chamber 2101. The viewing window may be configured to absorb at least 95%, 95%, or 99% of the radiation reflected to the viewing windows during printing.

In some embodiments, a processing chamber may comprise a slotted floor to facilitate the unpacking process, FIG. 22 shows various perspective views of portions of an unpacking station. Perspective view 2200 is depicted with respect to environmental gravitational vector 2290. View 2200 depicts a portion of an unpacking station comprising slots (e.g., slot 2202) arranged on a processing chamber floor 2204, e.g., floor with respect to a gravitational center of the Earth. Actuator 2206 is operatively coupled to two slot coverings, e.g., slot coverings 2208a and 2208b, such that the respective slot coverings, e.g., slot coverings 2208a and 2208b, may be reversibly opened and closed by actuation of the actuator 2206. The processing chamber floor 2204 includes an opening 2210 configured to accommodate a build plate (not shown). Funnels (e.g., funnel 2212) are arranged below (e.g., with respect to gravitational center of the Earth) the processing chamber floor 2204 and coupled to respective slots (e.g., slot 2202) such that a flow of material through the slots is collected by a respective funnel. The funnels are coupled to material reservoir(s) (not shown) which are operatively coupled to the material conveyance system. View 2250 depicts a portion of a processing chamber floor 2252. Processing chamber floor 2252 includes slots, e.g., slot 2254, which are depicted as elongated along a dimension aligned with a respective edge of the processing chamber floor 2252. Slot coverings 2256 and 2258 are depicted in an open position, e.g., exposing respective slots. Slot coverings 2260 and 2262 are depicted in a closed position, e.g., covering respective slots. Processing chamber floor 2204 comprises sensors aligned with respective slot coverings, e.g., sensor 2264 aligned with slot covering 2256, such that the sensor can detect an open or closed position of the respective slot covering. A curved portion of the slot covering, e.g., portion 2266 of slot covering 2260, is aligned with a respective sensor (not shown). The curved portion of the slot covering may further align with a field of view of at least one detector (e.g., camera) and/or a field of view of at least one energy beam (e.g., projector) of the 3D printing system (not shown). Processing chamber floor 2204 includes an opening, e.g., opening 2268, configured to accommodate an actuator (not shown) to engage with the slot coverings. The processing chamber floor 2252 includes an opening 2270 configured to accommodate a build plate (not shown). Example 2200 is depicted relative to gravitational vector 2290 pointing towards the gravitational center of the ambient environment.

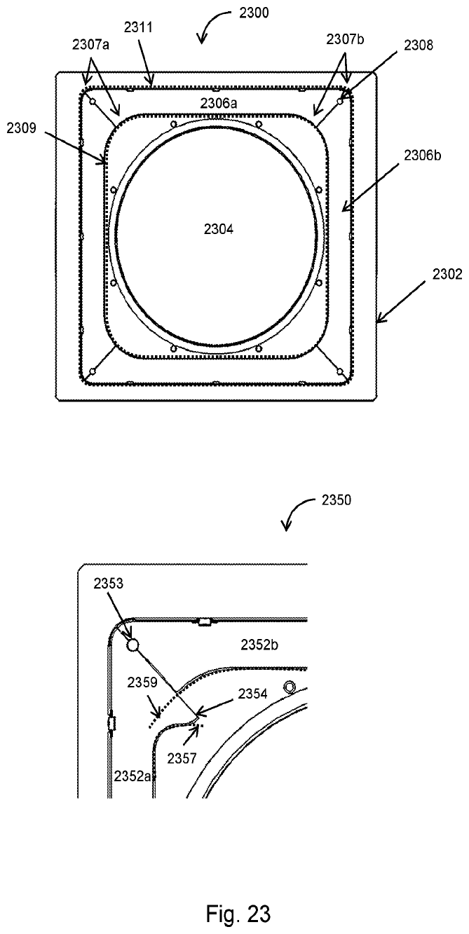

In some embodiments, the unpacking station comprises slot coverings including curved features. FIG. 23 shows various views of a processing chamber floor including slot coverings. Processing chamber floor 2302 depicted in view 2300 comprises an opening 2304 configured to accommodate a build plate (not shown). Slot coverings, e.g., slot coverings 2306a and 2306b, are arranged to define a square about the opening 2304. Though depicted in FIG. 23 where the slot coverings are arranged about the opening 2304 with the opening 2304 centered with respect to the square defined by the slot coverings, the opening 2304 may be arranged in other embodiments asymmetrically with respect to the slot coverings (e.g., off center). Slot coverings include curved features, e.g., curved features 2307a and 2307b, where an inner perimeter 2309 and an outer perimeter 2311 defined by the slot coverings about the opening 2304 define squares having rounded edges with respective degrees of curvature. Slot coverings are depicted in FIG. 23 as in closed positions, where exposed surfaces of respective actuators, e.g., actuator 2308, are flush (e.g., coplanar) with exposed surfaces of the slot coverings, that are flush with the exposed surface of the processing chamber floor when the slot coverings are closed. FIG. 23 depicts a portion of a processing chamber floor 2350 comprising slot coverings 2352a and 2352b and actuator 2353. Slot covering 2352a includes a tab portion 2354, where a curvature 2357 of the tab portion 2354 of slot cover 2352a is different than a curvature 2359 of the curved portion of slot covering 2352b. Tab portion 2354 may align with a field of view of at least one detector and/or a field of view of at least one energy beam (not shown) of a metrological detection system and/or of an optical assembly.

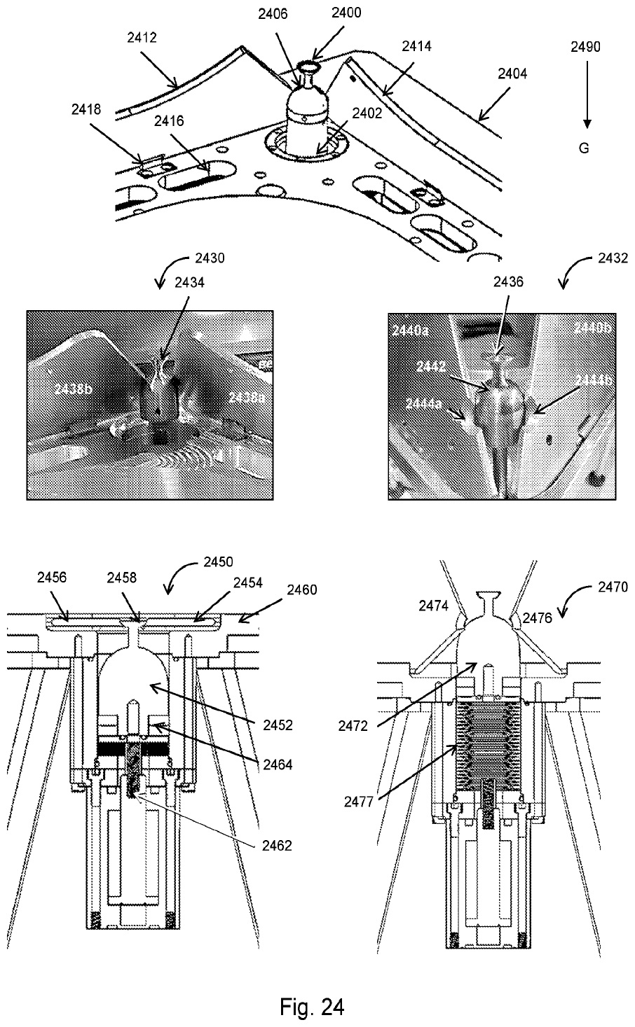

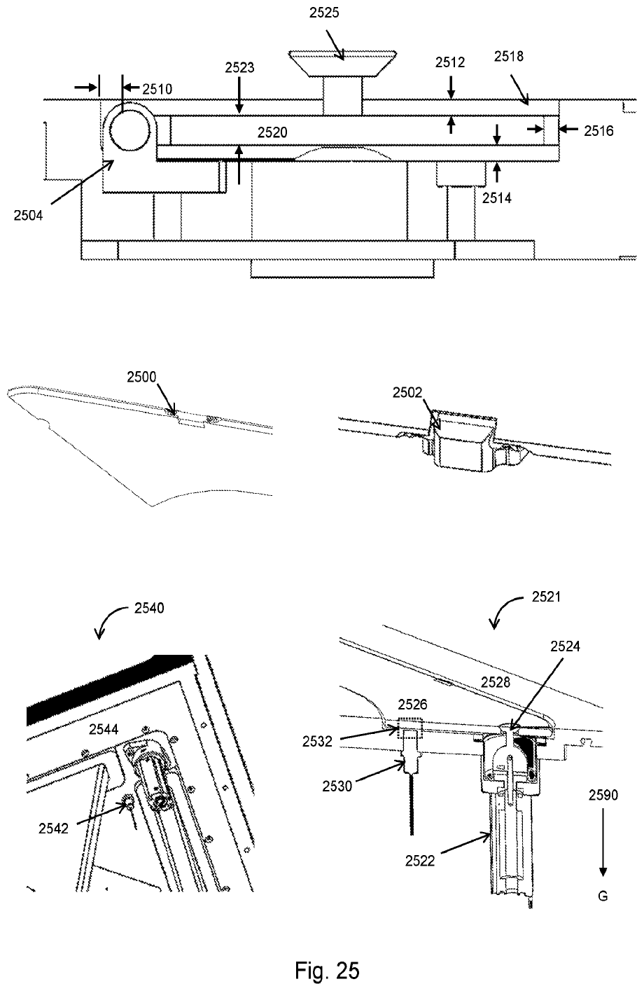

In some embodiments, an unpacking station comprises one or more actuators configured to engage with one or more slot coverings, e.g., with two immediately adjacent slot coverings. The actuator(s) can comprise a first engagement structure configured to engage with a second corresponding engagement structure on at least one slot covering. FIG. 24 shows various views of portions of an unpacking station. Actuator 2400 is arranged within an opening 2402 of a processing chamber floor 2404 such that a portion of the actuator may protrude above a plane of the processing chamber floor 2404, e.g., when the actuator is in an “open” position. Actuator 2400 and associated components are arranged with respect to gravitational vector 2490 pointing towards the environmental gravitational center. Actuator 2400 comprises a first engagement structure 2406, including a beveled (e.g., tapered, oblique, curved) portion configured to engage with a corresponding second engagement structure of the covering, e.g., each of slot coverings 2412 and 2414 having a portion that is a second engagement structure. The first engagement structure 2406 may engage with the corresponding second engagement structures of the slot coverings 2412, 2414 to adjust a position (e.g., open and/or closed) of the slot coverings 2412, 2414 with respect to the processing chamber floor 2404. The first engagement structure “pushes” the slot coverings 2412, 2414 into an open position as the actuator extends to a first position above the processing chamber floor 2404, e.g., as shown in view 2470. In the first position, the opened slot coverings expose slots, e.g., slot 2416, in the processing chamber floor 2404. Slot coverings can pivot about hinges, e.g., hinge 2418, to reversibly open and close the slot openings. Slot coverings may include a fixture to accommodate flush hinges, (e.g., FIG. 25, fixture 2500, and hinges 2502, 2504), where an exposed surface of the hinge does not protrude (e.g., is coplanar) from an exposed surface of the slot covering when the slot covering is in a closed position. The engagement structure 2406 can pull the slot coverings, retract the slot coverings, or allow the slot coverings to fall (e.g., using gravity) into a closed position, as the actuator 2400 retracts to a second position, e.g., as depicted in view 2450. The beveled structure may engage to secure the slot covering in the closed position (e.g., lock the slot covering into the closed position). Images 2430 and 2432 depict views actuators 2434, 2436 oriented with respect to corresponding slot coverings 2438a, 2438b and 2440a, 2440b. As shown in image 2432, engagement structure 2442 of actuator 2436 is configured to engage with corresponding structures 2444a and 2444b of respective slot coverings 2440a and 2440b. Views 2450 and 2470 depict actuators 2452 and 2472 in respective open and close positions. As depicted in view 2450, actuator 2452 is in a closed position such that slot coverings 2454 and 2456 are in closed positions. Engagement structures 2458 of the actuator 2452 is engaged with corresponding structures of the slot coverings 2454 and 2456 such that the slot coverings are locked into place by the actuator 2452. Exposed surfaces of the slot coverings 2454, 2456 are flush (e.g., coplanar) with a surface of the processing chamber floor 2460. In the example depicted in view 2450, actuator 2452 comprises a linear actuator with a screw 2462. Seals 2464 are arranged with respect to actuator 2452 to prevent material (e.g., powder) from contaminating a region below the seals 2464, e.g., by the remainder material. As depicted in view 2470, actuator 2472 is in an open position such that slot coverings 2474 and 2476 are in open positions. Actuator 2472 comprises bellows 2477 arranged to prevent material (e.g., powder) from contaminating a volume within the bellows 2477. Tolerances of one or more components of the slot covering, actuator, and hinge(s) may be selected to prevent material (e.g., powder) contamination. For example, tolerances 2510, 2512, 2514, and 2516 depicted in FIG. 25 may be selected to minimize powder contamination from between the processing chamber floor 2518 and a slot covering 2520. Slot covering 2520 comprises a dimension (e.g., thickness) 2523 sufficiently large to provide robustness of the slot covering, e.g., along a length. For example, the thickness 2523 of the slot covering 2520 may be sufficiently thick to prevent flexing (e.g., bending) of the slot covering before, during, or after an actuation by the actuator 2525.

In some embodiments, the unpacking station comprises one or more sensors. FIG. 25 depicts various example views of portions of unpacking stations. View 2521 depicts a cross-sectional view of a portion of an unpacking station with respect to environmental gravitational vector 2590. Actuator 2522 is configured in a closed state, where an engagement structure 2524 of the actuator 2522 is arranged to allow, or retain (e.g., affix), a slot covering 2526 to be in a closed position with respect to a processing chamber floor 2528. Sensor 2530 is arranged below the processing chamber floor 2528, e.g., with respect to gravitational vector 2590, and oriented such that the sensor 2530 may detect a proximity of a portion 2532 of the slot covering 2526 when the slot covering 2526 is in the closed position. View 2540 depicts another view of a portion of an unpacking station comprising a sensor. Proximity sensor 2542 is arranged below the processing chamber floor 2544 and configured to detect a portion of a slot covering (not shown) through a dimension (e.g., thickness) of the processing chamber floor 2544.

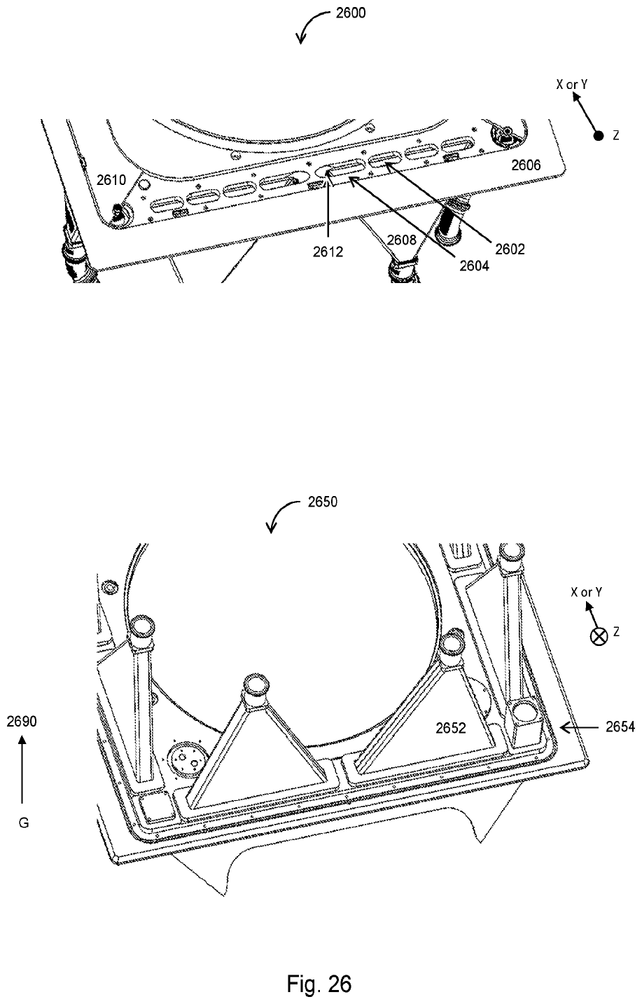

In some embodiments, the unpacking station comprises slots arranged on the processing chamber floor and coupled to one or more funnels configured to collect a flow of material through the slots. FIG. 26 shows example views of portions of unpacking stations. View 2600 depicts slots, e.g., slots 2602, 2604, arranged in a processing chamber floor 2606. As depicted, the slots are arranged linearly and aligned with an edge of the processing chamber floor 2606. Funnels, e.g., funnel 2608, are arranged below (e.g., with respect to a gravitational vector) the processing chamber floor 2606 and opposite the slot coverings, e.g., slot covering 2610. A subset of the slots, e.g., slot 2604, comprise a slanted (e.g., beveled) wall feature 2612, where the slanted wall feature is oriented to facilitate flow of material from a middle point of the linear row of slots through the slot 2604 and into the funnel 2608. A subset of slots, e.g., slot 2602, comprise straight wall features and are devoid of the slanted wall feature. As depicted in view 2600, a set of slots 2614 are aligned with a funnel 2608 such that material may pass through the set of slots 2614 and be collected by funnel 2608. View 2650 depicts a view of funnels, e.g., funnel 2652, of an unpacking station, with respect to gravitational vector 2690 pointing towards the environmental gravitational center. The funnels are arranged to facilitate collection of material from one or more slots located in the processing chamber floor 2654. Funnels can be operatively coupled, e.g., via flexible hose, to one or more material reservoirs, not shown.

At times, components of the unpacking station is part of a 3D printing system and is arranged with respect to the 3D printing system. FIG. 27 shows an example of a portion of a 3D printing system comprising an integrated unpacking station, in which the processing chamber takes the role of the unpacking chamber, e.g., at the end of the printing. 3D printing system portion 2700 comprises a support frame 2702, where the support frame 2702 may be supportive of a portion of the unpacking station and/or a material (e.g., powder) conveyance system. Funnels of the unpacking station such as funnels 2704, 2706, are arranged to accommodate a support beam 2708 of the support frame 2702. The respective channels comprising a curvature such as channels 2710 and 2712 extend from ends respective funnels that are arranged to direct flow of material away, e.g., from the support beam. The channels may comprise a curved portion. The channels may comprise a flexible portion such as flexible hose. The channels (e.g., 2710, 2712) are configured to direct a flow of material (not shown) from the processing chamber (e.g., acting as the unpacking chamber) to material reservoirs (e.g., such as 2714 that can be a hopper). The material reservoir connects the flow of material to the material conveyance system, as described herein. The 3D printing system portion 2700 includes an elevation mechanism and framing 2780. 3D printing system portion 2700 is shows with respect to gravitational vector 2790 pointing towards the gravitational center of the ambient environment. In the example shown in FIG. 27, the channels (e.g., 2712) of the funnels (e.g., 2706) are disconnected from their respective material reservoirs (e.g., 2714), e.g., for presentation purposes. However, in a working 3D printer, those would be respectively coupled, with every two funnels connecting to one hopper, e.g., see FIG. 18 for an example. The connection may comprise connection through a temperature conditioning system component. A portion of the material conveyance system (e.g., 2770) may be coupled to (I) a material removal device, e.g., as disclosed herein such as vacuum wand, (II) a material removal mechanism (e.g., as part of a layer dispensing mechanism), (III) to a material recycling system, and/or (IV) to a gas conveyance system. An example for such coupling is depicted in FIG. 18.

In some embodiments, a larger number of energy beams incident on a target surface increase (i) the (e.g., total) processing field available for printing (e.g., in a X-Y plane) and/or (ii) the rate of 3D printing completion for a given print cycle as compared to using a smaller number of energy beams such as a single energy beam. Usage of the larger number of energy beams may be useful in providing a relatively larger processing area in which one or more 3D objects may be generated above a build plate, e.g., in a printing cycle.

In some embodiments, one or more (e.g., a plurality of) optical assemblies direct a plurality of energy beams, respectively, to the target surface, e.g., to different positions of the target surface. The one or more optical assemblies may be arranged in an array of optical assemblies. The optical assemblies may each comprise an optical element and/or optical mechanism. The optical assembly may comprise a scanner. A given scanner may direct a plurality of energy beams from the same energy source. An optical assembly may direct one or more energy beams generated by more than one energy sources. In some embodiments, an optical assembly directs one energy beam generated by an energy source. At least two of the energy beams may have (e.g., substantially) the same (I) characteristics (e.g., energy density, and cross section) and/or (II) scanning scheme in the 3D printing process. At least two of the energy beams may have different (I) characteristics (e.g., energy density, and cross section) and/or (II) scanning scheme in the 3D printing process. An optical assembly may be controlled manually and/or by at least one controller, e.g., as disclosed herein. For example, at least two optical assemblies may be directed by the same controller. For example, at least two optical assemblies may be directed by different controllers. For example, at least one optical assembly may be directed by its own (e.g., unique) controller. The plurality of controllers may be configured to operatively couple (e.g., and may be operatively coupled) to each other, to the optical assembly(s) (e.g., scanner(s)), and/or to the energy source(s). The different controllers may be of a control system, e.g., the control system disclosed herein. The at least one controller (e.g., the control system) may be configured to direct other aspects of the 3D printing. At least two of the plurality of energy beams may irradiate the target surface simultaneously or sequentially. At least two of the plurality of energy beams may irradiate the target surface cooperatively, e.g., synchronously. At least two of the plurality of energy beams may be generated by the same energy source. At least two of the plurality of energy beams may be generated by at least two energy sources, e.g., a respective energy source for each energy beam. At least two of the plurality of energy beams may be directed towards the same position at the target surface, or to different positions at the target surface. In some embodiments, at least two of the energy source(s) and/or beam(s) can be translated at different rates (e.g., different velocities). In some cases, at least two energy source(s) and/or energy beam(s) can comprise at least one different characteristic. The characteristics may comprise wavelength, power, amplitude, trajectory, footprint, intensity, energy, or charge. The charge can be electrical and/or magnetic charge. One or more sensors may be disposed adjacent to the target surface. The at least one of the one or more sensors may be disposed in an indirect view of the target surface. The at least one of the one or more sensors may be disposed in a direct view of the target surface (e.g., a camera viewing the target surface). The one or more sensors may be configured to have a field of view of at least a portion of the target surface (e.g., an exposed surface of the material bed). The at least one or more sensors may be any sensor disclosed herein, e.g., optical sensors.

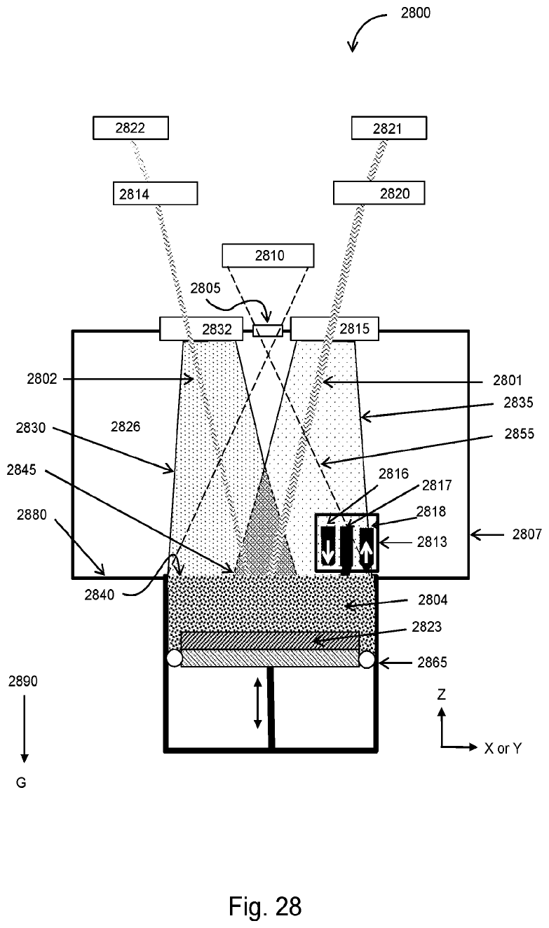

FIG. 28 shows an example of a 3D printing system 2800 and related components, including a (e.g., first) energy source 2821 that emits a (e.g., first) energy beam 2801 (e.g., laser beam) and a (e.g., second) energy beam source 2822 that emits a (e.g., second overlapping) energy beam 2802 (e.g., laser beam). The 3D printing system can have additional energy sources not shown in FIG. 28. The energy sources are disposed adjacent to enclosure having interior space 2826, e.g., having an internal atmosphere. The enclosure comprises a processing chamber 2807 and a build module 2865. In the example of FIG. 28 the energy from energy source 2821 travels through an optical fiber, through an (e.g., first) optical assembly 2820 (e.g., comprising a scanner) and through an optical window 2815, to impinge upon a target surface 2840 within enclosure (e.g., processing chamber) having interior 2826 (e.g., comprising an atmosphere). Target surface 2840 may comprise at least one layer of pre-transformed material (e.g., powder material) that is disposed above to a platform (e.g., 2809), e.g., with respect to a gravitational center. FIG. 28 shows the energy from the energy beam source 2822 travels through an optical cable, through an optical assembly 2814 (e.g., comprising a scanner) and through an optical window 2832 to impinge upon the target surface 2840 (e.g., exposed surface of material bed 2804). In the example of FIG. 28, the energy beam 2802 trajectory defines a processing volume 2830 (shown as a vertical cross section), the energy beam 2801 trajectory defines a processing volume 2835 (shown as a vertical cross section), and the processing volumes 2830 and 2835 have an overlapping region 2845. The processing volume 2830 may be a processing cone, e.g., truncated cone disposed within interior space 2826. The processing cone may assume a shape of a truncated cone within the processing chamber. A maximal portion of the enclosure, that is occupied by the irradiating energy (e.g., during the 3D printing) can define a processing cone. An intersection of the processing cone with a target surface can be defined as the field of view of the energy beam. A processing volume may have a corresponding processing field defined by the intersection of the processing volume with the target surface. The target surface may comprise a (e.g., portion of) hardened material (e.g., FIG. 28, 2806) formed via transformation of material within a material bed (e.g., FIG. 28, 2804). In the example of FIG. 28, a layer forming device 2813 includes a (e.g., powder) dispenser 2816, a leveler 2817, and material removal mechanism 2818. The material bed may be supported by a (e.g., movable) platform, which platform may comprise a base (e.g., FIG. 28, 2823). The base (e.g., build plate) may be detachable (e.g., after the printing cycle concludes). A hardened material may be anchored to the build plate 2823 (e.g., via supports and/or directly), or un-attached to the base (e.g., floating anchorlessly in the material bed, e.g., suspended in the material bed). At times, a (e.g., optical) detection system 2810 is disposed to detect one or more characteristics of the printing process. The detection system 2810 may comprise any detection system disclosed herein, e.g., a height mapper system. Detection system 2810 may have a field of view 2855 of the target surface 2880 within the processing chamber via an optical window 2805. FIG. 28 an example of an optical system including optical assemblies disposed within respective enclosures. In some embodiments, at least one of energy beam sources 2821 and 2822 may be easily removable and/or insertable. In some embodiments, at least one of optical assemblies 2814 and 2820 may be easily removable and/or insertable. For example, a user (e.g., service and/or installation engineer) may maneuver an energy beam source (e.g., 2821, and/or 2822) to and/or from the 3D printing system, e.g., without usage of tooling. For example, a user (e.g., service and/or installation engineer) may maneuver an energy beam source (e.g., 2821, and/or 2822) to and/or from the 3D printing system, e.g., without usage of tooling. The 3D printing system 2800 is depicted with respect of gravitational vector 2890 pointing towards the gravitational center of the ambient environment.

In some embodiments, a method of calibration is employed in printing at least one 3D object, e.g., in a printing cycle. The method of calibration may be performed while printing at least one three-dimensional object in a printing cycle, after printing of at least one three-dimensional object in a printing cycle, and/or before printing of at least one three-dimensional object in a printing cycle. A calibration mark may be generated by projecting a non-transforming energy beam onto a target surface, e.g., an exposed surface such as of a material bed. Generation of calibration marks may comprise generating more than one calibration mark at different locations on the target (e.g., exposed) surface. The calibration mark may be ephemeral and/or temporary. The calibration mark may generate a non-lasting change on the target surface, e.g., exposed surface of a material bed. The calibration mark may leave a self-reversing change on the target surface. The calibration mark may fade away without leaving a detectable mark on the target surface. For example, the calibration mark may cause generation of light and/or heat reflected from the target surface, which light and/or heat fade away, e.g., without leaving a detectable mark on the target surface (e.g., before transforming the target surface with a transforming energy beam). Sensing (e.g., imaging such as photographing) a reflection of the calibrating (e.g., non-transforming) energy beam may comprise at least two successive measurements of sensing the location of the calibration mark. The at least two successive measurements of sensing the location of the calibration mark may have a high accuracy. At times, one sensor (e.g., camera) measurement may provide the high accuracy. The high accuracy may be an accuracy that is of at least about 20 μm (micrometers), 10 μm, 5 μm, or a greater accuracy. The high accuracy may be accuracy between the aforementioned value, e.g., from about 20 μm to about 5 μm. Sensing a reflection of the non-transforming energy beam may comprise performing at least one measurement without detectable damage to the sensor. Sensing a reflection of the non-transforming energy beam may comprise performing at least about 1, 2, 5, or 10 successive measurements by the sensor, without detectable and/or substantial damage to the sensor. Positions (e.g., centers) of the calibration mark (e.g., in X-axis and Y-axis directions in a Cartesian coordinate system and/or in directions relative to other coordinate systems, such as radial) may be located. The position may be a center of the mark, intersection of two lines constituting the mark (e.g., intersection point of the shapes such as “X” or “+”), or meeting points of two lines forming a mark (e.g., edge points of the shapes such as “\hat{ },” “Δ,” or “ [symbol] ”). A guidance system of a transforming energy beam may be calibrated, e.g., when the calibrating (non-transforming) beam and the transforming beam (e.g., utilized for printing the 3D object(s)) share the same optical path and/or guidance system. The guidance system may comprise an optical fiber. The guidance beam may serve as the calibrating (e.g., non-transforming) beam utilized for the calibration. In some embodiments, at least one calibration mark is generated by projecting a (e.g., non-transforming) energy beam onto a target surface (e.g., on an exposed surface of a material bed and/or on an exposed surface adjacent to the material bed), block 3541. Generation of calibration marks may comprise generating more than one calibration mark, at different locations on an exposed surface. The calibration mark(s) may be erasable or self-erasing mark(s) that fade away and/or leave no detectable mark on the target surface after a time window. The time window may be sufficient for detection of the calibration mark by the sensor (e.g., before they are erased). The calibration mark(s) may generate a fleeing, temporary, disappearing, and/or ephemeral change in the target surface. The calibration mark(s) may be self-vanishing, and/or self-erasable. The calibration mark may not require external intervention for their disappearance. The calibration mark may not require reversal of the change they impart on the target surface, for reversal of this change to occur. The calibration mark may not require reversal of the change they impart on the target surface, for erasing the mark. For example, the calibrating energy beam may shine light on the target surface that may be reflected, which reflection disappears once the calibration beam ceases its irradiation, or shortly thereafter. For example, the calibrating energy beam may heat the target surface, which heat dissipates once (or shortly after) the calibration beam ceases its irradiation, e.g., depending on the heat capacity of the target surface. A sensor or a detection system (e.g., a camera, such as a CCD camera and/or a CMOS camera) may sense the calibration mark on the target surface (e.g., by sensing a reflectance and/or heat generated by the non-transforming energy beam). Calibration of the first guidance system of the non-transforming energy beam may facilitate calibration of the second guidance system of the transforming energy beam as (a) the first guidance system and the second guidance system are the same guidance system, (b) the first guidance system and the second guidance system share at least one common component of the optical system (e.g., an optical fiber), or (c) the first guidance system and the second guidance system are linked guidance system (e.g., optically and/or controllably linked). For example, at least one first optical component of the first guidance system and respective at least one second optical component of the second guidance system may be linked to the same actuator (e.g., motor) and/or the same controller (e.g., microcontroller). The controller may be part of the control system controlling the 3D printer. The control system can be a hierarchical control system, e.g., comprising at least two or three hierarchy levels of control.

In some embodiments, the alignment of the energy beam(s) is done during, before, and/or after, a printing cycle. In some embodiments, the alignment of the energy beam(s) is done due to drifting in an alignment of at least one energy beam. In some embodiments, the energy beam alignment drifts done due to temperature changes of optical component(s) through which the energy beam propagates from it way from the energy source to the target surface. The alignment drift may be due to thermal lensing effects experience by the optical component(s), e.g., as the energy beam travels therethrough such as over time. The temperature changers can be in the processing chamber. The temperature changes can be due to irradiation of a transforming energy beam through the optical window. For example, during irradiation of the energy beam, various areas of the optical window may heat up more than others and create a (e.g., temporary) deformation. For example, during irradiation of the energy beam, various areas of the optical window may heat up more than others and create a (e.g., temporary) lens.

In some embodiments, a printing cycle may comprise (a) depositing a new layer of pre-transformed (e.g., starting) material as part of a material bed, and (b) using energy beam(s) to irradiate the new layer of pre-transformed material utilized to print at least a portion of one or more 3D objects. The energy beam(s) can be translated laterally along the material bed during operation (b), e.g., using scanner(s) such as galvanometer scanner(s). The generated energy beam(s) may travel through an optical system, e.g., as disclosed herein. An energy beam can travel into the processing chamber through an optical window to impinge on the target surface such as an exposed surface of the material bed. One or more controllers may control components of the 3D printer comprising (i) the energy source (e.g., energy beam source), (ii) the optical system (e.g., including the scanner), (iii) the layer dispensing mechanism (e.g., recoater), (iv) the elevator vertically translating the material bed, (v) the gas conveyance system, (vi) the material conveyance system, (vii) the material recycling system, or (viii) a detector (e.g., comprising a sensor). The control system may be a hierarchical control system, e.g., having two, three, or more hierarchy levels of control. The one or more controllers can control the transforming energy beam and/or a non-transforming energy beam such as one used for calibration. The one or more controllers can control a guide beam of the energy source, e.g., used to calibrate the energy beam generated by the energy source. The optical system may comprise a scanner, a prism, a mirror, a beam splitter, or a lens. At times, a metrological detection system is utilized to calibrate the energy beams. The metrological detection system may comprise a height mapper. The height mapper system may be configured to generate a topological map of a target surface, e.g., in real time and/or during the printing. The height mapper system may be configured to reduce (e.g., avoid) specular reflection(s) generated on the target surface during its operation (e.g., during detection).

In some embodiments, calibration marks(s) are utilized to align the energy beam. The calibration marks may be physical or optical calibration marks. For example, they may be lightly fused calibration marks that can be removed by the layer dispensing mechanism, e.g., using the layer remover mechanism. The controller(s) that control a detector (e.g., camera) capturing calibration mark(s) generated on a target surface. The calibration mark generation, processing, and output generation may occur during operation of the layer dispensing mechanism to dispense a layer of pre-transformed (e.g., staring) material. The calibration mark generation, processing, and output generation may occur during recoat of the material bed by a new planar layer of pre-transformed (e.g., staring) material by the layer dispensing mechanism. Using the planar layer deposition (e.g., recoat) operation time window for such energy beam alignment takes up minimum (or no) extra time from the build cycle. Timewise, the energy beam alignment during the print cycle may be a time efficient (e.g., seamless) operation.

In some embodiments, the non-transforming energy beam generates an optical calibration mark. The optical calibration mark can be in the visible and/or infrared spectrum region. The visible spectrum is the spectrum visible to an average human eye. The optical calibration mark can be of any continuous boundary of a two-dimensional (2D) shape (e.g., a circumference of a 2D shape, e.g., a continuous circumference of a closed 2D shape). The 2D shape can be a planar shape (e.g., reside within the exposed shape of the material bed). The geometric shape can comprise a simple geometric shape. The 2D geometric shape may comprise a polygon such as a polyhedral. The 2D geometric shape may comprise a Euclidean or a non-Euclidean geometrical shape. The 2D geometric shape may comprise a quadrilateral. The continuous boundary of the 2D shape can comprise a continuous boundary of a 2D geometric shape or of a 2D amorphous shape. The 2D shape may comprise a triangle, a rectangle, a rhombus, a parallelogram, a trapezoid, an ellipse (e.g., a circle), a heptagon, a hexagon, or an octagon. At least one portion of the shape can be concave. At least one portion of the shape can be convex. The shape may comprise an equilateral and/or an equiangular shape. The shape may comprise a cyclic shape. The continuous boundary of the shape may comprise a linear portion or a curved portion. The continuous shape may comprise a diagonal line with respect to (i) a wall of the processing chamber in which the shape is generated on the exposed surface of a material bed, (ii) a circumference of the material bed, (iii) an edge of a floor of the processing chamber, and/or (iii) an edge of a ceiling of the processing chamber. The continuous mark (e.g., border) may be more time efficient to generate (e.g., optically-draw) as compared to a non-continuous shape, e.g., considering that only the generated (e.g., optically drawn) portion of the shape is considered for alignment. Generating (e.g., drawing) the continuous mark may increase the time efficiency of generating the mark, e.g., as compared to generating a discontinuous mark having the same length. In some embodiments, the generated mark (e.g., optically drawn border of the shape) may comprise a reduced (e.g., non-detectable, or is devoid of) an infrared signature (e.g., a heat signature).

In some embodiments, the mark (e.g., optical border of the shape of the calibration mark) is captured by a detector (e.g., camera) as it is generated, e.g., in real-time. For example, the exposure time of the camera may be proportional to the time it takes to draw one mark (e.g., one border of the shape of the mark). For example, the exposure time of the camera may be configured as an integer number of optical calibration marks (e.g., shape circumferences). The initiation of camera exposure may be synchronized with initiation of calibration mark generation (e.g., optical drawing). The synchronization may include triggering the camera as the energy beam (e.g., laser) initiates generation of the calibration mark.

In some embodiments, some calibration marks (e.g., ghost calibration marks) used by the calibration software cannot be corroborated experimentally, e.g., due to physical limits of the material bed. The ghost calibration marks can be theoretically generated, e.g., using extrapolation. The extrapolation can comprise linear or bicubic extrapolation. The extrapolation can verify continuity of the surface and of the derivative of the surface in which the calibration marks (e.g., real and ghost calibration marks) are disposed.

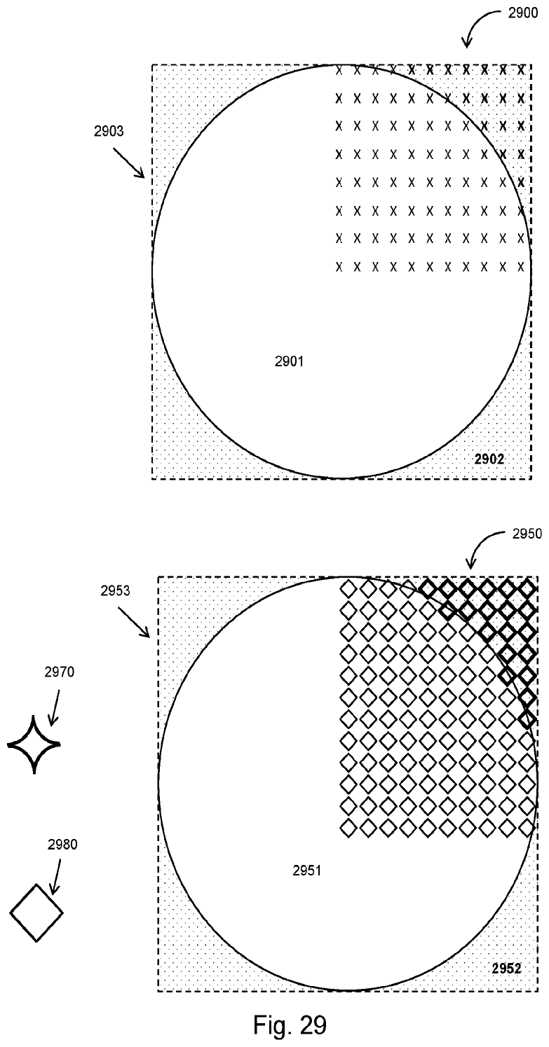

FIG. 29 shows an example 2900 of forming multiple alignment markers (e.g., of transformed material that are attractable and/or erasable from the material bed) that form a proposed alignment marker arrangement of alignment markers having an “X” shape, in circular material bed 2901, and proposed alignment markers depicted outside of the region of material bed 2901, in a region like region 2902 as part of rectangle 2903. Rectangle 2903 can represent a measurement region of a detector (e.g., camera) configured to detect the calibration marks. Calibration marks included in rectangle 2903 and excluded from material bed 2901 cannot be printed (e.g., as there is not pre-transformed material to form them), and can be referred to as ghost marks. These marks are marked by a bold “X” in FIG. 29. These marks can be theoretically synthesized, e.g., by the calibration software. These ghost calibration marks cannot be experimentally corroborated. FIG. 29 shows an example 2950 of forming multiple alignment markers (e.g., that are optical) that form a proposed alignment marker arrangement of alignment markers having a rhombus shape, in circular material bed 2951, and proposed alignment markers depicted outside of the region of material bed 2951, in a region like region 2952 as part of rectangle 2953. Rectangle 2953 can represent a measurement region of a detector (e.g., camera) configured to detect the calibration marks. Shape circumference 2970 shows an example of a circumference of a rectangle having convex sides. Shape circumference 2980 shows an example of a circumference of a rectangle having s straight equilateral sides (e.g., a circumference of a rhombus). Calibration marks included in rectangle 2953 and excluded from material bed 2951 can be referred to as ghost marks. These marks are marked by a bold rhombus in FIG. 29. These marks can be optically generated or theoretically synthesized, e.g., by the calibration software. Since these marks are optically generated, in principle, they can be experimentally corroborated.

In some embodiments, the optical calibration marks are generated in situ and/or in real time during a printing cycle. For example, the calibration marks can be generated after generating a layer as part of the material bed, and before transforming at least a portion of the material bed to form at least a portion of one or more 3D objects. The compensation may be implemented in situ (e.g., in the 3D printer) and/or in real time (e.g., during operation of the 3D printer such as during the printing). In the 3D printer may comprise in any component of the 3D printer (e.g., in the processing chamber). During operation of the 3D printer may comprise during operation of any of its components. The printer components may comprise an energy beam, an energy source, a layer dispensing mechanism, an elevator, a gas flow system, a material conveyance system, a material recycling system, a sensor, a control system, or an optical system.

At times, the energy beam generates calibration marks by transforming at least a portion of the material bed, e.g., by transforming at least a portion of a pre-transformed material. The transformation may generate visibly transformed material, e.g., to facilitate their detection by the detector(s) (e.g., camera(s)). The calibration marks comprising the transformed material may be referred to as “dust markers”. These calibration marks may comprise transformed material that is not fully fused (e.g., sintered). These calibration marks may comprise clumped up, or agglomerated, material. The visibly transformed material may be in an agglomerate form that can be attracted by the layer dispensing mechanism, e.g., by the material removal mechanism as part of the layer dispensing mechanism. At times, the energy beam generates calibration marks that are optical calibration marks and are devoid of (e.g., do not comprise) transformed material. The calibration marks generated by transformation may be generated at the end of the printing cycle (e.g., at the end of a built).

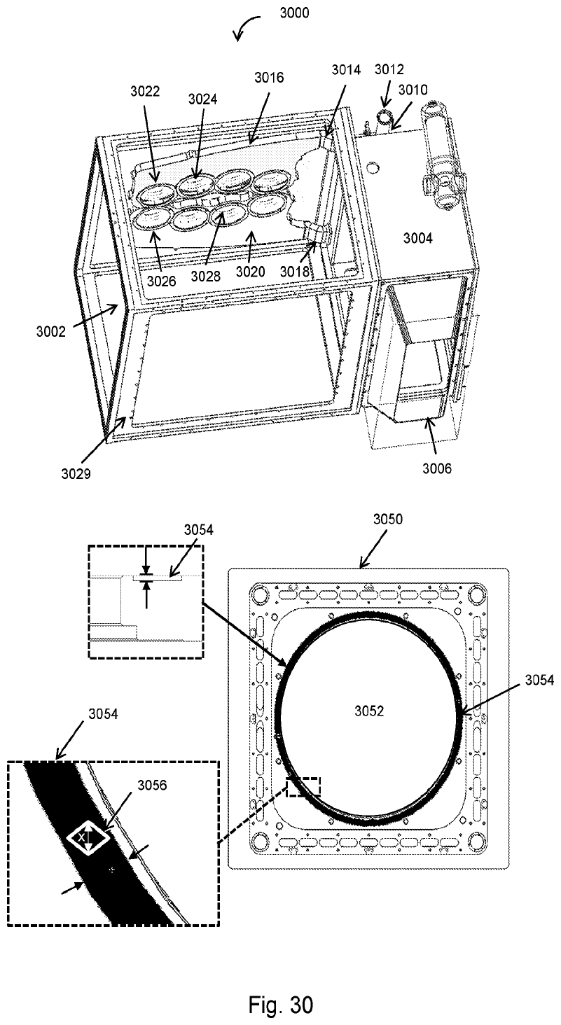

In some embodiments, the 3D printing system comprises alignment features to facilitate calibration of one or more energy beams of the 3D printing system. As depicted in FIG. 30, a processing chamber floor 3050 comprises an opening 3052 configured to accommodate a build plate (not shown). The processing chamber floor 3050 includes a circumference portion 3054 surrounding the opening 3052. Circumference portion 3054 comprises a divot (e.g., channel, cavity, trough, notched region) concentrically oriented to the build plate opening and surrounding the outer perimeter of the opening 3052. The Circumference portion 3054 comprises a dimension (e.g., depth) extending from a surface of the processing chamber floor 3050 which may be accommodating of pre-transformed material, e.g., powder. Circumference portion 3054 comprises a dimension (e.g., a width) that is sufficiently large to accommodate at least one calibration mark generated by an energy beam within the Circumference portion 3054. Circumference portion 3054 may be arranged within a field of view at least one energy beam (e.g., of a plurality of energy beams), such that the at least one energy beam may generate a calibration mark within circumference portion 3054 by transforming at least a portion of the material retained within circumference portion 3054. At times, the calibration mark comprises a rhombus 3056 have a FLS of X as depicted in FIG. 30. The circumference portion may comprise a recessed portion.

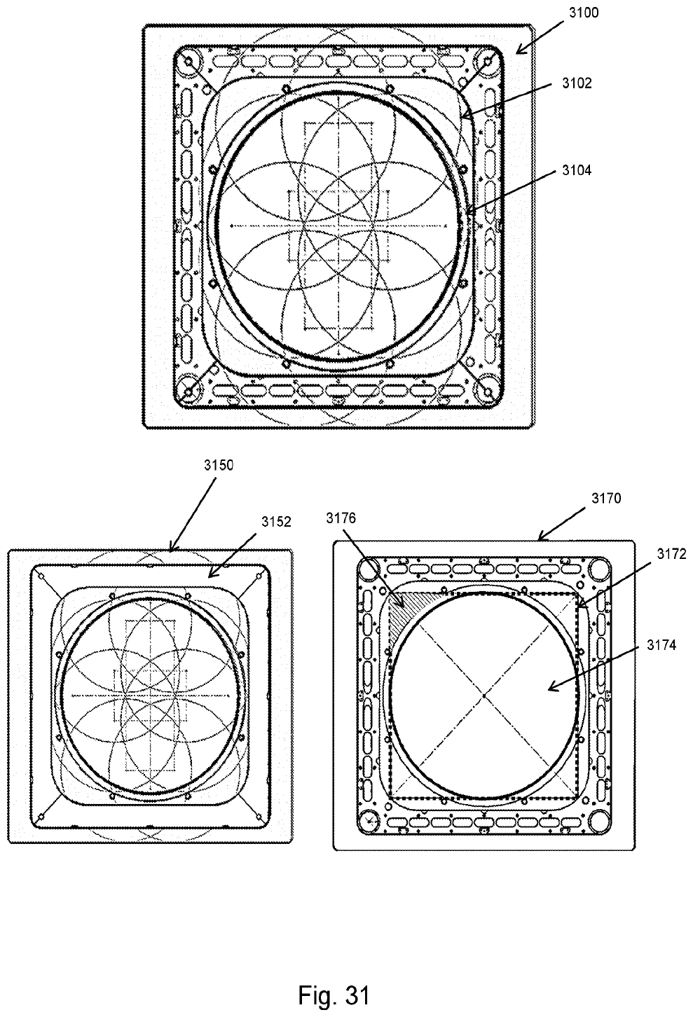

FIG. 31 depicts various horizontal views of processing chamber floors. FIG. 31 depicts an example of a processing chamber floor 3100 and a set of overlapping circles, e.g., circle 3102, representing respective fields of view of energy beams of an optical system (e.g., a plurality of optical assemblies) at the processing chamber floor 3100. As depicted, each circle of the plurality of circles overlaps with a portion of the Circumference portion 3104 of the processing chamber floor 3100, such that a corresponding energy beam for each circle may generate at least one calibration mark in circumference portion 3104. In the example shown in FIG. 31, the processing chamber can act as the unpacking chamber, e.g., at the end of a build cycle. Processing chamber floor 3150 depicts the overlap of respective fields of view of energy beams of an optical system with the processing chamber floor 3150. Processing chamber floor 3150 includes slot coverings, e.g., slot covering 3152. Processing chamber floor 3170 depicted with an overlaid region 3172 corresponding to a field of view of at least one detector and/or at least one projector of a metrological detection system (e.g., a height mapper system). As depicted, the overlaid region 3172 includes a portion, e.g., portion 3176, that is not overlapping with opening 3174 configured to accommodate a built plate (not shown). The portion not overlapping with opening 3174 may include overlap with one or more components of the unpacking station, e.g., with at least one slot covering, such that the metrological detection system may be utilized to detect a property of the at least one slot covering.

FIG. 30 illustrates a schematic partial view example of a processing chamber comprising a plurality of optical window holders disposed in two manifolds. The portion of the 3D printing system 3000 comprises a processing chamber 3002, which may contain an atmosphere such as the one disclosed herein (e.g., a pressurized atmosphere with respect to an ambient atmosphere external to the processing chamber). The portion of the 3D printing system 3000 comprises an ancillary chamber (e.g., garage) portion 3004 with an excess powder exit port 3006. The portion of a 3D printing system 3000 comprises a gas flow system portion. The gas flow system portion comprises a main channel 3010 having an opening port 3012. The main channel connects to a first channel 3014 directing gas into a first manifold 3016, and a second channel 3018 directing gas into a second manifold 3020. The manifolds 3016 and 3018 are operatively coupled to a ceiling of processing chamber 3002. The first manifold 3016 directs gas to a first set of nozzles such as nozzle 3022, each surrounding a respective optical window of a first set of optical windows such as optical window 3024, which nozzles 3022 direct gas into the processing chamber 3002. The second manifold 3020 directs gas to a second set of nozzles such as nozzle 3026, each surrounding a respective optical window of a second set of optical windows such as optical window 3028, which nozzles 3026 direct gas into the processing chamber 3002. The processing chamber has a portion of a floor 3029. Ancillary chamber portion 3004 is configured to accommodate a layer dispensing mechanism (e.g., recoater) configured to dispense at least a portion of a material bed, e.g., a layer of the material bed. Excess starting material from the recoater is released through exit port 3006. Each manifold comprises a plurality of holders supporting each of optical windows, respectively. The device comprising the optical windows is configured to be disposed at a ceiling of a processing chamber in which one or more 3D object can be printed. Each of the optical windows is configured to facilitate passage of a transforming energy beam into the processing chamber.

In some embodiments, the 3D printing system comprises, or is operatively coupled to, a metrological detection system comprising a height mapper system. The height mapper system may comprise one or more detectors (e.g., also referred to herein as sensors), and an optical image generator. The one or more detectors may comprise a metrological detector, e.g., a video camera or a still camera. The optical image generator may comprise a projector or a laser. The optical image generator may generate a detectable optical image. The optical image may comprise areas of different optical intensity having a detectable difference. For example, areas of light and no light. For example, areas of more intense light and areas of discernable diminished light. For example, the optical image generator may generate an optical image having detectable oscillating (e.g., fluctuating) intensity. The optical image may, or may not, vary in time. The optical image generator may project an oscillating image having areas of detectable different optical intensity. The height mapper system may include (1) one or more optical detectors, and (2) one or more optical image generators. The height mapper system may comprise, or be operatively coupled to, one or more processors configured to process the detected image. The one or more processors may be operatively coupled to, or part of, one or more controllers. The one or more controllers (e.g., control system) may be the control may be configured to control the 3D printing of one or more 3D objects. The control system may be a hierarchical control system (e.g., comprising three or more hierarchical levels of control). At times, the height mapper system may comprise a first detector and an additional detector distant from the first detector. The exposed surface of a material bed may be the target surface. The additional detector can be disposed distant from the first optical image generator that is configured to project the image on the exposed surface from another angle. The location of the additional detector can alleviate detection issues, e.g., due to specular reflection, by projecting an image on the exposed surface that will not cause saturation of the detector. At times, the height mapper system may comprise a first projector and an additional projector distant from the first projector. The additional projector can be disposed distant from the detector that is configured to detect the image on the exposed surface. The location of the additional projector can alleviate detection issues, e.g., due to specular reflection, by projecting an image on the exposed surface that will not cause saturation of the detector. A number of optical image generators for a height mapper system may depend, in part, on one or more optical components of the optical image generator, e.g., a lens. For example, a number of optical image generators utilized may depend on (a) a throw of the lens of the projector, (b) a focal length of the lens of the projector, (c) a depth of field of the lens of the projector, (d) a focus of the lens of the projector, or (e) any combination of (a) to (d). The throw of the lens is the distance between a projector lens and the target surface on which light passing the lens is incident. A number of optical image generators for a height mapper system may depend, in part, on one or more FLS of the target surface. For example, a number of optical image generators may be utilized to project a substantially resolvable projected image (e.g., stripes) onto the target surface. The stripes may have discernable stripes of higher light intensity and lower light intensity (e.g., not light) arranged in a pattern such as arranged interchangeably. A number of optical image generators (e.g., projectors) for a height mapper system may depend, in part, on an angle of incidence of the projected image by the optical image generator onto the target surface. For example, an angle of incidence that is at most about 25 degrees, 20 degrees, 15 degrees, or less from the plane of the target surface may result in shadow formation at the target surface (e.g., due to features of the target surface). At times, utilizing two or more optical image generators in the height mapper system may reduce a shadowing effect at the target surface. A number of detectors (e.g., cameras) for a height mapper system may depend, in part, on one or more FLS of the target surface. For example, a number of cameras may be utilized to capture the entire target surface within respective fields of view of the number of cameras. A number of detectors (e.g., cameras) for a height mapper system may depend, at least in part, on optical features generated at the target surface. For example, a number of cameras may be utilized to compensate for specular reflection generated at the target surface.

In some embodiments, optical image generator of the metrological detection system (e.g., height mapper system) projects an image. For example, a light pattern, onto a target surface such as an exposed surface of a material bed. The target surface may comprise a protruding object such as a marker object, or at least a portion of a 3D object. The target surface may include a protruding object. The target surface may include a component of the 3D printing system, e.g., a component of an unpacking station. The target surface may include a flap (e.g., cover) of an unpacking station. The projected image may be a projected pattern. The projected image may be an oscillatory (e.g., fluctuating) pattern. The height mapper system may operate during at least a portion of the 3D printing. For example, the height mapper system can project an image before, after, and/or during the operation of the transforming energy beam. For example, the height mapper system can project an image before operation of a layer dispensing mechanism (e.g., recoater), e.g., to prevent harmful interaction of the layer dispensing mechanism with the protruding object. Harmful may be to the layer dispensing mechanism and/or to the protruding object. The projected image may comprise a shape. The shape may be a geometrical shape. The shape may be a rectangular shape. The shape may comprise a line. The shape may scan the target surface (e.g., exposed surface of the material bed) laterally, for example, from one side of the target surface to its opposing side. The shape may scan at least a portion of the target surface (e.g., in a lateral scan). The scan may be along the length of the exposed surface. The projected shape may span (e.g., occupy) at least a portion of the width of the target surface. For example, the shape may span a portion of the width of the target surface, the width of the target surface, or exceed the width of the target surface. The shape may scan the at least a portion of the target surface before, after and/or during the 3D printing. The scan may be controlled manually and/or automatically (e.g., by a controller). The projected shape may be of an electromagnetic radiation (e.g., visible light). The projected shape may be detectable. The projected shape may be formed by an energy beam scanning the target surface at a frequency of at least about 0.1 Hertz (Hz), 0.2 Hz, 0.5 Hz, 0.7 Hz, 1 Hz, 1.5 Hz, 2 Hz, 3 Hz, 4 Hz, 5 Hz, 6 Hz, 7 Hz, 8 Hz, 10 Hz, 20 Hz, 50 Hz, 100 Hz, 200 Hz, 300 Hz, 400 Hz, or 500 Hz. The projected shape may be formed by an energy beam scanning can the target surface at a frequency between any of the afore-mentioned frequencies (e.g., from about 0.1 Hz to about 500 Hz, from about 1 Hz to about 500 Hz, from about 1 Hz to about 100 Hz, from about 0.1 Hz to about 100 Hz, from about 0.1 Hz, to about 1 Hz, from about 0.5 Hz to about 8 Hz, or from about 1 Hz to about 8 Hz). At times, the projected image is altered in time. The projected image may alter in time by any of the above frequencies of the energy beam scan. The projected image may comprise (e.g., alternating) stripes. The distance between the stripes may be constant. The distance between the stripes may be variable. The distance between the stripes may be varied (e.g., manually or by a controller) in real time. Real time may be when performing metrological detection. Real time may be when building (e.g., printing) the 3D object. Real time may be before, during, or after a translation of the translation mechanism with respect to the processing chamber. The deviation from the regularity (e.g., linearity) of the stripes may reveal a height deviation from the average (or mean) exposed surface (e.g., of the material bed) height. The shape of the deviation from regularity (e.g., linearity) may reveal a shape characteristic of the buried 3D object portion (that is buried in the material bed). The deviated (e.g., curved) lines above a 3D object may relate to a warping of the 3D object that is (immediately) underneath. The regularity (e.g., linearity) of the lines detected above the 3D object may relate to the planarity of the top surface of the 3D object that is (immediately) underneath. For example, lines above the 3D object (whether buried in the material bed, or exposed) that match the regularity of the projected image, may reveal a planar top surface of a 3D object. For example, a deviation from the regularity of the projected image above the 3D object (whether buried in the material bed, or exposed), may reveal a deformation in the top surface of a 3D object. For example, linear lines above the 3D object may reveal a planar top surface of a 3D object, when the metrology projector projects stripes. For example, non-linear (e.g., curved) lines above the 3D object may reveal a non-planar (e.g., curved) top surface of a 3D object, when the metrology projector projects stripes. The reflectivity of the target surface may indicate the planar uniformity of the exposed surface. At times, a fluctuating pattern may be apparent on at least a portion of the target surface. In some embodiments the fluctuating pattern is detectable (e.g., may appear) on at least a portion of the target surface, wherein fluctuating intensity pattern is presented as a function of location (e.g., of at least a portion of the target surface).

At times, the target surface is planar and tilted with respect to the horizon. In some embodiments, the height mapper system detects a planar target surface that deviates from its horizontal placement. The target surface may or may not have protruding objects therefrom. The deviation from planarity may cause a deviation (e.g., deformation) in the projected image apparent on the planar surface that is horizontally oriented as compared to the original image utilized for the projection. For example, the projected image includes parallel rectangular shapes. When this image is projected on the target surface that is horizontally aligned, the shapes will be detected as parallel and rectangular. When this image is projected on the target surface that deviates from its horizontal alignment (e.g., a slanted surface), the image detected may include trapezoid shapes instead of the rectangular shapes. The degree of deviation between the rectangular shape to the trapezoid shape may be indicative on the degree and/or direction of deviation from planarity of the target surface. The size of the features (e.g., shapes) of the image as projected onto the target surface, may facilitate determination of the vertical distance of the target surface from the detector and/or projector. This distance may correlate to a distance from the floor of the build module.

At times, one or more components of the height mapper system may be translatable. At times, the translation mechanism is configured to translate at least one component of a metrological detection system. The at least one component of the metrological detection system may be affixed to a same or a different support mount than the support mount of the optical assemblies. The at least one component of the metrological detection system may be translated asynchronously or synchronously to a translation of the optical assemblies. For example, the one or more components of the height mapper system may be operatively coupled to, or a part of, the translatable optical system. For example, the one or more components of the height mapper system may be separately translatable from the translatable optical system. The one or more components that may be translatable can include (A) one or more detectors, (B) one or more projectors, or (C) a combination of (A) and (B). One or more components of the height mapper system may be stationary (e.g., non-translatable). The one or more stationary components can include (A) at least one detector, (B) at least one projector, or (C) a combination of (A) and (B). The height mapper system may include at least one translatable component and at least one non-translatable component. The at least one translatable component and the at least one non-translatable component may be of a same type or of a different type. The at least one translatable component may be of a first type (e.g., a detector or an optical image generator) and the at least one non-translatable component may of a second, different type (e.g., an optical image generator or a detector). At times, components of the height mapper system may be arranged with respect to at least one other component based on a symmetry of the components. Components of the height mapper system may be arranged with respect to at least one other component based on a plurality of symmetries of the components. For example, a location of a detector of the height mapper system may depend at least in part on a location of (A) another detector of the height mapper system, (B) an optical image generator of the height mapper system, or (C) a combination of (A) and (B). For example, a location of an optical image generator of the height mapper system may depend in part on a location of (A) another optical image generator of the height mapper system, (B) a detector of the height mapper system, or (C) a combination of (A) and (B). At times, components of the height mapper system may comprise a set of optical image generator(s) and detector(s). For example, one optical image generator and two detectors. For example, two optical image generators and one detector. For example, two or more optical image generators and two or more detectors. The height mapper system may comprise multiple sets of components, where each set of components may be arranged with respect to another set of components via one or more symmetries. At least one component of the height mapper system may be arranged with respect to the array of optical assemblies. The at least one component of the height mapper system may be arranged between linear arrays of the optical assemblies. Between may comprise bounded on two sides by a central axis of each of the linear arrays. Between may comprise located adjacent to (e.g., immediately proximate) to respective central axes of each of the linear arrays of optical assemblies. Between may comprise being two immediately adjacent linear arrays devoid of an intervening linear array disposed between the two immediately adjacent linear arrays. Between may comprise located adjacent to (e.g., immediately proximate) to respective outer surfaces of respective housings of at least two optical assemblies. Between may comprise being two immediately adjacent optical assemblies devoid of an intervening optical assembly disposed between the two immediately adjacent optical assemblies.

At times, at least one optical assembly of the array of optical assemblies includes a component of the height mapper system enclosed by a housing of the optical assembly. At times, each optical assembly of the array of optical assemblies includes a component of the height mapper system enclosed by a respective housing of each optical assembly. At times, at least one optical assembly of the array of optical assemblies excludes (does not include) a component of the height mapper system enclosed by the housing of the optical assembly. The component may comprise a detector or an optical image generator (e.g., a projector). The detector may be a camera, e.g., a video camera or a still camera. The detector may be arranged with respect to the optical assembly such that at least a portion of a field of view of the detector overlaps with an opening of the housing of the optical assembly. The detector may be arranged with respect to the optical assembly such that at least a portion of a field of view of the detector overlaps with a beam path of an energy beam of the optical assembly. The detector may be arranged with respect to the optical assembly such that at least a portion of the field of view of the detector overlaps with an optical window coupled with an opening of the optical assembly through which energy beam(s) emerge on their way to the target surface. The detector may be arranged with respect to the optical assembly such that the detector may capture imaging data within a field of view of the detector at least a portion of the target surface (e.g., at least a portion of a processing region of the target surface). At times, a first type of component of the height mapper system is enclosed within at least one housing of an optical assembly (e.g., a detector or an optical image generator, and a second, different type of component of the height mapper system is located outside the housing of the optical assembly (e.g., an optical image generator or detector). At times, at least two detectors may be arranged with respect to respective optical assemblies of the array of optical assemblies, where the two detectors may capture imaging data with respective fields of view of the detectors. The at least two detectors may have at least a portion of overlapping fields of view. The at least two detectors may have adjacent fields of view, e.g., may capture adjacent (e.g., abutting) portions of the target surface within their respective fields of view. For example, each detector may capture a field of view having a resolution area of about 300 millimeters (mm)×300 mm, about 250 mm×250 mm, about 200 mm×200 mm, about 150 mm×150 mm, or less. For example, each detector may capture a field of view having a resolution area of about 6%, about 5%, about 4%, about 3%, about 2%, about 1%, about 0.5%, about 0.25% or less of the area of the target surface. Each detector may capture a field of view having a resolution area between any of the aforementioned values relative to the area of the target surface, for example, from about 6% to about 3%, from about 4% to about 1%, or from about 2% to about 0.25%. Captured imaging data may be processed to combine (e.g., stitch) the imaging data from different detectors together (e.g., mosaicked) to generate combined imaging data of the at least two fields of view.

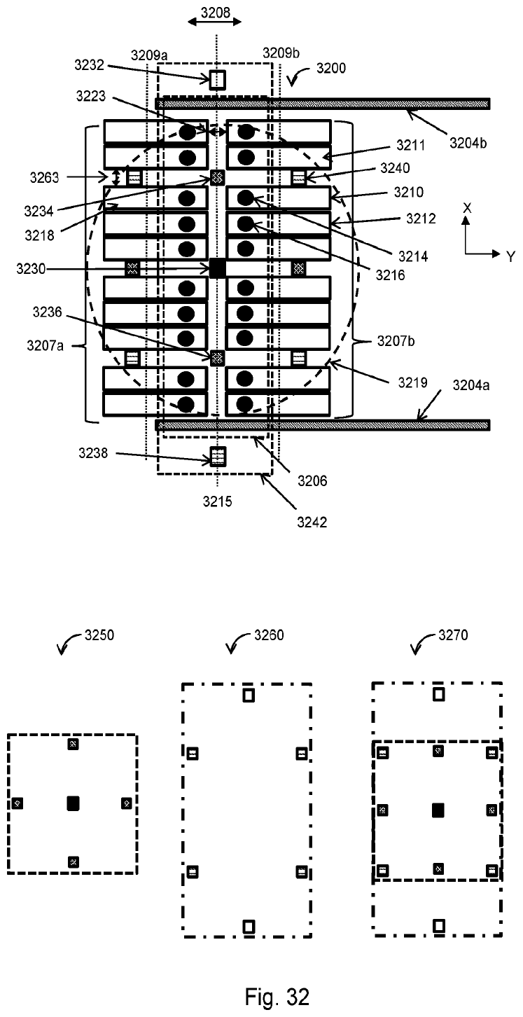

FIG. 32 depicts an example translatable optical system 3200 including a height mapper system. Translatable optical system 3200 includes a rail system including rails 3204a, 3204b. A support mount 3206 is operatively coupled to the rails 3204a, 3204b such that the support mount may translate along rails 3204a, 3204b along a direction 3208, e.g., aligned with the Y-axis. Rails 3204a, 3204b and/or support mount 3206 may be operatively coupled to an actuator (e.g., a motor) and an encoder (e.g., an optical encoder), not shown. The support mount 3206 is operatively coupled to (e.g., engaged with) optical assemblies, e.g., optical assemblies 3210, 3212. The optical assemblies are arranged in respective linear arrays 3207a, 3207b, where the optical assemblies of each linear array are arranged along a respective central axis 3209a, 3209b. The optical assemblies may be reversibly engaged with the support mount 3206 by fixtures, e.g., mounting hardware. The support mount 3206 can align the openings of the optical assemblies, e.g., openings 3214, 3216, with respect to a target surface 3219 within an enclosure. Adjacent optical assemblies are separated along the y-axis by a spacing 3223, e.g., optical assemblies 3210 and 3218 are separated by spacing 3223. Spacing 3223 is sufficiently large to accommodate one or more components of the height mapper system. Two or more optical assemblies are separated along the X-axis by a gap 3263, e.g., optical assembly 3210 and 3211 are separated by gap 3263. Gap 3263 is sufficiently large to accommodate one or more components of the height mapper system. The height mapper system includes at least one component of a first type, e.g., either a detector or an optical image generator, e.g., component 3230. The height mapper system includes at least one component of a second type, e.g., either an optical image generator or a detector, e.g., component 3232. The at least one component of the first type and the at least one component of the second type are aligned with axis 3215, that is parallel to axis 3209a, 3209b (e.g., parallel to the X-axis). Optionally, the height mapper system includes two or more components of the first type, e.g., components 3230, 3234, 3236. Optionally, the height mapper system includes two or more components of the second type, e.g., components 3232, 3238, 3240. As depicted in FIG. 32, the first type of components is operatively coupled to the support mount 3206 and configured to translate with the translatable optical system 3200. Optionally, the second type of components is not operatively coupled to the support mount 3206 and can be affixed to a surface of the enclosure (e.g., a ceiling of the processing chamber). Optionally, the second type of components may be operatively coupled to the support mount 3206 or to another translatable mount 3242 that is configured to translated along direction 3208. FIG. 32 depicts schematic views of example arrays of components of a height mapper system. A first type of components, e.g., a detector or an optical image generator, is arranged in an array of first type components 3250. A second type of components, e.g., an optical image generator or a detector, is arranged in an array of second type components 3260. The array of the first type components 3250 and the array of the second type components 3260 are overlaid such that the two types of components are interleaved, overlapped, staggered, or disposed interchangeably in a combined array of first and second type components 3270.

At times, a build module of a 3D printing system is configured for operational coupling (e.g., engagement) with an unpacking station. Examples unpacking stations, 3D printing systems, their components, associated methods of use, software, devices, systems, and apparatuses, can be found in International Patent Application Serial Number PCT/US17/39422, titled “THREE-DIMENSIONAL PRINTING AND THREE-DIMENSIONAL PRINTERS,” filed on Jun. 27, 2017, which is incorporated herein by reference in its entirety. The unpacking station may be configured to engage with at least one build module (e.g., FIG. 33, 3330). The unpacking station may be configured to manipulate (e.g., insert and/or remove) at least one build module to an unpacking chamber. The build module may comprise a platform upon which a 3D object (e.g., FIG. 33, 3306) formed by the 3D printing rests and/or is attached. The build module may comprise (e.g., un-transformed) pre-transformed material disposed surrounding the formed 3D object, e.g., a material collection, FIG. 33, 3308. The unpacking station may be configured to remove (e.g., separate) a formed 3D object from a build plate (e.g., of the build module). The unpacking station may be configured to remove (e.g., recycle) at least some of the pre-transformed material from the build module. The unpacking may comprise a manipulator arm that is configured to grasp and to move a 3D object formed by the 3D printing and/or a build module. The unpacking may be a glove box that is configured to allow an operator in an ambient environment to grasp and to move a 3D object located in an environment different from ambient (e.g., an inert environment). The unpacking station may comprise a gas conveyor system. The unpacking station may comprise an unpacking material conveyor system. The gas and/or material conveyor systems may comprise at least one compressor, at least one blower, or at least one valve. In some embodiments, the unpacking material conveyor system forms a part of a material conveyor system of a coupled 3D printing system. In some embodiments, the unpacking material conveyor system is separate (e.g., distinct) from a material conveyor system of a coupled 3D printing system. The unpacking material conveyor system may comprise any of the components and/or any of the component arrangements of the 3D printing system material conveyor system(s) described herein.

FIG. 33 depicts an example of a (e.g., pre-transformed) material conveyor system coupled to an unpacking chamber (e.g., 3370) of an unpacking station 3300, relative to gravitational vector 3390 pointing to the gravitational center of the ambient environment. The material conveyor system may comprise at least one pressure container. The example of FIG. 33 depicts two pressure containers 3305 and 3310. At least one pressure container may contain pre-transformed material (e.g., during operation of the material conveyor). At least one pressure container may contain a low amount of pre-transformed material (e.g., no pre-transformed material) during operation of the material conveyor. The pre-transformed material may be inserted into the two pressure containers from an external material source (e.g., a bulk feed 3320) and/or from at least one (e.g., sieve assembly) separator (e.g., 3355). A bulk feed reservoir may provide material to the pressure container(s) via a coupling with a separator (e.g., cyclonic) and/or the unpacking chamber (e.g., via the vacuum wand). The pre-transformed material may be inserted into at least two pressure containers (e.g., substantially) simultaneously. The pre-transformed material may be inserted into at least two pressure containers alternatingly. The pre-transformed material may be inserted into at least two pressure containers in a (e.g., predetermined) sequence. The insertion of the pre-transformed material into the pressure container may be controlled. Control may comprise using one or more valves (e.g., 3322, and/or 3324). The valves may be any valve described herein. In some examples, the unpacking station material conveyor system may comprise a plurality of gas conveying channels. At least two of the plurality of gas conveying channels may have at least one channel characteristic that is (e.g., substantially) the same. At least two of the plurality of gas conveying channels may have at least one channel characteristic that is different. The gas conveying channel may convey gas to one or more components of the unpacking station material conveyor system. The gas may comprise a pressure. The gas conveying channel may equilibrate pressure and/or content within one or more components of the unpacking station material conveyor system. For example, a gas conveying channel may equilibrate a first atmosphere within an unpacking chamber with a second atmosphere (e.g., of the bulk reservoir and/or of the pressure container(s)). The first atmosphere and/or second atmosphere may be a (e.g., substantially) inert atmosphere. The gas conveying channel may be operatively coupled (e.g., fluidly connected) to at least one of the material conveying channel(s), the pressure container(s), the unpacking chamber, the cyclone separator, the sieve assembly, the trash container, and/or the bulk reservoir.

In the example of FIG. 33 a material removal device (e.g., suction mechanism) 3368 such as a vacuum wand, is configured to remove material from a material collection 3308 within the unpacking enclosure, e.g., unpacking chamber. The material removal device may be operatively (e.g., fluidly) coupled with at least one attractive force source. The unpacking chamber may be operatively coupled to an accelerated gas mechanism, e.g., a blower, a fan, or a pump. A fluid coupling may comprise a coupling that facilitates a flow therethrough of (i) a fluid, (ii) a gas, (iii) a plasma, or (iv) any combination thereof. A fluid may comprise a mixture of a solid (e.g., phase) material and a liquid or a gas. The accelerated gas mechanism may be operable to establish a pressure gradient within a channel, e.g., a gas conveyor channel and/or a material conveyor channel. The pressure gradient may be above ambient pressure external to the unpacking enclosure. A pressure gradient may facilitate movement of a gas and/or a material remainder in the channel. The material remainder may be removed from around (e.g., surrounding) formed 3D object(s) disposed above the build module such as printed 3D object(s). The material remainder may be removed from a surface of the unpacking chamber, e.g., from a bottom surface, where bottom is with respect to a gravitational field vector 3390. The removed material may be conveyed to a separator by a channel, e.g., 3358. The material collection may comprise (i) pre-transformed material (e.g., that surrounds a formed 3D object) or (ii) debris such as soot. The material to be collected 3308 may be brought by a build module engaged with the unpacking station, e.g., as the build plate is pushed upwards from within the build module towards the unpacking chamber. In some embodiments, one or more mechanisms may be used to facilitate material removal from (e.g., a surrounding of) the printed 3D object, the material removal taking place in the unpacking chamber. The unpacking station may be operatively coupled to an attractive force source. The unpacking station may be operatively coupled to an accelerated gas mechanism (e.g., a blower, a fan, or a pump). The accelerated gas mechanism may intake a gas from one of its sides (e.g., suck the gas), and eject the gas from another of its sides, e.g., blow the gas out of the unpacking chamber. The other side may oppose the first side. In the example of FIG. 33 an accelerated gas mechanism 3335 (e.g., a blow-off wand) is disposed to direct a positively pressurized gas toward a 3D object to separate (e.g., loosen) material surrounding the 3D object. In some embodiments, the removed material is provided to a (e.g., first) separator 3350, e.g., a cyclone separator. In some embodiments, a (e.g., cyclonic) separator is fluidly coupled with the blow-off wand. For example, a blower may be disposed in a channel between the cyclone separator and the blow-off wand. The channel may comprise one or more valves. The channel may comprise one or more filters. In the example of FIG. 33 a filter 3312 is disposed between the separator and a blower 3315. The one or more filters may filter any materials (e.g., soot) remaining in the gas following separation by the first (e.g., cyclonic) separator. In some embodiments, the material conveyor comprises at least two cyclone separators. The at least two cyclones may be coupled in parallel and/or in series. In the example of FIG. 33 a (e.g., second) separator 3355 (e.g., a sieve assembly) is coupled with the separator 3350. In some embodiments, the material conveyor system comprises at least two sieve assemblies. The at least two sieve assemblies may be coupled in parallel and/or in series. A sieve assembly may be coupled with a material removal (e.g., trash) container. The sieve assembly may be configured to remove debris from the (e.g., pre-transformed) material, e.g., to the trash container. The sieve assembly may provide (e.g., filtered) sieved material to the pressure container(s).

In some embodiments, a pressure container contains one or more sensors configured to detect a material level within and/or a material flux into the pressure container. The one or more sensors can be any sensor as described herein. In response to a (e.g., detected) filled condition of a pressure container, the unpacking station may be configured to remove at least a portion of the material from the pressure container. The pressure container may be (e.g., fluidly) coupled with a removal channel, e.g., FIG. 33, 3328. The removal channel may reversibly engage with at least a second (e.g., pressure) container, e.g., FIG. 33, 3325. The second container may be internal and/or external to the unpacking station. The second container may comprise (i) a second pressure container, and/or (ii) a material reservoir, e.g., of a 3D printing system. The second pressure container may be disposed (a) within the unpacking station, (b) within a 3D printing system, and/or (c) on a portable vessel. The removal channel may facilitate removal of the material from the filled pressure container to the second pressure container and/or the material reservoir. In some embodiments, the removal channel is coupled with the portable vessel. The portable vessel removal channel (e.g., umbilical channel) may be used to facilitate a first transfer of material from a first (e.g., filled) pressure container, and a second transfer of material to a second pressure container.

In some embodiments, the unpacking station comprises a material removal device such as a suction mechanism (e.g., a vacuum wand). The material removal device may comprise at least one conduit (e.g., two or more conduits). The conduit may comprise, for example, a tube, channel, or pipe. The conduit may comprise a cross-sectional shape that is, for example, circular, ellipsoidal, rectangular, polygonal, or irregular shape. The conduit may comprise a first opening coupled to a channel (e.g., the gas conveyor channel and/or material conveyor channel). The conduit may comprise a second opening opposite the conduit from the first opening and configured to suction the material (e.g., from the material bed). The conduit may be elongated along a length perpendicular to the first opening and the second opening. The second opening may comprise one or more entry features configured to facilitate the suction of the material. For example, entry features may reduce agglomeration (e.g., bridging) of material at the second opening during the suction process. Entry features may comprise, for example, (A) scallops, (B) divots, (C) texture, or (D) any combination thereof. The second opening may define a surface that is oriented at an angle with respect to an elongated axis of the second conduit. At times, the material removal device comprises a cover configured to adjust a flow through the conduit. The cover may comprise an aperture(s). The aperture may be adjustable. For example, at least one FLS of the aperture may be adjustable. The cover may comprise a plurality of aperture. The aperture may comprise an adjustable area of the opening, e.g., an adjustable cross-sectional area and/or shape. The aperture may comprise an iris, or be part of an iris. The cover may be configured to adjust (A) a number of openings, (B) a dimension of at least one opening, (C) an orientation of at least one opening with respect to the conduit, or (D) any combination of (A) to (C). The aperture may be rotatable and/or translatable, e.g., in 2D or in 3D. The cover may be arranged at (e.g., adjacent to) the second opening. The cover may be arranged within the conduit (e.g., perpendicular to the flow) between the first opening and the second opening. The cover may be arranged at (e.g., adjacent to) the first opening. At times, the material removal device may comprise two or more (e.g., a plurality of) covers. At least two covers may be of a same type, e.g., having a same type of aperture(s). At least two covers may be of a different type, e.g., having a different type of aperture(s). A cover may comprise non-adjustable aperture(s). The aperture(s) of the cover may be adjusted to change (A) a volume of flow through the material removal device, (B) a flow rate of the flow through the material removal device, (C) a tendency of the material to bridge (e.g., agglomerate) within the material removal device, or (D) any combination of (A) to (C). In some embodiments, the material removal device comprises a grip or handle, for a user to hold and/or manipulate before, during, or after an unpacking process. The grip or handle may be adjustable, e.g., have an adjustable position with respect to the material removal device. In some embodiments, the material removal device may comprise, or be operatively coupled to, a flexible (e.g., extendable, bendable, and/or non-rigid) hose to facilitate positioning the material removal device within the processing chamber before, during, or after an unpacking process. The flexible hose may be coupled to a first opening of the conduit.

In some embodiments, the unpacking stations and/or 3D printer comprises a material removal device. At least a portion of the material removal device (e.g., vacuum wand) may be portable, e.g., within the enclosure it is disposed. The material removal device may be utilized by an operator, e.g., using a glove box arrangement such as the one disclose herein. Utilization by the operator may comprise maneuvering the material removal device, e.g., in three dimensions. The maneuvering of the material removal device may be confined to the enclosure in which it is disposed, e.g., to the processing chamber and/or to the unpacking chamber. The material removal device may comprise elemental metal, metal alloy, elemental carbon, or ceramic. The material removal device may comprise a composite material (e.g., as disclosed herein). The material removal device may comprise glass, stone, zeolite, or a polymeric material. The polymeric material may comprise silicone, a hydrocarbon, or a fluorocarbon. The polymeric material may comprise rubber. The material removal device may comprise Teflon. The material removal device may comprise an opaque portion or a transparent portion.

In some embodiments, the material removal device is configured to remove flowable material, e.g., during its removal. The material to be removed may lose its fluidity and/or become bridged (e.g., clump up, aggregate, or agglomerate) during its attempted removal. It may be requested to (e.g., substantially) maintain the remainder material in its fluid state to facilitate its removal, e.g., undisturbed removal. For example, the material removal device is configured to remove powder, e.g., without its agglomeration, or clumping, during removal. In some embodiments, the material removal device is configured to remove flowable material without its blinding (e.g., clogging) during a removal operation such as during removal of remainder material from a material bed after a printing cycle. The material removal mechanism may comprise (i) conducts or (ii) perforations. At least two of the channels may be at least partially nested one within the other. The perforations (e.g., holes) may comprise vents. The perforations may be disposed at a side of the material removal device, and/or at an end of the material removal device. The material removal device may be elongated, e.g., may comprise a long axis. The side of the material removal device may be along its long axis. the side of the material removal device may be along a side of the conduit, e.g., a body of the conduit. The perforations may be along a body of a conduit. The end of the material removal device may comprise an end of the conduit. A first end of the material removal device may be operatively coupled to an attractive force source. The material to be attracted may be attracted into the device and flow towards the attractive force source. The material to be attracted may ingress the material removal device through a second end of the material removal device opposing its first end. In some embodiments, the material removal device comprises at least two conduits. Each of the conduits may be hollow. Each of the conduits may have an inner (e.g., cylindrical) volume. A second conduit may be arranged encircling (e.g., surrounding, encompassing, enclosing) a portion of the first conduit. The first conduit may be nestled at least in part within the second conduit. The first conduit may extend along an axis and comprise a first opening coupled to a channel (e.g., the gas conveyor channel and/or material conveyor channel). The first conduit may comprise a second opening opposite the conduit from the first opening and configured to suction the material (e.g., from the material bed). The second conduit may extend along the same axis. At least two of the conduits may be concentrically arranged, e.g., along the long axis of the material removal device. For example, a second conduit and a first conduit may be concentrically arranged, e.g., share a same central axis. At times, an orientation of at least one second conduit with respect to an orientation of at least one first conduit may be adjustable (e.g., variable, adaptable, movable). At times, an orientation of at least one first conduit with respect to an orientation of at least one second conduit may be adjustable. Adjustable may comprise (A) a translation, (B) a rotation, or (C) a combination thereof. At least one second conduit may be translatable with respect to at least one first conduit along an axis of the material removal device, e.g., along an axis aligned with an elongated dimension of the first conduit and/or the second conduit. Translation of the at least one second conduit with respect to the at least one first conduit may comprise modifying an amount of overlap between a first portion of a second conduit and a second portion of a first conduit. The first conduit may be translatable with respect to the second conduit along an axis, e.g., along an axis aligned with an elongated dimension of the first conduit and/or the second conduit. Translation of the at least one first conduit with respect to the at least one second conduit may comprise modifying an amount of overlap between a second portion of the first conduit and a first portion of the second conduit. The at least one second conduit may be rotatable with respect the at least one first conduit about an axis, e.g., about an axis align with an elongated dimension of the first conduit and/or the second conduit. Rotation of a second conduit with respect to a first conduit may comprise modifying an orientation of the second conduit with respect to the first conduit. The first conduit may be rotatable with respect the second conduit about an axis, e.g., about an axis align with an elongated dimension of the first conduit and/or the second conduit. Rotation of the first conduit with respect to the second conduit may comprise modifying an orientation of the first conduit with respect to the second conduit. Adjusting the respective orientations of the at least one second conduit and the at least one first conduit with respect to each other can adjust a characteristic of the material removal device. For example, adjusting the respective orientations of a first and second conduits with respect to each other can adjust (A) a volume of flow through the material removal device, (B) a flow rate of the flow through the material removal device, (C) a tendency for the material to bridge (e.g., agglomerate) within the material removal device, or (D) any combination of (A) to (C). In some embodiments, the second conduit comprises one or more perforations acting as vents. The perforations(s) may comprise slots, holes, or windows. The perforations(s) may extend from an outer surface of the second conduit to an inner surface of the second conduit. The perforations(s) may extend through a dimension of the second conduit. The perforations(s) may be arranged about an outer perimeter of the second conduit. For example, the perforations(s) may be arranged about an outer circumference of the second conduit. The perforations(s) may be distributed evenly about the outer perimeter of the second conduit. The perforations(s) may comprise an elongated dimension along an axis, e.g., along an axis aligned with the elongated dimension of the second conduit and/or the first conduit. The perforations(s) may comprise an elongated dimension that is less than a dimension of the second conduit (e.g., than an elongated dimension of the second conduit). In some embodiments, perforations(s) of the second conduit overlaps with a portion of the first conduit. In some embodiments, at least a portion of at least one perforation of the second conduit overlaps with a portion of the first conduit. At times, the perforations(s) of the second conduit may be arranged with respect to the first conduit to adjust (A) a volume of flow through the material removal device, (B) a flow rate of the flow through the material removal device, (C) a tendency for the material to bridge (e.g., agglomerate, or clog) within the material removal device, or (D) any combination of (A) to (C). For example, the perforation(s) of the second conduit with respect to the first conduit (e.g., with respect to an opening of the first conduit) may generate a Venturi, or a Venturi-type, nozzle. In some embodiments, the material removal device may comprise a fixture configured to affix respective orientations of the at least one second conduit and the at least one first conduit with respect to each other. A fixture may comprise, for example, a pin, hook, latch, set screw, or notch. For example, the fixture may be utilized to set a fixed orientation (e.g., an overlap) of the second conduit with respect to the first conduit, e.g., or vice-versa.

FIG. 34 depicts various views of material removal device and components thereof. material removal device 3400 (e.g., a vacuum wand) comprises a first conduit 3404 and a second conduit 3402, where a portion 3406 of second conduit 3402 at least partially overlaps a portion 3408 of first conduit 3404. As depicted, second conduit 3402 comprises perforations (e.g., acting as vents), e.g., perforation 3410, which are elongated along an axis 3412. A set screw 3414 affixes a position of the second conduit 3402 with respect to the first conduit 3404. A second opening 3416 of the first conduit 3404 is coupled to a material remover (e.g., a pump) via a material conveyer channel and/or gas conveyer channel (not shown). A first opening disposed in the direction 3418 of the first conduit 3404 may be utilized to facilitate an unpacking process, e.g., to attract material remainder and/or debris from a material bed. The first opening being covered by the second conduit 3402 in the example shown in 3400. The perforations of the second conduit 3402, e.g., perforation 3410, are configured to facilitate gas flow through the perforations and into the first opening in the direction 3418 of the first conduit 3404. The second conduit having a third opening in the direction 3418 and an opposing fourth opening sliding along 3404. The fourth opening of the second conduit 3402 is closer to second opening 3416 than the third opening. The fourth opening of the second conduit 3402 is further away from the first opening of the first conduit 3404. Views 3420 and 3422 depict various partial views of the second conduit with respect to the first conduit. View 3420 depicts second conduit 3424 with respect to the first conduit 3426 including perforations, e.g., perforation 3427. View 3422 depicts a cross-sectional view of the second conduit 3428 with respect to first conduit 3430 including perforations, e.g., perforation 3429. Respective flow paths 3432 and 3434 indicated on views 3420 and 3422 indicate a flow of gas and/or non-gaseous material (e.g., powder) during an unpacking process via respective perforations, e.g., perforations 3427 and 3429. Respective flow paths 3436 and 3438 indicated on views 3420 and 3422 indicate a flow of gas and/or material during an unpacking process from between the second conduit and first conduit. Respective flow paths 3433 and 3435 indicated on views 3420 and 3422 indicate a flow of gas and/or material during an unpacking process through respective perforations 3427 and 3429. View 3440 depicts a conduit 3442 comprising recessed (e.g., scalloped) edges, e.g., edge 3444. View 3450 depicts a conduit 3452 having a first opening 3454 that is oriented at an angle 3456 with respect to an axis 3460 oriented along a length of the conduit 3452 having a long axis. Conduit 3452 includes a fixture 3462 configured to secure opening 3466 to a channel such as a flexible hose (not shown). The channel may be operatively coupled to an attractive force source, to a material conveyance system and/or to a gas conveyance system. The first opening of the first conduit and/or the third opening of the third conduit, may comprise a cover covering the respective opening(s). Covers 3470 and 3472 includes respective apertures, e.g., apertures such as 3474 and 3476. Cover 3470 includes a rotational adjustment 3478 configured to adjust at least one FLS (e.g., an area) of the apertures, e.g., aperture 3474. Cover 3472 includes a translational adjustment 3480 configured to adjust at least one FLS (e.g., an area) of the apertures, e.g., aperture 3476.

At times, temperature conditioning of the material removal device and/or the material to be removed is requested. For example, the material removal mechanism may be requested to cool during removal of the material, e.g., using a temperature conditioning system. In some embodiments, a material removal device comprises, or is operatively coupled to, a temperature conditioning system, e.g., any temperature conditioning system disclosed herein. For example, the vacuum wand may comprise, or be operatively coupled to, a temperature conditioning system. The material removal device may comprise one or more channels disposed at a portion of its first conduit. The one or more channels may be disposed at the portion of the first conduit away from the second conduit, e.g., towards an opening of the first conduit (e.g., FIG. 34, 3416) that opposes the second conduit (e.g., FIG. 34, 3402). The temperature conditioning system may control (e.g., alter and/or maintain) the temperature of a material attracted through the material removal device and/or various portions of the material removal device. For example, temperature conditioning system may reduce the temperature of a remainder material attracted through the material removal device and/or various portions of the material removal device, e.g., at least a portion of the first conduit of the device. The temperature conditioning system may comprise a heat transfer device, e.g., a cooling member. The temperature conditioning system may comprise at least one channel. The temperature conditioning system may comprise a heater, a cooler, or a heaving ventilation and air conditioning system (HVAC). The temperature conditioning system may comprise a thermostat. The temperature conditioning system may comprise a temperature conditioning material, e.g., a heat exchanger such as a cooling member. The temperature conditioning material may comprise an active temperature exchanger, or a passive temperature exchanger. The temperature conditioning material may comprise an energy conductive material. The temperature conditioning material may comprise an active energy transfer, or a passive energy transfer. The temperature conditioning material may comprise a cooling liquid (e.g., aqueous or oil), cooling gas or cooling solid. The temperature conditioning material may be further connected to a cooler, heater, HVAC, and/or to a thermostat. The fluid (e.g., gas or liquid) comprising the temperature conditioning material may be stationary or circulating. The temperature conditioning material can circulate through a plumbing system. The plumbing system may comprise one or more channels (e.g., pipe, or coil). The temperature conditioning material can be configured to exchange (e.g., absorb/release) heat through any one or combination of heat transfer mechanisms, e.g., conduction, natural convection, forced convection, and radiation. The one or more channels may accommodate the temperature conditioning material. The channel may be configured to facilitate flow a fluid temperature conditioning material comprising a gas, a liquid, or a semisolid (e.g., gel). The temperature conditioning material may comprise air, argon, water, or oil. The temperature conditioning system may comprise a temperature conditioning material. The temperature conditioning material may flow in the channel(s). The temperature conditioning material may stationary. The temperature conditioning material may be configured for high heat conductivity. In some embodiments, the channels comprise a solid temperature conditioning material. For example, the channels may be rods. The temperature conditioning material may comprise a solid temperature exchange material comprising a heat sink. The temperature conditioning material may comprise an elemental metal or a metal alloy. The temperature conditioning material may comprise copper, silver, or aluminum.

Examples. The following are illustrative and non-limiting examples of methods of the present disclosure.

Example 1: In a processing chamber, Inconel-718 powder having a diameter distribution of from about 15 micrometers to about 45 micrometers was dispensed by a layer dispensing mechanism (e.g., recoater), the powder being dispensed above a build plate having a diameter of about 600 mm to form a powder bed, the build plate being similar to the one depicted in FIG. 27, 2781. A layer dispensing mechanism was used to form a powder bed. When idle, a layer dispensing mechanism is parked in an ancillary chamber (e.g., garage) coupled to the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The processing chamber was under an atmosphere that is less reactive with the powder than the ambient atmosphere external to the processing chamber. The internal processing chamber atmosphere comprised argon, oxygen, and humidity. The oxygen as at a concentration of at most about 1000 ppm, and the humidity had a dew point from about −55° C. to about −15° C. The internal processing chamber atmosphere had a pressure of about 16 KPa above atmospheric pressure (e.g., above 101 KPa), and was at ambient temperature. The processing chamber was equipped with eight optical windows such as the ones in roof 1101 of FIG. 11, the optical windows made of sapphire in an arrangement similar to the one depicted in FIG. 30, 3000. Each laser beam was guided by an optical setup in an optical system enclosure such as 1009 of FIG. 10, the optical system enclosure disposed above the processing chamber, the optical chamber comprising a galvanometer scanner. Each of the laser beams originated from a fiber laser and traversed its respective optical window into the processing chamber to impinge on an exposed surface of the powder bed to print layerwise a 3D printer. A metrological detector (height mapper) was disposed between the optical windows (e.g., a portion of which depicted in FIG. 10, 1080) the metrological detector comprising a CCD camera and a projector projecting an oscillating striped image. The layer dispensing mechanism formed a powder bed by sequential layerwise deposition, the powder bed being disposed in a build module above the build plate, the build module being similar to the build module in FIG. 10, 1058. The build plate was disposed above a piston. The build plate traversed down at increments of about 50 μm at a precision of +/−2 micrometers using an optical encoder. The powder bed incrementally weighting at most about 1000 Kg. The elevation mechanism and framing were similar to the ones depicted in FIG. 27, 2780. The powder bed was used for 3D printing of a 3D object using the lasers. After the 3D printing, a remainder of the powder was evacuated using a vacuum wand similar to the vacuum wand depicted in FIG. 18, 1854.

Example 2: In a processing chamber, Inconel-718 powder having a diameter distribution of from about 15 micrometers to about 45 micrometers was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism is parked in an ancillary chamber (e.g., garage) coupled to the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The processing chamber was under an atmosphere that is less reactive with the powder than the ambient atmosphere external to the processing chamber. The internal processing chamber atmosphere comprised argon, oxygen, and humidity. The oxygen as at a concentration of at most about 1000 ppm, and the humidity had a dew point from about −55° C. to about −15° C. The internal processing chamber atmosphere had a pressure of about 16 KPa above atmospheric pressure (e.g., above 101 KPa), and was at ambient temperature. The processing chamber was equipped with two optical windows made of sapphire. Each laser beam was guided by an optical setup in an optical system enclosure, the optical system enclosure disposed above the processing chamber, the optical chamber comprising a galvanometer scanner. Each of the laser beams originated from a fiber laser and traversed its respective optical window into the processing chamber to impinge on an exposed surface of the powder bed to print layerwise a 3D object. A metrological detector (height mapper) was disposed between the optical windows the metrological detector comprising a CCD camera and a projector projecting an oscillating striped image. The layer dispensing mechanism formed a powder bed by sequential layerwise deposition, the powder bed being disposed in a build module above the build plate. The build plate was disposed above a piston. The build plate traversed down at increments of about 50 μm at a precision of +/−2 micrometers using an optical encoder. The powder bed was used for layerwise printing the 3D object using the lasers. After the 3D printing, a remainder of the powder was evacuated using a vacuum wand similar to the vacuum wand depicted in FIG. 18, 1854.

Example 3: In a processing chamber, a processing chamber was engaged with a build module enclosing a build plate having a diameter of about 600 mm, the build plate being similar to the one depicted in FIG. 21, 2104. The processing chamber was similar to the one depicted in FIG. 16, 1651. The build plate was disposed at its upmost position in the build module, at the floor of the processing chamber. Around the build plate, slots were arranged along sides of a square in an arrangement similar to the one in FIG. 15, 1500, the slots (e.g., openings) being covered with flaps. After actuators opened four flaps similar to the ones depicted in FIGS. 23, 2300 and 2350, the slots were exposed. FIGS. 24 2430 and 2432 show the flaps, holes, actuator, and their respective arrangement used. Funnels were coupled to the floor of the processing chamber to receive remainder material through the slots and direct it away from the processing chamber through a material conveyance system comprising channels, the funnels being similar to the ones depicted in FIG. 16, 1650 such as funnel 1654, the channels being similar to channel 1653.

While preferred embodiments of the present invention(s) have been shown, and described herein, it will be obvious to those skilled in the art that such embodiments are provided by way of example only. It is not intended that the invention(s) be limited by the specific examples provided within the specification. While the invention(s) has been described with reference to the afore-mentioned specification, the descriptions and illustrations of the embodiments herein are not meant to be construed in a limiting sense. Numerous variations, changes, and substitutions will now occur to those skilled in the art without departing from the invention(s). Furthermore, it shall be understood that all aspects of the invention(s) are not limited to the specific depictions, configurations, or relative proportions set forth herein which depend upon a variety of conditions and variables. It should be understood that various alternatives to the embodiments of the invention(s) described herein might be employed in practicing the invention(s). It is therefore contemplated that the invention(s) shall also cover any such alternatives, modifications, variations, or equivalents. It is intended that the following claims define the scope of the invention(s) and that methods and structures within the scope of these claims and their equivalents be covered thereby.

1. A device for material removal, the device comprising:
a first conduit extending along a long axis, the first conduit being hollow and configured to facilitate flow of gaseous and non-gaseous material therethrough from a first opening of the first conduit to a second opening of the first conduit opposing the first opening, the first opening and the second opening being along the long axis of the first conduit;
a second conduit extending along the long axis, the second conduit being hollow and configured to facilitate flow of gas, the first conduit being disposed at least in part within the second conduit such that during operation at least a first portion of the first conduit overlaps a second portion of the second conduit, the second conduit having one or more perforations configured to facilitate flow of the gas into the hollow portion of the first conduit and the hollow portion of the second conduit; and;
the device being configured to reversibly toggle between a first orientation and a second orientation, the first orientation of the first conduit is adjustable with respect to the second orientation of the second conduit along the long axis, wherein adjustment of the first conduit with respect to the second conduit is alters the overlap between the first portion of the first conduit and the second portion of second conduit.

2-3. (canceled)

4. The device of claim 1, wherein the one or more perforations are positioned about an outer perimeter of the second conduit.

5. The device of claim 4, wherein the one or more perforations are distributed evenly about the outer perimeter of the second conduit.

6. (canceled)

7. The device of claim 4, wherein the one or more perforations are elongated along the long axis.

8-19. (canceled)

20. The device of claim 1, wherein the first conduit is operatively coupled to an attractive force source.

21. The device of claim 20, wherein the attractive force source comprises a vacuum force source, an electrostatic force source, or a magnetic force source.

22-23. (canceled)

24. The device of claim 1, wherein the non-gaseous material comprises an elemental metal, a metal alloy, a ceramic, or an allotrope of elemental carbon.

25. The device of claim 1, wherein the device is configured to attract the non-gaseous material, the material being a remainder of starting material for a three-dimensional printing and/or debris generated during the three-dimensional printing.

26-46. (canceled)

47. The device of claim 1, wherein the second conduit further comprises a third opening and a fourth opening opposing the third opening, the third opening being closer to the first opening as compared to the fourth opening, and wherein the device further comprises a first cover disposed about the first opening of the first conduit; or a second cover disposed about the third opening of the second conduit.

48. (canceled)

49. The device of claim 47, wherein the first cover or the second cover include at least one aperture.

50. The device of claim 49, wherein during operation of the device, the at least one aperture is configured to reduce clogging the first conduit by the non-gaseous material.

51. (canceled)

52. The device of claim 49, wherein the at least one aperture is configured to adjust a number of passageways through the at least one aperture, at least one dimension of the at least one aperture, or an orientation of the at least one aperture with respect to the long axis.

53. The device of claim 49, wherein the at least one aperture is configured to be rotatable or translatable.

54. The device of claim 1, wherein the first conduit comprises recessions arranged (I) on about the first opening of the first conduit and the second conduit further comprises recessions arranged about the third opening of the second conduit.

55. The device of claim 54, wherein during operation of the device, the recessions are configured to reduce clogging the first conduit by the non-gaseous material.

56. The device of claim 55, wherein each of the recessions comprise either a curved portion or a straight portion.

57. The device of claim 1, wherein further comprising an adjuster configured to reversibly adjust an overlap of the first conduit with respect to the second conduit.

58. The device of claim 1, wherein the first opening of the first conduit defines a surface oriented at an angle with respect to the long axis.

59-62. (canceled)

63. An apparatus for removing material, the apparatus comprising:
a first conduit extending from a first opening to a second opposed opening, the first conduit having a hollow portion and configured to facilitate flow of gaseous and non-gaseous material from the first opening to the second opening;
a second conduit extending from a first opening to a second opposed opening, the second conduit having a hollow portion, and one or more perforations, the first opening of the first conduit being positioned at least in part within the second opening of the second conduit such that a portion of the second conduit overlaps a portion of the first conduit, the one or more perforations configured to facilitate flow of the gas into the hollow portion of the second conduit and the hollow portion of the first conduit; and
the device being configured to reversibly toggle between a first orientation and a second orientation, the first orientation of the first conduit is adjustable with respect to the second orientation of the second conduit along the long axis, wherein adjustment of the first conduit with respect to the second conduit alters the amount of overlap between the first conduit and the second conduit.

64. The device of claim 63, wherein the one or more perforations are positioned about an outer perimeter of the second conduit.
